(19) United States
(12) Patent Application Publication
(10) Pub. No.: US 2024/0092024 A1
(43) Pub. Date: Mar. 21, 2024

(54) ARRAYS OF OPTICAL COMPONENTS IN THREE-DIMENSIONAL PRINTING

(71) Applicant: Velo3D, Inc., Campbell, CA (US)

(72) Inventors: Benyamin Buller, Cupertino, CA (US); Alexander Vladimirovich Varlakhanov, San Carlos, CA (US); Joseph Andrew Tralongo, El Cajon, CA (US); Gregory Ferguson Brown, San Jose, CA (US); Sergey Korepanov, Los Altos, CA (US)

(21) Appl. No.: 18/367,254

(22) Filed: Sep. 12, 2023

Related U.S. Application Data
(60) Provisional application No. 63/407,515, filed on Sep. 16, 2022.

(51) Int. Cl. B29C 64/386

(52) U.S. Cl. CPC B29C 64/386; B33Y 30/00

(57) ABSTRACT

The present disclosure provides three-dimensional (3D) printing systems, devices, apparatuses, methods, and non-transitory computer readable media associated with 3D printing systems that include dynamically movable optical components operatively coupled with a translation mechanism, e.g., comprising an optical image generator, a detector, or an optical assembly configured to direct a printing agent such as an energy beam. The present disclosure includes resulting objects printed in the 3D printing systems, as well as various other components relating to a 3D printing system.

### PRIORITY APPLICATIONS

This patent application claims priority to U.S. Provisional Patent Application Ser. No. 63/407,515 filed on Sep. 16, 2022, which is entirely incorporated herein by reference.

### BACKGROUND

Three-dimensional (3D) printing (e.g., additive manufacturing) is a process for making a three-dimensional object of any shape from a design. The design may be in the form of a data source such as an electronic data source or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, an allotrope of elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based at least in part on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

At times, a large build platform is required for 3D printing. For example, it may be requested to print a 3D object requiring the large build platform, or a number of 3D objects arranged laterally occupying a large lateral area of the build platform in a print cycle. It may be required to execute the print cycle at short time scales, and optionally (i) at high fidelity and/or (ii) at a consistent manner, e.g., consistent in terms of (a) geometry, (b) surface finish and/or (c) material properties. Such 3D printing may utilize processing by energy beams utilized for in the print cycle. The processing by the energy beams may (e.g., in terms of space and/or time) be at least partially concerted, cooperative, parallel and/or simultaneous. Stationary placement of energy beams may (A) not adequately cover a target surface utilized for the 3D printing and/or (B) require a large number of energy beams with respective fields of view (e.g., processing cones) to cover the target surface at a reasonable processing time period, e.g., the target surface being above the build platform supporting the 3D object(s) during their printing. The processing by the energy beams may generate debris that may compromise one or more of the energy beams during printing. For example, where debris generated within a field of view of a first energy beam (e.g., laser or e-beam) may compromise a field of view of at least one other (e.g., second) energy beam, e.g., due to a directional gas flow across the target surface from a first region including the field of view of the first energy beam to a second region including the field of view of the at least one other (e.g., second) energy beam. The compromised performance of the energy beam(s) affected by the debris may include compromised accuracy and/or compromised power of the energy beam affected by the debris. For example, some of the energy beam may be absorbed by the debris, e.g., on its way to the target surface. For example, some of the energy beam may be deflected by the debris, e.g., on its propagation path to the target surface.

### SUMMARY

In some aspects, the present disclosure resolves one or more of the aforementioned hardships. In an aspect disclosed herein is a 3D printing system including a build platform sufficient to accommodate 3D object(s) during a print cycle, and a dynamically movable optical system operatively coupled with (e.g., physically connected with) a translation mechanism. The translation mechanism is configured to receive (e.g., support, and/or affix) an array of optical assemblies with respect to the translation mechanism (e.g., on a support plate, mount, and/or fixture), e.g., an array of optical field replaceable units (also referred to herein as “optical FRUs” or “FRUs”). The optical assemblies (e.g., FRUs) are configured to each direct an energy beam towards a target surface within a processing chamber in which the build platform is disposed. The target surface may comprise an exposed surface of a material bed supported by the build platform. An optical assembly can be configured to direct an energy beam towards a sub-region of the target surface. The optical assemblies can operatively couple to the translation mechanism facilitating translation of the optical assemblies at least during the 3D printing. The optical assemblies may be arranged with respect to each other, e.g., to reduce a cross-contamination by debris such that debris generated by a respective energy beam of an (e.g., each) optical assembly during a 3D printing process in its field of view may have a minimal impact on an (e.g., each) other optical assembly of the optical assemblies. Reduce the cross contamination by the debris may include substantially and/or measurably eliminate the cross contamination by the debris. Minimal may comprise a substantially negligent or non-measurable. Substantially negligent may be with respect to the intended purpose of the printed 3D object(s). The energy beams may facilitate printing the 3D object(s) such that the debris may minimally cross contaminate another energy beam's field of view. The subject energy beams may or may not have an overlapping field of view. Translation of the optical assemblies between sub-regions on the target surface can reduce a cross-contamination by debris between different sub-regions of the target surface during the print cycle, and/or enable the high-fidelity 3D printing requested. The debris may comprise (e.g., may constitute) a byproduct of the 3D printing. The debris may comprise soot, splatter, or spatter. In some embodiments, the translation mechanism is configured to translate positions of the optical assemblies with respect to the build platform, e.g., to facilitate 3D printing at the target surface supported by the build platform. The build platform may be disposed in the processing chamber, e.g., with respect to optical window(s) of the processing chamber, to facilitate transmission of the energy beam(s) from one environment to another with minimal change comprising energy loss or alteration of trajectory. The one environment may comprise the internal environment of the FRU(s). the other environment may comprise the internal environment of the processing chamber. Translation of the translation mechanism may be optimized to minimize a time interval between print cycles. For example, to minimize a time to translate the translation mechanism while minimizing a time to sufficiently stabilize the optical components of the optical assemblies to facilitate accurate propagation of the energy beam in requested locations at the target surface.

In another aspect, a device for three-dimensional printing, the device comprises: an array of optical assemblies, each optical assembly of the array of optical assemblies comprises: at least one optical component configured to direct propagation of an energy beam along a beam path from within the optical assembly to impinge on a target surface disposed above a build platform, the build platform configured to carry at least one three-dimensional object printed by the three-dimensional printing; and a housing configured to (a) accommodate the at least one optical component and a portion of the beam path of the energy beam, and (b) allow impingement of the energy beam on the target surface to print the at least one three-dimensional object by the three-dimensional printing; and a translation mechanism supportive of the array of optical assemblies, the translation mechanism being configured to (e.g., linearly) translate the array of optical assemblies with respect to the target surface during at least a portion of the three-dimensional printing to facilitate printing the at least one three-dimensional object. In some embodiments, the translation mechanism is configured to (e.g., linearly) translate from a first alignment position with respect to a first processing region of the target surface to a second alignment position with respect to a second processing region of the target surface. In some embodiments, the first processing region at least borders or at least partially overlaps with the second processing region. In some embodiments, a surface of the at least one three-dimensional object spans at least the first processing region and the second processing region. In some embodiments, the translation mechanism is configured to (e.g., linearly) translate along a (e.g., substantially) straight line. In some embodiments, the translation mechanism is configured to (e.g., linearly) translate (i) laterally, (ii) horizontally, (iii) along an axis perpendicular to a gravitational vector aligned with a gravitational center, or (iv) any combination of (i), (ii), and (iii). In some embodiments, the gravitational center is a gravitational center of an environment in which the device is disposed. In some embodiments, the environment (e.g., external environment or ambient environment) is Earth. In some embodiments, the device further comprises an enclosure, where the build platform is disposed within the enclosure. In some embodiments, the enclosure comprises a processing chamber and a build module. In some embodiments, the translation mechanism is configured to translate with respect to the target surface disposed within the enclosure. In some embodiments, the translation mechanism is configured for incremental translation. In some embodiments, the translation mechanism is configured for continuous translation. In some embodiments, the translation mechanism is configured for discrete translation. In some embodiments, the translation mechanism is operatively coupled with operation of the printing agent such as the energy beam. In some embodiments, the translation mechanism is stationary during a portion of the printing, e.g., while the printing agent is active. In some embodiments, the translation mechanism is configured to (e.g., linearly) translate from a first lateral position with respect to the target surface to a second lateral position with respect to the target surface, e.g., disposed in an enclosure. In some embodiments, the device further comprises an array of optical windows disposed on a ceiling (e.g., roof) of the enclosure. In some embodiments, the device further comprises an array of optical windows is disposed on a wall of the enclosure opposing the target surface. In some embodiments, impingement comprises allowing the energy beam to traverse along the target surface to print the at least one three-dimensional object by the three-dimensional printing. In some embodiments, the translation mechanism is configured to (e.g., linearly) translate from a first alignment position with respect to a first process region of the target surface in the enclosure to a second alignment position with respect to a second process region of the target surface in the enclosure. In some embodiments, the device is configured such that, in the first alignment position and in the second alignment position, the housings of the array of optical assemblies are stationary with respect to the target surface during the three-dimensional printing. In some embodiments, the translation mechanism is configured to (e.g., linearly) translate for a first period of time comprising variable acceleration and for a second period time comprising variable deceleration. In some embodiments, an absolute value of an integration of the variable acceleration is different in magnitude from an absolute value of an integration of the variable deceleration. In some embodiments, an absolute value of an integration of the variable acceleration is (e.g., substantially) the same in magnitude as an absolute value of an integration of the variable deceleration. In some embodiments, the variable acceleration comprises variable magnitude of acceleration and the variable deceleration comprises variable magnitude of deceleration. In some embodiments, the translation mechanism is operatively coupled with the array of optical assemblies. In some embodiments, the translation mechanism is configured to (e.g., linearly) translate the array of optical assemblies along an axis parallel to the target surface. In some embodiments, the translation mechanism is configured to translate laterally along an axis that is perpendicular to a vertical axis (e.g., along an axis that is horizontal). In some embodiments, the translation mechanism is configured to translate laterally along an axis that is perpendicular to a gravitational vector pointing to a gravitational center. In some embodiments, the gravitational center is a gravitational center of an environment in which the device is disposed. In some embodiments, the environment is Earth. In some embodiments, the translation mechanism comprises guidance system such as a railing system. In some embodiments, the translation mechanism comprises a railing system, the railing system being configured to (e.g., linearly) translate the array of the optical assemblies from a first position to a second position with respect to the target surface, e.g., disposed in an enclosure. In some embodiments, the railing system comprises a labyrinth railing. In some embodiments, the railing system comprises a non-labyrinth railing. In some embodiments, the railing system comprises an actuator. In some embodiments, the actuator comprises a servo motor. In some embodiments, the railing system comprises two or more independently operable actuators. In some embodiments, at least two optical assemblies of the array of optical assemblies differ in their relative placement in the array of optical assemblies. In some embodiments, the device further comprises a sensor. In some embodiments, the sensor comprises a camera comprising a stills camera or a video camera. In some embodiments, the device further comprises an optical image generator. In some embodiments, the optical image generator comprises (i) a projector or (ii) a laser. In some embodiments, the sensor and the optical image generator are components of a metrological detection system. In some embodiments, at least one optical assembly of the array of optical assemblies includes, or is operatively coupled to, at least one of the components of the metrological detection system. In some embodiments, the metrological detection system comprises a plurality of optical image generators comprising the optical image generator. In some embodiments, the metrological detection system comprises a plurality of sensors comprising the sensor. In some embodiments, the metrological detection system comprises a plurality of optical image generators arranged in an array of optical image generators comprising the optical image generator. In some embodiments, the metrological detection system comprises a plurality of sensors arranged in an array of sensors. In some embodiments, the array of optical image generators is arranged with respect to the array of sensors such that at least a portion of the array of optical image generators is interleaved (e.g., interlaced or staggered) with a portion of the array of sensors. In some embodiments, at least one optical image generator of the array of optical image generators is interleaved with at least one sensor of the array of sensors. In some embodiments, at least one optical assembly of the array of optical assemblies comprises at least one of the components. In some embodiments, at least during operation, the components are configured for translation with respect to the translation mechanism. In some embodiments, at least during operation, at least two of the components are stationary with respect to the translation mechanism. In some embodiments, two of the components are of (e.g., substantially) the same type including (i) optical image generators or (ii) sensors. In some embodiments, two of the components are arranged symmetrically with respect to the translation mechanism and/or the build platform. In some embodiments, at least one of the components is enclosed by a housing of the at least one optical assembly (e.g., respectively). In some embodiments, at least one of the components is supported by a mounting plate of the translation mechanism and configured to translate with the array of optical assemblies. In some embodiments, at least one optical image generator is stationary with respect to a translation of the translation mechanism, where at least one projector is supported by the mounting plate of the translation mechanism such that the at least one projector translates with the array of optical assemblies. In some embodiments, the at least one of the components is arranged between two optical assemblies of the array of optical assemblies. In some embodiments, the at least one of the components is arranged between linear arrays of the optical assemblies. In some embodiments, the linear arrays being two immediately adjacent linear arrays devoid of an intervening linear array disposed between the two immediately adjacent linear arrays. In some embodiments, the at least one optical component is configured to direct an energy beam along a beam path from within the optical assembly to traverse along the target surface. In some embodiments, the device further comprises a plurality of optical windows, where the energy beam is configured to engage with an optical window of the plurality of optical windows such that the energy beam traverses the optical window to impinge on the target surface. In some embodiments, two or more energy beams are configured to engage with one optical window of the plurality of optical windows. In some embodiments, two or more energy beams are each configured to engage with a different optical window of the plurality of optical windows. In some embodiments, each energy beam of a plurality of energy beams is operatively coupled with a respective optical window of the plurality of optical windows. In some embodiments, fields of view of the energy beams of the plurality of energy beams are symmetrically arranged with respect to each other at the target surface, the plurality of energy beams impinging on the target surface. In some embodiments, the translation mechanism comprises a mounting plate operatively coupled with the array of optical assemblies. In some embodiments, operatively coupled comprises affixed to the mounting plate. In some embodiments, operatively coupled comprises reversibly attached to, and reversibly detached from, the mounting plate. In some embodiments, at least one optical assembly of the optical assemblies is modular. In some embodiments, at least one optical assembly of the array of optical assemblies is configured to be reversibly extracted, and reversibly inserted, into the array of optical assemblies. In some embodiments, at least one optical assembly is configured to be reversibly inserted into the array of optical assemblies at a time comprising before, or after, the three-dimensional printing. In some embodiments, the optical assemblies of the array of optical assemblies are arranged such that respective fields of view of the energy beams of the optical assemblies are disposed along at least one line with respect to the target surface. In some embodiments, the optical assemblies are disposed along an axis that is (i) lateral, (ii) horizontal, (iii) perpendicular to a gravitational vector aligned with a gravitational center, where the gravitational center is a gravitational center of an environment in which the device is disposed, or (iv) any combination of (i), (ii), and (iii). In some embodiments, the environment is Earth. In some embodiments, the optical assemblies of the array of optical assemblies are arranged such that the fields of view of the energy beams of the optical assemblies are disposed along at least two lines with respect to the target surface. In some embodiments, the at least two lines are (e.g., substantially) parallel to each other and perpendicular to the gravitational vector. In some embodiments, the at least two lines are separated from each other by a gap. In some embodiments, the gap is disposed along a direction of translation of the translation mechanism. In some embodiments, the optical assemblies of the array of optical assemblies are arranged such that the fields of view of the energy beams of the optical assemblies are disposed about a central axis oriented along a horizontal plane. In some embodiments, at least a first of the optical assemblies is disposed offset from the central axis by a first offset in a first direction perpendicular to the central axis. In some embodiments, at least a second of the optical assemblies is disposed offset from the central axis by a second offset in a second direction perpendicular to the central axis, the second direction opposite from the first direction from the central axis. In some embodiments, the optical assemblies are arranged with respect to the central axis such that the fields of view of the respective energy beams are disposed along a curvature with respect to the target surface. In some embodiments, at least two optical assemblies of the array of optical assemblies are (e.g., substantially) the same in their relative placement in the array of optical assemblies. In some embodiments, the array of optical assemblies comprises an odd number of optical assemblies. In some embodiments, the array of optical assemblies comprises an even number of optical assemblies. In some embodiments, two optical assemblies of at least one pair of optical assemblies of the array of optical assemblies are symmetrically arranged with respect to each other. In some embodiments, symmetrically arranged with respect to each other comprises a rotational symmetry axis, or a mirror symmetry plane, where the rotational symmetry axis is disposed between the two optical assemblies of the pair of optical assemblies, and where the mirror symmetry plane is disposed between the two optical assemblies of the pair of optical assemblies. In some embodiments, (A) the rotational symmetry axis and/or (B) the mirror symmetry plane, is perpendicular to a plane in which an optical window is disposed. In some embodiments, the symmetry the rotational symmetry axis comprises a C2 (180 degrees), C3 (120 degrees), or C4 (90 degrees) symmetry axis. In some embodiments, at least two optical assemblies of the array of optical assemblies are asymmetrically arranged with respect to each other. In some embodiments, the array of optical assemblies is configured to operatively couple to at least one optical window such that each optical assembly of a plurality of optical assemblies is engaged with an optical window; and where each optical assembly of the array of optical assemblies is configured to extend away from the optical window. In some embodiments, the array of optical assemblies is configured to operatively couple to a plurality of optical windows disposed adjacent to each other such that each optical assembly of the plurality of optical assemblies is engaged with an optical window of the plurality of optical windows; and where each optical assembly of the array of optical assemblies is configured to extend away from the optical window. In some embodiments, two or more optical assemblies are configured to engage with a same optical window of the plurality of optical windows. In some embodiments, the device where each optical assembly of the optical assemblies is operatively coupled with a respective optical window of an array of optical windows. In some embodiments, the optical assemblies of the array of optical assemblies are symmetrically arranged with respect to each other in the symmetry of the optical windows of the plurality of optical windows. In some embodiments, at least one pair of optical assemblies of the array of optical assemblies is disposed such that optical assemblies of the at least one pair of optical assemblies are disposed at opposing sides of an enclosure ceiling, the enclosure including the optical window at its ceiling. In some embodiments, each optical assembly of the array of optical assemblies is configured to extend away from the optical window to engage with (i) an energy source for the energy beam, (ii) a temperature conditioning source, (iii) a gas source, or (iv) any combination of (i), (ii), and (iii). In some embodiments, optical windows of the plurality of optical windows are symmetrically arranged with respect to each other. In some embodiments, symmetrically arranged with respect to each other comprises a rotational symmetry axis, or a mirror symmetry plane, where the rotational symmetry axis is disposed between two optical windows of a pair of optical windows and where the mirror symmetry plane is disposed between the two optical windows. In some embodiments, (A) the rotational symmetry axis and/or (B) the mirror symmetry plane, is perpendicular to a floor of the housing relative to a gravitational center, where the gravitational center is a gravitational center of an environment in which the device is disposed. In some embodiments, the environment is Earth. In some embodiments, the symmetry the rotational symmetry axis comprises a C2 (180 degrees), C3 (120 degrees), or C4 (90 degrees) symmetry axis. In some embodiments, at least two optical windows of the plurality of optical windows are asymmetrically arranged with respect to each other. In some embodiments, a respective fundamental length scale (FLS) of a first cross-section of at least one optical window is different than a corresponding FLS of a second cross-section of one other optical window. In some embodiments, a respective fundamental length scale (FLS) of a first cross-section of at least one optical window is (e.g., substantially) the same as a corresponding FLS of a second cross-section of one other optical window. In some embodiments, at least one optical window of the plurality of optical windows comprises a cross-section in a plane of the optical window that is (i) elliptical, (ii) polygonal, or (iii) irregular in shape. In some embodiments, elliptical comprises circular, and polygonal comprises rectangular. In some embodiments, the at least one optical window comprises an elongated dimension aligned along an axis that is (i) horizontal, (ii) perpendicular to a gravitational vector of an environment, or (iii) any combination of (i) and (ii). In some embodiments, at least two optical windows of the plurality of optical windows comprise a respective elongated dimension aligned with the axis, the respective elongated dimensions of each optical window being parallel to each other. In some embodiments, the elongated dimension has a length extending in a same direction as a translation direction of the translation mechanism. In some embodiments, the elongated dimension has a length extending in a perpendicular direction to a translation direction of the translation mechanism. In some embodiments, the plurality of optical windows comprises at least about 2, 4, 6, 8, 10, 12, 14, 16, 20, 24, 28, 32, or 36 optical windows. In some embodiments, the plurality of optical windows comprises an array of optical windows, the array of optical windows comprising at least two optical windows, the two optical windows being aligned along respective axis. In some embodiments, the array of optical windows comprises a linear array of optical windows. In some embodiments, the array of optical windows comprises a two-dimensional array of optical windows, the two-dimensional array comprising at least four optical windows. In some embodiments, the plurality of optical windows of the array of optical windows is periodically arranged with respect to a surface of an enclosure, where the surface comprises (a) a floor of the enclosure or (b) a ceiling of the enclosure. In some embodiments, the optical windows comprise arrays of optical windows, at least one (e.g., each) of the arrays having successively disposed optical windows along a single file. In some embodiments, the single file direction is along a direction of the translation of the translation mechanism. In some embodiments, the portion of the three-dimensional printing comprises extruding. In some embodiments, extruding is by an extruder to facilitate printing the at least one three-dimensional object. In some embodiments, the device is configured to comprise, or operatively coupled to, the extruder. In some embodiments, the portion of the three-dimensional printing comprises laminating. In some embodiments, laminating comprises depositing by a laminator configured to deposit layerwise laminated layers to facilitate printing the at least one three-dimensional object. In some embodiments, the device is configured to comprise, or be operatively coupled to, the laminator. In some embodiments, the portion of the three-dimensional printing comprises connecting particulate matter to facilitate printing the at least one three-dimensional object. In some embodiments, the particulate matter is disposed in a material bed. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, at least two optical assemblies of the array of optical assemblies are different in relative placement of their assembly components. In some embodiments, at least two optical assemblies of the array of optical assemblies are different in at least one type of their assembly components. In some embodiments, the assembly components comprise the at least one optical component. In some embodiments, at least two optical assemblies of the array of optical assemblies are different. In some embodiments, at least two optical assemblies of the array of optical assemblies are configured to be different in at least one environmental characteristic of their respective internal environment as compared to an ambient environment external to the at least two optical assemblies. In some embodiments, during operation, the at least one environmental characteristic of the internal environment comprises (i) an environmental temperature, (ii) a pressure in the environment, (iii) a level of reactant species present in the environment, or (iv) any combination thereof, the at least one environmental characteristic of the internal environment being with respect to the ambient environment external to the at least two optical assemblies. In some embodiments, at least two optical assemblies of the array of optical assemblies are (e.g., substantially) the same. In some embodiments, at least two optical assemblies of the array of optical assemblies are (e.g., substantially) the same in relative placement of their assembly components. In some embodiments, at least two optical assemblies of the array of optical assemblies are different in at least one type of assembly components. In some embodiments, the at least one type of assembly components comprises the at least one optical component. In some embodiments, the at least one optical component comprises a scanner. In some embodiments, at least two optical assemblies of the array of optical assemblies are (e.g., substantially) the same in at least one environmental characteristic of their respective internal environment as compared to an ambient environment external to the at least two optical assemblies. In some embodiments, the at least one environmental characteristic of the respective internal environment comprises (i) an environmental temperature during operation, (ii) an operating pressure in the environment, (iii) a level of reactant species present in the environment during operation, or (iv) any combination thereof, the at least one environmental characteristic of the respective internal environment being with respect to the ambient environment external to the at least two optical assemblies. In some embodiments, the optical assemblies of the array of optical assemblies are operatively coupled with at least one optical window of an enclosure. In some embodiments, at least one of the optical windows are supported by and/or disposed in a nozzle having a gas outlet including at least one outlet opening. In some embodiments, the at least one outlet opening is arranged with respect to the at least one optical window and configured to direct a flow of gas away from the optical window. In some embodiments, the at least one outlet opening is configured to direct the flow of gas away from the at least one optical window and towards a target surface. In some embodiments, the at least one outlet opening is configured to direct the flow of gas away from the at least one optical window and towards an inner volume of an enclosure in which the target surface is disposed. In some embodiments, the flow of gas is at least about 3 kilopascals. In some embodiments, the flow of gas is sufficient to (e.g., substantially) eliminate debris in the enclosure from contacting a surface of the optical window. In some embodiments, at least a part of the debris is generated as a byproduct during the three-dimensional printing. In some embodiments, the flow of gas is sufficient to (e.g., substantially) eliminate debris in the enclosure from adhering to the surface of the optical window. In some embodiments, the at least one outlet opening comprises a plurality of outlet openings. In some embodiments, the at least one optical window comprises a material having diminished (e.g., substantially lacking) absorption of electromagnetic wavelengths between about 400 nanometers (nm) to 4000 nm during the three-dimensional printing. In some embodiments, the at least one optical window comprises a material having diminished (e.g., substantially lacking) thermal absorption during the three-dimensional printing. In some embodiments, the at least one optical window comprises a material having diminished (e.g., substantially lacking) thermal lensing effect during the three-dimensional printing. In some embodiments, the material of the at least one optical window comprises sapphire, beryllium, zinc selenide, calcium fluoride (CaF₂), or fused silica. In some embodiments, the device further comprises an alignment detection system operatively coupled to, or a component of, (i) the translation mechanism and/or (ii) the array of optical assemblies. In some embodiments, the alignment detection system comprises (A) at least one detector, (B) at least one energy source, or (C) a combination thereof. In some embodiments, the energy source comprises a light source. In some embodiments, the light source comprises a visible light source. In some embodiments, the light source comprises an infrared light source. In some embodiments, the light source comprises a laser light source. In some embodiments, the light source comprises a structured light source. In some embodiments, the structured light source is configured to generate structured light comprising areas of detectable varied light intensity. In some embodiments, the varied light intensity comprises no intensity. In some embodiments, the structured light source is configured to direct structured light onto the target surface. In some embodiments, the detector comprises an interferometric detector. In some embodiments, the detector comprises a stills camera or a video camera. In some embodiments, the camera comprises (i) a complementary metal-oxide semiconductor (CMOS) detector or (ii) a charge-coupled detector (CCD) camera. In some embodiments, at least one optical assembly of the array of optical assemblies comprises a detector configured to detect a reflected light from the target surface, from at least a portion of the at least one three-dimensional object, or from the target surface and from the at least the portion of the at least one three-dimensional object. In some embodiments, the target surface is an exposed surface of a material bed In some embodiments, the material bed comprises a powder bed. In some embodiments, the material bed includes a material comprising an elemental metal, a metal alloy, a ceramic, or an allotrope of elemental carbon. In some embodiments, the array of optical assemblies comprises an even number of optical assemblies. In some embodiments, the array of optical assemblies comprises an odd number of optical assemblies. In some embodiments, the array of optical assemblies comprises at least 2, 4, 6, 8, 16, 24, 32, or 64 optical assemblies. In some embodiments, the target surface comprises (i) an exposed surface of a material bed or (ii) a surface of the build platform. In some embodiments, the material bed generated on the surface of the build platform having a fundamental length scale of at least about 400 mm, 600 mm, 1000 mm, 1200 mm, 1500 mm, or 1750 mm. In some embodiments, the material bed is generated on the surface of the build platform; and wherein the build platform is configured to support a weight of at least about 1000 kg, or 2000 kg. In some embodiments, the material bed has at least one fundamental length scale of at least about 400 mm, 600 mm, 1000 mm, 1200 mm, 1500 mm, or 1750 mm. In some embodiments, facilitating the three-dimensional printing comprises facilitating deposition of pre-transformed material on a target surface. In some embodiments, the device further comprises a dispenser configured to dispense a first portion of pre-transformed material on the target surface. In some embodiments, the device further comprises a remover configured to remove a second portion of the deposited pre-transformed material from the target surface to generate a planar layer of pre-transformed material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of the pre-transformed material removed by the remover and/or (ii) provides at least a portion of the pre-transformed material utilized by the dispenser. In some embodiments, facilitating deposition of pre-transformed material on the target surface comprises enlarging a volume of the material bed, where an exposed surface of the material is (e.g., substantially) at a same position after deposition of pre-transformed material on the target surface, e.g., as part of alignment of energy beam(s). In some embodiments, facilitating deposition of pre-transformed material on the target surface comprises layerwise deposition. In some embodiments, the pre-transformed material comprises powder material. In some embodiments, the pre-transformed material comprises elemental metal, metal alloy, ceramic, or an allotrope of carbon. In some embodiments, the device is configured to operate at an interior atmosphere of an enclosure that is different from an ambient atmosphere external to the enclosure. In some embodiments, the device is configured to operate at an interior atmosphere of an enclosure under a positive pressure atmosphere relative to an ambient atmosphere external to the enclosure. In some embodiments, the device is configured to operate at an interior atmosphere of an enclosure that is depleted of a reactive agent relative to its concentration in an ambient atmosphere external to the the enclosure, the reactive agent being configured to react with a starting material of the three-dimensional printing at least during the three-dimensional printing. In some embodiments, the reactive agent comprises oxygen, water, or hydrogen sulfide. In some embodiments, the device further comprises an enclosure comprising a build module body configured to retain the build platform during the three-dimensional printing. In some embodiments, the build module body further comprises a seal. In some embodiments, the seal is included, or is operatively coupled with a shutter, a lid, a closure, an envelope, or a flap. In some embodiments, the seal is arranged with respect to an upper-most portion of the build module body and opposite a bottom portion of the build module body. In some embodiments, the seal is gas tight. In some embodiments, the seal is a hermetic seal. In some embodiments, the enclosure comprises a processing chamber engaged with the build module during the three-dimensional printing. In some embodiments, the seal is configured to facilitate retaining an internal atmosphere in the build module body for a time period after disengagement of the build module from the processing chamber, the internal atmosphere being different from an ambient atmosphere external to the build module. In some embodiments, the seal is configured to facilitate retaining for a time period after disengagement of the build module from the processing chamber (i) a positive pressure in the build module body relative to an ambient atmosphere external to the device and/or (ii) a reactive agent at a concentration lower than its concentration in an ambient atmosphere external to the build module, the reactive agent being configured to at least react with pre-transformed material of the three-dimensional printing during the three-dimensional printing. In some embodiments, the device is configured to facilitate printing one or more three-dimensional objects in an atmosphere maintained to be different from an ambient atmosphere by at least one characteristic, the ambient atmosphere being external to a build module and to an enclosure. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, the housing is configured to facilitate flow of at least one coolant type therethrough, the at least one coolant type configured to cool a mirror and/or an actuator during operation of the device to translate the energy beam. In some embodiments, the at least one coolant type comprises a gas, a liquid, or a semisolid. In some embodiments, the at least one coolant type comprises air, nitrogen, argon, or water. In some embodiments, the air comprises clean dry air. In some embodiments, the housing is configured to operate under a positive pressure atmosphere relative to an ambient atmosphere external to the housing. In some embodiments, the housing is configured to operate under a positive pressure atmosphere relative to the ambient atmosphere external to the housing that is different than a positive pressure atmosphere relative to the ambient atmosphere in an enclosure. In some embodiments, the housing is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide.

In another aspect, a method of three-dimensional printing, the method comprises: providing the device of any of the above devices; and using the device during three-dimensional printing. In some embodiments, the three-dimensional printing comprises connecting a particulate matter, e.g., powder. In some embodiments, connecting comprises fusing. In some embodiments, fusing comprises melting.

In another aspect, an apparatus for three-dimensional printing, the apparatus comprising at least one controller configured to (i) operatively coupled with the device of any of the above devices; and control, or direct control of, one or more operations associated with the device. In some embodiments, the at least one controller is operatively coupled with at least one connector configured to connect to a power source, e.g., electrical power source. In some embodiments, the at least one controller is configured to operatively couple to a power source at least in part by (i) having a power socket and/or (ii) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the device is a component of a three-dimensional printing system, and where the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing.

In another aspect, non-transitory computer readable program instructions for three-dimensional printing, the program instructions, when read by one or more processors operatively coupled with the device of any of the above devices cause the one or more processors to execute, or direct execution of, one or more operations associated with the device. In some embodiments, the non-transitory computer readable program instructions where the program instructions are inscribed in one or more media.

In another aspect, a system for three-dimensional printing, the system comprises: the device of any of the above devices (e.g., configured to perform three-dimensional printing); and an energy beam configured to irradiate the target surface (e.g., of a planar layer of powder material) to print at least a portion of at least one three-dimensional object at least in part by using the three-dimensional printing. In some embodiments, the system further comprises a scanner configured to translate the energy beam along a target surface, where the device is operatively coupled with the scanner. In some embodiments, the system further comprises an energy source configured to generate the energy beam, where the device is operatively coupled with the energy source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

In another aspect, an object printed by three-dimensional printing, the object having three-dimensions and printed utilizing the device of any of the above devices. In some embodiments, the object comprises successive layers of hardened material, the successive layers being stacked.

In another aspect, a method for three-dimensional printing, the method comprises: (A) propagating an energy beam along a beam path from within an optical assembly to impinge on a target surface disposed above a build platform to print a portion of at least one three-dimensional object, the build platform configured to carry the at least one three-dimensional object, the optical assembly being included in an array of optical assemblies, each respective optical assembly of the array of optical assemblies comprises: (I) at least one respective optical component configured to direct propagation of a respective energy beam along a respective beam path from within the respective optical assembly to impinge on the target surface, and (II) a respective housing configured to (a) accommodate the at least one respective optical component and a portion of the respective beam path, and (b) allow impingement of the respective energy beam on the target surface to print a respective portion of the at least one three-dimensional object by the three-dimensional printing; and (B) (e.g., linearly) translating the array of optical assemblies with respect to the target surface to facilitate printing the at least one three-dimensional object. In some embodiments, (A) is performed prior to (B), where (B) is performed prior to (A), where (A)-(B) is repeated until the three-dimensional object is completed. In some embodiments, directing an array of energy beams along an array of beam paths from within an array of optical assemblies to impinge on a target surface disposed above a build platform to print at least one three-dimensional object, the build platform configured to carry the at least one three-dimensional object. In some embodiments, the method further comprises: directing a first energy beam along a first beam path from within a first optical assembly of an array of optical assemblies and towards a target surface disposed above a build platform to print a first portion of one or more three-dimensional objects by three-dimensional printing; and directing a second energy beam along a second beam path from within a second optical assembly of the array of optical assemblies and towards the target surface disposed above the build platform to print a second portion of the one or more three-dimensional objects by three-dimensional printing. In some embodiments, the first energy beam and second energy beam are (e.g., substantially) the same. In some embodiments, the first energy beam and second energy beam are different. In some embodiments, the first portion and second portion are of a same three-dimensional object of the one or more objects. In some embodiments, the first portion and second portion are of different three-dimensional objects of the one or more objects. In some embodiments, (e.g., linearly) translating comprises aligning the array of optical assemblies from a first position to a second position. In some embodiments, (e.g., linearly) translating comprises translating the array of optical assemblies from alignment with a first process region to alignment with a second process region.

In another aspect, an apparatus for three-dimensional printing, the apparatus comprising at least one controller configured to: (A) operatively couple to an array of optical assemblies, each respective optical assembly of the array of optical assemblies comprises: (I) at least one respective optical component configured to direct a respective energy beam along a respective beam path from within the respective optical assembly to impinge on a target surface, and (II) a respective housing configured to (a) accommodate the at least one respective optical component and a portion of the respective beam path, and (b) allow impingement of the respective energy beam on the target surface to print a respective portion of at least one three-dimensional object by the three-dimensional printing; (B) operatively couple to a translation mechanism that is operatively coupled to, or that is part of, the array of optical assemblies; (C) direct propagation of an energy beam along a beam path from within an optical assembly to impinge on the target surface disposed above a build platform to print a portion of the at least one three-dimensional object, the build platform configured to carry the at least one three-dimensional object, the optical assembly being included in the array of optical assemblies; and (D) direct (e.g., linear) translation of the array of optical assemblies with respect to the target surface to facilitate printing the at least one three-dimensional object. In some embodiments, the at least one controller is configured to (i) operatively couple to a guidance system, and (ii) direct the guidance system to guide the energy beam to impinge on the target surface at a location. In some embodiments, directing the guidance system comprises guiding the energy beam to traverse along the target surface. In some embodiments, the at least one controller is configured to (i) operatively couple to at least one actuator, and (ii) direct the at least one actuator to (e.g., linearly) translate the array of optical assemblies with respect to the target surface. In some embodiments, the at least one controller is configured to direct a flow of gas through at least one outlet opening of a gas outlet away from an optical window and toward the target surface.

In another aspect, non-transitory computer readable program instructions for three-dimensional printing, the non-transitory computer readable program instructions, when read by one or more processors operatively coupled with an array of optical assemblies, cause the one or more processors to execute operations comprises: (a) directing propagation of an energy beam along a beam path from within an optical assembly to impinge on a target surface disposed above a build platform to print a portion of at least one three-dimensional object, the build platform configured to carry the at least one three-dimensional object, the optical assembly being included in the array of optical assemblies, each respective optical assembly of the array of optical assemblies comprises: (I) at least one respective optical component configured to direct a respective energy beam along a respective beam path from within the respective optical assembly to impinge on the target surface, and (II) a respective housing configured to (A) accommodate the at least one respective optical component and a portion of the respective beam path, and (B) allow impingement of the respective energy beam on the target surface to print a respective portion of the at least one three-dimensional object by the three-dimensional printing; and (b) directing (e.g., linear) translation of the array of optical assemblies with respect to the target surface to facilitate printing the at least one three-dimensional object. In some embodiments, the one or more processors can direct other devices to perform mechanical operations. In some embodiments, the non-transitory computer readable program instructions where the one or more processors perform (i) calculations and/or (ii) other digital operations (e.g., logical operations). In some embodiments, the one or more processors are coupled to a guidance system, and where the operations comprise directing the guidance system to guide the energy beam to impinge on the target surface at a location. In some embodiments, the operations comprise directing the guidance system to guide the energy beam to traverse along the target surface. In some embodiments, the one or more processors are operatively coupled with at least one actuator, and where the operations comprise directing the at least one actuator to (e.g., linearly) translate the array of optical assemblies with respect to the target surface.

In another aspect, an object printed by three-dimensional printing, the object having three-dimensions, the three-dimensional printing comprises at least one material indication of the three-dimensional printing comprising: (A) propagating an energy beam along a beam path from within an optical assembly to impinge on a target surface disposed above a build platform to print a portion of at least one three-dimensional object, the build platform configured to carry the at least one three-dimensional object, the optical assembly being included in an array of optical assemblies, each respective optical assembly of the array of optical assemblies comprises: (I) at least one respective optical component configured to direct propagation of a respective energy beam along a respective beam path from within the respective optical assembly to impinge on the target surface, and (II) a respective housing configured to (a) accommodate the at least one respective optical component and a portion of the respective beam path, and (b) allow impingement of the respective energy beam on the target surface to print a respective portion of the at least one three-dimensional object by the three-dimensional printing; and (B) (e.g., linearly) translating the array of optical assemblies with respect to the target surface to facilitate printing the at least one three-dimensional object.

In another aspect, a device for three-dimensional printing, the device comprises: an optical assembly comprises: at least one optical component configured to direct propagation of an energy beam along a beam path from within the optical assembly to impinge on a target surface disposed above a build platform, the build platform configured to carry at least one three-dimensional object printed by the three-dimensional printing; and a housing configured to (a) accommodate the at least one optical component and a portion of the beam path of the energy beam, and (b) allow impingement of the energy beam on the target surface to print the at least one three-dimensional object by the three-dimensional printing; and a translation mechanism supportive of the optical assembly, the translation mechanism being configured to effectuate a linear translation the optical assembly with respect to the target surface during at least a portion of the three-dimensional printing to facilitate printing the at least one three-dimensional object, the linear translation including (i) a first period of time of variable acceleration and (ii) a second period of time of variable deceleration. In some embodiments, the linear translation occurs during at least a portion of the three-dimensional printing. In some embodiments, the variable acceleration includes (i) a variable magnitude of acceleration (ii) a variable time span of the acceleration, or (iii) a variable magnitude of acceleration and a variable time span of the acceleration. In some embodiments, the variable deceleration includes (i) a variable magnitude of deceleration, (ii) a variable time span of the deceleration, or (iii) a variable magnitude of deceleration and a variable time span of the deceleration. In some embodiments, an absolute value of an integration of the variable acceleration is different in magnitude from an absolute value of an integration of the variable deceleration. In some embodiments, an absolute value of an integration of the variable acceleration is (e.g., substantially) the same in magnitude an absolute value of an integration of the variable deceleration. In some embodiments, a vector of the variable acceleration is oriented in an opposite direction to a vector of the variable deceleration. In some embodiments, the translation mechanism is configured to (e.g., linearly) translate from a first alignment position with respect to a first processing region of the target surface to a second alignment position with respect to a second processing region of the target surface. In some embodiments, the first processing region at least borders or at least partially overlaps with the second processing region. In some embodiments, a surface of the at least one three-dimensional object spans at least the first processing region and the second processing region. In some embodiments, the translation mechanism is configured to (e.g., linearly) translate along a (e.g., substantially) straight line. In some embodiments, the translation mechanism is configured to (e.g., linearly) translate (i) laterally, (ii) horizontally, (iii) along an axis perpendicular to a gravitational vector aligned with a gravitational center, or (iv) any combination of (i), (ii), and (iii). In some embodiments, the gravitational center is a gravitational center of an environment in which the device is disposed. In some embodiments, the environment is Earth. In some embodiments, the device further comprises an enclosure, where the build platform is disposed within the enclosure. In some embodiments, the enclosure comprises a processing chamber and a build module. In some embodiments, the translation mechanism is configured to translate with respect to the target surface disposed within the enclosure. In some embodiments, the translation mechanism is configured for incremental translation. In some embodiments, the translation mechanism is configured for continuous translation. In some embodiments, the translation mechanism is configured for discrete translation. In some embodiments, the translation mechanism is operatively coupled with operation of the printing agent such as the energy beam. In some embodiments, the translation mechanism is stationary during a portion of the printing, e.g., while the printing agent is active. In some embodiments, the translation mechanism is configured to (e.g., linearly) translate from a first lateral position with respect to the target surface to a second lateral position with respect to the target surface, e.g., disposed in an enclosure. In some embodiments, the device further comprises an array of optical windows disposed on a ceiling (e.g., roof) of the enclosure. In some embodiments, the device further comprises an array of optical windows is disposed on a wall of the enclosure opposing the target surface. In some embodiments, impingement comprises allowing the energy beam to traverse along the target surface to print the at least one three-dimensional object by the three-dimensional printing. In some embodiments, the translation mechanism is configured to (e.g., linearly) translate from a first alignment position with respect to a first process region of the target surface (e.g., in an enclosure) to a second alignment position with respect to a second process region of the target surface (e.g., in the enclosure). In some embodiments, the device is configured such that, in the first alignment position and in the second alignment position, the housing of the optical assembly is stationary with respect to the target surface during the three-dimensional printing. In some embodiments, the translation mechanism is operatively coupled with the array of optical assemblies. In some embodiments, the translation mechanism is configured to (e.g., linearly) translate the optical assembly along an axis parallel to the target surface. In some embodiments, the translation mechanism is configured to translate laterally along an axis that is perpendicular to a vertical axis (e.g., along an axis that is horizontal). In some embodiments, the translation mechanism is configured to translate laterally along an axis that is perpendicular to a gravitational vector pointing to a gravitational center. In some embodiments, the gravitational center is a gravitational center of an environment in which the device is disposed. In some embodiments, the environment is Earth. In some embodiments, the translation mechanism comprises guidance system such as a railing system. In some embodiments, the translation mechanism comprises a railing system, the railing system being configured to (e.g., linearly) translate the optical assembly from a first position to a second position with respect to the target surface, e.g., disposed in an enclosure. In some embodiments, the railing system comprises at labyrinth railing. In some embodiments, the railing system comprises at non-labyrinth railing. In some embodiments, the railing system comprises an actuator. In some embodiments, the actuator comprises a servo motor. In some embodiments, the railing system comprises two or more independently operable actuators. In some embodiments, the device further comprises a sensor. In some embodiments, the sensor comprises a camera comprising a stills camera or a video camera. In some embodiments, the device further comprises an optical image generator. In some embodiments, the optical image generator comprises (i) a projector or (ii) a laser. In some embodiments, the sensor and the optical image generator are components of a metrological detection system. In some embodiments, the optical assembly includes, or is operatively coupled to, at least one of the components of the metrological detection system. In some embodiments, the metrological detection system comprises a plurality of optical image generators comprising the optical image generator. In some embodiments, the metrological detection system comprises a plurality of sensors comprising the sensor. In some embodiments, the metrological detection system comprises a plurality of optical image generators arranged in an array of optical image generators comprising the optical image generator. In some embodiments, the metrological detection system comprises a plurality of sensors arranged in an array of sensors. In some embodiments, the array of optical image generators is arranged with respect to the array of sensors such that at least a portion of the array of optical image generators is interleaved (e.g., interlaced or staggered) with a portion of the array of sensors. In some embodiments, at least one optical image generator of the array of optical image generators is interleaved with at least one sensor of the array of sensors. In some embodiments, at least during operation, the components of the metrological detection system are configured for translation with respect to the translation mechanism. In some embodiments, at least during operation, at least two of the components of the metrological detection system are stationary with respect to the translation mechanism. In some embodiments, two of the components of the metrological detection system are of (e.g., substantially) the same type including (i) optical image generators or (ii) sensors. In some embodiments, two of the components of the metrological detection system are arranged symmetrically with respect to the translation mechanism and/or the build platform. In some embodiments, at least one of the components of the metrological detection system is supported by a mounting plate of the translation mechanism and configured to translate with the array of optical assemblies. In some embodiments, at least one optical image generator is stationary with respect to a translation of the translation mechanism, where at least one projector is supported by the mounting plate of the translation mechanism such that the at least one projector translates with the array of optical assemblies. In some embodiments, the translation mechanism comprises a mounting plate operatively coupled with the optical assembly. In some embodiments, operatively coupled comprises affixed to the mounting plate. In some embodiments, operatively coupled comprises reversibly attached to, and reversibly detached from, the mounting plate. In some embodiments, the optical assembly is (e.g., all optical assemblies are) modular. In some embodiments, the optical assembly is configured to be reversibly extracted, and reversibly inserted, into an array of optical assemblies. In some embodiments, the optical assembly is configured to be reversibly inserted into the array of optical assemblies at a time comprising before, or after, the three-dimensional printing. In some embodiments, the optical assembly is configured to operatively couple to at least one optical window such that the optical assembly is engaged with an optical window of the at least one optical window; and where the optical assembly is configured to extend away from the optical window. In some embodiments, the optical assembly is configured to extend away from the optical window to engage with (i) an energy source for the energy beam, (ii) a temperature conditioning source, (iii) a gas source, or (iv) any combination of (i), (ii), and (iii). In some embodiments, optical windows of a plurality of optical windows are symmetrically arranged with respect to each other. In some embodiments, symmetrically arranged with respect to each other comprises a rotational symmetry axis, or a mirror symmetry plane, where the rotational symmetry axis is disposed between two optical windows of the plurality of optical windows, and where the mirror symmetry plane is disposed between the two optical windows. In some embodiments, (A) the rotational symmetry axis and/or (B) the mirror symmetry plane, is perpendicular to a floor of the housing relative to a gravitational center, where the gravitational center is a gravitational center of an environment in which the device is disposed. In some embodiments, the environment is Earth. In some embodiments, the symmetry the rotational symmetry axis comprises a C2 (180 degrees), C3 (120 degrees), or C4 (90 degrees) symmetry axis. In some embodiments, at least two optical windows of the plurality of optical windows are asymmetrically arranged with respect to each other. In some embodiments, a respective fundamental length scale (FLS) of a first cross-section of at least one optical window is different that a corresponding FLS of a second cross-section of one other optical window. In some embodiments, a respective fundamental length scale (FLS) of a first cross-section of at least one optical window is (e.g., substantially) the same as a corresponding FLS of a second cross-section of one other optical window. In some embodiments, at least one optical window of the plurality of optical windows comprises a cross-section in a plane of the optical window that is (i) elliptical, (ii) polygonal, or (iii) irregular in shape. In some embodiments, elliptical comprises circular, and where polygonal comprises rectangular. In some embodiments, the at least one optical window comprises an elongated dimension aligned along an axis that is (i) horizontal, (ii) perpendicular to a gravitational vector of an environment, or (iii) any combination of (i) and (ii). In some embodiments, at least two optical windows of the plurality of optical windows comprise a respective elongated dimension aligned with the axis, the respective elongated dimensions of each optical window being parallel to each other. In some embodiments, the elongated dimension has a length extending in a same direction as a translation direction of the translation mechanism. In some embodiments, the elongated dimension has a length extending in a perpendicular direction to a translation direction of the translation mechanism. In some embodiments, the plurality of optical windows comprises at least about 2, 4, 6, 8, 10, 12, 14, 16, 20, 24, 28, 32, or 36 optical windows. In some embodiments, the plurality of optical windows comprises an array of optical windows, the array of optical windows comprising at least two optical windows, the two optical windows being aligned along respective axis. In some embodiments, the array of optical windows comprises a linear array of optical windows. In some embodiments, the array of optical windows comprises a two-dimensional array of optical windows, the two-dimensional array comprising at least four optical windows. In some embodiments, the plurality of optical windows of the array of optical windows is periodically arranged with respect to a surface of an enclosure, where the surface comprises (a) a floor of the enclosure or (b) a ceiling of the enclosure. In some embodiments, the optical windows comprise arrays of optical windows, at least one (e.g., each) of the arrays having successively disposed optical windows along a single file. In some embodiments, the single file direction is along a direction of the translation of the translation mechanism. In some embodiments, the portion of the three-dimensional printing comprises extruding. In some embodiments, extruding is by an extruder to facilitate printing the at least one three-dimensional object. In some embodiments, the device is configured to comprise, or operatively coupled to, the extruder. In some embodiments, the portion of the three-dimensional printing comprises laminating. In some embodiments, laminating comprises depositing by a laminator configured to deposit layerwise laminated layers to facilitate printing the at least one three-dimensional object. In some embodiments, the device is configured to comprise, or be operatively coupled to, the laminator. In some embodiments, the portion of the three-dimensional printing comprises connecting particulate matter to facilitate printing the at least one three-dimensional object. In some embodiments, the particulate matter is disposed in a material bed. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, at least two optical assemblies of the array of optical assemblies are different in relative placement of their assembly components. In some embodiments, at least two optical assemblies of the array of optical assemblies are different in at least one type of their assembly components. In some embodiments, the assembly components comprise the at least one optical component. In some embodiments, at least two optical assemblies of the array of optical assemblies are different. In some embodiments, at least two optical assemblies of the array of optical assemblies are configured to be different in at least one environmental characteristic of their respective internal environment as compared to an ambient environment external to the at least two optical assemblies. In some embodiments, during operation, the at least one environmental characteristic of the internal environment comprises (i) an environmental temperature, (ii) a pressure in the environment, (iii) a level of reactant species present in the environment, or (iv) any combination thereof, the at least one environmental characteristic of the internal environment being with respect to the ambient environment external to the at least two optical assemblies. In some embodiments, at least two optical assemblies of the array of optical assemblies are (e.g., substantially) the same. In some embodiments, at least two optical assemblies of the array of optical assemblies are (e.g., substantially) the same in relative placement of their assembly components. In some embodiments, at least two optical assemblies of the array of optical assemblies are different in at least one type of assembly components. In some embodiments, the at least one type of assembly components comprise the at least one optical component. In some embodiments, the at least one optical component comprises a scanner. In some embodiments, at least two optical assemblies of the array of optical assemblies are (e.g., substantially) the same in at least one environmental characteristic of their respective internal environment as compared to an ambient environment external to the at least two optical assemblies. In some embodiments, the at least one environmental characteristic of the respective internal environment comprises (i) an environmental temperature during operation, (ii) an operating pressure in the environment, (iii) a level of reactant species present in the environment during operation, or (iv) any combination thereof, the at least one environmental characteristic of the respective internal environment being with respect to the ambient environment external to the at least two optical assemblies. In some embodiments, the optical assemblies of the array of optical assemblies are operatively coupled with at least one optical window of an enclosure. In some embodiments, at least one of the optical windows are supported by and/or disposed in a nozzle having a gas outlet including at least one outlet opening. In some embodiments, the at least one outlet opening is arranged with respect to the optical window and configured to direct a flow of gas away from the at least one optical window. In some embodiments, the at least one outlet opening is configured to direct the flow of gas away from the at least one optical window and towards the target surface. In some embodiments, the at least one outlet opening is configured to direct the flow of gas away from the at least one optical window and towards an inner volume of the enclosure. In some embodiments, the flow of gas is at least about 3 kilopascals. In some embodiments, the flow of gas is sufficient to (e.g., substantially) eliminate debris in the enclosure from contacting a surface of the at least one optical window. In some embodiments, at least a part of the debris is generated as a byproduct during the three-dimensional printing. In some embodiments, the flow of gas is sufficient to (e.g., substantially) eliminate debris in the enclosure from adhering to the surface of the at least one optical window. In some embodiments, the gas outlet comprises a plurality of outlet openings. In some embodiments, the at least one optical window comprises a material having diminished (e.g., substantially lacking) absorption of electromagnetic wavelengths between about 400 nanometers (nm) to 4000 nm during the three-dimensional printing. In some embodiments, the optical window comprises a material having diminished (e.g., substantially lacking) thermal absorption during the three-dimensional printing. In some embodiments, the optical window comprises a material having diminished (e.g., substantially lacking) thermal lensing effect during the three-dimensional printing. In some embodiments, the material of the at least one optical window comprises sapphire, beryllium, zinc selenide, calcium fluoride (CaF₂), or fused silica. In some embodiments, the device further comprises an alignment detection system operatively coupled to, or a component of, (i) the translation mechanism and/or (ii) the array of optical assemblies. In some embodiments, the alignment detection system comprises (A) at least one detector, (B) at least one energy source, or (C) a combination thereof. In some embodiments, the energy source comprises a light source. In some embodiments, the light source comprises a visible light source. In some embodiments, the light source comprises an infrared light source. In some embodiments, the light source comprises a laser light source. In some embodiments, the light source comprises a structured light source. In some embodiments, the structured light source is configured to generate structured light comprising areas of detectable varied light intensity. In some embodiments, the varied light intensity comprises no intensity. In some embodiments, the structured light source is configured to direct structured light onto the target surface. In some embodiments, the detector comprises an interferometric detector. In some embodiments, the detector comprises a stills camera or a video camera. In some embodiments, the detector comprises (i) a complementary metal-oxide semiconductor (CMOS) detector or (ii) a charge-coupled detector (CCD) camera. In some embodiments, at least one optical assembly of the array of optical assemblies comprises a detector configured to detect a reflected light from the target surface, from at least a portion of the at least one three-dimensional object, or from the target surface and from the at least the portion of the at least one three-dimensional object. In some embodiments, the target surface is an exposed surface of a material bed. In some embodiments, the material bed comprises a powder bed. In some embodiments, the material bed includes a material comprising an elemental metal, a metal alloy, a ceramic, or an allotrope of elemental carbon. In some embodiments, the array of optical assemblies comprises an even number of optical assemblies. In some embodiments, the array of optical assemblies comprises an odd number of optical assemblies. In some embodiments, the array of optical assemblies comprises at least 2, 4, 6, 8, 16, 24, 32, or 64 optical assemblies. In some embodiments, the target surface comprises (i) an exposed surface of a material bed or (ii) a surface of the build platform. In some embodiments, the material bed generated on the surface of the build platform having a fundamental length scale of at least about 400 mm, 600 mm, 1000 mm, 1200 mm, 1500 mm, or 1750 mm. In some embodiments, the material bed is generated on the surface of the build platform; and wherein the build platform is configured to support a weight of at least about 1000 kg or 2000 kg. In some embodiments, the material bed has at least one fundamental length scale of at least about 400 mm, 600 mm, 1000 mm, 1200 mm, 1500 mm, or 1750 mm. In some embodiments, facilitating the three-dimensional printing comprises facilitating deposition of pre-transformed material on a target surface. In some embodiments, the device further comprises a dispenser configured to dispense a first portion of pre-transformed material on the target surface. In some embodiments, the device further comprises a remover configured to remove a second portion of the deposited pre-transformed material from the target surface to generate a planar layer of pre-transformed material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of the pre-transformed material removed by the remover and/or (ii) provides at least a portion of the pre-transformed material utilized by the dispenser. In some embodiments, facilitating deposition of pre-transformed material on the target surface comprises enlarging a volume of the material bed, where an exposed surface of the material is (e.g., substantially) at a same position after deposition of pre-transformed material on the target surface, e.g., as part of alignment of energy beam(s). In some embodiments, facilitating deposition of pre-transformed material on a target surface comprises layerwise deposition. In some embodiments, the pre-transformed material comprises powder material. In some embodiments, the pre-transformed material comprises elemental metal, metal alloy, ceramic, or an allotrope of carbon. In some embodiments, the device is configured to operate at an interior atmosphere of an enclosure that is different from an ambient atmosphere external to the enclosure. In some embodiments, the device is configured to operate at an interior atmosphere of an enclosure under a positive pressure atmosphere relative to an ambient atmosphere external to the enclosure. In some embodiments, the device is configured to operate at an interior atmosphere of an enclosure that is depleted of a reactive agent relative to its concentration in an ambient atmosphere external to the enclosure, the reactive agent being configured to react with a starting material of the three-dimensional printing at least during the three-dimensional printing. In some embodiments, the reactive agent comprises oxygen, water, or hydrogen sulfide. In some embodiments, the device further comprises an enclosure comprising a build module body configured to retain the build platform during the three-dimensional printing. In some embodiments, the build module body further comprises a seal. In some embodiments, the seal is included, or is operatively coupled with a shutter, a lid, a closure, an envelope, or a flap. In some embodiments, the seal is arranged with respect to an upper-most portion of the build module body and opposite a bottom portion of the build module body. In some embodiments, the seal is gas tight. In some embodiments, the seal is a hermetic seal. In some embodiments, the enclosure comprises a processing chamber engaged with the build module during the three-dimensional printing. In some embodiments, the seal is configured to facilitate retaining an internal atmosphere in the build module body for a time period after disengagement of the build module from the processing chamber, the internal atmosphere being different from an ambient atmosphere external to the build module. In some embodiments, the seal is configured to facilitate retaining for a time period after disengagement of the build module from the processing chamber (i) a positive pressure in the build module body relative to an ambient atmosphere external to the device and/or (ii) a reactive agent at a concentration lower than its concentration in an ambient atmosphere external to the build module, the reactive agent being configured to at least react with pre-transformed material of the three-dimensional printing during the three-dimensional printing. In some embodiments, the device is configured to facilitate printing one or more three-dimensional objects in an atmosphere maintained to be different from an ambient atmosphere by at least one characteristic, the ambient atmosphere being external to a build module and to an enclosure. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, the housing is configured to facilitate flow of at least one coolant type therethrough, the at least one coolant type configured to cool a mirror and/or an actuator during operation of the device to translate the energy beam. In some embodiments, the at least one coolant type comprises a gas, a liquid, or a semisolid. In some embodiments, the at least one coolant type comprises air, nitrogen, argon, or water. In some embodiments, the air comprises clean dry air. In some embodiments, the housing is configured to operate under a positive pressure atmosphere relative to an ambient atmosphere external to the housing. In some embodiments, the housing is configured to operate under a positive pressure atmosphere relative to the ambient atmosphere external to the housing that is different than a positive pressure atmosphere relative to the ambient atmosphere in an enclosure. In some embodiments, the housing is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide.

In another aspect, a method of three-dimensional printing, the method comprises: providing the device of any of the above devices and using the device during three-dimensional printing. In some embodiments, the three-dimensional printing comprises connecting a particulate matter. In some embodiments, connecting comprises fusing. In some embodiments, fusing comprises melting. In some embodiments, three-dimensional printing utilizes one or more materials comprising an elemental metal, metal alloy, a ceramic, or an allotrope of elemental metal.

In another aspect, an apparatus for three-dimensional printing, the apparatus comprising at least one controller configured to (i) operatively coupled with the device of any of the above devices and control, or direct control of, one or more operations associated with the device. In some embodiments, the at least one controller is operatively coupled with at least one connector configured to connect to a power source, e.g., electrical power source. In some embodiments, the at least one controller is configured to operatively couple to a power source at least in part by (i) having a power socket and/or (ii) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the device is a component of a three-dimensional printing system, and where the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing.

In another aspect, non-transitory computer readable program instructions for three-dimensional printing, the program instructions, when read by one or more processors operatively coupled with the device of any of the above devices cause the one or more processors to execute, or direct execution of, one or more operations associated with the device. In some embodiments, the non-transitory computer readable program instructions where the program instructions are inscribed in one or more media.

In another aspect, a system for three-dimensional printing, the system comprises: the device of any of the above devices (e.g., configured to perform three-dimensional printing); and an energy beam configured to irradiate the target surface (e.g., of a planar layer of powder material) to print at least a portion of at least one three-dimensional object at least in part by using three-dimensional printing. In some embodiments, the system further comprises a scanner configured to translate the energy beam along the target surface, where the device is operatively coupled with the scanner. In some embodiments, the system further comprises an energy source configured to generate the energy beam, where the device is operatively coupled with the energy source. In some embodiments, the system further comprises at least one controller that (i) is operatively coupled with the device and (ii) direct one or more operations associated with the device. In some embodiments, the system further comprises at least one controller that (i) is operatively coupled with at least one mechanism associated with the three-dimensional printing and (ii) direct one or more operations associated with the at least one mechanism, the at least one mechanism being different from the device. In some embodiments, the system is configured to operatively couple to at least one controller configured to (i) operatively couple to the system and (ii) direct one or more operations associated with the system.

In another aspect, a method for three-dimensional printing, the method comprises: (A) propagating an energy beam along a beam path from within an optical assembly to impinge on a target surface disposed above a build platform to print at least one three-dimensional object, the build platform configured to carry the at least one three-dimensional object, the optical assembly comprises: (I) at least one optical component configured to direct propagation of the energy beam along the beam path from within the optical assembly to impinge on the target surface, and (II) a housing configured to (a) accommodate the at least one optical component and a portion of the beam path, and (b) allow impingement of the energy beam on the target surface to print the at least one three-dimensional object by the three-dimensional printing; and (B) translating the optical assembly using a linear translation with respect to the target surface to facilitate printing the at least one three-dimensional object, the linear translation including (i) translating the optical assembly for a first period of time with the linear translation comprising variable acceleration and (ii) translating the optical assembly for a second period of time with the linear translation comprising variable deceleration.

In another aspect, non-transitory computer readable program instructions for three-dimensional printing, the non-transitory computer readable program instructions, when read by one or more processors operatively coupled with an array of optical assemblies, cause the one or more processors to execute operations comprises: (A) directing propagation an energy beam along a beam path from within an optical assembly to impinge on a target surface disposed above a build platform to print at least one three-dimensional object, the build platform configured to carry the at least one three-dimensional object, the optical assembly comprises: (I) at least one optical component configured to direct propagation of the energy beam along the beam path from within the optical assembly to impinge on the target surface, and (II) a housing configured to (a) accommodate the at least one optical component and a portion of the beam path, and (b) allow impingement of the energy beam on the target surface to print the at least one three-dimensional object by the three-dimensional printing; and (B) directing (e.g., linear) translation of the optical assembly with respect to the target surface to facilitate printing the at least one three-dimensional object, which directing the linear translation includes (i) directing translation of the optical assembly for a first period of time, the linear translation comprising variable acceleration and (ii) directing translation of the optical assembly for a second period of time, the linear translation comprising variable deceleration. In some embodiments, the linear translation the optical assembly is during at least a portion of the three-dimensional printing. In some embodiments, the non-transitory computer readable program instructions are inscribed on one or more non-transitory computer readable media.

In another aspect, an apparatus for three-dimensional printing, the apparatus comprises: at least one controller configured to: (A) operatively couple to an optical assembly comprises: (I) at least one optical component configured to direct an energy beam along a beam path from within the respective optical assembly to impinge on a target surface, and (II) a housing configured to (a) accommodate the at least one optical component and a portion of the beam path, and (b) allow impingement of the energy beam on the target surface to print at least one three-dimensional object by the three-dimensional printing; (B) operatively couple to a translation mechanism that is operatively coupled to, or that is part of, the optical assembly; (C) direct propagation of an energy beam along the beam path from within the optical assembly to impinge on the target surface disposed above a build platform to print the at least one three-dimensional object, the build platform configured to carry the at least one three-dimensional object; and (D) direct (e.g., linear) translation of the optical assembly with respect to the target surface to facilitate printing the at least one three-dimensional object, the at least one controller being configured to direct the linear translation at least in part by being configured to (i) direct translation of the optical assembly for a first period of time, the linear translation comprising variable acceleration and (ii) direct translation of the optical assembly for a second period of time, the linear translation comprising variable deceleration.

In another aspect, an object printed by three-dimensional printing, the object having three-dimensions and comprises at least one material indication of the three-dimensional printing comprising: (A) propagating an energy beam along a beam path from within an optical assembly to impinge on a target surface disposed above a build platform to print at least one three-dimensional object, the build platform configured to carry the at least one three-dimensional object, the optical assembly comprises: (I) at least one optical component configured to direct propagation of the energy beam along the beam path from within the optical assembly to impinge on the target surface, and (II) a housing configured to (a) accommodate the at least one optical component and a portion of the beam path, and (b) allow impingement of the energy beam on the target surface to print the at least one three-dimensional object by the three-dimensional printing; and (B) translating the optical assembly using a linear translation with respect to the target surface to facilitate printing the at least one three-dimensional object, the linear translation including (i) translating the optical assembly for a first period of time with the linear translation comprising variable acceleration and (ii) translating the optical assembly for a second period of time with the linear translation comprising variable deceleration.

In another aspect, an object having three-dimensions, the object comprises: (I) successive layers of hardened material, the successive layers being stacked; (II) a first portion of the object having first microstructures, each of the first microstructures having (A) non detectibly defined boundary, or (B) a defined boundary that is detectable and a first fundamental length scale (FLS) range, the first microstructures being arranged along a layer of the successive layers; and (III) a second portion of the object defining an exposed surface of the object, the second portion having at least two of: (a) a first section of second microstructures successively arranged along the exposed surface, each of the second microstructures having (i) a defined boundary that is detectable, (ii) an elongated axis in a first growth direction corresponding to direction of growth of each of the second microstructures, and (iii) a second FLS range larger than the first FLS when the first FLS is detectable; (b) a second section of third microstructures having blurred boundaries; and (c) a third section of fourth microstructures successively arranged along the exposed surface, each of the fourth microstructures having (i) a defined boundary that is detectable, (ii) an elongated axis in a second growth direction corresponding to direction of growth of each of the fourth microstructures, and (iii) the second FLS range larger than the first FLS when the first FLS is detectable. In some embodiments, each of the successive layers contacts at least one other layer of the successive layers. In some embodiments, the successive layers are connected. In some embodiments, the object is indicative of a three-dimensional printing process. In some embodiments, the object is indicative of three-dimensional printing process comprising (A) extruding, (B) laminating, or (C) connecting particular matter. In some embodiments, the object is indicative of three-dimensional printing process including connecting that comprises fusing. In some embodiments, the successive layers are indicative of a fusing process comprising (i) sintering, (ii) melting, or (iii) smelting. In some embodiments, the successive layers are indicative of a layerwise growth process. In some embodiments, the successive layers are indicative of an additive deposition process. In some embodiments, the successive layers are stacked along a third growth direction, where the third growth direction has a direction component that is (A) aligned with the first growth direction, (B) aligned with the second growth direction, or (C) any combination of (A) and (B). In some embodiments, the successive layers are stacked along a third growth direction, where the third growth direction is (A) aligned with the first growth direction, (B) aligned with the second growth direction, (C) a combination of (A) and (B). In some embodiments, the successive layers are stacked along a third growth direction, where the third growth direction is not aligned with the first growth direction and second growth direction. In some embodiments, the successive layers are stacked along a third growth direction, where the third growth direction is misaligned with the first growth direction and second growth direction. In some embodiments, the second microstructures and the fourth microstructures are of a same type. In some embodiments, the type comprises (A) a dendrite, (B) a hatch pattern, (C) a tiling pattern, or (D) a keyhole. In some embodiments, the first growth direction and the second growth direction have a common vector component pointing in (e.g., substantially) the same direction. In some embodiments, the elongated axis in the first growth direction and the elongated axis in the second growth direction are aligned with respect each other. In some embodiments, the first growth direction and the second growth direction are offset by an angle with respect to each other. In some embodiments, the first growth direction and second growth direction are offset by an angle of at least about 45 degrees. In some embodiments, the first growth direction and the second growth direction are offset by an angle of at least about 90 degrees. In some embodiments, the second section of third microstructures have blurred boundaries contacts (i) the first section of second microstructures, (ii) the third section of fourth microstructures, or (iii) both the first section of second microstructures and the third section of fourth microstructures. In some embodiments, the second section of third microstructures have blurred boundaries comprises an overlap region adjacent to the first section of second microstructures and adjacent to the third section of fourth microstructures. In some embodiments, the first portion of first microstructures has a third growth direction oriented along an elongated axis different from at least one of (i) the elongated axis in the first growth direction and (ii) the elongated axis in the second growth direction. In some embodiments, the first portion of first microstructures has a third growth direction oriented along an elongated axis that is (e.g., substantially) the same as (i) the elongated axis in the first growth direction or (ii) the elongated axis in the second growth direction. In some embodiments, the first portion of the first microstructures comprises (e.g., substantially) zero long-range order. In some embodiments, the first portion of the first microstructures is devoid of a single grain that is detectable. In some embodiments, detectable comprises optically detectable. In some embodiments, optically detectable comprises using an optical microscope. In some embodiments, the first portion of first microstructures is (A) aligned along an edge of the object, or (B) aligned away from the edge of the object. In some embodiments, the second section of third microstructures comprises (e.g., substantially) zero long-range order. In some embodiments, the second section of third microstructures comprises anisotropic grain growth directions. In some embodiments, the second section of third microstructures comprises anisotropic dendrite growth. In some embodiments, the three-dimensional object includes a material comprising an elemental metal, a metal alloy, a ceramic, or an allotrope of elemental carbon. In some embodiments, the three-dimensional object comprises a super alloy. In some embodiments, the three-dimensional object comprises a copper-based alloy, a nickel-based alloy, stainless steel, or titanium. In some embodiments, the exposed surface of the object comprises an outer surface of the object. In some embodiments, the exposed surface of the object is devoid of any auxiliary support mark. In some embodiments, the exposed surface of the object comprises at least two auxiliary support marks, where the at least two auxiliary support marks are spaced apart by at least about 10.5 millimeters, 40.5 millimeters, or more. In some embodiments, the exposed surface of the object comprises an initially formed surface of the three-dimensional object (e.g., a bottom skin layer). In some embodiments, the exposed surface of the object comprises an initially formed hanging layer of the three-dimensional object, the hanging layer comprising an angle that is less than 35 degrees with respect to (I) an axis perpendicular to a growth direction of the successive layers and/or (II) an average layering plane of the successive layers. In some embodiments, the first formed hanging layer of the three-dimensional object extends beyond a previously transformed portion. In some embodiments, the exposed surface of the object comprises a shallow angle with respect to an axis perpendicular to a growth direction of the successive layers of hardened material. In some embodiments, the shallow angle comprises an angle less than 45 degrees, or less than 35 degrees, with respect to (i) the axis perpendicular to the growth direction of the successive layers, or (ii) with respect to an average layering plane of the successive layers. In some embodiments, the shallow angle comprises an angle less than 25 degrees. In some embodiments, the elongated axis in the first growth direction corresponding to the direction of growth of each of the second microstructures being indicative of microstructure growth along the first growth direction to generate the first section. In some embodiments, the elongated axis in the first growth direction is indicative of an energy beam impinging on a material bed in a first impingement direction to generate the first section. In some embodiments, at least one of the second microstructures comprises a detectable: (a) a transition line, (b) surface step, (c) melt pool, (d) grain boundary, or (e) layer marking that is detectable. In some embodiments, at least one of the second microstructures comprises a single grain. In some embodiments, a detectable grain boundary of the single grain has sharp angles, the single grain having a misorientation greater than about 10 degrees, or greater than about 15 degrees, the misorientation being with respect to at least another single grain. In some embodiments, the single grain comprises a multi-crystalline structure. In some embodiments, the single grain comprises a single crystalline structure. In some embodiments, the second FLS range is larger than the first FLS, the second FLS comprising an FLS of the single grain. In some embodiments, the second FLS of the single grain (e.g., substantially) spans an FLS of a melt pool from which the second microstructure is formed. In some embodiments, the detection comprises optical detection. In some embodiments, the detection includes using detection equipment comprising (a) an optical microscope, (b) a scanning electron microscope, (c) a tunneling electron microscope, or (d) an X-ray diffraction system. In some embodiments, the first growth direction of the second microstructures is indicative of each of the microstructures being grown in the first growth direction. In some embodiments, the first growth direction is indicative of a first energy beam impinging on a material bed and translating along the material bed in the first growth direction to generate each of the second microstructures. In some embodiments, the first growth direction is indicative of a first energy beam impinging on the material bed in a first impingement direction. In some embodiments, the blurred boundaries of the second section of third microstructures are indicative of the third microstructures being grown in different growth directions. In some embodiments, the blurred boundaries of the second section of third microstructures are indicative of at least two different energy beams impinging on a material bed and translating along the material bed in at least two different directions to generate the third microstructures in a first set of growth directions. In some embodiments, the first set of growth directions comprises (A) the first growth direction, or (B) the second growth direction. In some embodiments, the elongated axis in the second growth direction corresponding to the direction of growth of each of the fourth microstructures being indicative of microstructure growth along the second growth direction to generate the third section. In some embodiments, the second growth direction of the fourth microstructures is indicative of each of the microstructures being grown in the second growth direction. In some embodiments, the second growth direction is indicative of a second energy beam impinging on a material bed and translating along the material bed in the second growth direction to generate each of the fourth microstructures. In some embodiments, the second growth direction is indicative of the second energy beam impinging on the material bed in a second impingement direction. In some embodiments, the second energy beam is different from the first energy beam. In some embodiments, the second energy beam is (e.g., substantially) the same as the first energy beam. In some embodiments, the elongated axis in the second growth direction is indicative of an energy beam impinging on a material bed in a second impingement direction to generate the third section. In some embodiments, at least one of the second microstructures comprises a detectable (a) transition line, (b) surface step, (c) melt pool, (d) grain boundary, or (e) layer marking. In some embodiments, at least one of the fourth microstructures comprises a single grain that is detectable. In some embodiments, a detectable grain boundary of the single grain has sharp angles, the single grain having a misorientation greater than about 10 degrees, or greater than about 15 degrees, the misorientation being with respect to at least another single grain. In some embodiments, the single grain comprises a multi-crystalline structure. In some embodiments, the single grain comprises a single crystalline structure. In some embodiments, the second FLS range larger than the first FLS comprises an FLS of the single grain. In some embodiments, the second FLS of the single grain (e.g., substantially) spans at least 60%, or 80% of a respective FLS of a melt pool from which the second microstructure is formed. In some embodiments, the detection comprises optical detection. In some embodiments, the detection includes using detection equipment comprising (a) an optical microscope, (b) a scanning electron microscope, (c) a tunneling electron microscope, or (d) an X-ray diffraction system. In some embodiments, the object further comprises: a fourth section of fifth microstructures having the blurred boundaries. In some embodiments, the second section of third microstructures is in a first region of the second portion, and the fourth section of fifth microstructures is in a second region of the second portion. In some embodiments, the first region and the second region being non-adjacent. In some embodiments, the blurred boundaries of the fourth section of the fifth microstructures are indicative of the fifth microstructures being grown in different directions of growth. In some embodiments, the blurred boundaries of the fourth section of the fifth microstructures are indicative of at least a third energy beam and a fourth energy beam impinging on a material bed and translating along the material bed in different directions. In some embodiments, the third energy beam is different than the fourth energy beam. In some embodiments, the third energy beam is (e.g., substantially) the same as the fourth energy beam. In some embodiments, the second set of growth directions comprises (A) the first growth direction, or (B) the second growth direction. In some embodiments, (i) the second microstructures, (ii) the fourth microstructures, or (iii) a combination of (i) and (ii), comprise at least one material indication of a slow (e.g., prolonged) hardening process of a microstructure. In some embodiments, the slow hardening process is slower than a hardening process forming the first microstructures. In some embodiments, the slow hardening process is sufficiently slow to allow organization of material structure at an atomic level. In some embodiments, the slow hardening process is sufficiently slow to facilitate formation of one or more grains and/or crystals. In some embodiments, at least one material indication comprises a single grain that is detectable. In some embodiments, the single grain comprises a single crystal. In some embodiments, the at least one material indication is optically detectable. In some embodiments, the at least one material indication is detectable by a naked eye. In some embodiments, the object has a material signature indicative of using at least one component of the device of any of the above devices. In some embodiments, a span of a microstructure of the (i) the second microstructures, (ii) the fourth microstructures, or (iii) both (i) and (ii), is more than about 50% of the smaller FLS of the microstructure.

In another aspect, a device for three-dimensional printing, the device configured to print the object of any of the above objects using three-dimensional printing. In some embodiments, the device comprising an optical assembly comprises at least one optical component configured to direct propagation of an energy beam along a beam path from within the optical assembly to impinge on a target surface disposed above a build platform, the build platform configured to carry at least one three-dimensional object printed by the three-dimensional printing. In some embodiments, the device further comprises an array of optical assemblies configured to direct propagation of a plurality of energy beams along respective beam paths from within the array of optical assemblies to impinge on the target surface disposed above the build platform. In some embodiments, the device further comprises a housing configured to (a) accommodate the at least one optical component and a portion of the beam path of the energy beam, and (b) allow impingement of the energy beam on the target surface to print the at least one three-dimensional object by the three-dimensional printing. In some embodiments, the device further comprises a translation mechanism supportive of the optical assembly, the translation mechanism configured to effectuate a (e.g., linear) translation of the optical assembly with respect to the target surface during at least a portion of the three-dimensional printing to facilitate printing the at least one three-dimensional object. In some embodiments, the translation mechanism is configured to facilitate linear translation that comprises (i) a first period of time of variable acceleration and (ii) a second period of time of variable deceleration.

In another aspect, a method for three-dimensional printing, the method comprises: using the three-dimensional printing to print the object of any of the above objects. In some embodiments, three-dimensional printing comprises fusing. In some embodiments, fusing comprises melting.

In another aspect, an apparatus for three-dimensional printing, the apparatus comprises: at least one controller configured to control, or direct control of, one or more three-dimensional printing operations to print the object of any of the above objects. In some embodiments, the at least one controller is operatively coupled with at least one connector configured to connect to a power source, e.g., electrical power source. In some embodiments, the at least one controller is configured to operatively couple to a power source at least in part by (i) having a power socket and/or (ii) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the at least one three-dimensional object. In some embodiments, the device is a component of a three-dimensional printing system, and where the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing.

In another aspect, a system for three-dimensional printing, the system comprises: an energy beam configured to irradiate a starting material to print at least a portion of the object of any of the above objects at least in part by using three-dimensional printing. In some embodiments, the system further comprises a scanner configured to translate the energy beam along a target surface, where the device is operatively coupled with the scanner. In some embodiments, the system where the starting material for the three-dimensional printing comprises a powder material. In some embodiments, the system where the energy beam is configured to irradiate a planar layer of a material bed. In some embodiments, the system further comprises an energy source configured to generate the energy beam, where the device is operatively coupled with the energy source. In some embodiments, the system further comprises at least one controller that (i) is operatively coupled with at least one mechanism associated with the three-dimensional printing and (ii) direct one or more operations associated with the at least one mechanism, the at least one mechanism being different from the device. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

In another aspect, non-transitory computer readable program instructions for three-dimensional printing, the program instructions, when read by one or more processors, cause the one or more processors to execute, or direct execution of, one or more operations associated with printing the object of any of the above objects least in part by the three-dimensional printing. In some embodiments, the non-transitory computer readable program instructions where the program instructions are inscribed in one or more media.

In another aspect, non-transitory computer readable program instructions for three-dimensional printing, the program instructions, when read by one or more processors operatively coupled with a three-dimensional printing system, cause the one or more processors to execute, or direct execution of, one or more operations associated with printing a three-dimensional that comprises: (I) successive layers of hardened material, the successive layers being stacked; (II) a first portion of the object having first microstructures, each of the first microstructures having (A) non detectibly defined boundary, or (B) a defined boundary that is detectable and a first fundamental length scale (FLS) range, the first microstructures being arranged along a layer of the successive layers; and (III) a second portion of the object defining an exposed surface of the object, the second portion having at least two of: (a) a first section of second microstructures successively arranged along the exposed surface, each of the second microstructures having (i) a defined boundary that is detectable, (ii) an elongated axis in a first growth direction corresponding to direction of growth of each of the second microstructures, and (iii) a second FLS range larger than the first FLS when the first FLS is detectable; (b) a second section of third microstructures having blurred boundaries; and (c) a third section of fourth microstructures successively arranged along the exposed surface, each of the fourth microstructures having (i) a defined boundary that is detectable, (ii) an elongated axis in a second growth direction corresponding to direction of growth of each of the fourth microstructures, and (iii) the second FLS range larger than the first FLS when the first FLS is detectable.

In another aspect, a system for three-dimensional printing, the system comprises: an energy beam configured to irradiate a starting material to print at least a portion of a three-dimensional object that comprises: (I) successive layers of hardened material, the successive layers being stacked; (II) a first portion of the object having first microstructures, each of the first microstructures having (A) non detectibly defined boundary, or (B) a defined boundary that is detectable and a first fundamental length scale (FLS) range, the first microstructures being arranged along a layer of the successive layers; and (III) a second portion of the object defining an exposed surface of the object, the second portion having at least two of: (a) a first section of second microstructures successively arranged along the exposed surface, each of the second microstructures having (i) a defined boundary that is detectable, (ii) an elongated axis in a first growth direction corresponding to direction of growth of each of the second microstructures, and (iii) a second FLS range larger than the first FLS when the first FLS is detectable; (b) a second section of third microstructures having blurred boundaries; and (c) a third section of fourth microstructures successively arranged along the exposed surface, each of the fourth microstructures having (i) a defined boundary that is detectable, (ii) an elongated axis in a second growth direction corresponding to direction of growth of each of the fourth microstructures, and (iii) the second FLS range larger than the first FLS when the first FLS is detectable.

In another aspect, an apparatus for three-dimensional printing, the apparatus comprises: at least one controller configured to operatively coupled with a three-dimensional printing system, the at least one controller is further configured to control, or direct control of, one or more three-dimensional printing operations to print a three-dimensional that comprises: (I) successive layers of hardened material, the successive layers being stacked; (II) a first portion of the object having first microstructures, each of the first microstructures having (A) non detectibly defined boundary, or (B) a defined boundary that is detectable and a first fundamental length scale (FLS) range, the first microstructures being arranged along a layer of the successive layers; and (III) a second portion of the object defining an exposed surface of the object, the second portion having at least two of: (a) a first section of second microstructures successively arranged along the exposed surface, each of the second microstructures having (i) a defined boundary that is detectable, (ii) an elongated axis in a first growth direction corresponding to direction of growth of each of the second microstructures, and (iii) a second FLS range larger than the first FLS when the first FLS is detectable; (b) a second section of third microstructures having blurred boundaries; and (c) a third section of fourth microstructures successively arranged along the exposed surface, each of the fourth microstructures having (i) a defined boundary that is detectable, (ii) an elongated axis in a second growth direction corresponding to direction of growth of each of the fourth microstructures, and (iii) the second FLS range larger than the first FLS when the first FLS is detectable.

In another aspect, a method for three-dimensional printing, the method comprises: providing a three-dimensional printer; and using the three-dimensional printer in the three-dimensional printing to print a three-dimensional object that comprises: (I) successive layers of hardened material, the successive layers being stacked; (II) a first portion of the object having first microstructures, each of the first microstructures having (A) non detectibly defined boundary, or (B) a defined boundary that is detectable and a first fundamental length scale (FLS) range, the first microstructures being arranged along a layer of the successive layers; and (III) a second portion of the object defining an exposed surface of the object, the second portion having at least two of: (a) a first section of second microstructures successively arranged along the exposed surface, each of the second microstructures having (i) a defined boundary that is detectable, (ii) an elongated axis in a first growth direction corresponding to direction of growth of each of the second microstructures, and (iii) a second FLS range larger than the first FLS when the first FLS is detectable; (b) a second section of third microstructures having blurred boundaries; and (c) a third section of fourth microstructures successively arranged along the exposed surface, each of the fourth microstructures having (i) a defined boundary that is detectable, (ii) an elongated axis in a second growth direction corresponding to direction of growth of each of the fourth microstructures, and (iii) the second FLS range larger than the first FLS when the first FLS is detectable.

In another aspect, an object having three-dimensions, the object comprises: (I) successive layers of hardened material, the successive layers being stacked (II) a portion of the object defining an exposed surface of the object, the portion having at least two of: (a) a first section of first microstructures successively arranged along the exposed surface, each of the first microstructures having (i) a defined boundary that is detectable, (ii) an elongated axis in a first growth direction corresponding to direction of growth of each of the first microstructures, and (iii) a first single grain that is detectable or at least one detectable material indicator of a slow (e.g., prolonged) hardening process; (b) a second section of second microstructures having blurred boundaries; and (c) a third section of third microstructures successively arranged along the exposed surface, each of the third microstructures having (i) a defined boundary that is detectable, (ii) an elongated axis in a second growth direction corresponding to direction of growth of each of the third microstructures, and (iii) a second single grain that is detectable or at least one material indication of a slow (e.g., prolonged) hardening process. In some embodiments, each of the successive layers contacts at least one other layer of the successive layers. In some embodiments, the successive layers are connected. In some embodiments, the object is indicative of a three-dimensional printing process. In some embodiments, the object is indicative of three-dimensional printing process comprising (A) extruding, (B) laminating, or (C) connecting particular matter. In some embodiments, the object is indicative of a three-dimensional printing process including connecting that comprises fusing. In some embodiments, the successive layers are indicative of a fusing process comprising (i) sintering, (ii) melting, or (iii) smelting. In some embodiments, the successive layers are indicative of a layerwise growth process. In some embodiments, the successive layers are indicative of an additive deposition process. In some embodiments, successive layers being stacked along a third growth direction, where the third growth direction has a direction component that is (A) aligned with the first growth direction, (B) aligned with the second growth direction, or (C) any combination of (A) and (B). In some embodiments, successive layers being stacked along a third growth direction, where the third growth direction is (A) aligned with the first growth direction, (B) aligned with the second growth direction, (C) a combination of (A) and (B). In some embodiments, successive layers being stacked along a third growth direction, where the third growth direction is not aligned with the first growth direction and second growth direction. In some embodiments, successive layers being stacked along a third growth direction, where the third growth direction is misaligned with the first growth direction and second growth direction. In some embodiments, the first microstructures and the third microstructures are of a same type. In some embodiments, the type comprises (A) a dendrite, (B) a hatch pattern, (C) a tiling pattern, or (D) a keyhole. In some embodiments, the first growth direction and the second growth direction have a common vector component pointing in (e.g., substantially) the same direction. In some embodiments, the first growth direction and the second growth direction are aligned with respect each other. In some embodiments, the first growth direction and the second growth direction are offset by an angle with respect to each other. In some embodiments, the first growth direction and the second growth direction are offset by an angle of at least about 45 degrees. In some embodiments, the first growth direction and the second growth direction are offset by an angle of at least about 90 degrees. In some embodiments, the second section of second microstructures having blurred boundaries contacts (i) the first section of first microstructures, (ii) third section of third microstructures, or (iii) both the first section of first microstructures and third section of third microstructures. In some embodiments, the second section of second microstructures having blurred boundaries comprises an overlap region adjacent to the first section of first microstructures and adjacent to the third section of third microstructures. In some embodiments, the portion is a first portion and further comprises a second portion of fourth microstructures having a fourth growth direction oriented along an elongated axis that is different from at least one of (i) the elongated axis in the first growth direction and (ii) the elongated axis in the second growth direction. In some embodiments, the portion is a first portion and further comprises a second portion of fourth microstructures having a fourth growth direction oriented along an elongated axis that is (e.g., substantially) the same as (i) the elongated axis in the first growth direction or (ii) the elongated axis in the second growth direction. In some embodiments, the second portion of the fourth microstructures comprises (e.g., substantially) zero long-range order. In some embodiments, the second portion of the fourth microstructures are devoid of a single grain that is detectable. In some embodiments, detectable comprises optically detectable. In some embodiments, optically detectable comprises using an optical microscope. In some embodiments, the second portion of fourth microstructures is (A) aligned along an edge of the object, or (B) aligned away from the edge of the object. In some embodiments, the second section of second microstructures comprises (e.g., substantially) zero long-range order. In some embodiments, the second section of second microstructures comprises anisotropic grain growth directions. In some embodiments, the second section of second microstructures comprises anisotropic dendrite growth. In some embodiments, the three-dimensional object comprises a super alloy. In some embodiments, the three-dimensional object comprises a copper-based alloy, nickel-based alloy, stainless steel, or titanium. In some embodiments, the exposed surface of the object comprises an outer surface of the object. In some embodiments, the exposed surface of the object is devoid of any auxiliary mark. In some embodiments, the exposed surface of the object comprises at least two auxiliary support marks, where the at least two auxiliary support marks are spaced apart by at least about 10.5 millimeters, 40.5 millimeters, or more. In some embodiments, the exposed surface of the object comprises an initially formed surface of the three-dimensional object (e.g., a bottom skin layer). In some embodiments, the exposed surface of the object comprises an initially formed hanging layer of the three-dimensional object, the hanging layer comprising an angle that is less than 35 degrees with respect to (I) an axis perpendicular to a growth direction of the successive layers and/or (II) an average layering plane of the successive layers. In some embodiments, the first formed hanging layer of the three-dimensional object extends beyond a previously transformed portion by a gap. In some embodiments, the exposed surface of the object comprises a shallow angle with respect to an axis perpendicular to a growth direction of the successive layers of hardened material. In some embodiments, the shallow angle comprises an angle less than 45 degrees, or less than 35 degrees, with respect to (i) the axis perpendicular to the growth direction of the successive layers, or (ii) with respect to an average layering plane of the successive layers. In some embodiments, the shallow angle comprises an angle less than 25 degrees. In some embodiments, the elongated axis in the first growth direction corresponds to a direction of growth of each of the first microstructures being indicative of microstructure growth along the first growth direction to generate the first section. In some embodiments, the elongated axis in the first growth direction is indicative of an energy beam impinging on a material bed in a first impingement direction to generate the first section. In some embodiments, at least one of the second microstructures comprises a detectable (a) transition line, (b) surface step, (c) melt pool, (d) grain boundary, or (e) layer marking that is detectable. In some embodiments, at least one of the first microstructures comprises a single grain. In some embodiments, a grain boundary of the single grain with respect to at least another grain has sharp angles having a misorientation greater than about 10 degrees, or greater than about 15 degrees. In some embodiments, the single grain comprises a multi-crystalline structure. In some embodiments, the single grain comprises a single crystalline structure. In some embodiments, an FLS of the single grain (e.g., substantially) spans an FLS of a melt pool from which the at least one of the first microstructures is formed. In some embodiments, the detection comprises optical detection. In some embodiments, the detection includes using detection equipment comprising (a) an optical microscope, (b) a scanning electron microscope, (c) a tunneling electron microscope, or (d) an X-ray diffraction system. In some embodiments, the first growth direction of the first microstructures is indicative of each of the microstructures being grown in the first growth direction. In some embodiments, the first growth direction is indicative of a first energy beam impinging on a material bed and translating along the material bed in the first growth direction to generate each of the second microstructures. In some embodiments, the first growth direction is indicative of a first energy beam impinging on the material bed in a first impingement direction. In some embodiments, the blurred boundaries of the second section of second microstructures are indicative of the third microstructures being grown in different growth directions. In some embodiments, the blurred boundaries of the second section of second microstructures are indicative of at least two different energy beams impinging on a material bed and translating along the material bed in at least two different directions to generate the second microstructures in a first set of growth directions. In some embodiments, the first set of growth directions comprises (A) the first growth direction or (B) the second growth direction. In some embodiments, the elongated axis in the second growth direction corresponding to the direction of growth of each of the third microstructures being indicative of microstructure growth along the second growth direction to generate the third section. In some embodiments, the second growth direction of the third microstructures is indicative of each of the microstructures being grown in the second growth direction. In some embodiments, the second growth direction is indicative of a second energy beam impinging on a material bed and translating along the material bed in the second growth direction to generate each of the third microstructures. In some embodiments, the second growth direction is indicative of the second energy beam impinging on the material bed in a second impingement direction. In some embodiments, the second energy beam is different from the first energy beam. In some embodiments, the second energy beam is (e.g., substantially) the same as the first energy beam. In some embodiments, the elongated axis in the second growth direction is indicative of an energy beam impinging on a material bed in a second impingement direction to generate the third section. In some embodiments, at least one of the second microstructures comprises (a) a transition line, (b) surface step, (c) melt pool, (d) grain boundary, or (e) layer marking that is detectable. In some embodiments, at least one of the third microstructures comprises a single grain that is detectable. In some embodiments, the detectable single grain is bounded by high angle grain boundaries having a misorientation greater than about 10 degrees, or optionally greater than about 15 degrees. In some embodiments, the single grain comprises a multi-crystalline structure. In some embodiments, the single grain comprises a single crystalline structure. In some embodiments, an FLS of the single grain (e.g., substantially) spans an FLS of a melt pool from which the at least one of the first microstructures is formed. In some embodiments, the second FLS of the single grain (e.g., substantially) spans at least 60%, or 80% of a respective FLS of a melt pool from which the second microstructure is formed. In some embodiments, the detection comprises optical detection. In some embodiments, the detection includes using detection equipment comprising (a) an optical microscope, (b) a scanning electron microscope, (c) a tunneling electron microscope, or (d) an X-ray diffraction system. In some embodiments, the object further comprises: a fourth section of fifth microstructures having the blurred boundaries. In some embodiments, the second section of second microstructures is in a first region of the second portion, and the fourth section of fifth microstructures is in a second region of the second portion. In some embodiments, the first region and the second region being non-adjacent. In some embodiments, the blurred boundaries of the fourth section of the fifth microstructures are indicative of the fifth microstructures being grown in different directions of growth. In some embodiments, the blurred boundaries of the fourth section of the fifth microstructures are indicative of at least a third energy beam and a fourth energy beam impinging on a material bed and translating along the material bed in different directions. In some embodiments, the third energy beam is (e.g., substantially) different than the fourth energy beam. In some embodiments, the third energy beam is (e.g., substantially) the same as the fourth energy beam. In some embodiments, the second set of growth directions comprises (A) the first growth direction or (B) the second growth direction. In some embodiments, (i) the first microstructures, (ii) the third microstructures, or (iii) a combination of (i) and (ii), comprise at least one material indication of a slow (e.g., prolonged) hardening process of a microstructure. In some embodiments, the slow hardening process is slower than a hardening process forming the first microstructures. In some embodiments, the slow hardening process is sufficiently slow to allow organization of material structure at an atomic level. In some embodiments, the slow hardening process is sufficiently slow to facilitate formation of one or more grains and/or crystals. In some embodiments, at least one material indication comprises a single grain that is detectable. In some embodiments, the single grain comprises a single crystal. In some embodiments, the at least one material indication is optically detectable. In some embodiments, the object has a material signature indicative of using at least one component of the device of any of the above devices. In some embodiments, the at least one material indication is detectable by a naked eye. In some embodiments, a span of a microstructure of (i) the first microstructures, (ii) the third microstructures, or (iii) both (i) and (ii), is more than about 50% of the smaller FLS of the microstructure.

In another aspect, a device for three-dimensional printing, the device configured to print the object of any of the above objects at least in part by the three-dimensional printing. In some embodiments, the device comprising an optical assembly comprises at least one optical component configured to direct propagation of an energy beam along a beam path from within the optical assembly to impinge on a target surface disposed above a build platform, the build platform configured to carry at least one three-dimensional object printed by the three-dimensional printing. In some embodiments, the device further comprises an array of optical assemblies configured to direct propagation of a plurality of energy beams along respective beam paths from within the array of optical assemblies to impinge on the target surface disposed above the build platform. In some embodiments, the device further comprises a housing configured to (a) accommodate the at least one optical component and a portion of the beam path of the energy beam, and (b) allow impingement of the energy beam on the target surface to print the at least one three-dimensional object by the three-dimensional printing. In some embodiments, the device further comprises a translation mechanism supportive of the optical assembly, the translation mechanism being configured to effectuate a linear translation the optical assembly with respect to the target surface during at least a portion of the three-dimensional printing to facilitate printing the at least one three-dimensional object. In some embodiments, the linear translation comprises (i) a first period of time of variable acceleration and (ii) a second period of time of variable deceleration.

In another aspect, a method for three-dimensional printing any object disclosed herein. In some embodiments, three-dimensional printing comprises fusing. In some embodiments, fusing comprises melting.

In another aspect, an apparatus for three-dimensional printing, the apparatus comprising at least one controller configured to control, or direct control of one or more three-dimensional printing operations to print any object of any of the above objects. In some embodiments, the at least one controller is operatively coupled with at least one connector configured to connect to a power source, e.g., electrical power source. In some embodiments, the at least one controller is configured to operatively couple to a power source at least in part by (i) having a power socket and/or (ii) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the device is a component of a three-dimensional printing system, and where the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing.

In another aspect, a system for three-dimensional printing, the system comprising an energy beam configured to irradiate a planar layer of powder material to print configured to print at least a portion of any object of any of the above objects at least in part by using three-dimensional printing. In some embodiments, the system further comprises a scanner configured to translate the energy beam along a target surface, where the device is operatively coupled with the scanner. In some embodiments, the system further comprises an energy source configured to generate the energy beam, where the device is operatively coupled with the energy source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

In another aspect, non-transitory computer readable program instructions for three-dimensional printing, the program instructions, when read by one or more processors, cause the one or more processors to execute, or direct execution of, one or more operations to print any object of any of the above objects. In some embodiments, the non-transitory computer readable program instructions where the program instructions are inscribed in one or more media.

In another aspect, non-transitory computer readable program instructions for three-dimensional printing, the program instructions, when read by one or more processors operatively coupled with a three-dimensional printing system, cause the one or more processors to execute, or direct execution of, one or more operations associated with printing a three-dimensional that comprises: (I) successive layers of hardened material, the successive layers being stacked (II) a portion of the object defining an exposed surface of the object, the portion having at least two of: (a) a first section of first microstructures successively arranged along the exposed surface, each of the first microstructures having (i) a defined boundary that is detectable, (ii) an elongated axis in a first growth direction corresponding to direction of growth of each of the first microstructures, and (iii) a first single grain that is detectable or at least one detectable material indicator of a slow hardening process; (b) a second section of second microstructures having blurred boundaries; and (c) a third section of third microstructures successively arranged along the exposed surface, each of the third microstructures having (i) a defined boundary that is detectable, (ii) an elongated axis in a second growth direction corresponding to direction of growth of each of the third microstructures, and (iii) a second single grain that is detectable or at least one material indication of a slow hardening process. a

In another aspect, a system for three-dimensional printing, the system comprises: an energy beam configured to irradiate a starting material to print at least a portion of a three-dimensional object that comprises: (I) successive layers of hardened material, the successive layers being stacked (II) a portion of the object defining an exposed surface of the object, the portion having at least two of: (a) a first section of first microstructures successively arranged along the exposed surface, each of the first microstructures having (i) a defined boundary that is detectable, (ii) an elongated axis in a first growth direction corresponding to direction of growth of each of the first microstructures, and (iii) a first single grain that is detectable or at least one detectable material indicator of a slow hardening process; (b) a second section of second microstructures having blurred boundaries; and (c) a third section of third microstructures successively arranged along the exposed surface, each of the third microstructures having (i) a defined boundary that is detectable, (ii) an elongated axis in a second growth direction corresponding to direction of growth of each of the third microstructures, and (iii) a second single grain that is detectable or at least one material indication of a slow hardening process.

In another aspect, an apparatus for three-dimensional printing, the apparatus comprises: at least one controller configured to operatively coupled with a three-dimensional printing system, the at least one controller is further configured to control, or direct control of, one or more three-dimensional printing operations to print a three-dimensional that comprises: (I) successive layers of hardened material, the successive layers being stacked (II) a portion of the object defining an exposed surface of the object, the portion having at least two of: (a) a first section of first microstructures successively arranged along the exposed surface, each of the first microstructures having (i) a defined boundary that is detectable, (ii) an elongated axis in a first growth direction corresponding to direction of growth of each of the first microstructures, and (iii) a first single grain that is detectable or at least one detectable material indicator of a slow hardening process; (b) a second section of second microstructures having blurred boundaries; and (c) a third section of third microstructures successively arranged along the exposed surface, each of the third microstructures having (i) a defined boundary that is detectable, (ii) an elongated axis in a second growth direction corresponding to direction of growth of each of the third microstructures, and (iii) a second single grain that is detectable or at least one material indication of a slow hardening process.

In another aspect, a method for three-dimensional printing, the method comprises: providing a three-dimensional printer; and using the three-dimensional printer in the three-dimensional printing to print a three-dimensional object that comprises: (I) successive layers of hardened material, the successive layers being stacked; (II) a portion of the object defining an exposed surface of the object, the portion having at least two of: (a) a first section of first microstructures successively arranged along the exposed surface, each of the first microstructures having (i) a defined boundary that is detectable, (ii) an elongated axis in a first growth direction corresponding to direction of growth of each of the first microstructures, and (iii) a first single grain that is detectable or at least one detectable material indicator of a slow hardening process; (b) a second section of second microstructures having blurred boundaries; and (c) a third section of third microstructures successively arranged along the exposed surface, each of the third microstructures having (i) a defined boundary that is detectable, (ii) an elongated axis in a second growth direction corresponding to direction of growth of each of the third microstructures, and (iii) a second single grain that is detectable or at least one material indication of a slow hardening process.

In another aspect, a device for three-dimensional printing, the device comprises: at least one optical image generator configured to project an optical image on a target surface utilized for the three-dimensional printing, the optical image comprising optical variations that are detectable, the at least one optical image generator being disposed adjacent to the target surface; at least one detector configured to optically detect (A) the optical variations appearing on the target surface and (B) a difference between the optical variations detected and a corresponding the optical variations projected, the difference corresponding to physical variation in uniformity of the target surface, the at least one detector operatively coupled with the at least one optical image generator, the at least one detector being disposed adjacent to the target surface; and a translation mechanism configured to translate with respect to the target surface during the three-dimensional printing, the translation mechanism being operatively coupled to, supportive of, and configured to translate: (A) the at least one optical image generator and/or (B) the at least one detector. In some embodiments, the device is utilized at least in part to generate (e.g., in real time during the printing) a topographical image of the target surface. In some embodiments, the device comprises a height mapper, e.g., as disclosed herein. In some embodiments, the target surface comprises (a) an exposed surface of a build platform, or (b) an exposed surface of a material bed utilized for the three-dimensional printing. In some embodiments, the uniformity of the target surface comprises uniformity in the planarity of the target surface. In some embodiments, a deviation from the uniformity of the target surface comprises (a) at least one portion of a three-dimensional object protruding from the planar surface (b) debris protruding from the planar surface, or (c) the target surface being non-planar (e.g., skewed). In some embodiments, the optical variations comprise a series of optical variations. In some embodiments, the optical variations comprise repetitive optical variations. In some embodiments, the optical image comprises geometric portions that are detectable. In some embodiments, the optical image comprises successive lines of varied optical intensity. In some embodiments, the optical image comprises successive lines of varied optical intensity. In some embodiments, the optical image comprises successive fringes of varied optical intensity. In some embodiments, the at least one optical image generator is configured to project the optical image that is stationary. In some embodiments, the at least one optical image generator is configured to project the optical image that is non-stationary during the projection, e.g., and during the printing. In some embodiments, the at least one optical image generator is configured to project the optical image that is changing during the projection, e.g., and during the printing. In some embodiments, the device is configured to facilitate alteration of the printing based at least in part on the difference detected. In some embodiments, the device is configured such that evaluation of the difference detected is performed when the translation system is stationary (e.g., does not translate), such as in real time during the printing. In some embodiments, the device is configured to operatively couple to at least one printing agent configured to transform a pre-transformed material to a transformed material to print at least one three-dimensional object as part of the three-dimensional printing, and where the device is configured to facilitate alteration of the printing at least in part by being configured to influence alteration (e.g., to cause alteration) of an operation of the printing agent for the three-dimensional printing. In some embodiments, the transforming agent comprises an energy beam. In some embodiments, the energy beam comprises a laser beam. In some embodiments, the device is configured to facilitate alteration of the printing at least in part by being configured to influence (e.g., to cause alteration of) operations of at least one other mechanism associated with the three-dimensional printing, the at least one mechanism being different than the translation mechanism. In some embodiments, the device is configured to operatively couple to a control system controlling the three-dimensional printing, and where the device is configured to facilitate alteration of the printing at least in part by being configured to influence operations of the control system, the operations being associated with the three-dimensional printing. In some embodiments, the at least one optical image generator is configured to project the optical image that is changing in a direction during the projection, e.g., and during the printing. In some embodiments, the translation mechanism is configured to linearly translate, e.g., along a straight line. In some embodiments, the translation machine is configured to translate laterally and parallel to the target surface. In some embodiments, the translation machine is configured to translate reversibly in a back and forth movement. In some embodiments, the translation mechanism is configured to translate (i) laterally, (ii) horizontally, (iii) along an axis perpendicular to a gravitational vector aligned with a gravitational center, or (iv) any combination of (i), (ii), and (iii). In some embodiments, the translation mechanism is configured for incremental translation. In some embodiments, the translation mechanism is configured for continuous translation. In some embodiments, the translation mechanism is configured for discrete translation. In some embodiments, the translation mechanism is operatively coupled with operation of the printing agent such as the energy beam. In some embodiments, the translation mechanism is stationary during a portion of the printing, e.g., while the printing agent is active. In some embodiments, the gravitational center is a gravitational center of an environment in which the device is disposed. In some embodiments, the environment is Earth. In some embodiments, the device further comprises an array of optical assemblies, each optical assembly of the array of optical assemblies comprises: (i) at least one optical component configured to direct propagation of an energy beam along a beam path from within the optical assembly to impinge on the target surface disposed above a build platform, the build platform configured to carry at least one three-dimensional object printed by the three-dimensional printing; and (ii) a housing configured to (a) accommodate the at least one optical component and a portion of the beam path of the energy beam, and (b) allow impingement of the energy beam on the target surface to print the at least one three-dimensional object by the three-dimensional printing, e.g., as disclosed herein. In some embodiments, the optical assembly (e.g., each optical assembly in the array of optical assemblies) is reversibly retractable from the device and reversibly insertable into the device, e.g., for maintenance, upgrade, reconfiguration and/or exchange. In some embodiments, the optical assembly is modular, e.g., each optical assembly in the array of optical assemblies is modular. In some embodiments, an optical image generator is disposed between two optical assemblies of the array of optical assemblies, the optical image generator being of the at least one optical image generator. In some embodiments, optical image generators are interlaced with optical assemblies of the array of optical assemblies, the optical image generators being of the at least one optical image generator. In some embodiments, an optical image generator is part of an optical assembly of the array of optical assemblies, the optical image generator being of the at least one optical image generator. In some embodiments, optical image generators are each part of an optical assembly of the array of optical assemblies, the optical image generators being of the at least one optical image generator. In some embodiments, an optical window array is operatively coupled with the array of optical assemblies. In some embodiments, the optical assembly is (e.g., all optical assemblies are) modular. In some embodiments, an optical image generator is disposed between two optical windows of the optical window array, the optical image generator being of the at least one optical image generator. In some embodiments, optical image generators are interlaced with optical windows of the optical window array, the optical image generators being of the at least one optical image generator. In some embodiments, the device is configured such that the at least one optical image generator is configured to project the optical image at least on the entire target surface. In some embodiments, the device is configured such that the at least one optical image generator is configured to project the optical image at least on the entire target surface during the translation. In some embodiments, the at least one optical image generator comprises optical image generators, and where the device is configured to perform image processing of (e.g., superimpose) projected optical images to project the optical image at least on an entire surface of the target surface. In some embodiments, the image processing is performed when the translation system is stationary (e.g., does not translate), such as during the printing. In some embodiments, an optical image generator is stationary during translation of the translation mechanism, the optical image generator being of the at least one optical image generator. In some embodiments, at least two optical image generators are stationary during translation of the translation mechanism, the two optical image generators being of the at least one optical image generator. In some embodiments, each of the at least two optical image generators are disposed in a horizontal direction away from (a) the target surface and (b) from the translation mechanism. In some embodiments, each of the at least two optical image generators is disposed in a horizontal direction away from translation mechanism, each of the at least two optical image generators being disposed at either side of the translation mechanism. In some embodiments, the translation mechanism comprises railing, and each of the at least two optical image generators is disposed horizontally away from the railing with respect to the target surface. In some embodiments, the railing is configured to be isolated from debris generated in the chamber, the debris being generated during the three-dimensional printing. In some embodiments, the railing is disposed external to the processing chamber, e.g., on a roof of the processing chamber. In some embodiments, the railing comprises a labyrinth railing. In some embodiments, the railing comprises a non-labyrinth railing. In some embodiments, the translation mechanism comprises ball bearing. In some embodiments, the at least two optical image generators comprise four optical image generators each being disposed on a corner of a rectangle. In some embodiments, the rectangle is disposed vertically (e.g., substantially) parallel to the target surface. In some embodiments, an optical image generator translates during translation of the translation mechanism, the optical image generator being of the at least one optical image generator. In some embodiments, during translation of the translation mechanism (a) a first optical image generator is stationary and (a) a second optical image generator translates, the first optical image generator and the second optical image generator being of the at least one optical image generator. In some embodiments, a detector is disposed between two optical assemblies of the array of optical assemblies, the detector being of the at least one detector. In some embodiments, detectors are interlaced with optical assemblies of the array of optical assemblies, the detectors being of the at least one optical image generator. In some embodiments, a detector is part of an optical assembly of the array of optical assemblies, the detector being of the at least one detector. In some embodiments, detectors are each part of an optical assembly of the array of optical assemblies, the detectors being of the at least one detector. In some embodiments, an optical window array is operatively coupled with the array of optical assemblies. In some embodiments, the optical window array is disposed on a ceiling of the enclosure, each optical window of the optical window array being configured to respectively facilitate traversal of an energy beam therethrough to impinge on the target surface to print the at least one three-dimensional object, the energy beam being of energy beams. In some embodiments, the device is configured to allow unobstructed operation (i) of the at least one detector, (ii) of the at least one optical image generators, and (iii) of the energy beams traversing trough the optical window array. In some embodiments, a detector is disposed between two optical windows of the optical window array, the detector being of the at least one detector. In some embodiments, detectors are interlaced with optical windows of the optical window array, the detectors being of the at least one detector. In some embodiments, the device is configured such that the at least one detector is configured to view (e.g., and detect from) at least an entire surface of the target surface. In some embodiments, the device is configured such that the at least one detector is configured to view (e.g., and detect from) at least an entire surface of the target surface during the translation. In some embodiments, the at least one detector comprises detectors, and where the device is configured to superimposed images detected by the detectors to generate view of (e.g., and detected images from) at least an entire surface of the target surface. In some embodiments, a detector is stationary during translation of the translation mechanism, the detector being of the at least one detector. In some embodiments, at least two detectors are stationary during translation of the translation mechanism, the at least two detectors being of the at least one detector. In some embodiments, each of the at least two detectors is disposed in a horizontal direction away from (a) the target surface and (b) from the translation mechanism. In some embodiments, each of the at least two detectors is disposed in a horizontal direction away from translation mechanism, each of the at least two detectors being disposed at either side of the translation mechanism. In some embodiments, the translation mechanism comprises railing, and each of the at least two detectors is disposed horizontally away from the railing with respect to the target surface. In some embodiments, the railing is configured to limit debris from entering the railing, the debris being generated during the three-dimensional printing. In some embodiments, the railing comprises a labyrinth railing. In some embodiments, the railing comprises a track having a vertical cross section comprising a triangle, and where the translation mechanism comprises a wheel having a V shape complementary to the triangle. In some embodiments, the translation mechanism comprises ball bearing. In some embodiments, the at least two detectors comprise four detectors each being disposed on a corner of a rectangle. In some embodiments, the rectangle is disposed vertically (e.g., substantially) parallel to the target surface. In some embodiments, a detector translates during translation of the translation mechanism, the detector being of the at least one detector. In some embodiments, during translation of the translation mechanism (a) a first detector is stationary and (a) a second detector translates, the first detector and the second detector being of the at least one detector. In some embodiments, the at least one detector comprises detectors and the at least one optical image generator comprises optical image generators. In some embodiments, the detectors are interlaced with the optical image generators along one or more axes. In some embodiments, the detectors are alternatingly disposed with the optical image generators along one or more axes. In some embodiments, the one or more axes comprise 2, 3, 4, or more axes. In some embodiments, at least two of the axes cross at a point. In some embodiments, components comprise a detector of the detectors and an optical image generator of the optical image generators, and where at least two of the axes including (a) (e.g., substantially) the same type of the components and/or (b) (e.g., substantially) the number of the components. In some embodiments, components comprise a detector of the detectors and an optical image generator of the optical image generators, and where at least two of the axes include (a) a different type of the components and/or (b) a different number of the components. In some embodiments, disposed at the point is a detector of the detectors or an optical image generator of the optical image generators. In some embodiments, the point is devoid of a detector of the detectors and of an optical image generator of the optical image generators. In some embodiments, at least two of the axes are (e.g., substantially) parallel to each other. In some embodiments, at least one of the axes is disposed between two optical assemblies. In some embodiments, at least one of the axes is disposed between two optical assembly arrays. In some embodiments, at least one of the axes is disposed in an optical assembly. In some embodiments, at least one of the axes is disposed perpendicular to a long axis of the optical assembly. In some embodiments, at least one of the axes is disposed in an optical assembly array. In some embodiments, optical assemblies in the optical assembly array are stacked along a direction and the at least one axes is disposed along the direction. In some embodiments, a detector of the detectors is immediately adjacent to two or more of the optical image generators. In some embodiments, a detector of the detectors is not immediately adjacent to two or more other detectors of the detectors. In some embodiments, an optical image generator of the optical image generators is immediately adjacent to two or more of the detectors. In some embodiments, an optical image generator of the optical image generators is not immediately adjacent to two or more other optical image generators of the optical image generators. In some embodiments, at least two optical assemblies of the array of optical assemblies differ in their relative placement in the array of optical assemblies. In some embodiments, the translation mechanism is supportive of the array of optical assemblies, the translation mechanism being configured to translate the array of optical assemblies with respect to the target surface during the three-dimensional printing to facilitate printing the at least one three-dimensional object. In some embodiments, the translation mechanism is configured to linearly translate, e.g., along a straight line. In some embodiments, the translation mechanism is configured to translate from a first alignment position with respect to a first processing region of the target surface to a second alignment position with respect to a second processing region of the target surface. In some embodiments, the first processing region at least borders or at least partially overlaps with the second processing region. In some embodiments, a surface of the at least one three-dimensional object spans at least the first processing region and the second processing region. In some embodiments, the translation mechanism is configured to linearly translate along a straight line. In some embodiments, the device further comprises an enclosure, where the target surface is disposed within the enclosure. In some embodiments, the enclosure comprises a processing chamber and a build module. In some embodiments, the translation mechanism is configured to translate with respect to the target surface disposed within the enclosure. In some embodiments, the translation mechanism is configured to translate from a first lateral position with respect to the target surface to a second lateral position with respect to the target surface disposed in an enclosure. In some embodiments, the translation mechanism is configured to linearly translate. In some embodiments, the device is configured to allow at least one energy beam to traverse along the target surface to facilitate the three-dimensional printing. In some embodiments, the translation mechanism is configured to translate from a first alignment position with respect to a first process region of the target surface to a second alignment position with respect to a second process region of the target surface. In some embodiments, the device is configured such that, in the first alignment position and in the second alignment position, the translation mechanism is stationary with respect to the target surface during the three-dimensional printing. In some embodiments, the translation mechanism is configured to translate for a first period of time comprising variable acceleration and for a second period time comprising variable deceleration. In some embodiments, the variable acceleration comprises variable magnitude of acceleration and the variable deceleration comprises variable magnitude of deceleration. In some embodiments, an absolute value of an integration of the variable acceleration is different in magnitude from an absolute value of an integration of the variable deceleration. In some embodiments, an absolute value of an integration of the variable acceleration is (e.g., substantially) the same in magnitude as an absolute value of an integration of the variable deceleration. In some embodiments, the translation mechanism is configured to translate along an axis parallel to the target surface. In some embodiments, the translation mechanism is configured to translate laterally along an axis that is perpendicular to a vertical axis. In some embodiments, the translation mechanism is configured to translate laterally along an axis that is perpendicular to a gravitational vector pointing to a gravitational center. In some embodiments, the translation mechanism comprises a railing system, the railing system being configured to translate from a first position to a second position with respect to the target surface. In some embodiments, the railing system comprises at labyrinth railing. In some embodiments, the railing system comprises an actuator. In some embodiments, the actuator comprises a servo motor. In some embodiments, the railing system comprises two or more independently operable actuators. In some embodiments, (e.g., each of) the at least one detector comprises a camera comprising a stills camera or a video camera. In some embodiments, the at least one optical image generator comprises (i) a projector or (ii) a laser. In some embodiments, the at least one detector and the at least one optical image generator are components of a metrological detection system. In some embodiments, (A) the at least one optical image generator is a plurality of optical image generators, and/or (B) the at least one detector is a plurality of detectors. In some embodiments, (A) the plurality of optical image generators are arranged in an array of optical image generators and/or (B) the plurality of detectors are arranged in an array of detectors. In some embodiments, the array of optical image generators is arranged with respect to the array of detectors such that at least a portion of the array of optical image generators is interleaved with a portion of the array of detectors. In some embodiments, at least one optical image generator of the array of optical image generators is interleaved with at least one detector of the array of detectors. In some embodiments, at least one component comprise (A) the at least one optical image generator or (B) at least one detector; and where the at least one component is arranged symmetrically with respect to the translation mechanism and/or the target surface. In some embodiments, the translation mechanism comprises a mounting plate, and therein the at least one of the components is supported by the mounting plate configured to translate with the at least one component. In some embodiments, operatively coupled comprises affixed to the mounting plate. In some embodiments, operatively coupled comprises reversibly attached to, and reversibly detached from, the mounting plate. In some embodiments, (A) the at least one optical image generator is configured to be stationary with respect to translation of the translation mechanism; and where the at least one detector is supported by the mounting plate of the translation mechanism such that the at least one detector translates with the array of optical assemblies or (B) the at least one detector is configured to be stationary with respect to translation of the translation mechanism; and where the at least one optical image generator is supported by the mounting plate of the translation mechanism such that the at least one optical image generator translates with the array of optical assemblies. In some embodiments, (A) the at least one detector is supported by the mounting plate of the translation mechanism such that the at least one detector translates with the array of optical assemblies and (B) the at least one optical image generator is supported by the mounting plate of the translation mechanism such that the at least one optical image generator translates with the array of optical assemblies. In some embodiments, the at least one of the components is arranged between two (e.g., immediately adjacent) optical assemblies of an array of optical assemblies. In some embodiments, the at least one of the components is arranged between two (e.g., immediately adjacent) arrays of the optical assemblies. In some embodiments, at least one of the array of optical assemblies is a linear array. In some embodiments, the array of optical assemblies are linear arrays. In some embodiments, the linear array of optical assemblies being two immediately adjacent linear arrays devoid of an intervening linear array disposed between the two immediately adjacent linear arrays. In some embodiments, the device further comprises an array of optical windows disposed on a ceiling (e.g., roof) of the enclosure. In some embodiments, the device further comprises an array of optical windows disposed on a wall of the enclosure opposing the target surface. In some embodiments, the device further comprises optical windows configured to facilitate traversal of respective energy beams therethrough to impinge on the target surface. In some embodiments, respective fields of view of the energy beams are symmetrically arranged with respect to each other at the target surface, the plurality of energy beams impinging on the target surface. In some embodiments, the optical windows are symmetrically arranged with respect to each other. In some embodiments, symmetrically arranged with respect to each other comprises a rotational symmetry axis, or a mirror symmetry plane; where the rotational symmetry axis is disposed between two of the optical windows of a pair of the optical windows; and where the mirror symmetry plane is disposed between the two of the optical windows. In some embodiments, (A) the rotational symmetry axis and/or (B) the mirror symmetry plane, is perpendicular to a floor of the housing relative to a gravitational center; and where the gravitational center is a gravitational center of an environment in which the device is disposed. In some embodiments, the symmetry the rotational symmetry axis comprises a C2 (180 degrees), C3 (120 degrees), or C4 (90 degrees) symmetry axis. In some embodiments, at least two of the optical windows are asymmetrically arranged with respect to each other. In some embodiments, a respective fundamental length scale (FLS) of a first cross-section of at least one optical window of the optical windows is different than a corresponding FLS of a second cross-section of one other optical window of the optical windows. In some embodiments, a fundamental length scale (FLS) of a first cross-section of at least one optical window of the optical windows is (e.g., substantially) the same as a corresponding FLS of a second cross-section of one other optical window of the optical windows. In some embodiments, at least one optical window of the plurality of optical windows comprises a cross-section in a plane of the optical window that is (i) elliptical, (ii) polygonal, or (iii) irregular in shape. In some embodiments, elliptical comprises circular, and where polygonal comprises rectangular. In some embodiments, the at least one optical window comprises an elongated dimension aligned along an axis that is (i) horizontal, (ii) perpendicular to a gravitational vector of an environment, or (iii) any combination of (i) and (ii). In some embodiments, at least two of the optical windows comprise a respective elongated dimension aligned with the axis, the respective elongated dimensions of each of the at least two of the optical windows being parallel to each other. In some embodiments, the elongated dimension has a length extending in (e.g., substantially) same direction as a translation direction of the translation mechanism. In some embodiments, the elongated dimension has a length extending in a perpendicular direction to a translation direction of the translation mechanism. In some embodiments, the optical windows comprises at least about 2, 4, 6, 8, 10, 12, 14, 16, 20, 24, 28, 32, or 36 optical windows. In some embodiments, the optical windows comprises an array of optical windows, the array of optical windows comprising at least two optical windows, the two optical windows being aligned along respective axis. In some embodiments, the array of optical windows comprises a linear array of optical windows. In some embodiments, the array of optical windows comprises a two-dimensional array of optical windows, the two-dimensional array comprising at least four optical windows. In some embodiments, the plurality of optical windows of the array of optical windows is periodically arranged with respect to a surface of an enclosure, where the surface comprises (a) a floor of the enclosure or (b) a ceiling of the enclosure. In some embodiments, the optical windows comprise arrays of optical windows, at least one (e.g., each) of the arrays having successively disposed optical windows along a single file. In some embodiments, the single file direction is along a direction of the translation of the translation mechanism. In some embodiments, the optical window is configured to be traversed by at least one printing agent (e.g., energy beam) such as during the printing, by emissions of the at least one optical image generator, and/or by emissions detected by the at least one detector. In some embodiments, the optical window is configured to be traversed by at least one printing agent (e.g., energy beam) such as during the printing, and the optical window is configured to not be traversed: (a) by emissions of the at least one optical image generator, and/or (b) by emissions detected by the at least one detector. In some embodiments, an optical window is configured to be traversed by (a) emissions of the at least one optical image generator, and/or (b) by emissions detected by the at least one detector, and the optical window is configured to not be traversed by at least one printing agent (e.g., energy beam), e.g., for the printing. In some embodiments, the optical window services radiation from different sources. In some embodiments, the different sources are of (e.g., substantially) the same type, e.g., different energy beam sources. In some embodiments, the different sources are of a different same type, e.g., (a) an energy beam source and an optical image generator; (b) energy beam source and radiation emitted from the target surface; (c) an optical image generator and radiation emitted from the target surface; or (d) an optical image generator, a radiation emitted from the target surface, and an energy beam source that is a printing agent. In some embodiments, the optical window services radiation from a single source, e.g., an energy beam source, a target surface, an optical image generator (e.g., a projector). In some embodiments, at least one of the optical windows are supported by and/or disposed in a nozzle having a gas outlet including at least one outlet opening. In some embodiments, the at least one outlet opening is arranged with respect to the at least one optical window and configured to direct a flow of gas away from the optical window. In some embodiments, the at least one outlet opening is configured to direct the flow of gas away from the at least one optical window and towards a target surface. In some embodiments, the at least one outlet opening is configured to direct the flow of gas away from the at least one optical window and towards an inner volume of an enclosure in which the target surface is disposed. In some embodiments, the flow of gas is at least about 3 kilopascals. In some embodiments, the flow of gas is sufficient to eliminate debris in the enclosure from contacting a surface of the optical window. In some embodiments, at least a part of the debris is generated as a byproduct during the three-dimensional printing. In some embodiments, the flow of gas is sufficient to eliminate debris in the enclosure from adhering to the surface of the optical window. In some embodiments, the at least one outlet opening comprises outlet openings. In some embodiments, at least one of the optical windows comprises a material having diminished absorption of electromagnetic wavelengths between about 400 nanometers (nm) to 4000 nm during the three-dimensional printing. In some embodiments, at least one of the optical windows comprises a material having diminished thermal absorption during the three-dimensional printing. In some embodiments, at least one of the optical windows comprises a material having diminished thermal lensing effect during the three-dimensional printing. In some embodiments, the material of the at least one optical window comprises sapphire, beryllium, zinc selenide, calcium fluoride (CaF2), or fused silica. In some embodiments, the device is utilized at least in part to align one or more printing agents with respect to the target surface. In some embodiments, the one or more printing agents comprise one or more energy beams respectively. In some embodiments, the device further comprises an alignment detection system operatively coupled to, or includes, the device. In some embodiments, the alignment detection system comprises (A) the at least one detector, (B) the at least one optical image generator, or (c) at least one energy source. In some embodiments, the at least one energy source and/or the at least one optical image generator, comprises a light source. In some embodiments, the light source comprises a visible light source. In some embodiments, the light source comprises an infrared light source. In some embodiments, the light source comprises a laser light source. In some embodiments, the light source comprises a projector. In some embodiments, the optical image comprises a structured light. In some embodiments, the structured light comprises areas of detectable varied light intensity. In some embodiments, the varied light intensity comprises no intensity. In some embodiments, a structured light source comprises (A) the at least one optical image generator or (B) the at least one energy source; and where the structured light source is configured to direct structured light onto the target surface. In some embodiments, the at least one detector comprises an interferometric detector. In some embodiments, the at least one detector comprises a stills camera or a video camera. In some embodiments, the camera comprises (i) a complementary metal-oxide semiconductor (CMOS) detector or (ii) a charge-coupled detector (CCD) camera. In some embodiments, the target surface is an exposed surface of a material bed. In some embodiments, the material bed comprises a powder bed. In some embodiments, the material bed includes a material comprising an elemental metal, a metal alloy, a ceramic, or an allotrope of elemental carbon. In some embodiments, the target surface comprises (i) an exposed surface of a material bed or (ii) a surface of a build platform configured to support at least one three-dimensional object printed by the three-dimensional printing. In some embodiments, the material bed generated on the surface of the build platform having a fundamental length scale of at least about 400 millimeters (mm), 600 mm, 1000 mm, 1200 mm, 1500 mm, or 1750 mm. In some embodiments, the material bed is generated on the surface of the build platform; and where the build platform is configured to support a weight of at least about 1000 kg or 2000 kg. In some embodiments, the material bed has at least one fundamental length scale of at least about 400 millimeters (mm), 600 mm, 1000 mm, 1200 mm, 1500 mm, or 1750 mm. In some embodiments, the three-dimensional printing comprises deposition of pre-transformed material on a target surface. In some embodiments, the device further comprises a dispenser configured to dispense a first portion of pre-transformed material on the target surface. In some embodiments, the device further comprises a remover configured to remove a second portion of the deposited pre-transformed material from the target surface to generate a planar layer of pre-transformed material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of the pre-transformed material removed by the remover and/or (ii) provides at least a portion of the pre-transformed material utilized by the dispenser. In some embodiments, deposition of pre-transformed material on the target surface comprises layerwise deposition of the pre-transformed material. In some embodiments, the pre-transformed material comprises powder material. In some embodiments, the pre-transformed material comprises elemental metal, metal alloy, ceramic, or an allotrope of carbon. In some embodiments, the device is configured to operate at an interior atmosphere of an enclosure that is different from an ambient atmosphere external to the enclosure. In some embodiments, the device is configured to operate at an interior atmosphere of an enclosure under a positive pressure atmosphere relative to an ambient atmosphere external to the enclosure. In some embodiments, the device is configured to operate at an interior atmosphere of an enclosure that is depleted of a reactive agent relative to its concentration in an ambient atmosphere external to the enclosure, the reactive agent being configured to react with a starting material of the three-dimensional printing at least during the three-dimensional printing. In some embodiments, the reactive agent comprises oxygen, water, or hydrogen sulfide. In some embodiments, the device further comprises an enclosure comprising a build module body (e.g., as disclosed herein) configured to support and/or retain the target surface during the three-dimensional printing. In some embodiments, the build module body further comprises a seal. In some embodiments, the seal is included, or is operatively coupled with a shutter, a lid, a closure, an envelope, or a flap. In some embodiments, the seal is arranged with respect to an upper-most portion of the build module body and opposite a bottom portion of the build module body. In some embodiments, the seal is gas tight. In some embodiments, the seal is a hermetic seal. In some embodiments, the enclosure comprises a processing chamber engaged with the build module during the three-dimensional printing. In some embodiments, the seal is configured to facilitate retaining an internal atmosphere in the build module body for a time period after disengagement of the build module from the processing chamber (e.g., and after the printing), the internal atmosphere being different from an ambient atmosphere external to the build module. In some embodiments, the seal is configured to facilitate retaining for a time period after disengagement of the build module from the processing chamber (i) a positive pressure in the build module body relative to an ambient atmosphere external to the device and/or (ii) a reactive agent at a concentration lower than its concentration in an ambient atmosphere external to the build module, the reactive agent being configured to at least react with pre-transformed material of the three-dimensional printing during the three-dimensional printing. In some embodiments, the device is configured to facilitate printing one or more three-dimensional objects in an atmosphere maintained to be different from an ambient atmosphere by at least one characteristic, the ambient atmosphere being external to a build module and to an enclosure. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, at least a portion of the three-dimensional printing comprises extruding. In some embodiments, extruding is by an extruder to facilitate printing the at least one three-dimensional object. In some embodiments, the device comprises, or operatively coupled to, the extruder. In some embodiments, at least a portion of the three-dimensional printing comprises laminating. In some embodiments, laminating comprises depositing by a laminator configured to deposit layerwise laminated layers to facilitate printing the at least one three-dimensional object. In some embodiments, the device comprises, or be operatively coupled to, the laminator. In some embodiments, at least a portion of the three-dimensional printing comprises connecting particulate matter to facilitate printing the at least one three-dimensional object. In some embodiments, the particulate matter is disposed in a material bed. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X.

In another aspect, a method of three-dimensional printing, the method comprises: providing the device of any of the above devices; and using the device during three-dimensional printing. In some embodiments, the three-dimensional printing comprises connecting a particulate matter. In some embodiments, connecting comprises fusing. In some embodiments, fusing comprises melting. In an example, a method of three-dimensional printing, the method comprises: (a) using at least one optical image generator to project an optical image on a target surface utilized for the three-dimensional printing, the optical image comprising optical variations that are detectable, the at least one optical image generator being disposed adjacent to the target surface; (b) using at least one detector to optically detect (A) the optical variations appearing on the target surface and (B) a difference between the optical variations detected and a corresponding the optical variations projected, the difference corresponding to physical variation in uniformity of the target surface, the at least one detector operatively coupled with the at least one optical image generator, the at least one detector being disposed adjacent to the target surface; and (c) translating a translation mechanism with respect to the target surface during the three-dimensional printing, the translation mechanism being operatively coupled to, supportive of, and configured to translate: (i) the at least one optical image generator and/or (ii) the at least one detector.

In another aspect, an apparatus for three-dimensional printing, the apparatus comprising at least one controller configured to operatively coupled with the device of any of the above devices; and control, or direct control of, one or more operations associated with the device. In some embodiments, the at least one controller is operatively coupled with at least one connector configured to connect to a power source, e.g., electrical power source. In some embodiments, the at least one controller is configured to operatively couple to a power source at least in part by (i) having a power socket and/or (ii) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the device is a component of a three-dimensional printing system, and where the at least one controller is configured to (i) operatively couple to an other component of the three-dimensional printing system and (ii) direct operation of the other component. In some embodiments, the at least one controller is configured to direct operation of the other component at least in part for participation of the other component in three-dimensional printing. In some embodiments, the at least one controller is configured to (i) operatively couple to a guidance system, and (ii) direct the guidance system to guide the energy beam to impinge on the target surface at a location. In some embodiments, the apparatus where directing the guidance system comprises guiding the energy beam to traverse along the target surface. In some embodiments, the at least one controller is configured to (i) operatively couple to at least one actuator, and (ii) direct the at least one actuator to linearly translate the array of optical assemblies with respect to the target surface. In some embodiments, the at least one controller is configured to direct a flow of gas through at least one outlet opening of a gas outlet away from an optical window and toward the target surface. In an example, an apparatus for three-dimensional printing, the apparatus comprising at least one controller configured to: (a) operatively coupled with at least one optical image generator, to at least one detector, and to a translation mechanism, the at least one optical image generator and the at least one detector are disposed adjacent to a target surface; (b) direct the at least one optical image generator to project an optical image on the target surface utilized for the three-dimensional printing, the optical image comprising optical variations that are detectable; (c) direct the at least one detector to optically detect the optical variations appearing on the target surface, the at least one detector operatively coupled with the at least one optical image generator; (d) evaluate, or direct the at least one detector to evaluate, a difference between the optical variations detected and a corresponding the optical variations projected, the difference corresponding to physical variation in uniformity of the target surface; and (e) direct a translation mechanism to translate with respect to the target surface during the three-dimensional printing, the translation mechanism being operatively coupled to, supportive of, and configured to translate: (A) the at least one optical image generator and/or (B) the at least one detector. In some embodiments, the evaluation is performed when the translation system is stationary (e.g., does not translate), such as in real time during the printing.

In another aspect, non-transitory computer readable program instructions for three-dimensional printing, the program instructions, when read by one or more processors operatively coupled with the device in device of any of the above devices, cause the one or more processors to execute, or direct execution of, one or more operations associated with the device. In some embodiments, the program instructions are inscribed in one or more media. In some embodiments, the one or more processors can direct other devices to perform mechanical operations. In some embodiments, the one or more processors perform (i) calculations and/or (ii) other digital operations. In some embodiments, the one or more processors are operatively coupled with a guidance system; and where the operations comprise directing the guidance system to guide the energy beam to impinge on the target surface at a location. In some embodiments, the operations comprise directing the guidance system to guide the energy beam to traverse along the target surface, e.g., at a predetermined path. In some embodiments, the one or more processors are operatively coupled with at least one actuator; and where the operations comprise directing the at least one actuator to linearly translate the array of optical assemblies with respect to the target surface. In an example, non-transitory computer readable program instructions for three-dimensional printing, the program instructions, when read by one or more processors operatively coupled with at least one optical image generator, to at least one detector, and to a translation mechanism, cause the one or more processors to execute, or direct execution of, one or more operations comprises: (a) directing the at least one optical image generator to project an optical image on a target surface utilized for the three-dimensional printing, the optical image comprising optical variations that are detectable, the at least one optical image generator being disposed adjacent to a target surface; (b) directing the at least one detector to optically detect the optical variations appearing on the target surface, the at least one detector operatively coupled with the at least one optical image generator, the at least one detector being disposed adjacent to a target surface; (c) evaluating, or directing the at least one detector to evaluate, a difference between the optical variations detected and a corresponding the optical variations projected, the difference corresponding to physical variation in uniformity of the target surface; and (d) directing a translation mechanism to translate with respect to the target surface during the three-dimensional printing, the translation mechanism being operatively coupled to, supportive of, and configured to translate: (A) the at least one optical image generator and/or (B) the at least one detector. In some embodiments, the evaluation is performed when the translation system is stationary (e.g., does not translate), such as in real time during the printing.

In another aspect, a system for three-dimensional printing, the system comprises: the device of any of the above devices; and an energy beam configured to irradiate the target surface (e.g., of a planar layer of powder material) to print at least a portion of at least one three-dimensional object by using the three-dimensional printing. In some embodiments, the system further comprises a scanner configured to translate the energy beam along the target surface, where the device is operatively coupled with the scanner. In some embodiments, the system further comprises an energy source configured to generate the energy beam, where the device is operatively coupled with the energy source. In some embodiments, the system further comprises at least one controller that (I) is operatively coupled with the device and (II) direct one or more operations associated with the device. In some embodiments, the system further comprises at least one controller that (i) is operatively coupled with at least one mechanism associated with the three-dimensional printing and (ii) direct one or more operations associated with the at least one mechanism, the at least one mechanism being different from the device. In some embodiments, the system is configured to operatively couple to at least one controller configured to (i) operatively couple to the system and (ii) direct one or more operations associated with the system. In an example, a system for three-dimensional printing, the device comprises: at least one optical image generator configured to project an optical image on a target surface utilized for the three-dimensional printing, the optical image comprising optical variations that are detectable, the at least one optical image generator being disposed adjacent to the target surface; at least one detector configured to optically detect (A) the optical variations appearing on the target surface and (B) a difference between the optical variations detected and a corresponding the optical variations projected, the difference corresponding to physical variation in uniformity of the target surface, the at least one detector operatively coupled with the at least one optical image generator, the at least one detector being disposed adjacent to the target surface; a translation mechanism configured to translate with respect to the target surface during the three-dimensional printing, the translation mechanism being operatively coupled to, supportive of, and configured to translate: (a) the at least one optical image generator and/or (b) the at least one detector; and an energy beam configured to irradiate a target surface to print at least one three-dimensional object by using the three-dimensional printing.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or be operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, or in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations (e.g., instructions) of the apparatus are directed by the same controller. In some embodiments, at least two of operations (e.g., instructions) of the apparatus are directed by different controllers.

In some embodiments, at least two of operations (e.g., instructions) are carried out by the same processor and/or by the same sub-computer software product. In some embodiments, at least two of operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the at least one controller is configured to control at least one other component of a 3D printing system. In some embodiments, the device disclosed herein is a component of a three-dimensional printing system, and wherein the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 sensors, or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions for three-dimensional printing, the non-transitory computer readable program instructions, when read by one or more processors operatively coupled to the device, cause the one or more processors to direct executing one or more operations associated with at least one configuration of the device(s) disclosed herein.

In some embodiments, the program instructions are of a computer product.

In another aspect, a system for three-dimensional printing, the system comprising: the any of the devices above; and an energy beam configured to irradiate powder material (e.g., a planar layer of powder material) to print at least a portion of at least one three-dimensional object at least in part by using three-dimensional printing. In some embodiments, the system further comprising a scanner configured to translate the energy beam along a target surface, wherein the device is operatively coupled with the scanner disposed in an optical system enclosure. In some embodiments, the system further comprises an energy source configured to generate the energy beam, wherein the device is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 schematically illustrates a side view of a three-dimensional (3D) printing system and its components;

FIG. 2 schematically illustrates a perspective view of a 3D printing system and its components;

FIG. 3 illustrates a path;

FIG. 4 schematically illustrates a computer control system that is programmed or otherwise configured to facilitate the formation of one or more 3D objects;

FIG. 5 shows a schematic view of a 3D printing system and its components;

FIG. 6 schematically illustrates a side view of a 3D printing system and its components;

FIG. 7 schematically illustrates views of 3D printing systems and its components;

FIG. 8 shows a schematic view of a 3D printing system and its components;

FIG. 9 shows schematic views of 3D printing system components;

FIG. 10 shows schematic views of 3D printing system components;

FIG. 11 shows schematic views of 3D printing system components;

FIG. 12 shows schematic views of 3D printing system components, and a photograph of an optical enclosure;

FIG. 13 shows schematic views of 3D printing system components;

FIG. 14 shows schematic views of 3D printing system components;

FIG. 15 shows schematic views of 3D printing system components;

FIG. 16 shows schematic views of 3D printing system components;

FIG. 17 shows schematic views of 3D printing system components;

FIG. 18 shows schematic views of 3D printing system components;

FIG. 19 shows a schematic view of 3D printing system components;

FIG. 20 shows a schematic view of 3D printing system components;

FIG. 21 shows example translation profile plots;

FIG. 22 shows schematic views of 3D printing system components;

FIG. 23 shows schematic views of 3D printing system components;

FIG. 24 schematically illustrates a view of a 3D printing system and its components;

FIG. 25 shows schematic views of 3D printing system components;

FIG. 26 schematically illustrates views of 3D printing systems and its components;

FIG. 27 shows schematic views of 3D printing system components;

FIG. 28 depicts a projected pattern of a metrological detection system on a physical exposed surface of a material bed;

FIG. 29 shows schematic views of 3D printing system components;

FIG. 30 shows schematic views of 3D printing system components;

FIG. 31 shows schematic views of 3D printing system components;

FIG. 32 schematically illustrates various views and vertical cross sections of 3D objects and planar layers;

FIG. 33 schematically illustrates various views and vertical cross sections of 3D objects;

FIG. 34 schematically illustrates a vertical cross sections of a melt-pool and shows photographs of physical 3D object portions;

FIG. 35 schematically illustrates a portion of a 3D object;

FIG. 36 shows an example of optical system components and various axes;

FIG. 37 shows a flow diagram of processes relating to 3D printing;

FIG. 38 shows a flow diagram of processes relating to 3D printing;

FIG. 39 shows a flow diagram of processes relating to 3D printing;

FIG. 40 shows a flow diagram of processes relating to 3D printing; and

FIG. 41 shows a flow diagram of processes relating to 3D printing.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter. For example, when a layer dispensing mechanism (e.g., recoater) reversibly translates in a first direction, that layer dispensing mechanism (e.g., recoater) can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

In an aspect provided herein is a system for generating a 3D object comprising: an enclosure for accommodating a material bed comprising pre-transformed material (e.g., starting material such as powder); an energy beam capable of transforming the pre-transformed material to form a transformed material; and a controller (e.g., as part of a control system) that directs the energy to impinge on and exposed surface of the material bed and translate along a path (e.g., as described herein). The transformed material may be capable of hardening to form at least a portion of a 3D object. The system may comprise an energy source generating the energy beam, a guiding system that guides the energy beam along the exposes surface such as an optical system (e.g., comprising a scanner), the control system, a layer dispensing mechanism comprising a recoater, gas source(s), pump(s), nozzle(s), valve(s), sensor(s), display(s), chamber(s), processor(s) comprising or software (e.g., comprising algorithm(s)) inscribed on a computer readable media/medium. The control system may be configured to control at least one component of the 3D printing system. The control system may be configured to control at least one aspect of the 3D printing process. For example, the control system may be configured to control temperature, pressure, gas flow, optics, actuator(s), energy source(s), energy beam(s), and/or atmosphere(s). The control system may comprise processor(s). The enclosure may comprise a processing chamber and/or a build module. The base may be referred to herein as the “build plate” or “build platform.” The substrate may comprise a piston, e.g., as part of an elevator system. The system for generating at least one 3D object (e.g., in a printing cycle) and the system's components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

The present disclosure provides three-dimensional (3D) printing apparatuses, systems, software, and methods for forming a 3D object. For example, a 3D object may be formed by sequential addition of material or joining of starting material (e.g., pre-transformed material or source material) to form a structure in a controlled manner (e.g., under manual or automated control).

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed by sequential addition of material or joining of starting material (e.g., pre-transformed material or source material) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may be in the form of a powder, wires, sheets, or droplets. The pre-transformed material may be pulverous. The pre-transformed material may have been introduced during a 3D printer process prior to the upcoming 3D printing process, and is left as a remainder material. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is considered a pre-transformed material relative to the second 3D printing process. The remainder can be filtered and otherwise recycled for use as a pre-transformed material in the second 3D printing process.

In some embodiments, in a 3D printing process, the deposited pre-transformed material may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a pre-transformed material.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more material beds (e.g., powder bed). In some embodiments, a plurality of 3D objects is formed in one material bed.

At times, the printing of a (e.g., complex) 3D object involves using a combination of methodologies (e.g., having respective process parameters). In some cases, different methodologies may be used to transform different portions of the object. In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder based arc welding), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition. Various apparatuses (e.g., controllers), systems (e.g., 3D printers), software, methods related to types of energy beam and formation of 3D objects, as well as various control schemes are described in U.S. patent application Ser. No. 15/435,128; International Patent Application number PCT/US17/18191; European Patent Application number EP17156707.6; and International Patent Application number PCT/US18/20406, each of which is entirely incorporated herein by reference.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In an aspect provided herein is a system for generating a 3D object comprising: an enclosure for accommodating at least one planar layer of pre-transformed material (e.g., powder); at least one energy (e.g., energy beam) capable of transforming the pre-transformed material to form a transformed material; and at least one controller (e.g., as part of a control system) that directs the energy beam(s) to impinge on the exposed surface of the layer of pre-transformed material and translate along a path (e.g., as described herein). The transformed material may be capable of hardening to form at least a portion of a 3D object. The system may comprise at least one energy source generating the energy beam(s), at least one optical system, a layer dispensing mechanism such as a recoater, gas source(s), pump(s), nozzle(s), valve(s), sensor(s), display(s), chamber(s), processor(s) comprising or software inscribed on a computer readable media/medium. The control system may be configured to control attributes including temperature, pressure, gas flow, optics, actuator(s), energy source(s), energy beam(s), and/or atmosphere(s). The chamber may comprise a base (e.g., also referred to herein as “build platform,” or “build plate”) and a substrate. The substrate may comprise a piston. The system for generating at least one 3D object (e.g., in a printing cycle) and its components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the deposited pre-transformed material within the enclosure is a liquid material, semi-solid material (e.g., gel), or a solid material (e.g., powder). The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, amorphous carbon, carbon fiber, carbon nanotube, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding.

The printed 3D object can be made of a single material (e.g., single material type) or a plurality of materials (e.g., a plurality of material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a type of material.

In some examples, the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity (e.g., at least about 1*10⁵ Siemens per meter (S/m)), low electrical resistivity (e.g., at most about 1*10⁻⁵ ohm times meter (Ω*m)), high thermal conductivity (e.g., at least about 10 Watts per meter times Kelvin (W/mK)), or high density (e.g., at least about 1.5 grams per cubic centimeter (g/cm³)). The density can be measured at ambient temperature (e.g., at R.T., or 20° C.) and at ambient atmospheric pressure (e.g., at 1 atmosphere).

In some examples, the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity, low electrical resistivity, high thermal conductivity, or high density.

In some embodiments, the elemental metal is an alkali metal, an alkaline earth metal, a transition metal, a rare-earth element metal, a precious metal, or another metal. The elemental metal may comprise Titanium, Copper, Platinum, Gold, or Silver.

In some embodiments, the metal alloy comprises iron-based alloy, nickel-based alloy, cobalt-based alloy, chrome-based alloy, cobalt chrome-based alloy, titanium-based alloy, magnesium-based alloy, or copper-based alloy. The alloy may comprise an oxidation or corrosion resistant alloy. The alloy may comprise a super alloy (e.g., Inconel, In718, Ti64, F357, Haynes282, GRCop-42, C22, CA6NM, Hastelloy-X). The alloy may comprise an alloy used for aerospace applications, automotive application, surgical application, or implant applications. The metal may include a metal used for aerospace applications, automotive application, surgical application, or implant applications.

In some embodiments, the metal alloys are refractory alloys. The refractory metals and alloys may be used for heat coils, heat exchangers, furnace components, or welding electrodes. The refractory alloys may comprise a high melting points, low coefficient of expansion, mechanically strong, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers, and associated methods, software, systems, devices, materials (e.g., alloys), and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the elemental carbon comprises graphite, Graphene, diamond, amorphous carbon, carbon fiber, carbon nanotube, or fullerene.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be about at least about 5 μm, 10 μm, 20 μm, 30 μm, 40 μm, 53 μm, 60 μm, or 75 μm. The particles can have a central tendency of the FLS of at most about 65 μm. In some cases, the powder particles may have central tendency of the FLS between any of the afore-mentioned FLSs.

In some embodiments, the powder comprises a particle mixture, which particle comprises a shape. The powder can be composed of a homogenously shaped particle mixture such that all the particles have substantially the same shape and FLS magnitude within at most about 1%, 5%, 8%, 10%, 15%, 20%, 25%, 30%, 35%, or 40% distribution of FLS.

In some embodiments, the 3D object(s) are printed from a material bed. The FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m or 5 m. The FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, the FLS of the material bed is in the direction of the gas flow.

In some examples, the 3D printing system requires operation of maximum a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the enclosure and/or processing chamber of the 3D printing system may be opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. it may denote 20° C., 25° C., or any value from about 20° C. to about 25° C.

In some embodiments, the 3D printer has a capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some embodiments, a time lapse between the end of printing in a first material bed, and the beginning of printing in a second material bed is at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to about 5 min, from about 60 min to about 30 min, from about 30 min to about 5 min, from about 20 min to about 5 min, from about 20 ‘min to about 10 min, or from about 15 min to about 5 min). In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr). At times, the 3D printing increases in efficiency when a plurality of energy beams is used for the 3D printing. For example, the time for 3D printing may be shortened when at least two of the plurality of energy beams operate simultaneously at least in part (e.g., in parallel). For example, the time for 3D printing may be shortened by at least about 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam). Examples of 3D printing systems, apparatuses, devices, and components, controllers, software, and 3D printing processes (e.g., speed of printing, throughput of printing processes) can be found in International Patent Application Serial No. PCT/US15/36802, and in International Patent Application Serial No. PCT/US19/226364, filed on May 16, 2019, each of which is incorporated herein by reference in its entirety.

In some embodiments, the at least one 3D object is removed from the material bed after the completion of the 3D printing process. For example, the 3D object(s) may be removed from the material bed when the transformed material that formed the 3D object hardens. For example, the 3D object may be removed from the material bed when the transformed material that formed the 3D object is no longer susceptible to deformation under standard handling operation (e.g., human and/or machine handling). At times, the generated 3D object requires very little or no further processing after its retrieval. Further processing may be post printing processing. Further processing may comprise trimming, annealing, curing, or polishing, e.g., as disclosed herein. Further processing may comprise polishing such as sanding. In some cases, the generated 3D object can be retrieved and finalized without removal of transformed material and/or auxiliary support features.

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dᵥ+L/K_{dv}, wherein Dᵥ is a deviation value, L is the length of the 3D object in a specific direction, and K_{dv} is a constant. Dᵥ can have a value of at most about 300 μm, 200 μm, 100 μm, 50 μm, 40 μm, 30 μm, 20 μm, 10 μm, 5 μm, 1 μm, or 0.5 μm. Dᵥ can have a value of at least about 0.5 μm, 1 μm, 3 μm, 5 μm, 10 μm, 20 μm, 30 μm, 50 μm, 70 μm, 100 μm, 300 μm or less. Dᵥ can have any value between the afore-mentioned values. For example, Dᵥ can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K dv can have a value of at least about 500, 1000, 1500, 2000, 2500, or 3000. K_{dv} can have any value between the afore-mentioned values. For example, K_{dv} can have a value that is from about 3000 to about 500, from about 1000 to about 2500, from about 500 to about 2000, from about 1000 to about 3000, or from about 1000 to about 2500.

At times, the generated 3D object (i.e., the printed 3D object) does not require further processing following its generation by a method described herein. The printed 3D object may require reduced amount of processing after its generation by a method described herein. For example, the printed 3D object may not require removal of auxiliary support (e.g., since the printed 3D object was generated as a 3D object devoid of auxiliary support). The printed 3D object may not require smoothing, flattening, polishing, or leveling. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, and components, controllers, software, and 3D printing processes (e.g., post-processing, post-generation treatment, and post-printing treatment) can be found in U.S. Pat. No. 10,286,452 issued May 14, 2019, which is entirely incorporated herein by reference.

At times, the methods described herein are performed in the enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled (e.g., maintained) pressure. The enclosure may have a predetermined and/or controlled atmosphere, e.g., during the 3D printing. The control may be manual or via a control system.

In some embodiments, the 3D printer comprises a chamber having an interior space. The chamber may be referred to herein as a “processing chamber.” The processing chamber may facilitate ingress of at least one energy beam into the processing chamber. The energy beam(s) may be directed towards a target surface, e.g., an exposed surface of a material bed. The 3D printer may comprise one or more modules, e.g., build modules. At times, at least one build module may be situated in the enclosure and coupled with the processing chamber. At times, at least one build module engages with the processing chamber to expand an interior volume of the processing chamber, e.g., to form at least a portion of the chamber.

In some embodiments, the 3D printer comprises a layer dispensing mechanism. The pre-transformed material may be deposited in the enclosure by a layer dispensing mechanism (also referred to herein as a “layer dispenser,” or “layer forming apparatus”). The layer dispensing mechanism may comprise a recoater. In some embodiments, the layer dispensing mechanism includes one or more material dispensers (also referred to herein as “dispensers” and “material dispensing mechanism”), and/or at least one powder removal mechanism (also referred to herein as material “remover” or “material remover”) to form a layer of pre-transformed material (e.g., starting material) within the enclosure. In some embodiments, the layer dispensing mechanism includes a leveler to planarize (e.g., smooth, such as substantially planarize) an exposed surface of a material bed within the enclosure. In some embodiments, the layer dispensing mechanism is devoid of a leveler to planarize (e.g., smooth, such as substantially planarize) an exposed surface of a material bed within the enclosure. The deposited starting material may be leveled by a leveling operation. The leveling operation may comprise using a powder removal mechanism that does not contact the exposed surface of the material bed. The material (e.g., powder) dispensing mechanism may comprise one or more dispensers. The material dispensing mechanism may comprise at least one material (e.g., bulk) reservoir. The layer dispensing mechanism and energy beam can translate (e.g., in a coordinated manner) to print the 3D object adjacent to the build platform, e.g., while the build platform gradually lowers its vertical position to facilitate layer-wise formation of the 3D object. The layer dispensing mechanism and energy beam can translate to print the 3D object in the material bed (e.g., as described herein), e.g., while the build platform gradually lowers its vertical position to facilitate layer-wise formation of the 3D object and expansion of the material bed. The layer dispensing mechanism can be used to form at least a portion of the material bed. The layer dispensing mechanism can dispense material, remove material from the material bed, and/or shape the material bed, e.g., shape an exposed surface of a layer of material of the material bed. The material can comprise a pre-transformed material or debris. Shaping the material bed may comprise altering a shape of the exposed surface of the material bed, e.g., planarizing the exposed surface of the material bed. The layer dispensing mechanism can be in a layer forming mode when dispensing the material and/or shaping the material bed. The layer dispensing mechanism can be in a parked mode when the layer dispensing mechanism is in an idle position such as a parked position. The material dispensing mechanism (e.g., the dispenser) can comprise a reservoir configured to retain a volume of pre-transformed material. The volume of pre-transformed material may be equivalent to about the volume of pre-transformed material sufficient for at least one or more dispensed layers above the build platform. Examples of 3D printing systems, apparatuses, devices, and components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 17/881,797, filed Aug. 5, 2022; or in International Patent Application serial number PCT/US16/66000 filed on Dec. 9, 2016; each of which is incorporated herein in its entirety.

In some embodiments, the 3D printing system comprises a build module. The build module may be mobile or stationary. The build module may comprise an elevation mechanism, e.g., comprising a build platform assembly. The build module may comprise a build platform that may be coupled to the build platform assembly. The build platform may be disposed within the build module. The base (e.g., build platform) may reside adjacent to the substrate, e.g., above the substrate relative to a gravitational center of the environment (e.g., Earth). For example, the base may (e.g., reversibly) connect to the substrate. The elevation mechanism may be reversibly connected to (and disconnected from) at least a portion of the base. The elevation mechanism may comprise a portion that vertically translates the build platform with respect to a gravitational center (e.g., a gravitational center of the Earth). The base may be disposed on the substrate. The base and the substrate may operatively couple (e.g., physically connect). A material bed may be disposed above base. The base may support the material bed. The build platform may comprise, or be configured to operatively couple to, an engagement mechanism. The substrate may comprise, or be configured to operatively couple to, an engagement mechanism. The engagement mechanism may facilitate engagement and/or dis-engagement between the base (e.g., of the build platform) and the substrate. The build platform may be configured to support one or more layers of pre-transformed material (e.g., as part of the material bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable. The translation of the build platform may be controlled and/or regulated by at least one controller (e.g., by a control system). The translation of the substrate may be controlled and/or regulated by at least one controller (e.g., by a control system). The build platform and/or substrate may be translatable horizontally, vertically, or at an angle (e.g., planar or compound angle). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the build module, processing chamber, and/or enclosure comprises one or more seals. The seal may be a sliding seal or a stationary (e.g., top) seal. For example, the build module and/or processing chamber may comprise a sliding seal that meets with the exterior of the build module upon engagement of the build module with the processing chamber. At least a portion of the 3D printing process, the atmospheres of the build module and processing chamber may be separate. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal, or compression seal. The seal may comprise an O-ring. For example, the build module and the processing chamber may be separated by a load lock. The build platform and/or substrate may be separated from one or more walls (e.g., side walls) of the build module by a seal. The seal may be impermeable or substantially impermeable to gas. The seal may be permeable to gas. The seal may be impermeable to the pre-transformed (e.g., and to the transformed) material. The seal may be flexible. The seal may be elastic. The seal may be bendable. The seal may be compressible. The seal may include a material comprising rubber (e.g., latex), Teflon, plastic, or silicon. The seal may comprise a mesh, membrane, sieve, paper (e.g., filter paper), cloth such as felt (e.g., Aramid felt, or another high temperature felt or fiber), or a brush. The mesh, membrane, paper and/or cloth may comprise randomly or non-randomly arranged fibers. The paper may comprise a HEPA filter. The seal may be permeable to at least one gas. The seal may be impermeable to the pre-transformed (e.g., and to the transformed) material. The seal may not allow a pre-transformed (e.g., and to the transformed) material to pass through.

In some embodiments, the substrate is separated from the base (e.g., build platform) assembly by a seal. The base and/or the substrate may be separated from the internal surface of the build module by one or more seals. The seal may be attached to the moving build platform and/or substrate (e.g., while the walls of the build module are devoid of a seal). The seal may be attached to the (e.g., vertical) walls of the build module (e.g., while the build platform and/or substrate is devoid of a seal). In some embodiments, both the build platform and/or substrate and the walls of the build module comprise a seal. The seal may be placed laterally (e.g., horizontally) between one or more walls (e.g., side walls) of the build module. The seal may be connected to a bottom plane of the build platform and/or substrate. The seal may be connected to a side (e.g., circumference) of the build platform and/or substrate. The seal may be permeable to gas. The seal may be impermeable to particulate material (e.g., powder). The seal may not allow permeation of particulate material into the build platform assembly and/or piston assembly. The build platform assembly may comprise a piston and a build platform. The piston assembly may comprise a piston. The seal may be flexible. The seal may be elastic. The seal may be bendable. The seal may be compressible. The seal may include a material comprising a polymeric material (e.g., nylon, polyurethane), Teflon, plastic, rubber (e.g., latex), or silicon. The seal may comprise a mesh, membrane, sieve, paper (e.g., filter paper), cloth (e.g., felt, or wool), or brush. The mesh, membrane, paper and/or cloth may comprise randomly and/or non-randomly arranged fibers. The paper may comprise a HEPA filter.

In some embodiments, the build platform is translated, e.g., before, during, and/or after printing one or more 3D objects in a print cycle. The translation may be in both directions (e.g., back and forth such as up and down relative to a gravitational vector). The translation may be vertical. The translation may be effectuated by a build platform assembly and/or an actuator (e.g., controlled by a control system). The build platform assembly may be configured to provide a high precision platform for building one or more 3D objects in a printing cycle with high fidelity. The build module may accommodate a material bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the material bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the material bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3500 mm, or 4000 mm. The build module may accommodate a build platform having at least one FLS (e.g., diameter, height and/or width), the FLS being of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm, 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error+/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision value (e.g., from about 0.25 μm to about 5 μm, from about 0.25 μm to about 2.5 μm, or from about 1.5 μm to about 5 μm). The build platform assembly may have a precision (e.g., error+/−) of at most about 0.5%, 1%, 2%, 3%, 4%, 5%, 6%, 8% or 10% of its incremental movement. The build platform assembly may have a precision value between any of the aforementioned precision value relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec), 5 mm/sec, 10 mm/sec, 20 mm/sec, 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec²), 2.5 mm/sec², 5 mm/sec², 7.5 mm/sec², 10 mm/sec², or 20 mm/sec². The build platform assembly may be configured to translate the build module at an acceleration of at least 0.5 mm/sec², 1 mm/sec², 2 mm/sec², 3 mm/sec², 5 mm/sec², 10 mm/sec², or 15 mm/sec². The build platform assembly may be configured to translate the build module at a speed between any of the aforementioned speeds (e.g., from about 0.5 mm/sec² to about 20 mm/sec², from about 0.5 mm/sec² to about 10 mm/sec², or from about 4 mm/sec² to about 20 mm/sec²). The build platform assembly may be configured such that a time to complete a translation of a first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that a time to complete a translation of a first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the pre-transformed material (e.g., starting material for the 3D printing) is deposited in an enclosure to generate a material bed. The enclosure may comprise a build module. The build module can contain the pre-transformed material (e.g., without spillage). Material may be placed in or inserted (e.g., deposited) to the build module. The material may be deposited in, pushed to, sucked into, or lifted to the build module. The material may be layered (e.g., spread) in the enclosure such as by using a layer dispensing mechanism. The pre-transformed material may be deposited by a layer dispensing mechanism. The platform may be configured to support one or more layers of pre-transformed material (e.g., as part of the material bed). The platform may be configured to support at least a portion of the 3D object (e.g., during forming of the 3D object). The pre-transformed material may be layer-wise deposited adjacent to a side of the build module, e.g., above and/or on the bottom of the build module. The pre-transformed material may be layered adjacent to the substrate and/or adjacent to the base. Adjacent to may be above. Adjacent to may be directly above, or directly on. The pre-transformed material may be layered on a target surface, e.g., on an exposed surface of a material or on a surface of the build platform. The deposited layer of pre-transformed material may be substantially planar. For example, the deposited layer may have a central tendency of planarity (e.g., a surface roughness R a) that is from about 15% to about 65% of a second central tendency of thickness of the deposited layer. The second central tendency of thickness of the deposited layer may be about equal to a discrete increment of vertical translation of the platform. The second central tendency of thickness of the deposited layer may be about equal to any discrete increment of vertical translation of the build platform assembly, e.g., as disclosed herein.

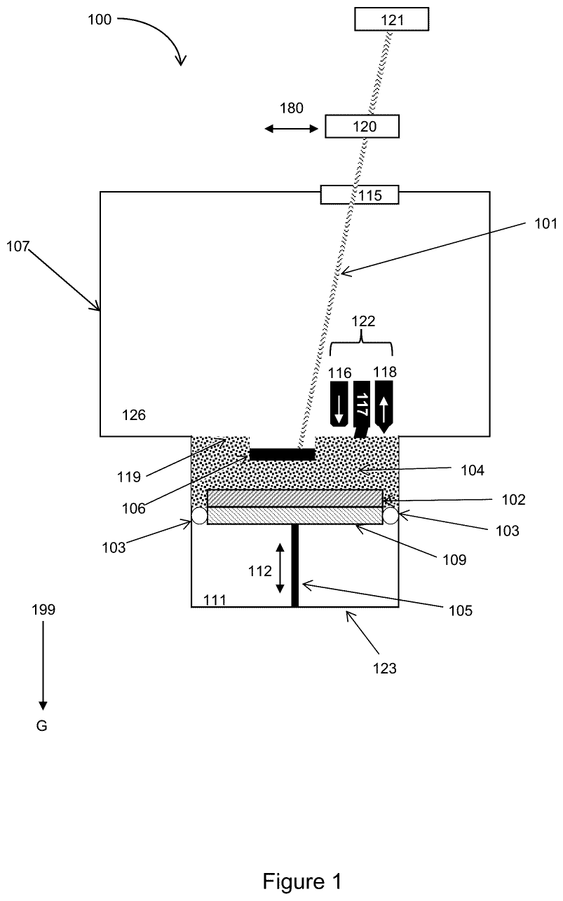

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise at least two, three, four, five, eight, twelve, sixteen, twenty-four, thirty-two, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. in some embodiments, the energy source is an energy beam source. The energy source (e.g., FIG. 1, 121) may be a laser source. The laser may comprise a fiber laser, a solid-state laser or a diode laser (e.g., diode pumped fiber laser).

In some embodiments, the energy source is a laser source. The laser source may comprise a Nd: YAG, Neodymium (e.g., neodymium-glass), or an Ytterbium laser. The laser beam may comprise a corona laser beam, e.g., a laser beam having a footprint similar to a doughnut shape or a ring shape. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. Examples of 3D printing systems, apparatuses, devices, components (e.g., energy beams), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process. In some embodiments, the energy beam (e.g., laser) has a power of at least about 150 Watt (W), 200 W, 250 W, 350 W, 500 W, 750 W, 1000 W, or 1500 W. The energy source may have a power between any of the afore-mentioned energy beam power values (e.g., from about from about 150 W to about 1000 W, or from about 1000 W to about 1500 W). The energy beam may derive from an electron gun.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a ring (e.g., corona or doughnut) beam profile. For example, the energy beam may print a first portion of the 3D object using a gaussian beam profile, and then print a second portion of the 3D object using a ring shaped beam profile.

In some embodiments, the beam profile of the energy beam is altered, e.g., during printing. Any of the 3D printing methodologies disclosed herein can include altering the beam profile. Alteration of the beam profile can be using a physical component and/or a computational scheme. Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

In some embodiments, an energy beam is utilized for the 3D printing. The energy beam(s) can translate vertically, horizontally, or in an angle (e.g., planar or compound angle). The energy beam(s) can be modulated. The energy beam(s) emitted by the energy source(s) can be modulated.

In some embodiments, the energy beam is moveable with respect to a material bed and/or 3D printing system. The energy beam can be moveable such that it can translate relative to the material bed. The energy beam can be moved by an optical system (e.g., comprising a scanner). The movement of the energy beam can comprise utilization of a scanner. In some embodiments, the energy source is stationary. In some embodiments, the energy beam (e.g., laser beam) impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from the at least one energy source to a position on a target surface such as an exposed surface of a material bed within the enclosure, e.g., to a predetermined position on the target surface. The 3D printing system may comprise a processor (e.g., a central processing unit). The processor can be programmed to control a trajectory of the at least one energy beam and/or energy source with the aid of the optical system. The systems and/or the apparatus described herein can comprise a control system in communication with the at least one energy source and/or energy beam. The control system can regulate a supply of energy from the at least one energy source to the material in the container. The control system may control the various components of the optical system. The various components of the optical system may include optical components comprising a mirror(s), a lens (e.g., concave or convex), a fiber, a beam guide, a rotating polygon, or a prism.

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printing system can comprise two, three, four, five, eight, ten, sixteen, eighteen, twenty, twenty-four, thirty-two, or more energy sources that each generates an energy beam (e.g., laser beam). An energy source can be a source configured to deliver energy to an area (e.g., a confined area). An energy source can deliver energy to the confined area through radiative heat transfer. The energy source may comprise a laser source or an electron beam source.

In some embodiments, the 3D printing system can comprise at least one (e.g., a plurality of) optical windows. The optical window(s) may be arranged on a ceiling (e.g., roof) of the processing chamber. The optical window(s) may be arranged on a side wall of the processing chamber. The optical window(s) may be arranged with respect to the processing chamber to allow transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. The optical windows may allow the energy beam to pass through without (e.g., substantial) energetic loss. During the 3D printing, a ventilator and/or gas flow may deter (e.g., measurably and/or substantially prevent) debris from accumulating on the surface optical window(s) that are disposed within the enclosure (e.g., within the processing chamber). The debris may comprise soot, spatter, or splatter. During the 3D printing, the ventilator and/or gas flow may (e.g., substantially) deter contamination at a surface of the optical window(s) by debris. The debris may comprise gas borne pre-transformed or transformed material. A portion of the enclosure that is occupied by the energy beam (e.g., during the 3D printing) can define a processing cone. During the 3D printing may comprise during the entire 3D printing. The processing cone can be the space that is occupied by a non-reflected energy beam during the (e.g., entire) 3D printing. The processing cone can be the enclosure space that is occupied by an energy beam that is directed towards the material bed during the (e.g., entire) 3D printing. During the 3D printing may comprise during printing of a layer of hardened material. The optical window may be supported by (or supportive of) a nozzle that directs debris away from the optical window, e.g., at towards the material bed. The processing cone may assume a shape of a truncated cone within the processing chamber.

In some embodiments, the 3D printing system comprises one or more sensors. The 3D printing system includes at least one enclosure. In some embodiments, the 3D printing system (e.g., its enclosure) comprises one or more sensors (alternatively referred to herein as one or more sensors). The enclosure described herein may comprise at least one sensor. The enclosure may comprise, or be operatively coupled to, the build module, the filtering mechanism, gas recycling system, the processing chamber, or the ancillary chamber. The sensor may be connected and/or controlled by the control system (e.g., computer control system, or controller(s)). The control system may be able to receive signals from the at least one sensor. The control system, e.g., through a control scheme, may act upon at least one signal received from the at least one sensor. The control scheme may comprise a feedback and/or feed forward control scheme, e.g., that has been pre-programmed. The feedback and/or feed forward control may rely on input from at least one sensor that is connected to the controller(s).

In some embodiments, the 3D printing system comprises one or more sensors. The one or more sensors can comprise a pressure sensor, a temperature sensor, a gas flow sensor, or an optical density sensor. The pressure sensor may measure the pressure of the chamber (e.g., pressure of the chamber atmosphere). The pressure sensor can be coupled to the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, depth, angle, and/or volume). The metrology sensor may comprise a magnetic, acceleration, orientation, or optical sensor. The optical sensor may comprise a camera. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may measure the temperature without contacting the material bed (e.g., non-contact measurements). The weight of the enclosure (e.g., container), or any components within the enclosure can be monitored by at least one weight sensor in or adjacent to the material. One or more position sensors (e.g., height sensors) can measure the height of the material bed relative to the substrate. The position sensors can be optical sensors. The position sensors can determine a distance between one or more energy sources and a surface of the material bed. The exposed surface of the material bed can be the upper surface of the material bed relative to a gravitational center of the environment. Examples of 3D printing systems, apparatuses, devices, material beds, and components (e.g., sensors), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the 3D printer comprises one or more valves. The methods, systems and/or the apparatus described herein may comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves. The valve may or may not comprise a sensor sensing the open/shut position of the valve. The valve may be a component of a gas flow mechanism, e.g., operable to control a flow of gas of the gas flow mechanism. A valve may be a component of gas flow assembly, e.g., operable to control a flow of gas of the gas flow assembly.

In some embodiments, the 3D printer comprises one or more actuators such as motors. The motor may be controlled by the controller(s) (e.g., by the control system) and/or manually. The motor may alter (e.g., the position of) the substrate and/or to the base. The motor may alter (e.g., the position of) the build platform assembly. The actuator may facilitate translation (e.g., propagation) of the layer dispenser, e.g., the actuator may facilitate reversible translation of the layer dispenser. The motor may alter an opening of the enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some embodiments, the 3D printer (e.g., its components) comprises one or more nozzles. The systems and/or the apparatus described herein may comprise at least one nozzle. For example, the material remover may comprise a nozzle. The nozzle may be regulated according to at least one input from at least one sensor. The nozzle may be controlled automatically or manually. The controller(s) may control the nozzle. The controller(s) may any controller(s) disclosed herein, e.g., as part of the control system of the 3D printer. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed. The nozzle may comprise a venturi nozzle.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump.

In some embodiments, the 3D printer comprises a communication technology. The communication may comprise wired or wireless communication. For example, the systems, apparatuses, and/or parts thereof may comprise Bluetooth, wi-fi, global positioning system (GPS), or radio-frequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may utilize one or more wired and/or wireless networks for communication, e.g., with other controllers or devices, apparatuses, or systems of the 3D printing system and its components. For example, wired ethernet technologies, e.g., a local area networks (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more of controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of controller, control protocols, control systems, 3D printing systems, apparatuses, devices, and any of their components, and 3D printing processes can be found in International Patent Application Serial No. PCT/US17/18191, filed Feb. 16, 2017, titled “ACCURATE THREE-DIMENSIONAL PRINTING,” which is incorporated herein by reference in their entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow system, material flow systems, energy (e.g., energy beams), build platform assembly, and/or with any other component of the 3D printing system.

In some embodiments, the 3D printer comprises at least one filter. The filter may be a ventilation filter. The ventilation filter may capture fine powder from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne pre-transformed material, or gas borne transformed material. The debris may result from the 3D printing process. The ventilator may direct the debris in a requested direction (e.g., by using positive or negative gas pressure). For example, the ventilator may use vacuum. For example, the ventilator may use gas flow. FIG. 1 shows an example of a 3D printing system 100 having a processing chamber 107 coupled to a build module 123. The build module comprises an elevation mechanism 105 (e.g., as part of a build platform assembly) that vertically translate a substrate 109 (e.g., piston) along arrow 112. A build platform 102 is disposed on substrate 109 (e.g., piston). Material bed 104 is disposed above build platform 102 (e.g., also referred herein as “base”, or “build plate”). The 3D printing system 100 comprises an optical assembly 120 (e.g., a guidance system) for energy beam 101 (e.g., a galvanometer scanner). Optical assembly 120 can be translatable along axis 180, e.g., translatable along an axis perpendicular to gravitational vector 199. Energy source (e.g., laser source) 121 generates energy beam 101 that traverses through the optical assembly 120 (e.g., comprising a scanner) and through an optical window 115 into processing chamber 107 enclosing interior space 126 that can include an atmosphere. The optical window 115 is configured to allow the energy beam to pass through without (e.g., substantial) energetic loss. Processing chamber 107 can include an optional temperature adjustment device (e.g., cooling plate), not shown. Seal 103 encircles the substrate and/or base, e.g., to deter (e.g., prevent) migration of material of the material bed from reaching elevation mechanism 105. Energy beam 101 impinges upon an exposed surface 119 of material bed 104, to form at least a portion of a 3D object 106. FIG. 1 shows an example of a build module 123. Build module 123 can contain the pre-transformed (e.g., starting) material in a material bed 104. As depicted in FIG. 1, the 3D printer comprises a layer dispensing mechanism 122. The layer dispensing mechanism 122 includes a material dispenser 116 and a powder removal mechanism 118 to form a layer of pre-transformed material (e.g., starting material) within the enclosure. Layer dispensing mechanism 122 includes a leveler 117. The material may be layered (e.g., spread) in the enclosure such as by using the layer dispensing mechanism 122. Build module 123 is configured to enclose a substrate 109 and arranged adjacent to a bottom 111 of build module 123. Bottom 111 is defined relative to the gravitational field along gravitational vector 199 pointing towards gravitational center G, or relative to the position of the footprint of the energy beam 101 on the layer of pre-transformed material as part of a material bed 104. Build module 123 comprises a build platform 102. The substrate is coupled to one or more seals 103 that enclose the material in a selected area within the build module to form material bed 104. One or more components of 3D printing system 100 are controlled by a control system (not shown in FIG. 1).

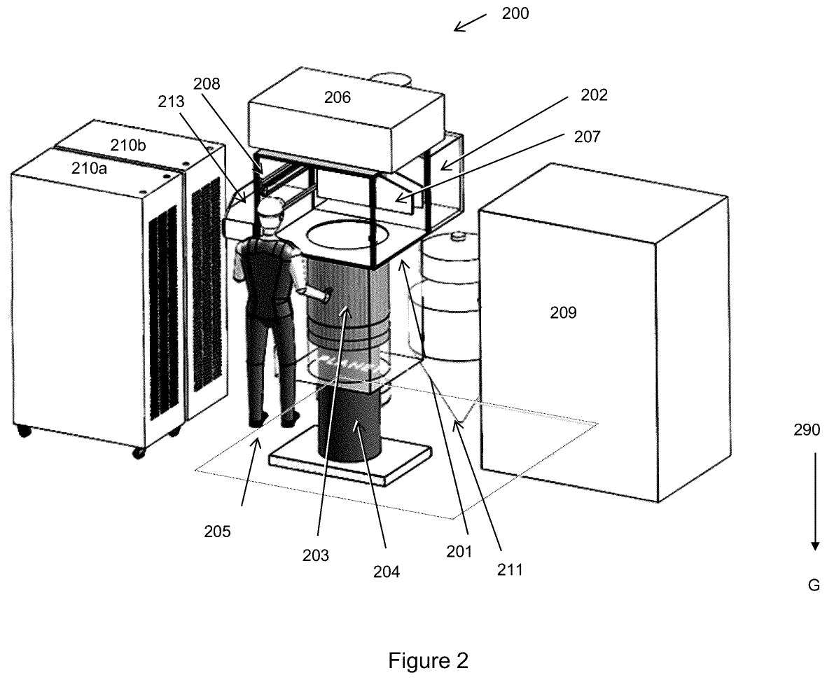

FIG. 2 shows an example of a 3D printing system 200 disposed in relation to gravitational vector 290 directed towards gravitational center G. The 3D printing system comprises processing chamber 201 coupled to an ancillary chamber (e.g., garage) 202 configured to accommodate a layer dispensing mechanism (e.g., recoater), e.g., in its resting (e.g., idle) position. The processing chamber is coupled to a build module 203 that extends 204 under a plane (e.g., floor) at which user 205 stands on (e.g., can extend under-grounds). The processing chamber may comprise a door (not shown) facing user 205. 3D printing system 200 comprises enclosure 206 that can comprise an energy beam alignment system (e.g., an optical system) and/or an energy beam directing system (e.g., scanner)—not shown. A layer dispensing mechanism (not shown) may be coupled to a framing 207 as part of a movement system that facilitate movement of the layer dispensing mechanism along the material bed and garage (e.g., in a reversible back-and-forth movement). The movement system comprises a translation inducer system (e.g., comprising a belt or a chain 208). 3D printing system 200 comprises a filter unit 209, heat exchangers 210a and 210b, pre-transformed material reservoir 211, and gas flow mechanism (e.g., comprising gas inlets and gas inlet portions) disposed in enclosure 213. The filtering system may filter gas and/or pre-transformed (e.g., powder) material. The filtering system may be configured to filter debris (e.g., comprising byproduct(s) of the 3D printing).

In some embodiments, the formation of the 3D object includes transforming (e.g., fusing, binding and/or connecting) the pre-transformed material (e.g., 3D printing starting material such as a powder material) using an energy beam. The energy beam may be projected on to the starting material (e.g., disposed in the material bed), thus causing the pre-transformed material to transform (e.g., fuse). The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material. Transformation of the material may comprise connecting disconnected starting materials. For example, connecting various powder particles. The connection may comprise phase transfer, or chemical bonding. The connection may comprise fusing the starting material, e.g., sintering or melting the starting material.

In some embodiments, the methods described herein comprise repeating the operations of material deposition and material transformation operations to produce (e.g., print) a 3D object (or a portion thereof) by at least one 3D printing (e.g., additive manufacturing) method. For example, the methods described herein may comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the material bed.

In some embodiments, the term “auxiliary support,” as used herein, generally refers to at least one feature that is a part of a printed 3D object, but not part of the requested, intended, designed, ordered, and/or final 3D object. Auxiliary support may provide structural support during and/or after the formation of the 3D object. The auxiliary support may be anchored to the enclosure. For example, an auxiliary support may be anchored to the build platform (e.g., build platform such as a build plate), to the side walls of the material bed, to a wall of the enclosure, to an object (e.g., stationary or semi-stationary) within the enclosure, or any combination thereof. The auxiliary support may be the build platform or the bottom of the enclosure. The auxiliary support may enable the removal or energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, build platform, or another stabilization feature. In some instances, the auxiliary support may be mounted, clamped, or situated on the build platform. The auxiliary support can be anchored to the build platform, to the sides (e.g., walls) of the build platform, to the enclosure, to an object (stationary or semi-stationary) within the enclosure, or any combination thereof.

In some examples, the generated 3D object(s) can be printed without auxiliary support in a material bed in which it/they are formed. In some examples, low hanging overhanging feature an/or hollow cavities of the generated 3D object can be printed without (e.g., without any) auxiliary support. The low overhanging features may be shallow overhanging features with respect to an exposed surface of the material bed. The low overhanging features may form an angle of at most about 40 degrees)(°, 35°, or 25° with the exposed surface of the material bed (or a plane parallel thereto). The printed 3D object can be devoid of auxiliary supports. The printed 3D object may be suspended (e.g., float anchorlessly) in the material bed (e.g., powder bed). The term “anchorlessly,” as used herein, generally refers to without, or in the absence of, an auxiliary anchor. In some examples, an object is suspended in a material bed anchorlessly without attachment to a support. For example, the object floats in the material bed. A portion of the printed 3D object can be devoid of auxiliary supports. The portion of the 3D object may be suspended over a volume of the material bed. For example, a portion of the object defines an enclosed cavity which may be temporarily filled with powder material during a build process. The generated 3D object may be suspended in the layer of pre-transformed material (e.g., powder material). The pre-transformed material can offer support to the printed 3D object (or the object during its generation). Sometimes, the generated 3D object may comprise one or more auxiliary supports. The auxiliary support may be suspended in the pre-transformed material (e.g., powder material). The auxiliary support may provide weight or stabilizer. The auxiliary support can be suspended in the material bed such as within the layer of pre-transformed material in which the 3D object (or a portion thereof) has been formed. The auxiliary support may touch the build platform. The auxiliary support may be suspended in the material bed and not touch (e.g., contact) the build platform. The auxiliary support may be anchored to the build platform.

In some examples, the at least 3D object may be generated above a build platform, which at least one 3D object comprises auxiliary supports. In some examples, the auxiliary support(s) adhere to the upper surface of the build platform. In some examples, the auxiliary supports of the printed 3D object may touch the build platform (e.g., the bottom of the enclosure, the substrate, or the base). Sometimes, the auxiliary support may adhere to the build platform. In some embodiments, the auxiliary supports are an integral part of the build platform. At times, auxiliary support(s) of the printed 3D object, do not touch the build platform. In any of the methods described herein, the printed 3D object may be supported only by the pre-transformed material within the material bed. Any auxiliary support(s) of the printed 3D object, if present, may be suspended adjacent to the build platform. Occasionally, the build platform may have a pre-hardened (e.g., pre-solidified) amount of material. Such pre-solidified material may provide support to the printed 3D object. At times, the build platform may provide adherence to the material. At times, the build platform does not provide adherence to the material. The build platform may comprise elemental metal, metal alloy, elemental carbon, or ceramic. The build platform may comprise a composite material (e.g., as disclosed herein). The build platform may comprise glass, stone, zeolite, or a polymeric material. The polymeric material may include a hydrocarbon or fluorocarbon. The build platform (e.g., base) may include Teflon. The build platform may include compartments for printing small objects. Small may be relative to the size of the enclosure. The compartments may form a smaller compartment within the enclosure, which may accommodate a layer of pre-transformed material.

In some examples, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam(s)). The average temperature of the material bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10 C, 15° C., or 20° C. below the transforming temperature. The average temperature of the material bed (e.g., pre-transformed material) can be by at most about 25° C. (degrees Celsius), 50° C., 100° C., 150° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 20° C., 25° C., 50° C., 100° C., 150° C., 200° C., 250° C., 300° C., 400° C., 500° C., 600° C., 700° C., 800° C., 900° C., 1000° C., 1200° C., 1400° C., 1600° C., or 1800° C. The average temperature of the material bed (e.g., of the pre-transformed material therein) can be any temperature between the afore-mentioned material average temperatures. The temperature of the material bed can be conditioned (e.g., heated or cooled) before, during, or after forming (e.g., printing) the 3D object (e.g., hardened material). The material bed temperature can be controller (e.g., substantially maintained) at a predetermined value. The temperature of the material bed can be monitored. The material temperature can be controlled manually and/or by a control system (e.g., such as any control system disclosed herein).

At times, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave.

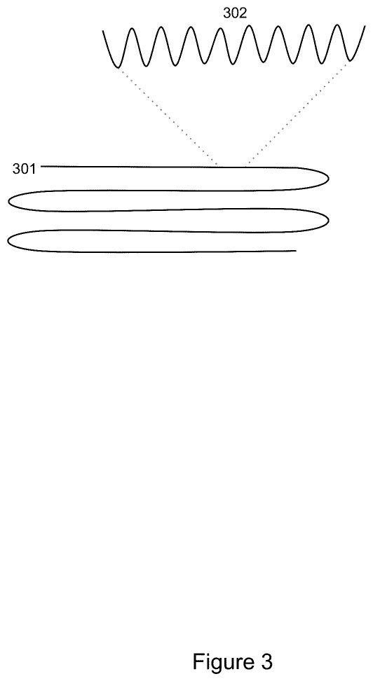

At times, the energy (e.g., energy beam) travels in a path. The path may comprise a hatch, e.g., path 301 of FIG. 3. The path of the energy beam may comprise repeating a path. For example, the first energy may repeat its own path. The second energy may repeat its own path, or the path of the first energy. The repetition may comprise a repetition of 1, 2, 3, 4, 5, 6, 7, 8, 9, 10 times or more. The energy may follow a path comprising parallel lines. The lines may be hatch lines. The distance between each of the parallel lines or hatch lines, may be at least about 1 μm, 5 μm, 10 μm, 20 μm, 30 μm, 40 μm, 50 μm, 60 μm, 70 μm, 80 μm, 90 μm, or more. The distance between each of the parallel lines or hatch lines, may be at most about 1 μm, 5 μm, 10 μm, 20 μm, 30 μm, 40 μm, 50 μm, 60 μm, 70 μm, 80 μm, 90 μm, or less. The distance between each of the parallel lines or hatch lines may be any value between any of the afore-mentioned distance values (e.g., from about 1 μm to about 90 μm, from about 1 μm to about 50 μm, or from about 40 μm to about 90 μm). The distance between the parallel or parallel lines or hatch lines may be substantially the same in every layer (e.g., plane) of transformed material. The distance between the parallel lines or hatch lines in one layer (e.g., plane) of transformed material may be different than the distance between the parallel lines or hatch lines respectively in another layer (e.g., plane) of transformed material within the 3D object. The distance between the parallel lines or hatch lines portions within a layer (e.g., plane) of transformed material may be substantially constant. The distance between the parallel lines or hatch lines within a layer (e.g., plane) of transformed material may be varied. The distance between a first pair of parallel lines or hatch lines within a layer (e.g., plane) of transformed material may be different than the distance between a second pair of parallel lines or hatch lines within a layer (e.g., plane) of transformed material respectively. The first energy beam may follow a path comprising two hatch lines or paths that cross in at least one point. FIG. 3 shows an example of a path 301 of an energy beam comprising a zigzag sub-pattern (e.g., energy beam 302 shown as an expansion (e.g., blow-up) of a portion of the path 301). The sub-path of the energy beam may comprise a wave (e.g., sine or cosine wave) pattern. The sub-path may be a small path that forms the large path. The sub-path may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof. The hatch lines or paths may be straight or curved. The hatch lines or paths may be winding. At times, the path comprises successive lines. The successive lines may touch each other. The successive lines may overlap each other in at least one point. The successive lines may substantially overlap each other. The successive lines may be spaced by a first distance (e.g., hatch spacing). Examples of 3D printing systems, apparatuses, devices, and any component thereof; controllers, software, and 3D printing processes (e.g., hatch spacings) can be found in International Patent Application Serial No. PCT/US16/34857 filed on May 27, 2016, titled “THREE-DIMENSIONAL PRINTING AND THREE-DIMENSIONAL OBJECTS FORMED USING THE SAME” that is entirely incorporated herein by reference.

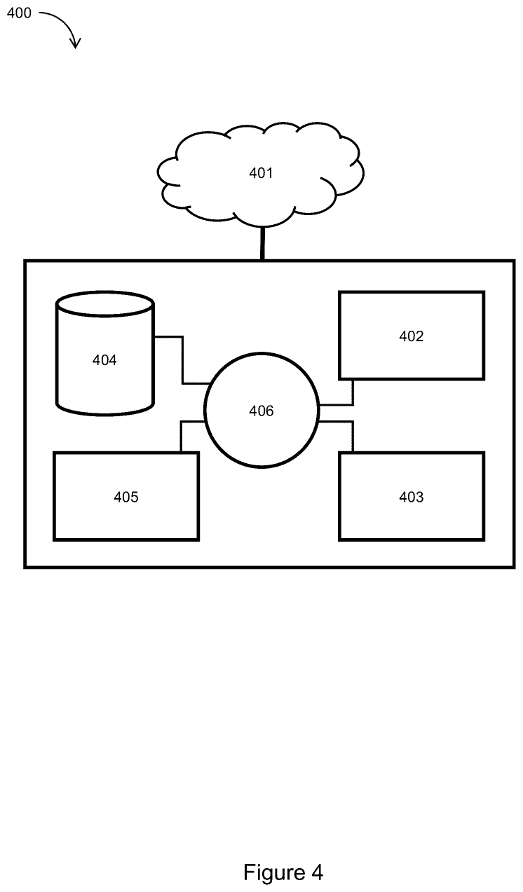

In some embodiments, the 3D printing system comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor (e.g., 3D printer processor) may be programmed to implement methods of the disclosure. The controller may control at least one component of the systems and/or apparatuses disclosed herein. FIG. 4 is a schematic example of a computer system 400 that is programmed or otherwise configured to facilitate the formation of a 3D object according to the methods provided herein. The computer system 400 can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 401 can be part of, or be in communication with, a 3D printing system or apparatus. The computer may be coupled to one or more mechanisms disclosed herein, and/or any parts thereof. For example, the computer may be coupled to one or more sensors, valves, switches, motors, pumps, scanners, optical components, or any combination thereof. The computer system 400 can include a processing unit 406 (also “processor,” “computer” and “computer processor” used herein). The computer system may include memory or memory location 402 (e.g., random-access memory, read-only memory, flash memory), electronic storage unit 404 (e.g., hard disk), communication interface 403 (e.g., network adapter) for communicating with one or more other systems, and peripheral devices 405, such as cache, other memory, data storage and/or electronic display adapters. The memory 402, storage unit 404, interface 403, and peripheral devices 405 are in communication with the processing unit 406 through a communication bus (solid lines), such as a motherboard. The storage unit can be a data storage unit (or data repository) for storing data. The computer system can be operatively coupled with a computer network (“network”) 401, e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server. The processing unit can execute a sequence of machine-readable instructions, which can be embodied in a program or software. The instructions may be stored in a memory location, such as the memory 402. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 400 can be included in the circuit.

In some embodiments, the storage unit 404 stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet. The processor may be configured to process control protocols, e.g., communicate with one or more components of the 3D printer system using the control protocols. Control protocols can be one or more of the internet protocol suite, e.g., transmission control protocol (TCP) or transmission control protocol/internet protocol (TCP/IP). Control protocols can be one or more of serial communication protocols. Control protocols can be one or more of controller area networks or another message-based protocol, e.g., for communication with microcontrollers and devices. Control protocols can interface with one or more serial bus interfaces for communication with the 3D printing system and its components. The control protocol can be any control protocol disclosed herein.

In some embodiments, the 3D printer comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory 402 or electronic storage unit 404. The machine executable or machine-readable code can be provided in the form of software. During use, the processor 406 can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the 3D printer comprises a gas flow mechanism. The gas flow mechanism may be in fluidic contact with one or more enclosures of the 3D printer. For example, the gas flow mechanism may be in fluidic contact with (i) a processing chamber, (ii) a build module, (iii) an optical enclosure (e.g., including an array of optical assemblies), (iv) a housing of an optical assembly, or (v) any combination thereof. The gas flow mechanism may be in fluidic contact with a processing chamber and/or a build module. The gas flow mechanism may be in fluid communication with the optical enclosure of the optical assemblies and/or with one or more individual optical assemblies (e.g., within the housing of the optical assembly).

In some embodiments, the enclosure comprises an atmosphere having an ambient pressure (e.g., 1 atmosphere), or positive pressure. The atmosphere may have a negative pressure (i.e., vacuum). Different portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, or below 1 atmosphere. The positively pressurized environment may comprise pressure above 1 bar or above 1 atmosphere. In some cases, the chamber pressure can be standard atmospheric pressure. The pressure may be measured at an ambient temperature (e.g., room temperature such as 20° C., or 25° C.).

In some embodiments, the enclosure comprises an atmosphere. The atmosphere within the enclosure may comprise a positive pressure. The atmosphere within the enclosure may be different that an atmosphere outside the enclosure. At times, a differential atmosphere (e.g., a difference in atmospheres between the inside of the enclosure and the outside of the enclosure) depends in part on a processing conditions of the three-dimensional printing. Processing conditions can include, for example, (i) a composition of the pre-transformed material, (ii) an internal temperature of the material bed during the three-dimensional processing, (iii) a number of energy beams (e.g., an average number of energy beams) transforming (e.g., incident on) the target surface during the three-dimensional processing, (iv) an amount of contamination by debris during the three-dimensional processing, (v) temperature in the material bed during 3D printing, (vi) temperature in the processing chamber during the printing, (vii) amount of energy supplied by the energy beams to the material bed, or (vii) any combination thereof. For example, a differential atmosphere between the interior of the enclosure (e.g., within the processing chamber) and an ambient environment external to the enclosure may depend at least in part on an average number of energy beams utilized during the three-dimensional process.

In some embodiments, the enclosure includes an atmosphere that is greater than (e.g., at a positive pressure with respect to) an ambient atmosphere external to the enclosure. The atmosphere within the enclosure may comprise a positive pressure of at least about 300 kiloPascals (kPa), 325 kPa, 350 kPa, 400 kPa, 450 kPa, 500 kPa, 550 kPa, 600 kPa, 650 kPa, 700 kPa, 750 kPa, 800 kPa, 850 kPa, 900 kPa, 950 kPa, or 1000 kPa. The atmosphere within the enclosure may comprise a positive pressure of any value between the aforementioned values, for example, from about 300 kPa to about 850 kPa, from about 550 kPa to about 900 kPa, or from about 700 kPa to about 1000 kPa. The composition of the atmosphere within the enclosure may comprise any one or more of the gases described herein, for example, clean dry air (CDA), argon, and/or nitrogen. The enclosure may comprise a gas flow, e.g., before, after, and/or during three-dimensional printing. The gas flow within the enclosure may comprise at least about 150 liters per minute (LPM), 200 LPM, 250 LPM, 300 LPM, 350 LPM, 400 LPM, 450 LPM, 500 LPM, 550 LPM, 600 LPM, 650 LPM, 700 LPM, 750 LPM, 800 LPM, 900 LPM, 1000 LPM, or 1200 LPM. The gas flow within the enclosure may comprise any value between the aforementioned values, for example, from about 150 LPM to about 500 LPM, from about 450 LPM to about 750 LPM, or from about 700 LPM to about 1200 LPM. The composition of the gas may comprise any one or more of the gases described herein, for example, clean dry air (CDA), argon, or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the afore-mentioned percentages of hydrogen gas.

In some embodiments, the enclosure includes an atmosphere. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm, (v/v). The level of the gas (e.g., depleted or reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere.

In some embodiments, material utilized in the 3D printing undergoes passivation, e.g., using a passivation system. A passivation system may comprise (A) an in-situ passivation system, (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, humidity levels and/or oxygen levels in at least a portion of the enclosure, (e.g., processing chamber, ancillary chamber, and/or build module) can be regulated such that an oxygenation and/or humidification of powder in the powder conveyance system is controlled. For example, oxygenation and/or humidification levels of recycled pre-transformed material (e.g., recycled powder material) can be about 5 parts per million (ppm) to about 1500 ppm. For example, oxygenation and/or humidification levels of recycled pre-transformed material can be at most about 1500 ppm, 1200 ppm, 1000 ppm, 500 ppm, 250 ppm, or less. For example, oxygenation and/or humidification levels of pre-transformed material can be about zero ppm. For example, oxygen content in pre-transformed material can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence a flowability of pre-transformed material (e.g., powder material) from the layer dispensing mechanism. A dew point of an internal atmosphere of an enclosure (e.g., of the processing chamber) can be (I) below a level in which the powder particles absorb water such that they become reactive under condition of 3D printing Process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). For example, a dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. For example, a dew point of an internal atmosphere of the enclosure can be any value within or including the afore-mentioned values. The 3D printing system may comprise an in-situ passivation system, e.g., to passivate filtered debris and/or any other gas borne material before their disposal. Examples of gas conveyance system and components (including control components), in-situ passivation systems, controlled oxidation methods and systems, 3D printing systems, control systems, software, and related processes, can be found in International Patent Applications Serial Nos. PCT/US17/60035 and PCT/US21/35350, each of which is incorporated herein by reference in its entirety.

In some embodiments, a 3D printing system includes, or is operationally couple to, one or more gas recycling systems. The gas recycling system can be at least a portion of the gas flow mechanism. The processing chamber may include gas inlet(s) and gas outlet(s). The gas recycling system can be configured to recirculate the flow of gas from gas outlet(s) back into processing chamber via the gas inlet(s). Gas flow through a channel exiting a gas outlet can include solid and/or gaseous contaminants such as debris (e.g., soot). A filtration system can be configured to filter out at least some of the solid and/or gaseous contaminants, thereby providing a clean gas (e.g., cleaner than gas flow through channel exiting the gas outlet). The filtration system can include one or more filters. The filters may comprise physical filters or chemical filters. The clean gas exiting the filtering mechanism (also herein “filtration system”) can be under lower pressure relative to the incoming gas pressure into the filtering mechanism. The lower pressure and the pressure of the incoming gas pressure may be above ambient pressure external to the 3D printing system. The clean gas can be directed through a pump to regulate (e.g., increase) its relative pressure prior to entry to the processing chamber. Clean gas with a regulated pressure that exits the pump can be directed through one or more sensors. The one or more sensors may comprise a flow meter, which can measure the flow (e.g., pressure) of the pressurized clean gas. The one or more sensors may comprise temperature, humidity, oxygen sensors, or any other sensor disclosed herein. In some cases, the clean gas can have an ambient pressure or higher. The higher pressure may provide a positive pressure within processing chamber (see example values of positive pressure described herein). A first portion of the clean gas can be directed through at least one inlet of a gas inlet portion of the enclosure, while a second portion of the clean gas can be directed to first and/or second window holders that provide gas purging of optical window areas, as described herein. That is, the gas recycling system can provide clean gas to provide a primary gas flow for the 3D printing system, as well as a secondary gas flow (e.g., window purging). In some embodiments, the pressurized clean gas is further filtered through a filter prior to reaching one or both of the window holders. In some embodiments, the one or more filters (e.g., as part of one or more filters and/or a filtration system) are configured to filter out particles having nanometer-scale (e.g., about 10 nm to about 500 nm) diameters. In some embodiments, the gas recycling system may provide clean gas to a recessed portion of the enclosure. In some embodiments, gas flow from the recessed portion of the enclosure can be directed through the gas recycling system. In some embodiments, gas flow from the recessed portion can be directed through one or more filters of a filtration system. In some embodiments, the gas recycling system provides clean gas directed to first and/or second window holders.

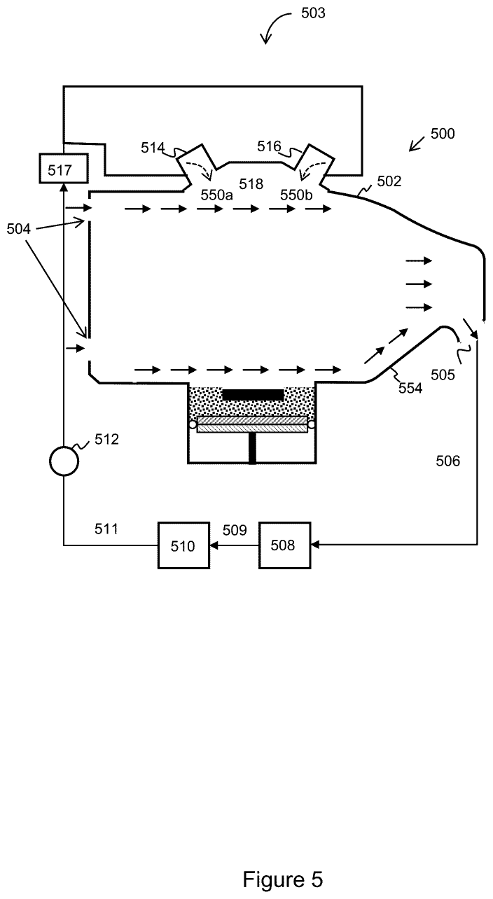

FIG. 5 shows a schematic side view of an example 3D printing system 500 that is coupled to a gas recycling system 503 in accordance with some embodiments. 3D printing system 500 includes processing chamber 502, which includes gas inlets 504 and gas outlet 505. The gas recycling system 503 is configured to recirculate the flow of gas from gas outlet 505 back into processing chamber 502 via the gas inlets 504. Filtration system 508 is configured to filter out at least some of the solid and/or gaseous contaminants, thereby providing a clean gas 509 (e.g., cleaner than gas flow through channel 506). The clean gas 509 exiting the filtering mechanism (also herein “filtration system”) can be under lower pressure relative to the incoming gas pressure into the filtering mechanism. The clean gas is directed through a pump 510 to regulate (e.g., increase) its relative pressure prior to entry to the processing chamber. Clean gas 511 with a regulated pressure that exits the pump is directed through one or more sensors 512, e.g., a flow meter, temperature sensors, humidity sensors, oxygen sensors, or any other sensor disclosed herein. A first portion of the clean gas is directed through at least one inlet(s) 504 of a gas inlet portion of the enclosure, while a second portion of the clean gas is directed to first and/or second window holders 514 and 516 that provide gas purging of optical window areas, as described herein. In some embodiments, the pressurized clean gas is further filtered through a filter e.g., 517 prior to reaching one or both of the window holders. In some embodiments, the one or more filters 517 and/or filtration system 508 are configured to filter out particles having nanometer-scale (e.g., about 10 nm to about 500 nm) diameters. In some embodiments, the gas recycling system provides clean gas to a recessed portion 518 of the enclosure. In some embodiments, gas flow 550a and 550b from the recessed portion 518 of the enclosure is directed through the gas recycling system 503. In some embodiments, gas flow from the recessed portion is directed through one or more filters of a filtration system. In some embodiments, the gas recycling system provides clean gas directed to first and/or second window holders 514 and 516. In some embodiments, the processing chamber comprises an upward slope 554 to direct a flow of gas through gas outlet 505. In some embodiments, the processing chamber does not include (e.g., is devoid of) an upward slope 554, e.g., has a (substantially) flat (e.g., planar) plane guiding flow of gas across build platform and through gas outlet 505.

In some embodiments, 3D printing system comprises a pre-transformed material (e.g., starting material such as powder) conveyor system (e.g., also referred to as “conveyance system” or “powder conveyance system”). The pre-transformed material conveyor system may be coupled to a processing chamber having a layer dispensing mechanism (e.g., recoater). Pre-transformed material (e.g., powder) from a reservoir (e.g., hopper) can be introduced into the layer dispensing mechanism disposed in the processing chamber. Once the layer dispensing mechanism dispenses a layer of pre-transformed material to layerwise form a material bed utilized for the three-dimensional printing, excess pre-transformed material may be attracted away from the material bed. In this process, excess pre-transformed material may be attracted away from the material bed using layer dispensing mechanism and introduced into separator (e.g., cyclone), and optionally to an overflow separator (e.g., cyclone). The pre-transformed material may undergo separation (e.g., cyclonic separation) in separator(s), and may be introduced into sieve(s), followed by gravitational flow into a lower reservoir (e.g., hopper). The separated and sieved pre-transformed material can be then delivered into separator(s), and into a reservoir that can deliver the pre-transformed material back into the layer dispensing mechanism. The separator may be coupled to sieve(s) instead of to the reservoir. The pre-transformed conveyor system may comprise pumps (e.g., displacement pump and/or compressor pumps), and a temperature regulator (e.g., heater or radiator such as a radiant plane). The pre-transformed conveyor system may comprise a venturi nozzle, for example, to facilitate suction of the pre-transformed material from the reservoir into separator(s). The conveyance system can include a condensed gas source (e.g., a blower or a cylinder of condensed gas). The conveyance system may include a heat exchanger. The conveyance system may include one or more filters. The conveyance system may operate at a positive pressure above ambient pressure external to the conveyance system (e.g., above about one atmosphere). The gas circulating system may be configured to circulate (e.g., and recirculate) gas also in the processing chamber. The gas circulating system may sweep debris (e.g., soot) away from the process area in which the 3D object is being printed. At times, a pressure differential is required to convey pre-transformed material from one compartment of the 3D printer to another. The pressure differential may be established via pressurizing or vacuuming one or more compartments. For example, pre-transformed material from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

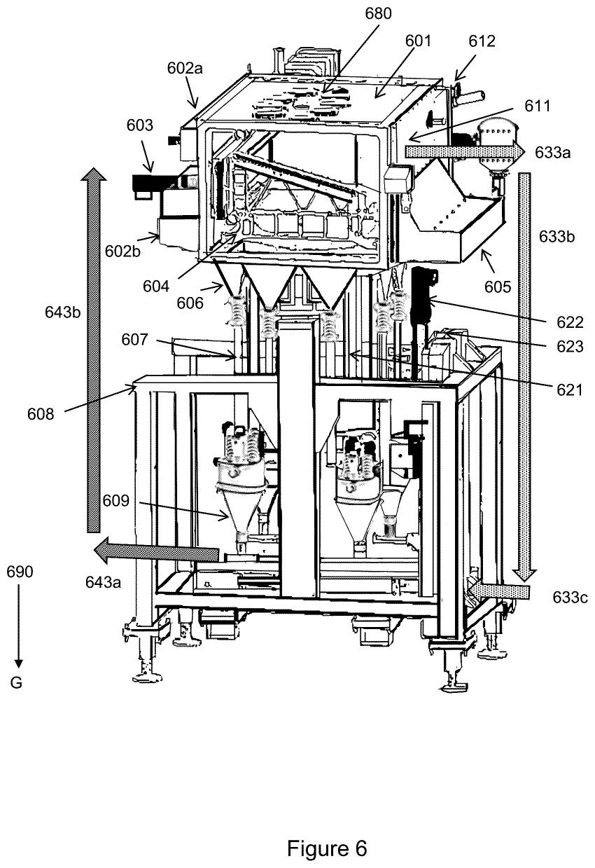

FIG. 6 shows a perspective view example of a portion of a 3D printing system including a processing chamber having a ceiling (e.g., roof) 601 in which optical windows such as 680 are disposed, e.g., to facilitate penetration of an energy beam into the processing chamber interior space. Side wall 611 of the processing chamber has a gas exit port covering 605 coupled thereto. The processing chamber has two gas entrance port coverings 602a and 602b coupled to an opposing wall to side wall 611. The opposing wall is coupled to an actuator 603 configured to facilitate translation of a layer dispensing mechanism mounted on a framing 604 above a base disposed adjacent to a floor of the processing chamber, which framing is configured to translate back and forth in the processing chamber along a guidance system comprising railings. The processing chamber floor has slots through which remainder material can flow downwards towards gravitational center G along gravitational vector 690. The slots are coupled to funnels such as 606 that are connected by channels (e.g., pipes) such as 607 to material reservoir such as 609. The processing chamber is coupled to a build module 621 that comprises a substrate to which the base is attached, which substrate is configured to vertically translate with the aid of actuator 622 coupled to an elevator motion stage (e.g., supporting plate) 623 via a bent arm. The elevator motion stage and coupled components are supported by framing 608, (e.g., depicted in FIG. 6 missing a beam that may be removed for installation and/or maintenance). Atmosphere (e.g., content and/or pressure) may be equilibrated between the material reservoirs and the processing chamber via schematic channel (e.g., pipe) portions 633a-c. Remainder material in the material reservoirs may be conveyed via schematic channels (e.g., pipes) 643a-b to a material recycling system, e.g., for future use in printing. The components of the 3D printing system are disposed relative to gravitational vector 690 pointing to gravitational center G.

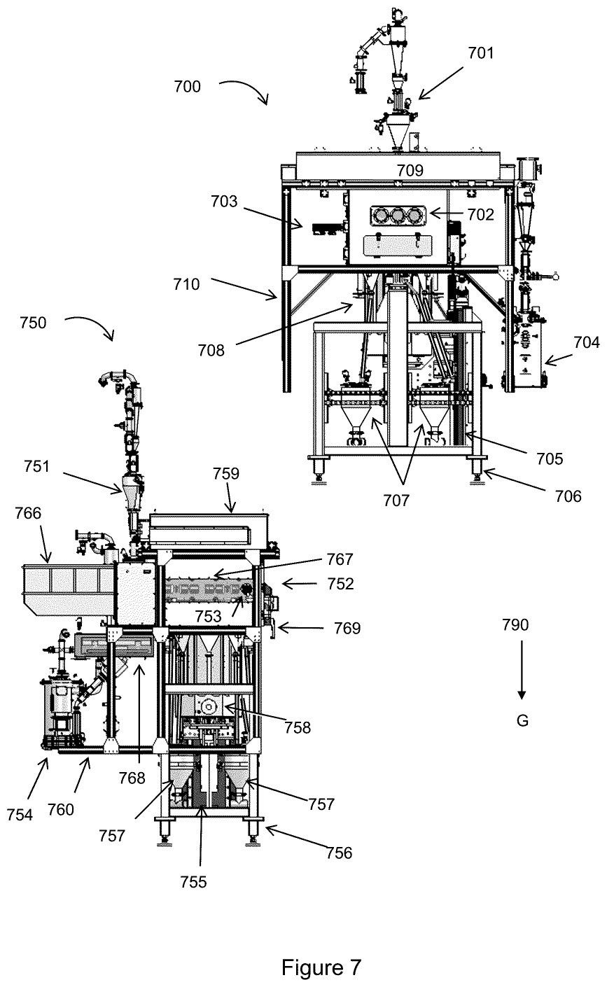

FIG. 7 shows in example 700 a front side example of a portion of a 3D printing system comprising a material reservoir 701 configured to feed pre-transformed material to a layer dispensing mechanism, an enclosure 709 configured to enclosure, e.g., scanner(s) and/or director(s) (e.g., optical system) of at least one energy beam (e.g., laser beam) configured to transform the pre-transformed material into a transformed material to print one or more 3D object in a printing cycle. Example 700 of FIG. 7 shows a processing chamber 702 having a door with three circular viewing windows. The windows may be any window disclosed herein. The viewing window may be a single or a double pane window. The window may be an insulated glass unit (IGU), the window may be configured to withstand positive pressure within the processing chamber, e.g., during printing. The positive pressure is above ambient pressure external to the build module, e.g., the ambient pressure may be about one atmosphere. Example 700 show a material reservoir 704 configured to accumulate recycled remainder starting material (e.g., pre-transformed material) from the layer dispensing process to form a material bed and/or a remainder of the material bed that did not form one or more 3D objects during a printing cycle, post 705 as part of a build platform assembly of build module 708; two material reservoirs 707 for accumulating a remainder of the material bed that did not form the 3D object, and actuator 703 configured to translate the layer dispensing mechanism to dispense a layer of pre-transformed material as part of a material bed. Supports 706 are planarly stationed in a first horizontal plane, which supports 706 and associated framing support one section of the 3D printing system portion 700 and framing 710 is disposed on a second horizontal plane higher than the first horizontal plane. FIG. 7 shows in 750 an example side view example of a portion of the 3D printing system shown in example 700, which side view comprises a material reservoir 751 configured to feed pre-transformed material to a layer dispensing mechanism, an enclosure 759 enclosing, e.g., scanners and/or directors (e.g., optical system) of at least one energy beam (e.g., laser beam) configured to transform the pre-transformed material into a transformed material to print one or more 3D object in a printing cycle. Example 750 of FIG. 7 shows an example of a processing chamber 752 having a door comprising handle 769 (as part of a handle assembly). 3D printing system portion 750 shows a material reservoir 754 configured to accumulate recycled remainder from the layer dispensing process to form a material bed and/or a remainder of the material bed that did not form one or more 3D objects during a printing cycle, a portion of the material conveyance system 768 configured to convey the material to reservoir 754. The material conveyed to reservoir 754 may be separated (e.g., sieved) before reaching reservoir 754. The example shown in 750 shows post 755 as part of a build platform assembly of build module 758; two material reservoirs 757 for accumulating a remainder of the material bed that did not form the 3D object, and actuator 753 configured to translate the layer dispensing mechanism to dispense a layer of pre-transformed material as part of a material bed, e.g., along railing 767 in processing chamber and into garage 766 in a reversible (e.g., back and forth) movement. Supports 756 are planarly stationed in a first horizontal plane, which supports 706 and associated framing support one section of the 3D printing system portion 750 and framing 760 is disposed on a second horizontal plane higher than the first horizontal plane. In the example shown in FIG. 7, the 3D printing system components may be aligned with respect to gravitational vector 790 pointing towards gravitational center G.

In some embodiments, a plurality of energy beams incident on a target surface may increase (i) the (e.g., total) processing field available for printing (e.g., in a X-Y plane) and/or (ii) the rate of 3D printing completion for a given print cycle (as compared to using a single energy beam). A plurality of energy beams (e.g., at least two energy beams) may be useful in providing a relatively larger processing area in which one or more 3D objects may be generated. A relatively larger processing area may be useful in generating a larger 3D object, or a plurality of (e.g., laterally) adjacent 3D objects. The larger 3D object may be larger in at least one dimension (e.g., in a X-Y plane), compared to a 3D object formed using a single energy beam. The platform and/or material bed may be larger in at least one dimension (e.g., in a X-Y plane), compared to a platform and/or a material bed used for 3D printing with a single energy beam. A relatively larger processing field may be larger in relation to a 3D printing system that comprises (e.g., only) a single energy beam, which processing area is limited to the areal extent (e.g., the processing field) of the single energy beam (e.g., as guided by a optical assembly), which is not arbitrarily sized.

At times, an energy beam from a first and/or second energy source is incident on, and/or is directed to, a target surface (e.g., the exposed surface of the material bed). The energy beam may be directed to and/or impinge on the pre-transformed material. The energy beam can be directed to the pre-transformed or transformed material for a specified period. The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy source and/or energy beam can be moveable such that it can translate relative to the surface (e.g., the target surface).

In some embodiments, the energy source is movable such that it can translate across (e.g., laterally) the top surface of the material bed, e.g., during the printing. Movable may be relative to the processing chamber, the build module, the target surface, or any combination thereof. The energy beam(s) can be moved via at least one scanner. In some embodiments, at least two energy beams are moved with the same scanner. In some embodiments, at least two energy beams are moved with different scanners (e.g., are each moved with a different scanner). The scanner may comprise a galvanometer scanner, a polygon, a mechanical-stage (e.g., X-Y-stage), a piezoelectric device, gimbal, or any combination of thereof. The galvanometer scanner may comprise a mirror. The scanner may comprise a modulator. The scanner may comprise a polygonal mirror. The scanner can be the same scanner for two or more energy sources and/or beams. At least two (e.g., each) energy sources and/or beams may have a separate scanner. At least two scanners may be operably coupled with a single energy source and/or energy beam. The energy sources and/or energy beams can be translated independently of each other. In some cases, at least two energy sources and/or energy beams can be translated at different rates, and/or along different paths. For example, the movement of a first energy beam may be faster (e.g., at a greater rate) as compared to the movement of a second energy beam. The systems and/or apparatuses disclosed herein may comprise one or more shutters (e.g., safety shutters). The energy beam(s), energy source(s), and/or the platform can be moved by the scanner (e.g., optical scanner to move the energy beam, or mechanical stage type scanner to move the platform or energy source). The galvanometer scanner may comprise a two-axis galvanometer scanner. The scanner may comprise a modulator. The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle).

At times, the energy source(s) are modulated. The energy (e.g., beam) emitted by the energy source can be modulated. The modulator can comprise an amplitude modulator, a phase modulator, or polarization modulator. The modulation may alter the intensity of the energy beam. The modulation may alter the current supplied to the energy source (e.g., direct modulation). The modulation may affect (e.g., alter) the energy beam (e.g., external modulation such as external light modulator). The modulator can comprise an acousto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam.

The scanner can be included in an optical system that is configured to direct energy from the energy source to a predetermined position on the (target) surface (e.g., exposed surface of the material bed). The scanner may comprise one or more optical elements (e.g., mirrors). At least one controller can be programmed to control a trajectory of the energy beam(s), e.g., with the aid of the optical system. At least one controller can be programmed to control a trajectory of the energy source(s), e.g., with the aid of actuator(s). The controller can regulate a supply of energy from the energy source to the pre-transformed material (e.g., at the target surface) to form a transformed material. The optical system may be enclosed in an optical enclosure (e.g., of the system of optical assemblies). Examples of 3D printing systems, apparatuses, devices, and components (e.g., optical housing and optical system), controllers, software, and 3D printing processes can be found Patent Application serial number PCT/US17/64474, filed Dec. 4, 2017, in International Patent Application serial number PCT/US18/12250, filed Jan. 3, 2018, in International Patent Application Serial No. PCT/US19/226364, filed on May 16, 2019, each of which is incorporated herein by reference in its entirety.

In some embodiments, one or more (e.g., a plurality of) optical assemblies direct a plurality of energy beams, respectively, to the target surface (e.g., to different positions of the target surface). The one or more optical assemblies may be arranged in an array of optical assemblies. The optical assemblies may each comprise an optical element and/or optical mechanism. The optical assembly may comprise a scanner. A given scanner may direct a plurality of energy beams from the same energy source. An optical assembly may direct a plurality of energy beams from more than one (e.g., at least two) energy sources. An optical assembly may direct one energy beam from an energy source. The plurality of energy beams may have the same or of different characteristics (e.g., energy density, and cross section) and/or scanning scheme in the 3D printing process. An optical assembly may be controlled manually and/or by at least one controller. For example, at least two optical assemblies may be directed by the same controller. For example, at least one optical assembly may be directed by its own (e.g., unique) controller. The plurality of controllers may be configured to operatively couple (e.g., and may be operatively coupled) to each other, to the optical assembly(s) (e.g., scanner(s)), and/or to the energy source(s). At least two of the plurality of energy beams may irradiate the target surface simultaneously or sequentially. At least two of the plurality of energy beams may irradiate the target surface cooperatively, synchronously. At least two of the plurality of energy beams may be generated by the same energy source. At least two of the plurality of energy beams may be generated by at least two energy sources (e.g., a respective energy source for each energy beam). At least two of the plurality of energy beams may be directed towards the same position at the target surface, or to different positions at the target surface. In some embodiments, at least two of the energy source(s) and/or beam(s) can be translated at different rates (e.g., velocities). In some cases, at least two energy source(s) and/or beam(s) can comprise at least one different characteristic. The characteristics may comprise wavelength, power, amplitude, trajectory, footprint, intensity, energy, or charge. The charge can be electrical and/or magnetic charge. One or more sensors may be disposed adjacent to the target surface. The at least one of the one or more sensors may be disposed in an indirect view of the target surface. The at least one of the one or more sensors may be disposed in a direct view of the target surface (e.g., a camera viewing the target surface). The one or more sensors may be configured to have a field of view of at least a portion of the target surface (e.g., an exposed surface of the material bed).

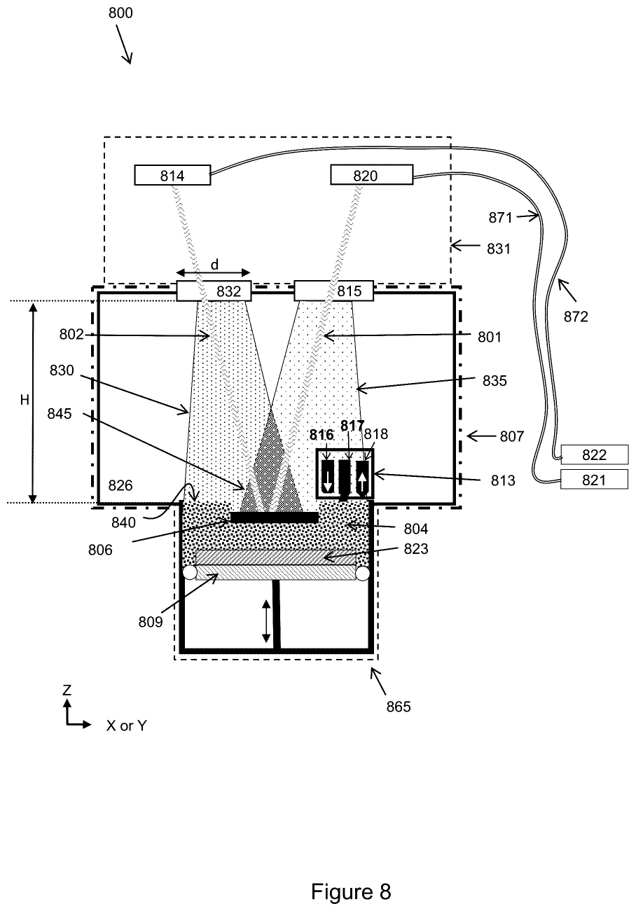

FIG. 8 shows an example of a 3D printing system 800 and related components, including a (e.g., first) energy source 821 that emits a (e.g., first) energy beam 801 (e.g., laser beam) and a (e.g., second) energy beam source 822 that emits a (e.g., second overlapping) energy beam 802 (e.g., laser beam). The 3D printing system can have additional energy sources not shown in FIG. 8. The energy sources are disposed adjacent to enclosure having interior space 826. (e.g., having an atmosphere). The enclosure comprises a processing chamber 807 and a build module 865. In the example of FIG. 8 the energy from energy source 821 travels through an optical fiber 871, through an (e.g., first) optical assembly 820 (e.g., comprising a scanner) and through an optical window 815, to impinge upon a target surface 840 within enclosure (e.g., processing chamber) having interior 826 (e.g., comprising an atmosphere). Target surface 840 may comprise at least one layer of pre-transformed material (e.g., powder material) that is disposed above to a platform (e.g., 809), e.g., with respect to a gravitational center. FIG. 8 shows the energy from the energy beam source 822 travels through an optical cable 872, through an optical assembly 814 (e.g., comprising a scanner) and through an optical window 832 to impinge upon the target surface 840 (e.g., exposed surface of material bed 804). In the example of FIG. 8, the energy beam 802 trajectory defines a processing volume 830 (shown as a vertical cross section), the energy beam 801 trajectory defines a processing volume 835 (shown as a vertical cross section), and the processing volumes 830 and 835 have an overlapping region 845. The processing volume 835 may be referred to as a “processing cone”, albeit it may have a 3D shape of a truncated cone. The processing volume 830 may be a processing cone (e.g., truncated cone disposed within interior space 826). The processing volume 830 may be referred to as a “processing cone”, albeit it may have a 3D shape of a truncated cone. A processing volume may have a corresponding processing field defined by the intersection of the processing volume with the target surface. The target surface may comprise a (e.g., portion of) hardened material (e.g., FIG. 8, 806) formed via transformation of material within a material bed (e.g., FIG. 8, 804). In the example of FIG. 8, a layer forming device 813 includes a (e.g., powder) dispenser 816, a leveler 817, and material removal mechanism 818. The material bed may be supported by a (e.g., movable) platform, which platform may comprise a base (e.g., FIG. 8, 823). The base (e.g., build plate) may be detachable (e.g., after the printing cycle concludes). A hardened material may be anchored to the base (e.g., via supports and/or directly), or un-attached to the base (e.g., floating anchorlessly in the material bed, e.g., suspended in the material bed). At times, a (e.g., optical) detection system is disposed to detect one or more characteristics of the printing process. The detection system may comprise any detection system disclosed herein, e.g., a height mapper system. FIG. 8 an example of an optical system including optical assemblies disposed within respective optical enclosure 831. In some embodiments, at least one of energy beam sources 821 and 822 may be easily removable and/or insertable. In some embodiments, at least one of optical assemblies 814 and 820 may be easily removable and/or insertable. For example, a user (e.g., service and/or installation engineer) may maneuver an energy beam source (e.g., 821, and/or 822) to and/or from the 3D printing system, e.g., without usage of tooling. For example, a user (e.g., service and/or installation engineer) may maneuver an energy beam source (e.g., 821, and/or 822) to and/or from the 3D printing system, e.g., without usage of tooling.

In some embodiments, an array of optical assemblies including at least two (e.g., a plurality of) optical assemblies are arranged within an optical system of a 3D printing system. The at least two optical assemblies may have at least two (e.g., a plurality) respective energy beams having respective processing fields, e.g., on the target surface. In some embodiments, a total processing area of the respective energy beams of the at least two optical assemblies may be a combination of the respective processing fields. The total processing area may encompass (e.g., at least) a target surface of the 3D printing system (e.g., exposed surface of a material bed). The target surface may be organized (e.g., divided) into at least two (e.g., a plurality of) regions, e.g., with respect to the energy beams. The at least two optical assemblies (e.g., each) may be arranged for processing (e.g., material transformation) by respective energy beams within at least one of the target surface regions. At least two optical assemblies may be arranged to facilitate printing with respective energy beams within a same target surface region. At least two optical assemblies may be arranged to facilitate printing with respective energy beams within different target surface regions.

In some embodiments, a processing volume is defined by a portion of the enclosure that can be occupied by the energy beam, e.g., during printing. The processing volume may comprise the processing cone (e.g., a truncated cone or a non-truncated cone). The processing volume may occupy a region comprising a height spanning from the optical window to the target surface. The processing volume may occupy a volume in which an energy beam can emerge from an optical window, impinge at the target surface and translate along the target surface. The energy beam(s) may travel through a region of the processing chamber referred to as a processing volume region (also referred the herein as a “processing volume”). In some embodiments, each optical assembly (e.g., of an array of optical assemblies) has a corresponding processing volume within which it is configured to direct an energy beam across at least a portion of the target surface, e.g., during printing. At least one of the arrays of optical assemblies may direct one or more energy beams through a processing volume. At least one of the arrays of optical assemblies can be configured to move the energy beam (e.g., by deflection using a scanner) in accordance with a (e.g., predetermined) path along the at least the portion of the target surface, e.g., a processing region of the target surface. Movement of the energy beam(s) during a printing operation can cause the energy beam(s) to potentially occupy a volume (e.g., processing volume) extending from the area or point of entry of the energy beam into the processing chamber to the area of the target surface (e.g., an exposed surface of the material bed, or a platform).

At times, a first processing field (e.g., of a first optical assembly) at least partially overlaps a second processing field (e.g., of a second optical assembly). At times, at least one processing field is adjacent to (e.g., contiguous) with at least a second processing field (e.g., abuts in a non-overlapping manner). At times, at least one processing field does not (i) abut or (ii) overlap, another processing field. An overlap may comprise a (e.g., shared) region comprising a (e.g., shared) portion of the first processing field and a (e.g., shared) portion of the second processing field. The non-overlapping region may comprise a portion of a first processing field that is (e.g., mutually) distinct from a portion of a second processing field. As understood herein, total (e.g., complete) overlapping comprises at least one processing field that is entirely shared with (e.g., by) another (e.g., at least one) processing field. A total overlapping may be mutual, for example, a first optical assembly having the same (e.g., shared) processing field as a second optical assembly. A total overlapping may be non-mutual, for example, a first processing field that is entirely within a second processing field, which second processing field comprises an area distinct from the first processing field. Overlapping may comprise a first processing field that is (e.g., entirely, or completely) shared with (e.g., a portion of) a second processing field. For example, a partial overlapping such that a portion of the second processing field is distinct from the first processing field (e.g., the first processing field is entirely encompassed by the second processing field). Characteristics of overlapping regions for a given processing field can vary between respective overlapping processing field regions (e.g., also referred to herein as a processing region). For example, a first processing field may be partially overlapping with a second processing field, and totally overlapping with a third processing field. Other combinations of (e.g., partial, total, and none) overlapping are possible for a plurality of energy beams. At times, two or more processing fields can define a processing region on a target surface, e.g., within an enclosure. The processing region may comprise at least a portion of the target surface where at least one energy beam can impinge on the target surface. The processing region may comprise a rectangular, circular, or irregular shape. The processing region may occupy a full area of the target surface that can be impinged upon by at least one energy beam. The processing region may be occupy less than a full area of the target surface that can be impinged upon by the overlapping processing fields of the energy beams on the target surface.

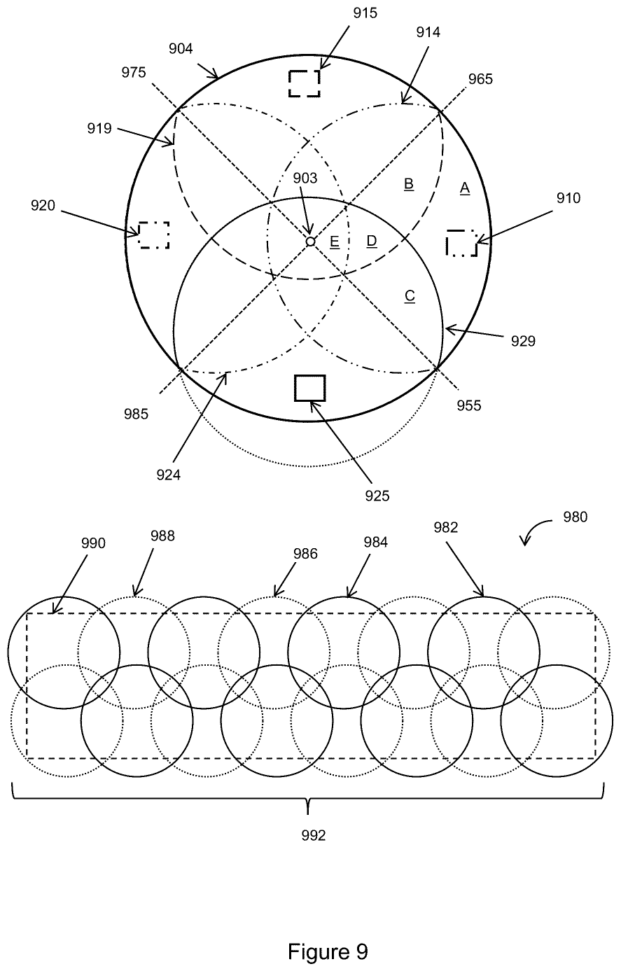

FIG. 9 depicts an example of a division of a target surface of a 3D printing system into a plurality of processing regions. In the example of FIG. 9, four processing regions are depicted with respect to the lines 955, 965, 975, and 985, inclusive: a (e.g., first) region in a between lines 955 and 965, inclusive; a (e.g., second) region in a sector between lines 965 and 975; a (e.g., third) region in a sector between lines 975 and 985, inclusive; and a (e.g., fourth) region in a sector between lines 985 and 955. The processing regions may be such a (e.g., first) processing region is juxtaposed with (e.g., does not overlap) a (e.g., second) processing region. The processing regions may be such a (e.g., first) processing region is at least partially overlapping with a (e.g., second) processing region. FIG. 9 depicts an example of an arrangement of a plurality of optical assemblies arranged with respect to a target surface 904 (e.g., FIGS. 9; 910, 915, 920, and 925). In the example of FIG. 9, each of the plurality of optical assemblies has a respective processing field (shown in like line type): for optical assembly 910, a processing field 914; for optical assembly 915, a processing field 919; for optical assembly 920, a processing field 924; and for optical assembly 925, a processing field and 929. The optical assemblies are depicted above (e.g., horizontally overlapping) the target surface.

In some embodiments a symmetry between at least two processing regions and/or at least two processing fields confers a design, processing, and/or manufacturing advantage. The design advantage may comprise simplification of hardware (e.g., re-used components), software (e.g., re-used modules and/or code), or a combination thereof. The design advantage may allow utilization of a platform rotation (e.g., during the printing). The design advantage may allow translation of components of the optical system with respect to the target surface, e.g., translation of the optical assemblies of the optical system with respect to the target surface. In some embodiments, at least two processing regions (e.g., of a target surface) are symmetric (e.g., by inversion, reflection, rotation, and/or translation). For example, at least two processing regions may be symmetrical segments of a circle (e.g., FIG. 9; sector between 955 and 965 (inclusive), and sector between 965 and 975, inclusive). The at least two processing regions may comprise a grid symmetry (e.g., the target surface divided into a grid, e.g., forming an array). In some embodiments, at least two processing regions (e.g., of a target surface) are asymmetric. In some embodiments, at least two processing fields (e.g., of a plurality of processing fields) are symmetric with respect to each other (e.g., by inversion, reflection, rotation, and/or translation). In some embodiments, at least two processing fields (e.g., of a plurality of processing fields) are not symmetry related with respect to each other. In some embodiments, an arrangement of optical assemblies comprises a symmetry. In the example of FIG. 9, the position of the plurality of optical assemblies 910, 915, 920, and 925 are related to each other in inversion symmetry about a point 903 (e.g., as well as in rotation, reflection, and translation symmetry).

FIG. 9 depicts an example of a variety of overlapping processing fields on a target surface. In the example of FIG. 9, the processing field 914 includes segments A, B, C, and D. The segment A comprises an example of a portion of the processing field 914 that is non-overlapping with any other processing field. The segments B and C comprise examples of portions of the processing field 914 that area overlapping with (e.g., a portion of) one other processing field (e.g., FIGS. 9; 919 and 929, respectively). The segment D comprises an example of a portion of the processing field 914 that is overlapping with (e.g., a portion of) two other processing fields (e.g., FIGS. 9; 919 and 929). The segment E comprises an example of a portion of the processing field 914 that is overlapping with (e.g., a portion of) three other processing fields (e.g., FIGS. 9; 919, 924 and 929). In some embodiments, a given processing field may overlap with at least about 1, 2, 3, 4, 5, 10, 15, or 20 other processing fields at least in part (e.g., at least a fraction of the processing field overlap). A processing field may overlap with any number of the afore-mentioned numbers of processing fields (e.g., from about 1 to about 20, about 1 to about 10, or about 10 to about 20 processing fields).

FIG. 9 depicts an example schematic of overlapping processing fields on a target surface depicted as overlapping processing regions (e.g., sub-regions). As depicted in FIG. 9, overlapping processing fields 980 comprise at least eight processing fields depicted as solid lines, e.g., processing fields 982, and 984. Overlapping processing fields 980 include additional eight processing fields depicted by dashed lines, e.g., processing fields 986, and 988. The solid and dashed lines of the processing field is provided for clarity of visualization of the different processing fields on the target surface. The overlapping processing fields 980 can have a consolidated processing field (e.g., collective field of view) 990 of at least a portion of a target surface, e.g., a processing region. The overlapping processing fields 980 may be generated by sixteen energy beams arranged in two linear arrays with each energy beam emerging from respective optical assembly (FRU), e.g., comprising sixteen optical assemblies each directing respective energy beams to impinge on the target surface to generate linear array 992 of the processing regions.

In some embodiments, the optical system comprising an array of optical assemblies is subject to installation and/or maintenance. Maintenance and/or installation of the array of optical assemblies of the optical system has one or more benefits. The benefits may comprise being quicker, cheaper, simpler, requiring fewer personnel, being more robust, or being more reliable than optical systems comprising non-modular optical assemblies (e.g., optical assemblies that are not easy to remove from the 3D system).

An optical assembly may comprise a housing. The housing may enclose (e.g., fully) one or more optical components of the optical assembly. The optical assembly may be modular, e.g., may be modular optical assembly. A first optical assembly may comprise a first housing that is different from a housing enclosing (e.g., fully) the at least one optical component of a different optical assembly. A plurality of optical assemblies, e.g., an array of optical assemblies, may each comprise a respective housing. The housing(s) of each optical assembly of the array of optical assemblies can be housed within an optical enclosure enclosing the optical assemblies (e.g., each having a housing). In some embodiments, the plurality of optical assemblies are enclosed (e.g., fully) within an optical enclosure.

At times, at least one optical assembly (e.g., a plurality of optical assemblies) includes at least one (e.g., a plurality of) component. The components may be enclosed (e.g., fully) by a housing of the optical assembly. Components may include optical components. Optical components may comprise a mirror(s), a lens (e.g., concave or convex), a fiber, a beam guide, a rotating polygon, or a prism. The at least one component may be affixed within the housing of the optical assembly, e.g., using mounting hardware, adhesive, or a combination thereof. The component may be affixed within the housing of the optical assembly (e.g., to the housing, to a support within the housing, etc.). For example, 2 mm diameter hardware (e.g., M2 hardware), 3 mm diameter hardware (e.g., M3 hardware), 4 mm diameter hardware (e.g., M4 hardware), or the like. The mounting hardware for affixing components with respect to the optical assembly within the housing may comprise torque specifications for example, of at least about 0.5 Newton*meter (Nm), 1 Nm, 1.5 Nm, 2.0 Nm, 2.5 Nm, 4.0 Nm, 5.0 Nm, or 10.0 Nm. The torque specification may be between the aforementioned torque values, for example, from about 0.95 Nm to about 1.5 Nm, from about 1.5 Nm to about 2.5 Nm, from about 0.5 Nm to about 10 Nm, or the like. A component may be affixed with respect to the optical assembly (e.g., within the housing) using an adhesive having a phase transition temperature of at least about 110° C., 120° C., 130° C., 140° C., or 150° C. A phase transition temperature can comprise a liquidous phase transition, a glass transition, a liquification, or the like. The at least one component may be affixed such that a movement (e.g., vibration, positional drift, frequency response drift) induced in the component by movement of the optical assembly (e.g., movement of the modular optical assembly) is minimized. The at least one component may be affixed such that a movement (e.g., vibration) induced in the component by movement of the array of optical assemblies is minimized.

In some embodiments, at least two optical assemblies are modular. The optical system can be configured to receive the modular optical assemblies, e.g., within an optical enclosure. The optical system can comprise at least about 2, 4, 5, 6, 8, 10, 12, 16, 24, 36, or 64 optical assemblies. The optical system can include any of the aforementioned number of optical assemblies (e.g., from about 2 to about 64, from about 2 to about 16, or from about 10 to about 64). The optical assemblies may or may not be collectively housed in an optical enclosure. For example, at least one of the optical assemblies may have its own housing. For example, at least two of the optical assemblies may be collectively disposed in a communal enclosure. For example, at least two of the optical assemblies may each have their own housing, and further be disposed in a communal enclosure. At least two of (e.g., all of) the optical assemblies may be arranged in an array of optical assemblies, e.g., a linear array or a two-dimensional (2D) array. The linear array may comprise optical assemblies (e.g., FRUs) disposed in a single file. The 2D array of optical assemblies may have a repeating cell comprising optical assemblies. At least two of the optical assemblies of the array of optical assemblies may be arranged in a periodic or in a non-periodic manner. At least one of (e.g., all of) the optical assemblies may be modular. The arrangement of the optical assembly may be with respect to the optical enclosure and/or the processing chamber. At least two of the optical assemblies may be operable to each direct a respective energy beam through a respective optical window into the processing chamber to impinge on a target surface. The target surface may comprise an exposed surface of a material bed. The optical system may be operable to receive a number of (e.g., modular) optical assemblies that is different than or equal to a number of optical windows. Different number may be a smaller number or a higher number. At least two of the optical assemblies may each be operatively coupled to, or be a part of, an energy source (e.g., fiber-coupled laser source).

In some embodiments, the optical enclosure and/or optical housing is coupled to the gas flow mechanism that is coupled to the processing chamber, with the optical housing enclosing an optical assembly and the optical enclosure enclosing optical assemblies. In some embodiments, the optical housing and/or enclosure is coupled to a gas flow assembly that is not coupled to the processing chamber. The gas flow assembly may service the optical enclosure and/or optical housing rather than other components of the 3D printing system. For example, the gas flow assembly may be dedicated to the optical enclosure and/or optical housing.

In some embodiments, gas flow of at least about 0.5 psi, can be directed through the optical enclosure and/or through the optical housing(s) of at least one (e.g., a plurality of) optical assembly. For example, gas flow may be at least about 0.5 pounds/inch 2 (psi), 1 psi, 2 psi, 3 psi, 4 psi, 5 psi, 6 psi, 7 psi, 8 psi, 9 psi, or 10 psi, above the ambient pressure of gas flow. The gas flow may be any value between the afore-mentioned values, for example, from about 0.5 psi to about 10 psi, or from about 0.5 psi to about 5 psi. The gas flow may or may have a gas composition (e.g., makeup) different from that of the ambient atmosphere external to the optical enclosure and/or optical housing(s). The gas in the optical enclosure and/or optical housing(s) may or may not have a gas makeup of the internal atmosphere of the processing chamber. Gas in the internal atmosphere of the processing chamber may include clean dry air (CDA), filtered air, argon, nitrogen, and/or another inert gas. The gas composition may be any gas composition disclosed herein. Gas in the optical enclosure and/or optical housing(s) may include clean dry air (CDA), filtered air, argon, nitrogen, and/or another inert gas. In some embodiments, a filtration system filters out at least some of the solid (e.g., debris) and/or gaseous contaminants from a gas flow, e.g., at an inlet into and/or at an outlet from the optical enclosure and/or optical housing(s). The filtration system may filter gas flow into the optical enclosure and/or optical housing(s) of at least one optical assembly providing a clean gas (e.g., cleaner than gas flow outside of the optical path environment). The filtration system may filter gas flow out of the optical enclosure and/or optical housing(s) of at least one optical assembly, e.g., removing contaminants that may be present in the gas flow within the optical enclosure and/or optical housing(s). The filtration system can include one or more filters. The filters may comprise oil filters, particulate filters (e.g., HEPA filters, 0.1-micron particulate filter, or the like), humidity filters or chemical filters (e.g., column). The particulate filter may comprise high efficiency particulate air (HEPA) filters, particulate filter configured to filter particles having a FLS of at least about 0.1 microns or larger, or the like.

In some embodiments, the optical enclosure and/or optical housing(s) are coupled to a temperature conditioning system such as a cooling system. The cooling system may comprise a coolant. The coolant can be a gas, a liquid, or a semisolid (e.g., gel). In some examples, the cooling system comprises water-based cooling, gas-based cooling, or a combination thereof. Cooling system for the optical enclosure and/or optical housing(s) may be coupled to a gas flow mechanism. Cooling system may be a gas flow assembly or include a gas flow assembly. Cooling system can be utilized to reduce a thermal load on one or more (e.g., optical) components of the optical enclosure and/or optical assembly(s), e.g., through heat exchange between a gas or water running adjacent and/or in contact with the one or more optical components. For example, optical system can include an inlet(s) to couple the optical system to a temperature conditioning (e.g., cooling) system, e.g., to a gas flow assembly.

In some embodiments, a gas flow mechanism comprises structures that at least partially dictate the flowing of gas across an (e.g., entire) enclosure and/or a portion of an enclosure. The gas flow mechanism can be used to at least partially control a characteristic of gas flow adjacent to (e.g., over) the target surface, the platform, and/or a mechanical component, e.g., an optical component such as a lens. Target surface may refer to a surface that is a radiation target for the energy beam. The gas flow mechanism can include a gas inlet portion that at least partially controls the flow of gas entering the enclosure and/or directed towards the component. The gas flow mechanism can include a gas outlet portion that at least partially controls the flow of gas exiting the enclosure. The gas flow mechanism can be used to at least partially control a characteristic of gas flow adjacent to or within a recessed portion of the enclosure (e.g., to purge the recessed portion). The gas flow mechanism can include the gas inlet portion, the gas outlet portion, features for purging a recessed portion of the enclosure, or any suitable combination thereof. The recessed portion may be at the ceiling of the enclosure (e.g., at a ceiling of the processing chamber). The recessed portion may be disposed at a wall of the enclosure opposing to the target surface. The gas may comprise an inert gas (e.g., nitrogen and/or argon). The gas may flow in bulk. The gas may flow in one or more streams. The gas may comprise a non-reacting (e.g., inert) gas. The gas may comprise a reactive agent depleted gas, e.g., a water depleted gas and/or an oxygen depleted gas. The flow of the gas may comprise flowing across at least a portion of the height (e.g., Y axis) of the enclosure. For example, the flow of the gas may comprise flowing across the entire height of the enclosure. The flow of the gas may comprise flowing across at least a portion of the depth (e.g., Z axis) of the enclosure. For example, the flow of the gas may comprise flowing across the entire depth of the enclosure. The flow of the gas may comprise flowing across at least a portion of the width (e.g., X axis) of the enclosure (e.g., also referred herein as the length of the enclosure). For example, the flow of the gas may comprise flowing across the entire width of the enclosure. The flow of gas may comprise flowing onto an internal surface of the optical window (e.g., facing the exposed surface of the material bed). The area adjacent to the optical window may comprise one or more slots (e.g., a slot per optical window, or a single slot for all optical windows, or dispersed multiple slots across one or more optical windows), one or more channels, or a combination thereof. The flow of gas may comprise flowing through the one or more slots, channels, or a combination thereof, on to the internal surface of the optical window. The slot and/or channel may facilitate directing the flow of gas onto the internal surface of the optical window. For example, the gas flow may be optionally evacuated from an area adjacent (e.g., directly adjacent) to the one or more optical windows. The flow of gas may be (e.g., substantially) lateral. The flow of gas may be (e.g., substantially) horizontal. The gas may flow along, away and/or towards the one or more optical windows. The gas may flow in a plurality of gas streams. The gas streams may be spread across at least a portion of the (e.g., entire) height and/or depth of the enclosure. The gas streams may be evenly spread. The gas streams may not be evenly spread (e.g., across at least a portion of the enclosure height and/or depth). The gas streams may flow across at least a portion of the enclosure height and/or depth Across the enclosure, the gas streams may flow in the same direction. The same direction may comprise from the gas-inlet to the gas-outlet. The same direction may comprise from one edge of the enclosure to the opposite end). The same direction may comprise from the gas-inlet to the gas-outlet. The gas flow may flow laterally across at least a portion of the (e.g., height and/or depth of the) enclosure. The gas flow may flow laminarly across at least a portion of the (e.g., height and/or depth of the) enclosure. The at least a portion of the enclosure may comprise the processing cone. In some embodiments, the gas streams may not flow in the same direction. In some embodiments, one or more gas streams may flow in the same direction and one or more gas streams may flow in the opposite direction. The gas flow (e.g., in the at least one stream) may comprise a laminar flow. The gas flow may comprise flow in a constant velocity during at least a portion of the 3D printing. For example, the gas flow may comprise flow in a constant velocity during the operation of the energy beam (e.g., during the transformation of at least a portion of the material bed). Laminar flow may comprise fluid flow (e.g., gas flow) in (e.g., substantially) parallel layers. The gas flow may comprise flow in a varied velocity during at least a portion of the 3D printing. For example, the gas flow may comprise flow in a varied velocity during the operation of the energy beam (e.g., during the transformation of at least a portion of the material bed). The gas streams may comprise a turbulent flow. Examples of 3D printing systems, apparatuses, devices, and components (e.g., gas flow mechanisms and optical windows), controllers, software, and 3D printing processes (e.g., contamination reduction by gas purging) can be found in International Patent Application Serial No. PCT/US22/16550, filed Feb. 16, 2022, and in International Patent Application Serial No. PCT/US17/60035, filed Nov. 3, 2017, each of which is entirely incorporated herein by reference.

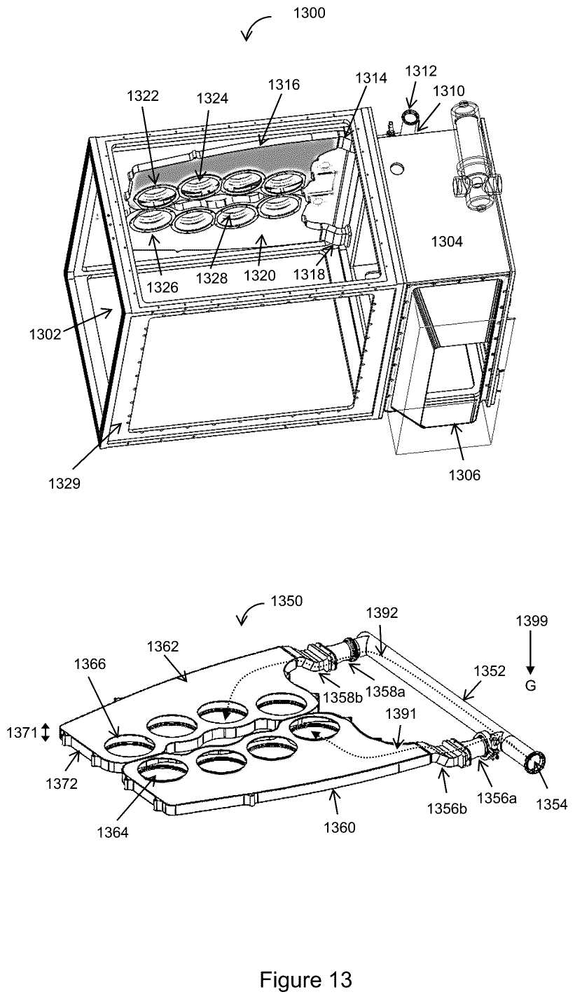

FIG. 13 illustrates an example of a portion of a 3D printing system 1300. The portion of the 3D printing system 1300 comprises a processing chamber 1302, which may contain an atmosphere such as the one disclosed herein (e.g., a pressurized atmosphere with respect to an ambient atmosphere external to the processing chamber). The portion of the 3D printing system 1300 comprises a garage portion 1304 with an excess powder exit port 1306. The portion of a 3D printing system 1300 comprises a gas flow system portion. The gas flow system portion comprises a main channel 1310 having an opening port 1312. The main channel connects to a first channel 1314 directing gas into a first manifold 1316, and a second channel 1318 directing gas into a second manifold 1320. The first manifold 1316 directs gas to a first set of nozzles such as nozzle 1322, each surrounding a respective optical window of a first set of optical windows such as optical window 1324, which nozzles 1322 direct gas into the processing chamber 1302. The second manifold 1320 directs gas to a second set of nozzles such as nozzle 1326, each surrounding a respective optical window of a second set of optical windows such as optical window 1328, which nozzles 1326 direct gas into the processing chamber 1302. The processing chamber has a portion of a floor 1329. Garage portion 1304 is configured to accommodate a layer dispensing mechanism (e.g., recoater) configured to dispense at least a portion of a material bed (e.g., a layer of the material bed). Excess starting material from the recoater is released through exit port 1306.

FIG. 13 illustrates an example of a gas flow system and manifold assembly 1350. The gas flow system and manifold assembly 1350 comprises a main channel 1352 having an opening portion 1354 that receives gas flow into the main channel 1352. The main channel 1352 connects to and directs gas into a first channel 1356a-1856b and a second channel 1358a-1858b. The gas flow system is configured to facilitate gas flow through main channel 1352, first channel 1356a-1856b, and into first manifold 1360 to exit each of the openings, e.g., along path 1391 showing exit through one of the openings as an example. The gas flow system is configured to facilitate gas flow through main channel 1352, second channel 1358a-1358b, and into second manifold 1362 to exit each of the openings, e.g., along path 1392 showing exit through one of the openings as an example. The first channel as a first portion 1356a having a circular vertical cross section, and a second portion 1356b having a rectangular cross section. A baffle may be disposed in the connection of the first portion 1356a and the second portion 1356b. The second channel as a first portion 1358a having a circular vertical cross section, and a second portion 1358b having a rectangular cross section. A baffle may be disposed in the connection of the first portion 1358a and the second portion 1358b. The first channel 1356a-1356b is disposed closer to the opening portion 1354 than the second channel 1358a-1358b. The first channel 1356a-1356b is connected to and directs gas into a first manifold 1360 and the second channel 1358a-1358b is connected to and directs gas into a second manifold 1362. The first manifold 1360 is a hollow casing configured to direct gas toward a first set of openings such as 1364. The first manifold has a height 1371. The second manifold 1362 is a hollow casing configured to direct gas toward a second set of openings such as 1366. The second manifold has a height 1372. The first and second sets of openings are configured to operatively engage optical windows and/or nozzles. Manifold assembly 1350 in FIG. 13 may be configured for disposition relative to gravitational vector 1399 pointing towards gravitational center G.

In some embodiments, the optical assembly and/or optical system is operatively coupled with one or more controllers. The one or more controllers may be configured to maneuver at least one of the optical components of the optical assembly(s). For example, the one or more controllers may be configured to alter a position and/or angle of the optical component(s) with respect to a reference. For example, the one or more controllers may be configured to alter a position and/or angle of the optical components with respect to each other. The one or more controllers may be part of the control system. The control system may comprise controllers that, e.g., may have a hierarchical structure. The hierarchical structure may comprise at least three levels of hierarchy. The control system may be configured to control one or more components of the 3D printing system. The control system may be configured to control the printing of one or more 3D objects by the 3D printing system, e.g., in a printing cycle. The control system may be configured to control maneuvering optical component(s) of optical assembly(s)(s) before, during (e.g., in real-time), and/or after operation of the 3D printer, e.g., to print one or more 3D objects (e.g., in a printing cycle). Examples of 3D printers, optical assemblies, optical components, controllers, related control system, related methods, apparatuses, systems, and program instructions (e.g., software) can be found in International Patent Application Serial No. PCT/US19/226364, filed on May 16, 2019, and in U.S. patent application Ser. No. 17/874,447 filed Jul. 29, 2022, each of which is incorporated herein by reference in its entirety.

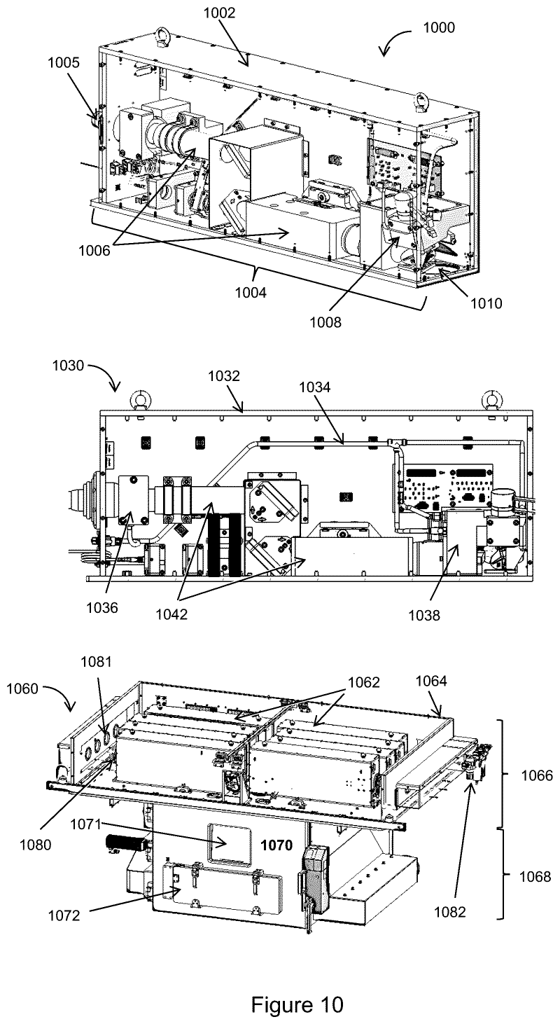

FIG. 10 depicts views of various components of a 3D printing system. As depicted in FIG. 10, an optical assembly 1000 comprises an optical housing 1002 enclosing (e.g., fully) an optical assembly 1004 including optical components. A portion of an optical path of an energy beam is enclosed by housing channels 1006. An optical assembly can comprise optical components comprising a mirror, lens, prism, beam splitter, collimator, or the like. Optical assembly 1004 comprises a scanner 1008. Optical assembly 1004 comprises a coupler 1005, e.g., a fiber-coupler or free space optics coupling, to direct light from an energy source, e.g., through an optical fiber from a laser source, into the optical assembly 1004. Optical assembly 1004 is configured to direct an energy beam along a beam path and through an opening in the optical housing 1002. When the optical assembly 1000 is aligned within an optical housing of an optical assembly and aligned with a processing chamber, optical assembly 1004 is configured to direct an energy beam along a beam path through opening 1010 and through an optical window located between the optical housing and the processing chamber such that the energy beam is directed toward a target surface disposed in the processing chamber, e.g., an exposed surface of a material bed.

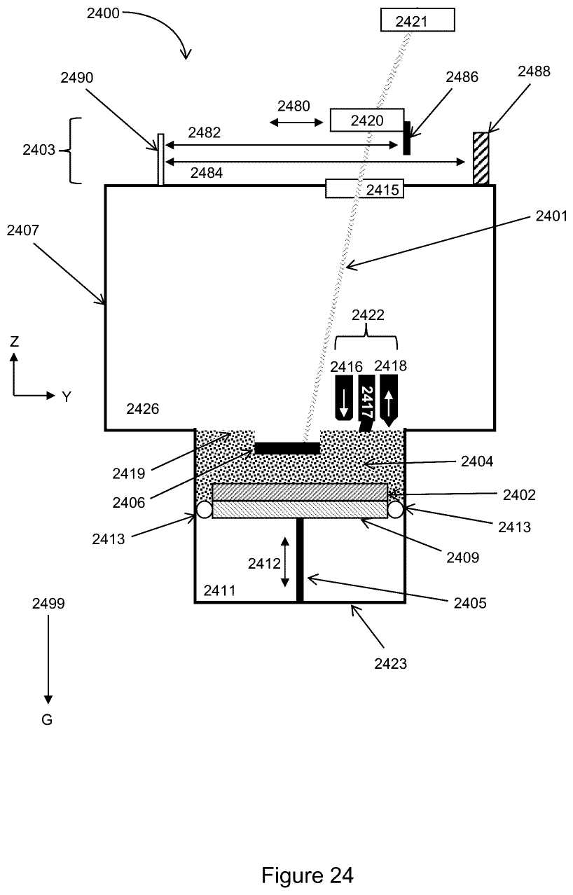

FIG. 10 depicts a schematic view 1030 example of a modular optical unit 1032, e.g., modular optical unit 1000. Modular optical unit 1032 comprises a cooling system 1034. Cooling system 1034 comprises coolant lines for directing coolant flow within the modular optical unit 1032. For example, coolant lines may be configured to distribute a coolant flow from an inlet of the cooling system 1034 to one or more components of the optical assembly. Cooling system 1034 can include water cooling and/or gas flow, e.g., to reduce a thermal load on one or more components of the optical assembly. Cooling system 1034 can provide cooling agent (e.g., water or gas) to a collimator 1036 and/or to portions of the scanner 1038, e.g., the actuators of the scanner. The cooling system 1034 can be configured to provide gas flow within the optical housing 1002. Cooling system 1034 can include a gas flow assembly, e.g., as described with reference to FIG. 24. The cooling system 1034 can provide a positive pressure (e.g., about 1 atmosphere or greater than 1 atmosphere) within the optical housing 1002. For example, cooling system 1034 can provide gas flow to one or more optical components, e.g., scanner 1038 of the optical assembly and/or provide a gas flow within one or more housing channels 1042 of the modular optical unit 1032. In some embodiments, the cooling system may be a temperature conditioning systems, the cooling lines may be lines configured to flow temperature conditioning agent(s), and the coolant comprises the temperature conditioning agent(s).

FIG. 10 depicts a schematic view 1060 of an optical assembly comprising eight optical assemblies such as 1062 (each with its own housing) arranged within an optical housing 1064 of an optical assembly 1066. The eight optical assemblies 1062 are each arranged within the optical housing 1064 to align each optical assembly such as 1062 with a respective optical window of the processing chamber 1068. For example, each optical assembly such as 1062 is arranged within the optical enclosure 1064 to align a beam path of an energy beam directed by an optical assembly of the optical assembly through an optical window of the processing chamber 1068 and toward a target surface (e.g., an exposed surface of a material bed) within the processing chamber 1068 having a primary door 1070 equipped with a viewing window 1071 and a secondary door 1072 (e.g., to a glove accessory). The eight optical assemblies (including optical units 1062) are each arranged within the optical enclosure 1064, e.g., to align each optical assembly with a respective energy source via an optical coupler of the optical assembly, e.g., optical coupler 1080 of optical assembly. An optical coupler 1080 can be, for example, a fiber-coupler or free-space optics. The optical couplers of the optical assemblies may be arranged with respect to ports such as port 1081 of the optical enclosure to allow for coupling between the optical couplers and respective energy sources, e.g., laser sources. For example, an optical coupler 1080 of an optical assembly is arranged with respect to a port to align an energy source with the optical coupler 1080.

In some embodiments, optical windows (e.g., and their corresponding window holders) are arranged symmetrically. The symmetry may comprise mirror symmetry, rotational axis symmetry (e.g., C₂ axis), or inversion symmetry. The symmetry may exclude inversion symmetry. For example, the optical window may be symmetrically disposed, which symmetry includes inversion symmetry. For example, the optical window holders may be symmetrically disposed, which symmetry may exclude inversion symmetry (e.g., due to a 3D shape of the window holder). The 3D shape of the window holder may comprise a hollow truncated cone, a hollow cylinder, or a hollow prism. The window holder may be closed on one of its open ends with the optical window. The optical windows (e.g., and their corresponding window holders) in the optical window arrangement may symmetrically relate to each other using one or more mirror symmetry planes, one or more rotational axis planes, and/or using an inversion point.

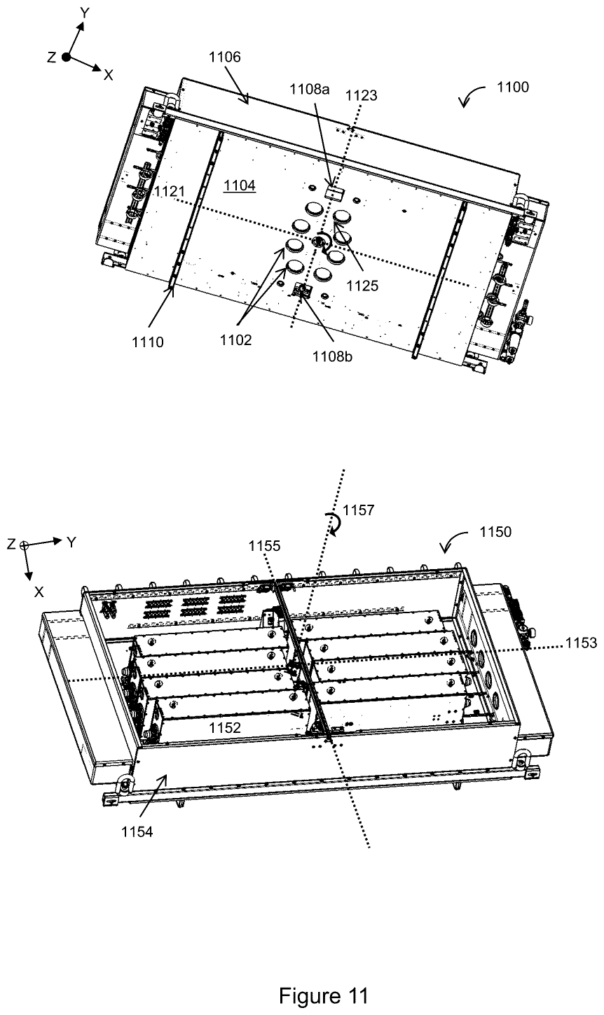

FIG. 11 shows schematic view of an example configuration of an optical system 1100 comprising optical window holders 1102 that are symmetrically arranged using symmetrical relations that include (i) a mirror symmetry plane parallel to the XZ plane and along dotted line 1121, (ii) a mirror symmetry plane parallel to the XZ plane and along dotted line 1123, (iii) a C₂ (180 degrees) rotational axis running through point 1125 and aligned parallel to the Z axis, (iv) a C₂ (180 degrees) rotational axis running along dotted line 1121, and (iv) a C₂ (180°) rotational axis running along dotted line 1123. The optical windows in the window holders 1102 would be similarly symmetrically related, except that they would also be related by an inverted symmetry through point 1125. Examples of 3D printers, optical assemblies, optical components, controllers, related control system, related methods, apparatuses, systems, and program instructions (e.g., software) can be found in International Patent Application Serial No. PCT/US22/016550 filed Feb. 16, 2022, which is incorporated herein by reference in its entirety.

As depicted in FIG. 11, window holders, e.g., window holders 1102, are arranged on a surface 1104 of an optical enclosure 1106 of the optical system 1100 located between the optical system 1100 and a processing chamber of a 3D printing system. Optical enclosure 1106 includes viewports 1108a and 1108b through which sensors, detectors, other optical beam(s), other optical measurement, and/or optical test equipment, may have line of sight of the target surface within the processing chamber. Optical enclosure 1106 includes mounting hardware, e.g., rails 1110, to affix or couple the optical enclosure 1106 to the processing chamber.

FIG. 11 shows an example configuration of an optical system 1150 comprising eight optical assemblies 1152 arranged within an optical enclosure 1154, e.g., optical enclosure 1106. Each of the optical assemblies such as optical assembly 1152 is enclosed in a housing, e.g., each of the optical assemblies such as optical assemblies 1062 of FIG. 10 is enclosed in a housing, the optical assemblies being arranged using symmetrical relationships including (i) a mirror symmetry plane perpendicular to an XZ plane along dotted line 1153 (ii) a mirror symmetry plane perpendicular to the XZ plane and along dotted line 1155, and/or (iii) a C₂ (180° (degrees)) rotation about axis 1157 and aligned parallel to the Y axis. Each of the optical assemblies (e.g., 1152) is arranged within optical enclosure 1154 such that an energy beam directed through an optical assembly is directed through an opening in the optical housing of the optical assembly 1152 and through an optical window retained by a corresponding optical window holder, e.g., optical window holder 1102. This discussion re symmetry relationship in FIG. 11 does not consider any couplers and/or ports, e.g., disposed at any end of the optical housing of an optical unit (e.g., optical FRU), or an interior arrangement in the optical housing, which may limit some of the symmetry relations.

In some embodiments, optical assemblies are arranged symmetrically as part of the optical system. The optical assemblies may be arranged symmetrically in an array of optical assemblies, e.g., a linear array or a two-dimensional array. The symmetries of the arrangement can be determined based at least in part on (i) the housing enclosing the component(s) of the optical assembly, (ii) the opening in the housing through which the energy beam is directed from in the optical assembly, (iii) an internal symmetry point of the optical assembly, or (iv) any combination thereof. The symmetry may comprise mirror symmetry, rotational axis symmetry (e.g., C₂ axis), or inversion symmetry. The symmetry may exclude inversion symmetry. For example, the optical assembly may be symmetrically disposed, which symmetry includes inversion symmetry. The optical assemblies in an array of optical assemblies may symmetrically relate to each other using one or more mirror symmetry planes, one or more rotational axis planes, and/or using an inversion point.

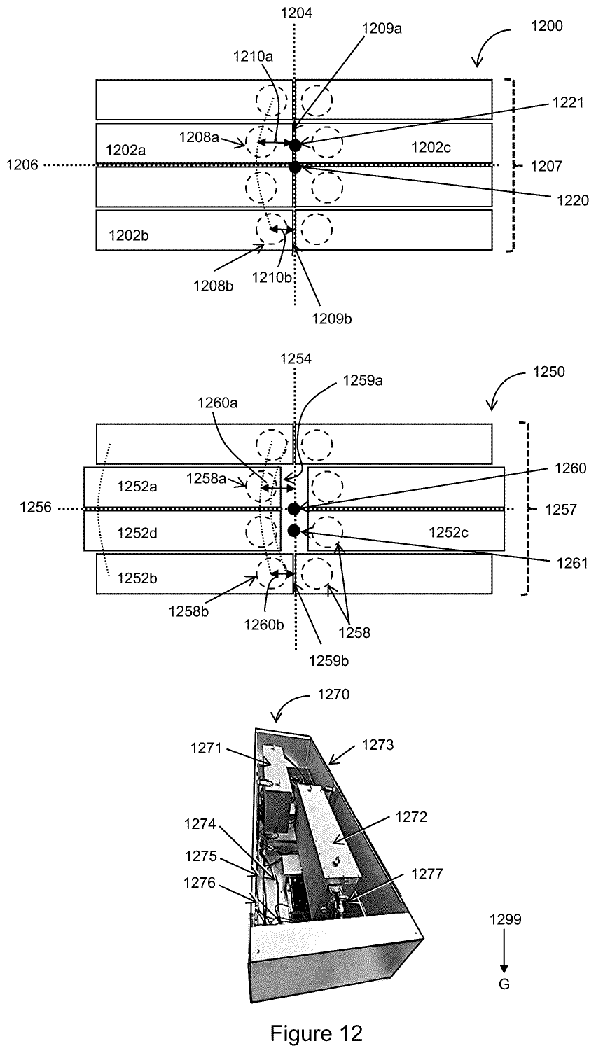

FIG. 12 schematically illustrates various 3D printer components. As depicted in FIG. 12, an arrangement 1200 of an array of optical assemblies 1207 (each having a housing), can align the optical assemblies symmetrically about a first mirror plane 1204 and about a second mirror plane 1206. As depicted, an optical assembly 1202a is oriented with respect to an optical window 1208a that is different than an orientation of at least one other optical assembly 1202b with respect to another optical window 1208b. For example, the optical window 1208a with respect an edge 1209a of the optical assembly 1202a has a first offset 1210a perpendicular to the first mirror plane 1204 and optical window 1208b with respect to an edge 1209b of the optical assembly 1202b has a second, different offset 1210b perpendicular to the first mirror plane 1204. Edge 1209a of the optical assembly 1202a and edge 1209b of the optical assembly 1202b are aligned with the first mirror plane 1204. The array of optical assemblies 1202 can be related via a C₂ rotational axis going through point 1220. Each horizontal pair of optical assemblies is related to each other via a C₂ symmetry axis. For example, optical assembly 1202a is related to optical assembly 1202c via the C₂ symmetry axis going through point 1221. This discussion regarding symmetry relationship in FIG. 12 does not consider any couplers and/or ports, e.g., disposed at any end of the optical assembly, or an interior arrangement in the optical assemblies, which may limit some of the symmetry relations.

As depicted in the example shown in FIG. 12, an arrangement 1250 of an array of optical assemblies 1252 can align the optical assemblies symmetrically about a first mirror plane 1254 and about a second mirror plane 1256. As depicted, the array of optical assemblies 1257 (each having a housing) are oriented with respect to respective optical windows such as optical windows 1258 in a similar orientation. For example, an edge 1259a of the optical assembly 1252a has a first offset 1260a perpendicular to the first mirror plane 1254 and an edge 1259b of the optical assembly 1252b has a second, offset 1260b perpendicular to the first mirror plane 1254. The array of optical assemblies 1252 can be related via a C₂ rotational axis going through point 1260. Each horizontal pair of optical assemblies is related to each other via a C₂ symmetry axis. For example, optical assembly 1252d is related to optical assembly 1252c via the C 2 symmetry axis going through point 1261. This discussion regarding symmetry relationship in FIG. 12 does not consider any couplers and/or ports, e.g., disposed at a rear side of the optical enclosure, or an interior arrangement in the optical enclosure, which may limit some of the symmetry relations.

In some embodiments, the optical assemblies are arranged in pairs. A pair of optical assemblies may be arranged in an optical enclosure. In some embodiments, several pairs of optical assemblies are operatively coupled with the processing chamber, e.g., to a ceiling of the processing chamber. The several pairs may be enclosure in an optical enclosure. At least one pair (e.g., each of the pairs) of the several pairs may be enclosed in its own optical enclosure.

FIG. 12 shows in example 1270 a perspective photographic view of an optical enclosure 1273 comprising two optical assemblies—a first optical assembly enclosed in a first housing 1271, and a second optical assembly enclosed in a second housing 1272. Each of the optical assemblies is connected via cabling such as cabling 1276, to an electrical source. Temperature conditioner (e.g., coolant) is directed to each of the optical assemblies through channels such as channel 1274. The temperature conditioner may condition one or more components of the optical assembly such as mirrors, e.g., the galvanometer scanner mirrors. Gas may be directed to each of the housings, e.g., to reduce contamination of the optical components of the optical assemblies and/or to condition temperature of various components of the optical assembly, e.g., scanner mirror(s) and/or lens(es). A laser beam is guided to each of the optical assemblies by optical fiber connected to a coupler such as 1277. Gas (e.g., dry clean air) is guided to each of the optical assemblies by channels such as 1275. Optical enclosure 1270 can be configured to be reversibly removed from and coupled to a processing chamber, e.g., as disclosed herein. Example 1270 is disposed relative to gravitational vector 1299 pointing towards gravitational center G of the ambient environment.

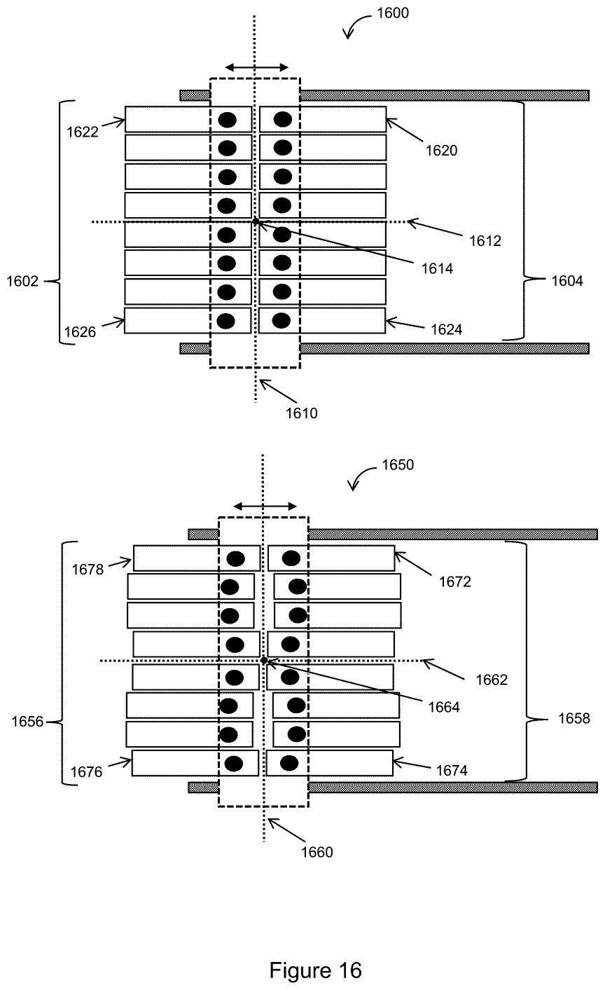

At times, the optical assemblies may be arranged in an array, e.g., a one-dimensional array or a two-dimensional array. FIG. 16 depicts a two-dimensional array of optical assemblies 1600, which includes two one-dimensional arrays 1602, 1604 (e.g., linear arrays) of optical assemblies (e.g., optical assemblies 1620, 1624) aligned parallel with respect to each other. At times, a two-dimensional array of optical assemblies comprises a wavy array. FIG. 16 depicts a two-dimensional array of optical assemblies 1650 arranged in a wavy array, where a distance from a same point of at least two optical assemblies (e.g., optical assemblies 1672, 1674) of the optical assemblies to a common axis is different. Two-dimensional array of optical assemblies 1650 includes two one-dimensional arrays 1656, 1658 (e.g., curved arrays). The arrays of optical assemblies 1600 and 1650 are arranged with respect to each other such that at least two optical assemblies 1620, 1624 and 1672, 1674 (e.g., pairs of optical assemblies) of respective arrays of optical assemblies 1600 and 1650 are symmetrically arranged with respect to each other. Array of optical assemblies 1600 includes symmetry axes 1610, 1612, and 1614. A mirror symmetry plane can be disposed between two optical assemblies of a pair of optical assemblies. For example, an optical assembly 1620 is related to optical assembly 1622 via a mirror symmetry plane 1610. For example, optical assembly 1620 is related to optical assembly 1624 via mirror symmetry plane 1612. A rotational symmetry axis can be disposed between two optical assemblies of a pair of optical assemblies. For example, optical assembly 1620 is related via a C₂ rotational symmetry to optical assembly 1626 via symmetry axis 1614. Array of optical assemblies 1650 includes symmetry axes 1660, 1662, and 1664. A mirror symmetry plane can be disposed between two optical assemblies of a pair of optical assemblies. For example, an optical assembly 1672 is related to optical assembly 1678 via a mirror symmetry plane 1660. For example, optical assembly 1672 is related to optical assembly 1674 via mirror symmetry plane 1662. A rotational symmetry axis can be disposed between two optical assemblies of a pair of optical assemblies. For example, optical assembly 1672 is related via a C₂ rotational symmetry to optical assembly 1676 via symmetry axis 1664.

At times, a 3D printing system comprises a build platform sufficient to accommodate and support 3D object(s) during a print cycle. At least one FLS of the build platform of the 3D printer may be at least about 1200 millimeters (mm), about 1500 mm, about 1750 mm, 1900 mm, 2000 mm, or greater. An FLS of the build platform (e.g., diameter) may be larger than a processing region of an optical system, e.g., larger than the accessible field(s) of view of the processing cone(s) of respective energy beam(s) of an optical system at the target surface supported by the build platform. At times, the build platform comprises a cross-sectional shape, e.g., perpendicular to a build direction, e.g., and perpendicular to a gravitational vector pointing towards a gravitation center (e.g., the Earth). The cross-sectional shape can comprise a geometric shape. The geometric shape may comprise a, elliptical, rectangular, or polygonal shape. The cross-sectional shape may comprise an irregular shape. For example, the cross-sectional shape of the build platform can be circular. For example, the cross-sectional shape of the build platform can be a square. At least one FLS (e.g., a diameter of a circular build platform or a width of a rectangular build platform) may span at least about 0.5 meters (m), 0.8 m, 1.0 m, 1.2 m, about 1.5 m, 1.8 m, 2.0 m, 2.5 m, 3.0 m, or more. For example, a diameter of a build platform may be at least about 0.5 meter, and a length of the build platform may be at least about 2 meters. At least one FLS may span any value between the aforementioned values (e.g., from about 0.5 m to about 3 m, from about 0.5 m to about 1.5 m, or from about 1 m to about 3 m). At times, the build platform may comprise anchor features. The anchor features may comprise texture on one or more surfaces of the build platform (e.g., on a surface supportive of the target surface of the material bed). Texture, e.g., surface texture, of the surface of the build platform can facilitate adherence of transformed material to the build platform during a three-dimensional printing process. The anchor features may comprise rigid and/or semi-rigid (e.g., flexible) structures. The rigid and/or semi-rigid structures may be affixed (e.g., adhered) to or a part of the build platform. The anchor features may be utilized during one or more three-dimensional processes to provide support for pre-transformed and/or transformed material supported by the build platform. In some embodiments, the build platform is devoid of anchor features. The build platform may be located within the enclosure such that at least one optical window is positioned to provide line-of-sight to at least a portion of a target surface supported by the build platform. For example, at least one optical window can be located on a ceiling (e.g., a top surface or a roof) of the enclosure such that a portion of the target surface is optically visible through the optical window. In some embodiments, a plurality of optical windows, e.g., an array of optical windows, may be arranged on a ceiling of the enclosure such that the optical windows provide a respective optical line-of-sight into the enclosure, e.g., of a respective portion of the target surface disposed above the build platform.

In some embodiments, in order to have coverage of a larger target surface, an optical system comprises translatable (e.g., movable) system. The optical system may be dynamically translatable. The translatable optical system may be operatively coupled with a translation mechanism, e.g., including at least one actuator. The translatable optical system may extend a processing region or include processing regions that are accessible by the energy beam(s) of the translatable optical system at the target surface, e.g., respectively. The extended accessibility may thereby cover a greater fraction (e.g., all) of the build platform. The translation mechanism may be configured to receive an array of optical assemblies with respect to the translation mechanism. The translation mechanism may be configured to support (e.g., and affix) the array of optical assemblies with respect to the translation mechanism. The translation mechanism may receive and/or support the array of optical assemblies, for example, on a structure comprising a support plate, mount, or fixture. The optical assemblies may be configured to each direct an energy beam towards a target surface within the processing chamber. A number of optical assemblies in an optical system may comprise an odd number of optical assemblies or an even number of optical assemblies. A number of optical assemblies in an optical system may comprise at least about two, four, eight, twelve, sixteen, twenty, twenty-four, twenty-eight, thirty-two, thirty-six, or more optical assemblies. At least two (e.g., each) optical assembly of the plurality of optical assemblies may be configured to direct an energy beam towards a sub-region of the target surface. For example, a plurality of energy beams may be directed towards respective sub-regions of the target surface by respective optical assemblies. The optical assemblies may be arranged with respect to each other such that at least two optical assemblies (e.g., a pair of optical assemblies) of an array of optical assemblies are symmetrically arranged with respect to each other. Symmetrically arranged may comprise, for example, a rotational symmetry axis or a mirror symmetry axis. The rotational symmetry axis can be disposed between the two optical assemblies of the pair of optical assemblies. The mirror symmetry plane can be disposed between the two optical assemblies of the pair of optical assemblies. In some embodiments, the rotational symmetry axis and/or the mirror symmetry plane are perpendicular (i) to a plane in which an optical windows are disposed, (ii) to the target surface and/or (iii) to the plane in which the optical assemblies are disposed. In some embodiments, the rotational symmetry axis is parallel (i) to a plane in which an optical windows are disposed, (ii) to the target surface and/or (iii) to the plane in which the optical assemblies are disposed. The rotational symmetry axis can be perpendicular or parallel to the gravitational vector pointing towards the environmental gravitational vector. The mirror plane can include the gravitational vector pointing towards the environmental gravitational vector. The rotational symmetry axis may comprise a C2 (e.g., 180 degrees), C3 (e.g., 120 degrees), or C4 (e.g., 90 degrees) symmetry axis. At least two of the optical assemblies may be arranged asymmetrically with respect to each other. The optical assemblies may be arranged with respect to each other such that immediately adjacent optical assemblies may have a pitch that is at least about 140 millimeters (mm), 155 mm, 160 mm, 165 mm, 170 mm, 180 mm, 190 mm, 200 mm, 225 mm, or more. For example, immediately adjacent optical assemblies are devoid of without another optical assembly disposed there between. The pitch can be a distance from a central axis of a first optical assembly to a central axis of a second optical assembly. The pitch between adjacent optical assemblies may be any value between the aforementioned values. For example, from about 140 mm to about 190 mm, from about 165 mm to about 200 mm, or from about 170 mm to about 225 mm. A gap between adjacent optical assemblies, e.g., between an outer surface of a housing of an optical assembly and an outer surface of a housing of an adjacent optical assembly may be at most about 150 mm, 100 mm, 85 mm, 75 mm, 65 mm, 50 mm, 40 mm, 30 mm, 25 mm, 15 mm, 10 mm, 5 mm, 2 mm, 1 mm, 0.5 mm, or (e.g., substantially) zero mm. The gap between adjacent optical assemblies may be any value between the aforementioned values, for example, from about 150 mm to about 25 mm, from about 30 mm to about 2 mm, or from about 10 mm to about zero mm. At times, the optical assemblies may be arranged in an array, e.g., a one-dimensional array or a two-dimensional array. A one-dimensional array of optical assemblies may comprise a linear array, e.g., where the optical assemblies are aligned in a line with respect to an axis. A one-dimensional array of optical assemblies may comprise a wavy array, e.g., where a distance from a same point of at least two optical assemblies of the optical assemblies to a common axis is different. For example, the optical assemblies may be arranged with respect to a central axis such that the fields of view of the respective energy beams are disposed along a curvature with respect to the target surface. The optical assemblies may be a two-dimensional array comprises two or more one-dimensional arrays of optical assemblies arranged with respect to each other. For example, the two-dimensional array of optical assemblies may comprise at least two linear arrays of optical assemblies or at least two wavy arrays of optical assemblies arranged adjacent to each other, e.g., such that the respective axis of each one-dimensional array is parallel. A spacing between each one-dimensional array in a two-dimensional array of optical assemblies, e.g., in a direction perpendicular to the respective axes of the one-dimensional arrays, may be at least about (e.g., substantially) zero millimeters (mm), 0.5 mm, 1 mm, 2 mm, 5 mm, 10 mm, 15 mm, 25 mm, 30 mm, 40 mm, 50 mm, 65 mm, 75 mm, 85 mm, 100 mm, 150 mm, 500 mm, 800 mm or more. The spacing between each one-dimensional array of the two-dimensional array may be any value between the aforementioned values, for example, from about zero mm to about 25 mm, from about 15 mm to about 100 mm, or from about 65 mm to about 800 mm. The optical assemblies may be arranged with respect to each other to reduce a cross-contamination by debris such that debris generated by a respective energy beam of each optical assembly during a three-dimensional printing process in its field of view may have a minimal impact on each other optical assembly of the optical assemblies. The energy beams may print the 3D object(s) such that the debris may minimally cross contaminate another energy beam's field of view. Reduce the cross contamination by the debris may include substantially and/or measurably eliminate the cross contamination by the debris. Minimal may comprise a substantially negligent or non-measurable. Substantially negligent may be with respect to the intended purpose of the printed 3D object(s). At times, the spacing between adjacent (e.g., immediately proximate) one-dimensional arrays of optical assemblies may be selected to minimize (e.g., significantly reduce) a quantity of downstream interactions between energy beams from the respective optical assemblies that are incident on a target surface. For example, to reduce an amount of contamination (e.g., from debris) generated by a first energy beam during printing from affecting a second energy beam at (e.g., or proximate to) the target surface, the first and second energy beams being directed by the optical system of optical assemblies. For example, to reduce an amount of contamination (e.g., from debris) generated by first energy beams corresponding to optical assemblies of a first one-dimensional array of optical assemblies from affecting second energy beams corresponding to optical assemblies of a second one-dimensional array of optical assemblies at (e.g., or proximate to) the target surface, the optical assemblies of the first one-dimensional array and the optical assemblies of the second one-dimensional array being of the optical system of optical assemblies.

At times, gas flow is utilized to reduce contamination by downstream interactions between energy beams from respective optical assemblies that configured to project energy beams incident on the target surface. For example, a gas flow from any of the gas flow system, gas flow assembly, or gas flow mechanism such as the ones disclosed herein. Localized gas flow may be utilized to reduce contamination between the adjacent arrays of optical assemblies. The localized gas flow may be located before, after, and/or between immediately adjacent arrays of optical assemblies. In some embodiments, the localized gas flow is located between immediately adjacent arrays of optical assemblies. For example, the localized gas flow is located between two single files of optical assemblies that are immediately adjacent to each other (without any intervening single file of optical assemblies therebetween). An array of optical assemblies may have at least one dedicated gas inlet and/or at least one gas outlet. The gas inlet(s) and/or outlet(s) may to (e.g., substantially) maintain, or aid in maintaining, cleanliness of processing volume (e.g., cone or truncated cone) of energy beam(s) utilized during the 3D printing at the time of their utilization, the energy beam(s) being directed by the array of the optical assembly/ies. The cleanliness of the processing volume comprising cleanliness from debris. Cleanliness of the processing region from debris may be to a substantial level such that the debris may negligently and/or insubstantially affect the generated 3D object(s), e.g., as to their intended purpose. The dedicated gas inlet(s) and/or gas outlet(s) may generate an isolated dedicated gas flow in the sub-region. The dedicated gas flow may be separate from (e.g., or in addition to) a gas flow in an adjacent (e.g., immediately proximate) sub-region of the target surface accessible by an energy beam of another array of the optical assemblies. For example, at least one of the arrays (e.g., linear arrays) of optical assemblies may have a dedicated gas inlet and/or gas outlet to substantially reduce the contamination within the sub-region from debris generated by at least one other array of optical assemblies. For example, at least one of the arrays (e.g., linear arrays) of optical assemblies may have a dedicated gas inlet and/or gas outlet to substantially maintain cleanliness of a processing volume of at least one sub-region of at least one array of optical assembly/ies from contamination with debris generated by the energy beams of another one-dimensional array within a respective sub-region of the target surface.

At times, a gas inlet and/or gas outlet may be translatable, e.g., translatable with respect to the target surface within the enclosure. The gas inlet and/or gas outlet may be translatable in a manner that is coordinated with a translatable optical system, e.g., such that the gas inlet and/or gas outlet are arranged with respect to position(s) of energy beams incident on the target surface from the optical assemblies of the optical system. For example, the gas inlet and/or gas outlet may be arranged adjacent to (e.g., proximate to) a sub-region accessible by the energy beam(s) of the optical assemblies on the target surface. The gas inlet and/or gas outlet may be translatable in a direction perpendicular to a translation movement of the optical system or perpendicular to the direction of translation of the optical system. The gas inlet and/or gas outlet may be moveable with respect to a layer dispensing mechanism, e.g., to avoid collision or interference with operation(s) of the layer dispensing mechanism. At times, a localized gas flow, e.g., located between adjacent optical assemblies, is utilized to reduce contamination between the adjacent optical assemblies.

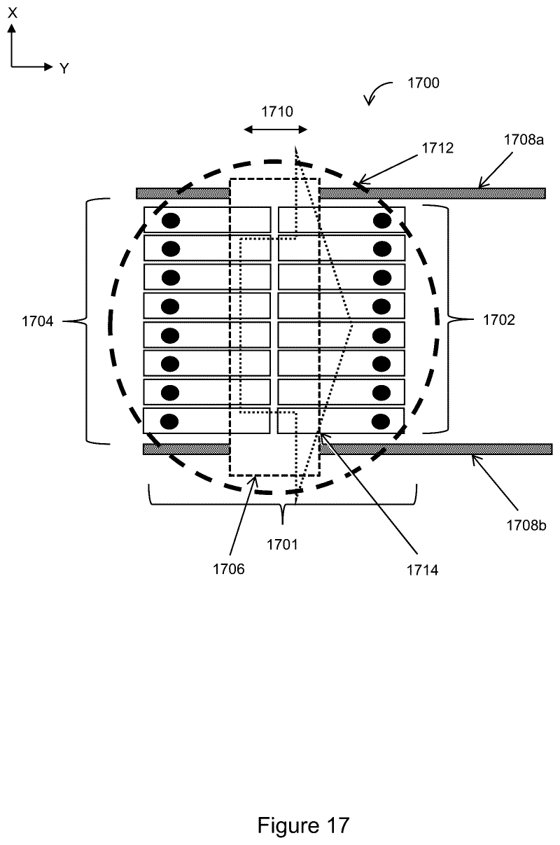

FIG. 17 depicts a schematic example of localized gas flow with respect to a target surface aligned with an optical system. An optical system 1700 includes an array of optical assemblies 1701 including two linear arrays of optical assemblies 1702, 1704. The optical assemblies of the array of optical assemblies 1701 are configured to reversibly engage and disengage with support mount 1706. The support mount 1706 is coupled to a guidance system comprising rails 1708a, and 1708b. The guidance system is configured to translate along a direction 1710, e.g., along a Y-axis, with respect to a target surface 1712 within an enclosure (not shown). A flow of gas 1714 is provided immediately between linear arrays of optical assemblies 1704 and 1702, e.g., without any additional linear arrays located between linear arrays of optical assemblies 1702 and 1704. The flow of gas 1714 includes a dedicated gas inlet (not shown) and/or gas outlet (not shown) to (e.g., substantially) reduce debris present in a processing volume of the energy beams of the linear array of optical assemblies 1702 from the linear array of optical assemblies 1704. For example, the gas flow may facilitate a clean(er) processing region of the energy beam(s) to (i) deter compromising the energy beam(s) on their way to sub regions of the target surface, and/or (ii) (e.g., substantially) preserve the energy beam(s) propagating to sub region(s) of the target surface.

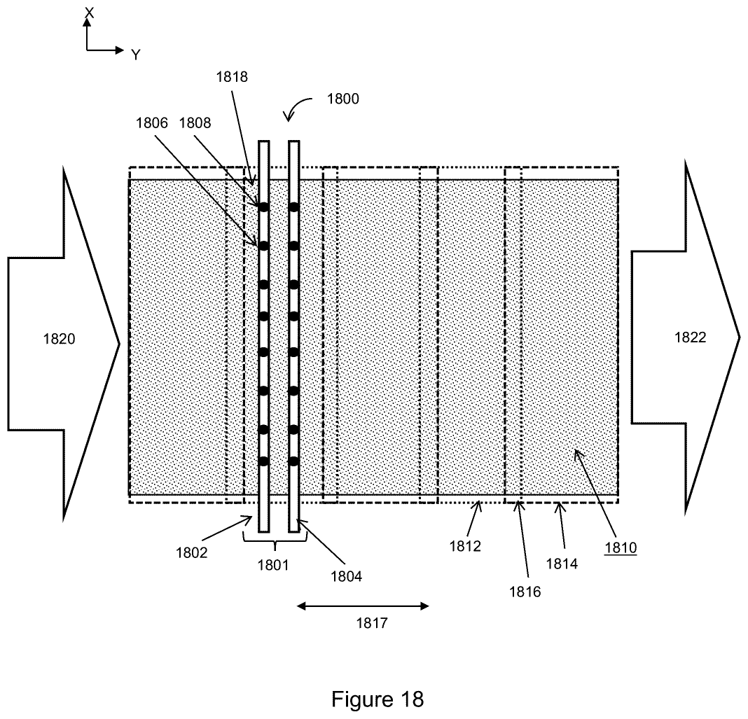

At times, a flow of gas is utilized to reduce contamination between adjacent processing volumes of energy beams. FIG. 18 depicts a schematic example of a gas flow in a direction across a target surface. An optical system 1800 is partially depicted in FIG. 18 as an array of openings 1801 depicted as black circles, with each opening corresponding to an opening in an optical assembly, which opening is configured to (i) allow energy beam(s) to travel therethrough and towards the target surface, and (ii) align with an optical window. The array of openings thus corresponds to an array of optical assemblies. An example of an opening in an optical assembly is depicted in FIG. 10, 1010. The array of openings 1801 includes two linear opening arrays 1802, and 1804 corresponding to two linear arrays of optical assemblies, respectively. The array of optical assemblies corresponding to the array of openings 1801 includes a plurality of optical assemblies corresponding to circular windows (e.g., windows 1806, 1808), where the windows are configured to allow respective energy beams to impinge on a target surface 1810. The target surface 1810 includes several consolidated processing regions, e.g., regions 1812, 1814, each being a consolidated processing region. Each of consolidated processing regions 1812 and 1814 includes overlapping sub-regions of energy beams, e.g., similar to that of FIG. 9, example 980. Adjacent consolidated processing regions include an area of overlap, e.g., area of overlap 1816 between consolidated processing regions 1812 and 1814. The array of optical assemblies corresponding to the array of openings 1801 is translatable along directions 1817, e.g., along a Y-axis. The array of optical assemblies corresponding to the array of openings 1801 is translatable to align with processing regions of the target surface 1810, e.g., consolidated processing region 1818. A gas flow in a direction across the target surface 1810 can be optionally introduced via a gas flow inlet 1820. The gas flow can flow in the direction across the target surface 1810 and be purged via a gas flow outlet 1822. The gas flow inlet 1820 and gas flow outlet 1822, as depicted in FIG. 18, are located on opposing sides of the target surface 1810, e.g., opposing sides with respect to the Y-axis. The gas flow can flow in the direction of propagation of the optical system (including openings array 1801 corresponding to an optical assembly array), or in a direction opposite thereto. In FIG. 18, the optical array assemblies corresponding to openings array 1801, translates along directions 1817. The target surface has uneven sides or axes. FIG. 18 shows an example of a rectangular target surface having longer and shorter sides. The target surface can be an ellipse having a longer axis and a shorter axis. In other embodiments, the target surface may be evenly sided (e.g., a rectangle or a circle). In the example shown in FIG. 18, the gas flow inlet 1820 and gas flow outlet 1822 are configured to provide gas flow in a direction across a length of the target surface, e.g., along the X-axis. As depicted in FIG. 18, the gas flow inlet 1820 and gas flow outlet 1822 extend a full length along the X-axis of the target surface 1810.

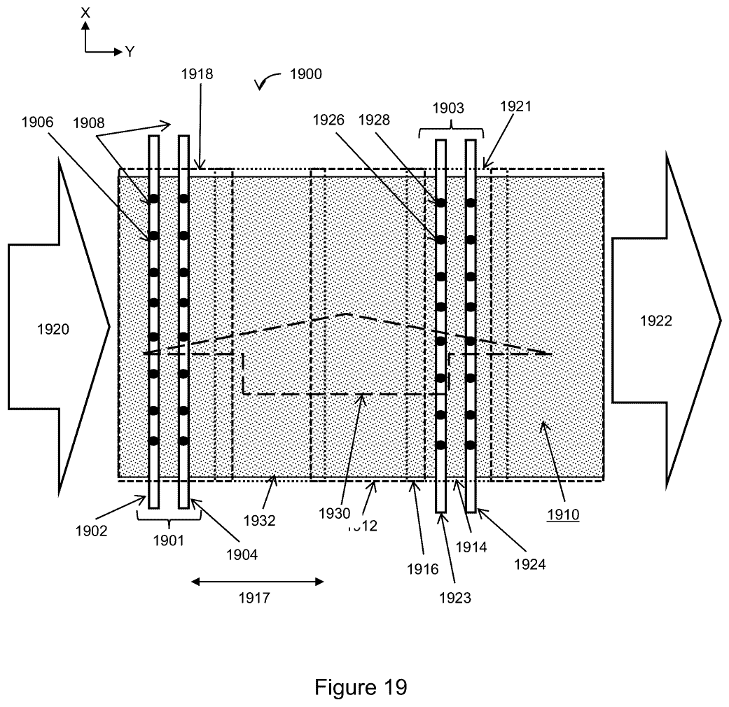

At times, a localized gas flow, e.g., located between adjacent arrays of optical assemblies, is utilized to reduce contamination between processing volumes corresponding to energy beams emitted from the adjacent arrays of optical assemblies. FIG. 19 depicts an illustrative example of a gas flow in a direction across a target surface. An optical system 1900 is partially depicted in FIG. 19 as a first array of openings 1901 and a second array of openings 1903, each opening corresponding to an optical assembly. Array of openings 1901 includes two linear arrays 1902, 1904. The array of openings 1901 that corresponds a plurality of optical assemblies, corresponding to circular windows (e.g., windows 1906, 1908), where the windows are configured to allow respective energy beams to impinge on a target surface 1910. The array of openings 1903 corresponds to two linear arrays 1923 and 1924 of openings. The array of openings 1903 corresponds to a plurality of optical assemblies, includes circular windows (e.g., windows 1926, 1928), where the windows are configured to allow respective energy beams to impinge on the target surface 1910. The target surface 1910 includes consolidated processing regions, e.g., with regions 1912, 1914 each being a consolidated processing region. Adjacent consolidated processing regions include an area of overlap, e.g., area of overlap 1916 between consolidated processing regions 1912 and 1914. The arrays of openings 1901, 1903 corresponding to arrays of optical assemblies are (e.g., separately, or jointly) translatable along directions 1917, e.g., along a Y-axis back and/or forth. The array of openings 1901 corresponding to an array of optical assemblies, is translatable to align with consolidated processing regions of the target surface 1910, e.g., consolidated processing region 1918. The array of openings 1903 corresponding to an array of optical assemblies, is translatable to align with processing regions of the target surface 1910, e.g., consolidated processing region 1921. A gas flow in a direction across the target surface 1910 can be introduced via a gas flow inlet 1920. The gas flow can flow in a direction across the target surface 1910 and be purged via a gas flow outlet 1922. The gas flow inlet 1920 and gas flow outlet 1922, as depicted in FIG. 19, are located on opposing sides of the target surface 1910, e.g., opposing sides with respect to the Y-axis. The gas flow inlet 1920 and gas flow outlet 1922 are configured to provide gas flow across a length of the target surface, e.g., along the X-axis. As depicted in FIG. 19, the gas flow inlet 1920 and gas flow outlet 1922 extend a full length along the X-axis of the target surface 1910. A gas flow 1930 can be introduced in a direction (e.g., substantially) perpendicular direction 1917 of translation of the array of optical assemblies, e.g., along the X-axis. As depicted, gas flow 1930 can substantially flow across an area of the target surface 1910 between the adjacent arrays of optical assemblies, e.g., between array of openings 1901 and 1903, each associated by an array of optical assemblies, for example, across consolidated processing regions 1912 and 1932. Gas flow 1930 can be utilized to reduce contamination (e.g., by debris) from affecting a three-dimensional printing processes performed by energy beam directed by the array of openings 1903 associated with respective optical assemblies.

At times, the optical assemblies operatively couple to a translation mechanism facilitating translation of the optical assemblies at least during printing, e.g., before, during, and/or after a 3D printing process. The translation mechanism may comprise a mounting support (e.g., a mounting plate). The translation mechanism may comprise a guidance system having a directing component for the translation path such as a railing system (e.g., at least one rail). The mounting support may be configured to support optical assemblies (e.g., an array of optical assemblies), for example, may be configured such that the optical assemblies may be reversibly affixed and released from the mounting support, e.g., individually and/or collectively. Reversibly affixed may comprise sufficiently restricting vibrational movement of the optical assemblies before, during, and/or after translation of the translation mechanism. The translation mechanism may comprise fixture(s) for reversibly affixing and releasing the optical assemblies (e.g., individually and/or collectively) with respect to the mounting support. Fixture(s) may comprise a form of mechanical, electro-magnetic, magnetic, or chemical bonding of the optical assemblies with respect to the mounting support. Fixture(s) may comprise, latches, mounting hardware, adhesives, non-slip pads, locks, pins, electro-magnets, screws, bolts, snap fastener, or snap lock. In some embodiments, the fixture(s) are devoid of screw(s). The fixtures may be configured to reversibly engage and disengage the optical assembly with the mounting support, e.g., to reliably and reversibly secure and release the optical assembly while (e.g., substantially) maintaining an alignment of the optical assembly, for example, (e.g., substantially) maintaining an internal alignment of one or more optical components of the optical assembly. The optical assemblies, e.g., an array of optical assemblies, may be arranged with respect to the mounting support and supported by the mounting support such that the optical assemblies are retained at a minimal distance above the optical window(s) of the enclosure. A distance (e.g., along a gravitational vector) between a bottom surface of the optical assembly and a closest surface of a corresponding optical window can be at most about 50 millimeters (mm), 25 mm, 20 mm, 10 mm, 5 mm, 2 mm, 0.5 mm, or less. The distance between the bottom surface of the optical assembly and the closest surface of the corresponding optical window can be any value between the aforementioned values, for example, from about 50 mm to about 10 mm, from about 20 mm to about 5 mm, or from about 10 mm to about 0.5 mm. The build platform may be disposed in the enclosure (e.g., including a processing chamber in atmospheric contact with a build module), e.g., with respect to optical window(s) of the enclosure, to facilitate transmission of the energy beam from one environment to another with minimal change such as energy loss.

At times, the translation mechanism comprises a guidance system such as a railing system. The translation guidance system may comprise, or be coupled to, the mounting support such that the mounting support may translate via the translation guidance (e.g., the railing system). The railing system may comprise at least one rail. The railing system may comprise at least two rails. The rails of the railing system may be parallel with respect to one another. The translation guidance system may facilitate translation along at least one direction, e.g., along an X-axis or Y-axis that are perpendicular to a gravitational vector. The translation guidance system may facilitate translation in multiple (e.g., at least two) degrees of freedom. The translation guidance system may facilitate translation about a rotational axis, e.g., rotation about a z-axis aligned with the gravitational vector of the environment. The railing system may or may not comprise a labyrinth railing. The railing system may comprise a non-labyrinth railing. The translation guidance system may comprise, or be operatively coupled to, an actuator. An actuator may comprise any actuator disclosed herein, e.g., a servo motor. The translation guidance system may comprise, or be operatively coupled to, an encoder, e.g., any encoder disclosed herein. The encoder may comprise a linear encoder or optical encoder. The encoder may be configured to provide positional information related to the translation mechanism, e.g., a relative or absolute position of the support mount. At least one rail of the railing system may comprise a respective motor configured for independent position control. At least one rail of the railing system may comprise a respective motor, where at least two rails of the railing system may comprise coupled motors for linked and/or synchronized position control. The translation guidance system may comprise one or more bearings. The bearings may comprise ball bearings, roller bearings, mounted bearings, or linear bearings.

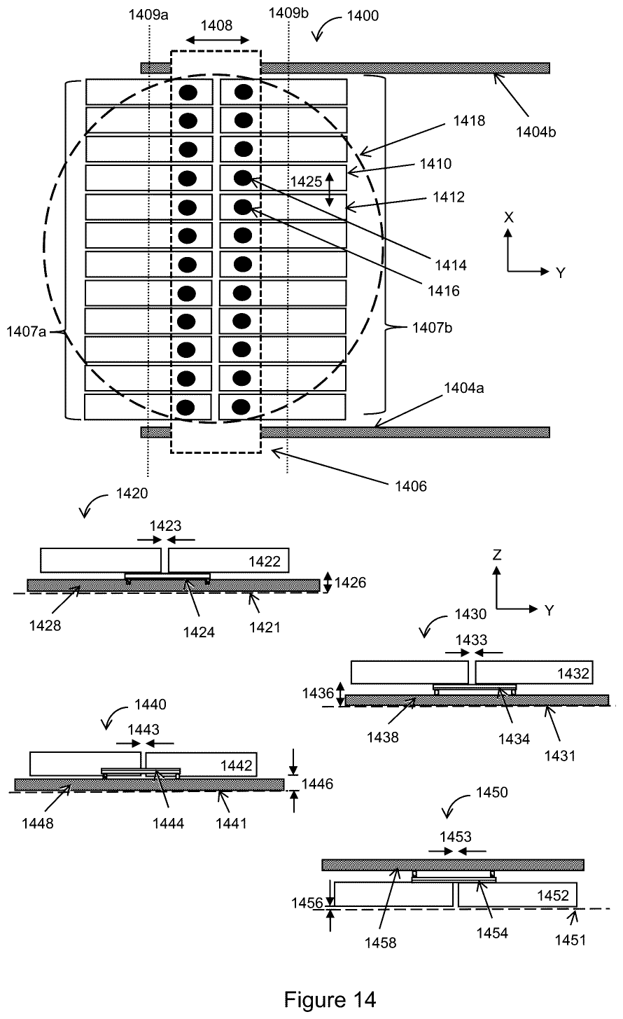

At times, an array of optical assemblies is reversibly engaged and disengaged with a support mount, e.g., such that respective housings of the optical assemblies of the array of optical assemblies are partially (e.g., a portion) supported by the support mount. At times, an array of optical assemblies is modularly engaged and/or disengaged with a support mount. FIG. 14 depicts a schematic example of a translatable optical system 1400. Translatable optical system 1400 includes a guidance system (e.g., rail system) including rails 1404a, 1404b. A support mount 1406 is operatively coupled with the rails 1404a, 1404b such that the support mount may translate along rails 1404a, 1404b along a direction 1408, e.g., aligned with the Y-axis. Rails 1404a, 1404b and/or support mount 1406 may be operatively coupled with an actuator (e.g., a motor) and an encoder (e.g., an optical encoder), not shown. The support mount 1406 is operatively coupled with (e.g., engaged with) optical assemblies, e.g., optical assemblies 1410, 1412. The optical assemblies are arranged in respective linear arrays 1407a, 1407b, where the optical assemblies of each linear array are arranged along a respective central axis 1409a, 1409b. The optical assemblies may be modularly and/or reversibly engaged with the support mount 1406 by fixtures, e.g., mounting hardware. The support mount 1406 can align the windows of the optical assemblies, e.g., windows 1414 and 1416, with respect to a target surface 1418 within an enclosure. As depicted, a portion of each optical assembly is engaged with (e.g., supported by) the support mount 1406. A pitch 1425 of the optical assemblies, e.g., optical assemblies 1410 and 1412, is defined along the X-axis from a central line of optical assembly 1410 to a central line of optical assembly 1412. FIG. 14 depicts example schematic side-views, e.g., a cross-section along the YZ plane, of translatable optical systems 1420, 1430, 1440, and 1450. The translatable optical systems 1420, 1430, 1440, and 1450 include optical assemblies, e.g., 1422, 1432, 1442, and 1452, respectively. The optical assemblies are separated from each other along the y-axis by a gap 1423, 1433, 1443, and 1453, respectively. The optical systems 1420, 1430, 1440, and 1450 are arranged to translate optical assemblies, e.g., optical assemblies 1422, 1432, 1442, and 1452, respectively) at a distance (e.g., distance 1426, 1436, 1446, and 1456, respectively) between a bottom surface of an optical assembly and a top (e.g., nearest) surface of the enclosure, e.g., 1421, 1431, 1441, and 1451, respectively. A surface of the enclosure can be, for example, a ceiling of the enclosure. At times, it may be advantageous to minimize the distance between a bottom surface of an optical housing and a top surface of the enclosure (e.g., a top surface of an optical window of the enclosure). As depicted in FIG. 14, translatable optical systems 1420, 1430, 1440, and 1450 include optical assemblies, (e.g., 1422, 1432, 1442, and 1452, respectively), that are engaged by respective support mounts, (e.g., 1424, 1434, 1444, and 1454, respectively). As depicted in the examples of optical system 1420 and 1430, the optical assemblies 1422 and 1432, respectively, are supported on bottom surfaces of the optical assemblies by the support mounts 1424 and 1434, respectively (e.g., with respect to the z-axis). In the example of optical system 1420, at least a portion of the support mount 1424 shares a common plane (e.g., the XY plane) with rail(s) 1428 of a railing system. In the example of optical system 1430, the support mount 1434 is located on a different plane (e.g., offset along the z-axis) from the rail(s) 1438 of a railing system. Translatable optical system 1440 depicts an example where the optical assemblies 1442 are engaged with the support mount 1444 such that a portion of the optical (assembly) housing is below a plane (e.g., an XY plane) of the support mount 1444. Translatable optical system 1450 depicts an example where the optical assemblies, e.g., optical assembly 1452, are engaged with the support mount 1454 and affixed to the support mount by respective top surfaces of the optical assemblies (e.g., with respect to the z-axis) such that the optical assemblies, e.g., optical assembly 1452, are located between the support mount 1454 and a surface of the enclosure 1451.

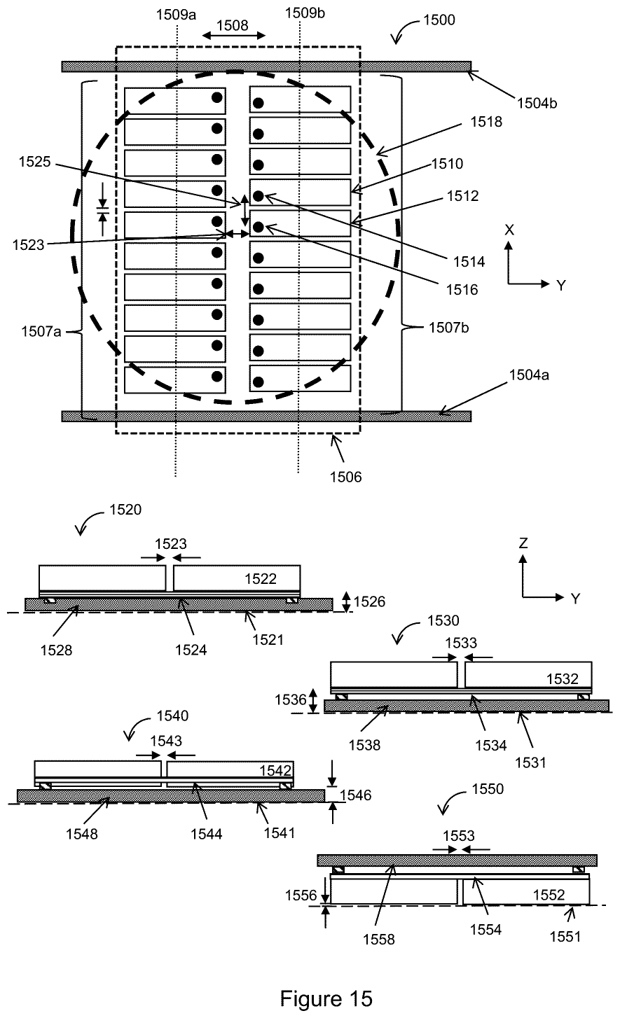

At times, an array of optical assemblies is reversibly engaged and disengaged with a support mount, e.g., such that respective housings of the optical assemblies of the array of optical assemblies are fully (e.g., entirely) supported by the support mount. At times, an array of optical assemblies is modularly engaged and/or disengaged with a support mount. FIG. 15 depicts a schematic of an example of a translatable optical system 1500. Translatable optical system 1500 includes a rail system including rails 1504a, 1504b. A support mount 1506 is operatively coupled with the rails 1504a, 1504b such that the support mount may translate along rails 1504a, 1504b along a direction 1508, e.g., aligned with the Y-axis. Rails 1504a, 1504b and/or support mount 1506 may be operatively coupled with an actuator (e.g., a motor) and an encoder (e.g., an optical encoder), not shown. The support mount 1506 is operatively coupled with (e.g., engaged with) optical assemblies, e.g., optical assemblies 1510, 1512. The optical assemblies are arranged in respective linear arrays 1507a, 1507b, where the optical assemblies of each linear array are arranged along a respective central axis 1509a, 1509b. The optical assemblies may be reversibly engaged with the support mount 1506 by fixtures, e.g., mounting hardware. The support mount 1506 can align the windows of the optical assemblies, e.g., windows 1514, 1516, with respect to a target surface 1518 within an enclosure. As depicted, each optical assembly is entirely engaged with (e.g., fully supported by) the support mount 1506. A separation (e.g., a pitch) 1525 of the optical assemblies, e.g., optical assemblies 1510 and 1512, is defined along the X-axis from a central point of window 1514 of optical assembly 1510 to a central point of window 1516 of optical assembly 1512. Adjacent optical assemblies are separated along the y-axis by a gap 1523. FIG. 15 depicts example schematic side-views, e.g., a cross-section along the YZ plane, of translatable optical systems 1520, 1530, 1540, and 1550. The translatable optical systems 1520, 1530, 1540, and 1550 include optical assemblies, e.g., 1522, 1532, 1542, and 1552, respectively. The optical assemblies are separated from each other along the y-axis by a gap 1523, 1533, 1543, and 1553, respectively. The optical systems 1520, 1530, 1540, and 1550 are arranged to translate optical assemblies, e.g., optical assemblies 1522, 1532, 1542, and 1552, respectively) at a distance (e.g., distance 1526, 1536, 1546, and 1556, respectively) between a bottom surface of an optical assembly and a top (e.g., nearest) surface of the enclosure, e.g., 1521, 1531, 1541, and 1551, respectively. A surface of the enclosure can be, for example, a ceiling of the enclosure. At times, it may be advantageous to minimize the distance between a bottom surface of an optical enclosure and/or optical housing, and a top surface of the enclosure (e.g., a top surface of an optical window of the enclosure). As depicted in FIG. 15, translatable optical systems 1520, 1530, 1540, and 1550 include optical assemblies, (e.g., 1522, 1532, 1542, and 1552, respectively), that are engaged by respective support mounts, (e.g., 1524, 1534, 1544, and 1554, respectively). As depicted in the examples of optical system 1520 and 1530, the optical assemblies 1522 and 1532, respectively, are supported on bottom surfaces of the optical assemblies by the support mounts 1524 and 1534, respectively (e.g., with respect to the z-axis). In the example of optical system 1520, at least a portion of the support mount 1524 shares a common plane (e.g., the XY plane) with rail(s) 1528 of a railing system. In the example of optical system 1530, the support mount 1534 is located on a different plane (e.g., offset along the z-axis) from the rail(s) 1538 of a railing system. Translatable optical system 1540 depicts an example where the optical assemblies 1542 are engaged with the support mount 1544 such that a portion of the optical (assembly) housing is below a plane (e.g., an XY plane) of the support mount 1544. Translatable optical system 1550 depicts an example where the optical assemblies, e.g., optical assembly 1552, are engaged with the support mount 1554 and affixed to the support mount by respective top surfaces of the optical assemblies (e.g., with respect to the z-axis) such that the optical assemblies, e.g., optical assembly 1552, are located between the support mount 1554 and a surface of the enclosure 1551.

At times, the translation mechanism is configured to translate respective positions of the optical assemblies with respect to the build platform to facilitate 3D printing over the target surface. Translation of the optical assemblies between sub-regions on the target surface may reduce a cross-contamination by debris between different sub-regions of the target surface during the print cycle, and/or enable printing a high-fidelity 3D printing requested. Translation of the translation mechanism may be optimized to minimize an interval between print cycles. For example, (i) minimizing a time to translate the translation mechanism and/or (ii) minimizing a time to sufficiently stabilize the optical components of the optical assemblies to facilitate accurate translation of the energy beam in requested locations at the target surface. Translation of the translation mechanism may comprise discrete translation or continuous translation. Translation of the translation mechanism may comprise translating components of the optical system, e.g., any of the optical components described herein. Translation of the translation mechanism may comprise translating at least one optical assembly. Translation of the translation mechanism may comprise translating at least one component of a metrological detection system (e.g., a detector or light source). Translation of the translation mechanism may comprise translating gas inlet(s) and/or gas outlet(s) of a gas flow system. Translation of the translation mechanism may comprise translating between consolidated process regions on the target surface. For example, translation includes translating between a first consolidated process region to an adjacent (e.g., immediately proximate) second consolidated process region. For example, translation includes translating between a first consolidated process region to a non-immediately adjacent second consolidated process region, e.g., having at least one consolidated process region between the first and the second consolidated process regions. An energy beam may have a process region at the target surface. The process region may be an intersection of the processing volume of an energy beam with the target surface. Process regions at the target surface may overlap with each other, e.g., at least one process region may have a portion that overlaps at least one other process region. The target surface may comprise a number of process regions, for example, at least two, three, four, five, eight, twelve, sixteen, thirty-two, sixty-four, or more process regions. The number of processing regions may correspond to the number of different energy beams utilized to print the 3D object(s) at the target surface in a printing cycle. Overlapping process regions of energy beams guided by an array of optical assemblies, may form a consolidated process region of the energy beams at the target surface. The array of optical assemblies may discretely translate relative to the target surface, e.g., during the 3D printing. The number of consolidated processing regions at the target surface may correspond to the number of discrete translations occurring during translation of the optical array along the target surface from one end of the target surface to an opposing end of the target surface. At least two of the consolidated processing regions may (i) partially overlap, or (ii) border each other.

In some embodiments, the optical system is translated by a translation mechanism. The translation may be relative to the target surface. The translation mechanism may translate the optical system in discrete steps, e.g., between at least two of the consolidated process regions. The translation mechanism may translate the optical system continuously laterally along the target surface. The translation mechanism may translate the optical system utilizing a translation profile. The translation profile may comprise linear or non-linear translation. The translation profile may comprise a rate change (e.g., an acceleration and/or deceleration). The rate change may comprise a variable rate change or a constant rate change. For example, the translation profile may comprise a first rate change for a first period of time and a second rate change for a second period of time. The first rate change and the second rate change may or may not be different. The (e.g., substantial) similarity between the first rate change and the second rate change may comprise (a) time period (e.g., duration), (b) profile (e.g., shape of the profile), (c) direction, or (d) any combination of (a) to (c). The difference between the first rate change and the second rate change may comprise (a) time period (e.g., duration), (b) profile (e.g., shape of the profile), (c) direction, or (d) any combination of (a) to (c). The first rate change may be opposite in sign than the second rate change. For example, the first rate change may comprise acceleration, and the second rate change may comprise deceleration. The first rate change may be of the same sign as the second rate change. For example, the first rate change and the second rate change may be acceleration rates. For example, the first rate change and the second rate change may be deceleration rates. The first rate change and the second rate change may or may not be of the same type. For example, the first rate change may be constant and the second rate change may be variable. For example, the first rate change may be variable and the second rate change may be variable. For example, the first rate change may be linear and the second rate change may be non-linear. For example, the first rate change may be non-linear and the second rate change may be non-linear. The first rate change and the second rate change may or may not span (e.g., substantially) the same time. For example, the first rate change may be shorter than the second rate change. For example, the first rate change may be (e.g., substantially) take the same time as the second rate change. The profile of the rate change may comprise (i) linear, (ii) sinusoidal, (iii) triangle, (iv) square (e.g., top-hat), (v) another regular profile, or (vi) an irregular profile. The translation mechanism may translate for at least one discrete interval. The translation mechanism may translate the optical system discretely. A translation interval may comprise a distance of travel to orient the optical system with respect to the target surface. The translation interval may comprise a distance of travel from a first alignment position with respect to the target surface (e.g., with respect to a first process region) to a second alignment position with respect to the target surface (e.g., with respect to a second process region). A translation interval may comprise a discrete distance of travel, for example, at least about 50 millimeters (mm), 75 mm, 100 mm, 125 mm, 150 mm, 200 mm, 250 mm, 300 mm, 350 mm, 400 mm, 450 mm, 500 mm, 600 mm, 700 mm, 800 mm, 1000 mm, 1200 mm, 1500 mm, 2000 mm, or more. A translation interval may comprise a discrete distance of travel that is any value between the aforementioned values, for example, from about 50 mm to about 800 mm, from about 300 mm to about 1000 mm, or from about 600 mm to about 2000 mm. A translation interval may comprise a discrete distance of travel, for example, at least about 5%, 10%, 15%, 20%, 25%, 30%, 35%, 40%, 50%, 60%, 75%, 80%, 95%, or more of an FLS of the target surface (e.g., a diameter or width of the target surface). A translation interval may comprise any value between the aforementioned values, for example, from about 5% to about 25%, from about 15% to about 35%, or from about 30% to about 90%. The translation interval may comprise a translation duration, for example, a time period to translate the translation mechanism a length of the translation interval. For example, a translation duration to translate from a first location to a second location with respect to the target surface. A translation duration may comprise at most about 10 seconds (sec), 8 sec, 6, sec, 4 sec, 2 sec, 1 sec, or less. A translation duration may comprise any value between the aforementioned values, for example, from about 10 sec to about 4 sec, from about 6 sec to about 2 sec, or from about 4 sec to about 1 sec. The translation interval may include a settling time duration. A settling time duration may comprise the translation duration and/or a stabilization duration for the optical system. The stabilization duration may be sufficient to accurately translate the energy beam long the target surface. The accuracy may align with the fidelity requested for the 3D object(s) printed. A settling time duration may comprise a length of time for component(s) of the optical system to settle (e.g., stabilize) before the optical system can be utilized for a three-dimensional printing process, e.g., before energy beam(s) can impinge on the target surface. The settling time duration may comprise a time period to calibrate (e.g., re-calibrate) the optical system in an updated alignment with respect to the target surface and/or with respect to adjacent (e.g., immediately adjacent) energy beam(s). Calibration of the optical system may comprise a calibration to update an alignment of energy beam position(s) with respect to the target surface. The settling time duration may comprise a time interval from when an energy beam is turned off (e.g., blocked from reaching the target surface) to when the energy beam is turned on again (e.g., allowed to reach the target surface). The settling time duration can be at most about 60 seconds (sec), 45 sec, 30 sec, 25 sec, 20 sec, 15 sec, 10 sec, 8 sec, 5 sec, 2 sec, or less. The settling time duration can be any value between the aforementioned values, for example, from about 60 sec to about 25 sec, from about 30 sec to about 10 sec, or from about 15 sec to about 2 sec.

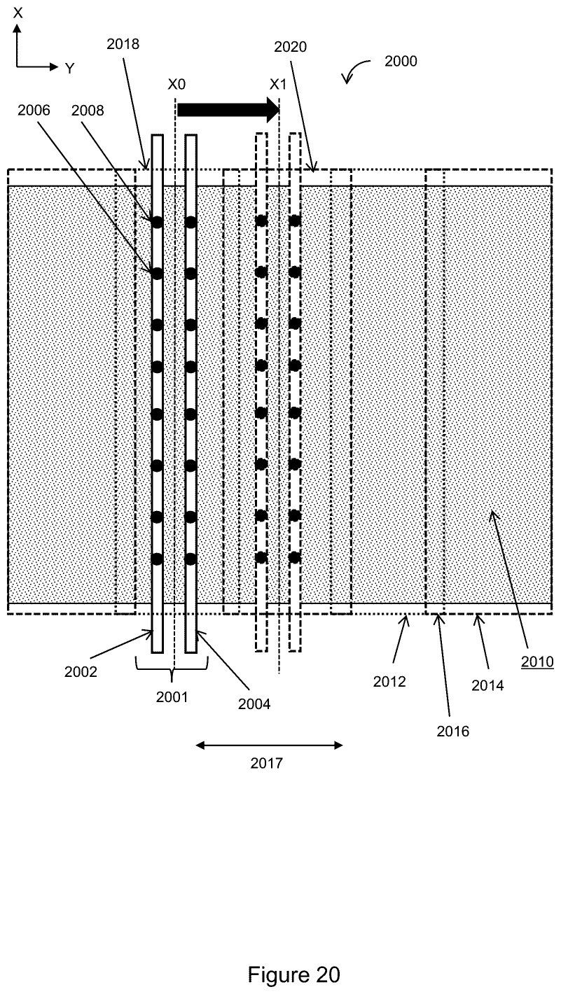

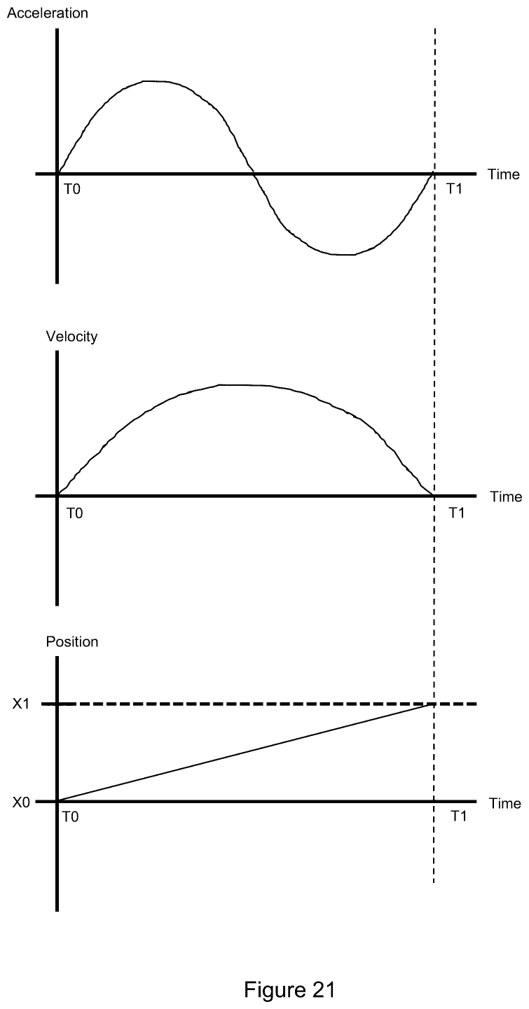

At times, the optical system is configured to translate with respect to the target surface to facilitate 3D printing over the target. The target surface may be supported by the build platform, e.g., when the target surface is an exposed surface of a material bed. The target surface may be disposed above the build platform. Above may be a direction closer to the optical window, closer to the optical assembly, in a direction opposite to a gravitational vector of the environment (e.g., of Earth), in a direction towards a ceiling of a processing chamber in which the target surface is disposed, or any combination thereof. FIG. 20 depicts an example of a translatable optical system. Optical system 2000 is partially depicted in FIG. 20 as an array of optical openings 2001 including linear arrays 2002 and 2004, where each opening corresponds to an optical assembly. The optical assemblies correspond to circular windows (e.g., windows 2006, 2008), where the windows are configured to allow respective energy beams to impinge on a target surface 2010. The target surface 2010 includes consolidated processing regions, e.g., consolidated processing regions 2012, 2014. Adjacent consolidated processing regions include an area of overlap, e.g., area of overlap 2016 between consolidated processing regions 2012 and 2014. The array of optical assemblies corresponding to array of openings 2001 is translated from a first alignment position X0 to a second alignment position X1 along a direction 2017, e.g., along the Y-axis. The first alignment position X0 is aligned with a first consolidated processing region 2018. The second alignment position X1 is aligned with a second consolidated processing region 2020. The optical system translates from alignment position X0 to alignment position X1 utilizing a translation profile. FIG. 21 depicts an example translation profile for the translation of an optical system with respect to a target surface. As depicted in FIG. 21, the position of the optical system (e.g., of the array of optical assemblies) from a first alignment position X0 to a second alignment position X1 is altered from a time T0 to a (e.g., later) time T1. A velocity profile of the translation from X0 to X1 between time T0 to T1 includes a curvature, with a peak velocity of the system occurring approximately at a mid-point of the translation profile. An acceleration profile of the translation from X0 to X1 between time T0 to T1 includes a sinusoidal profile, where variable acceleration is utilized in a first period of the translation and variable deceleration is utilized in second period of the translation.

In some embodiments, the translation mechanism is configured to translate the optical system with respect to at least one optical window operatively coupled with an enclosure, e.g., to facilitate an energy beam to impinge onto a target surface disposed in the enclosure. The enclosure may comprise a plurality of optical windows arranged with respect to the enclosure to facilitate at least one energy beam to impinge on the target surface within the enclosure. The number of optical windows may correspond to the number of energy beams and/or number of optical assemblies included in the optical system. The correspondence may be a 1:1 correspondence between the optical assembly and the optical window. For example, an optical assembly may be configured to translate an energy beam (along a path) to propagate through an optical window. The correspondence may or may not be a 1:1 correspondence between the energy beam and the optical window. For example, an optical assembly may be configured to translate two or more energy beams to propagate through an optical window, the two or more energy beams propagating along one or more paths in the optical assembly. Each energy beam may correspond to a respective optical window. An optical window may correspond to at least one energy beam, e.g., allow impingement by the at least one energy beam onto the target surface within the enclosure such as during printing. An optical window may correspond to two or more energy beams, e.g., allow impingement by the two or more energy beams through the optical window and onto the target surface within the enclosure such as during printing. An optical window may (e.g., at times) correspond to zero energy beams, e.g., no energy beams impinge on the target surface via the optical window such as during at least a portion of the 3D printing. For example, in a first alignment position of the optical assemblies, one or more optical windows may not be utilized to allow impingement of the energy beams of the optical assemblies onto the target surface, e.g., during a portion of the print cycle. An optical window may comprise a cross-sectional shape, e.g., in a plane that is perpendicular to a gravitational vector. The cross-sectional shape of the optical window may comprise an elliptical (e.g., circular), rectangular (e.g., square), polygonal, or irregular shape. An FLS of the cross-sectional shape of at least one optical window may be different than a corresponding FLS of a cross-sectional shape of at least one other optical window. An FLS of the cross-sectional shape of at least one optical window may be (e.g., substantially) the same as a corresponding FLS of a cross-sectional shape of at least one other optical window. The cross-sectional shape of the optical window may be elongated in a direction, e.g., in a direction perpendicular or parallel to a direction of motion of the optical system. For example, an optical window may comprise a strip oriented parallel to a direction translation of the optical system. An optical window may correspond to a (e.g., substantial) portion of a target surface, for example, an optical window that covers at least about 45%, 50%, 65%, 75%, 85%, 95% or more of an area corresponding to a target surface. An optical window may comprise a (e.g., substantial) portion of a surface of the enclosure, for example, an optical window that covers at least about 45%, 50%, 65%, 75%, 85%, 95% or more of a ceiling of the enclosure.

In some embodiments, the enclosure comprises, or is operatively coupled to, optical windows. A plurality of optical windows may be distributed about the enclosure (e.g., wall(s) of the enclosure comprising the ceiling) to facilitate impingement of the energy beam(s) of the optical system onto the target surface. The plurality of optical windows may comprise at least about two, four, six, eight, ten, twelve, fourteen, sixteen, eighteen, twenty, twenty-four, twenty-eight, thirty-two, thirty-six, sixty-four, ninety-six, or more optical windows. The plurality of optical windows may be arranged in an array of optical windows. The array of optical windows, e.g., at least two optical windows, may be distributed asymmetrically with respect to each other. The array of optical windows may be distributed asymmetrically with respect to the enclosure and/or target surface. The array of optical windows may be distributed symmetrically with respect to each other. The array of optical windows may be distributed symmetrically with respect to the ceiling of the enclosure and/or with respect to the target surface. The symmetry of the optical assemblies in the optical system may correspond to the symmetry of the optical windows. The symmetry of the optical windows may correspond to the symmetry of the optical assemblies in the optical system. Symmetrically arranged may comprise a rotational symmetry axis or a mirror symmetry plane. The rotational symmetry axis may be disposed between two optical windows or a pair of optical windows. The mirror symmetry plane may be disposed between two optical windows. The rotational symmetry axis and/or the mirror symmetry plane may be oriented perpendicular to a floor of the enclosure relative to a gravitational center (e.g., gravitational center of the environment, e.g., the Earth). The rotational symmetry axis may comprise a C2 (180 degrees), C3 (120 degrees), or C4 (90 degrees) symmetry axis. The rotational symmetry axis and/or the mirror symmetry plane may be perpendicular (i) to a plane in which an optical windows are disposed, (ii) to the target surface and/or (iii) to the plane in which the optical assemblies are disposed. In some embodiments, the rotational symmetry axis is parallel (i) to a plane in which an optical windows are disposed, (ii) to the target surface and/or (iii) to the plane in which the optical assemblies are disposed. The rotational symmetry axis can be perpendicular or parallel to the gravitational vector pointing towards the environmental gravitational vector. The mirror plane can include the gravitational vector pointing towards the environmental gravitational vector. The array of optical windows may comprise at least one linear array of optical windows. The array of optical windows may comprise a two-dimensional array of optical windows, for example, including at least four optical windows. The array of optical windows may comprise a two-dimensional array of optical windows including at least two linear arrays, where the optical windows of each linear array are aligned with respect to a central axis of the linear array and where the central axis of each linear array is arranged parallel to each other. For example, the array of optical windows includes four linear arrays of two optical windows each. For example, the array of optical windows includes 8 linear arrays of at least 8 optical windows each, e.g., for a total of at least about 64 optical windows in the two-dimensional array. The optical window may comprise an FLS, e.g., a thickness, substantially sufficient to retain (e.g., within the enclosure) an internal atmospheric environment within the enclosure that is separate from an external atmospheric environment outside the enclosure, e.g., any atmospheric environment disclosed herein. The optical window(s) may comprise a material, for example, sapphire, beryllium, zinc selenide, calcium fluoride, or fused silica. The optical window(s) may comprise a material having a (e.g., substantially) diminished thermal lensing effect during a three-dimensional printing process. At least one optical window may be engaged by a component of a metrological detection system, e.g., may facilitate line-of-sight by a component of a metrological detection system of the target surface within the enclosure. Further details of the metrological detection system are discussed herein.

At times, the translation mechanism is configured to translate with respect to at least one optical window arranged with respect to an enclosure to facilitate an energy beam to impinge on a target surface within the enclosure. The enclosure may comprise at least one (e.g., a plurality of) optical window arranged with respect to the enclosure to facilitate an energy beam to impinge on the target surface within the enclosure.

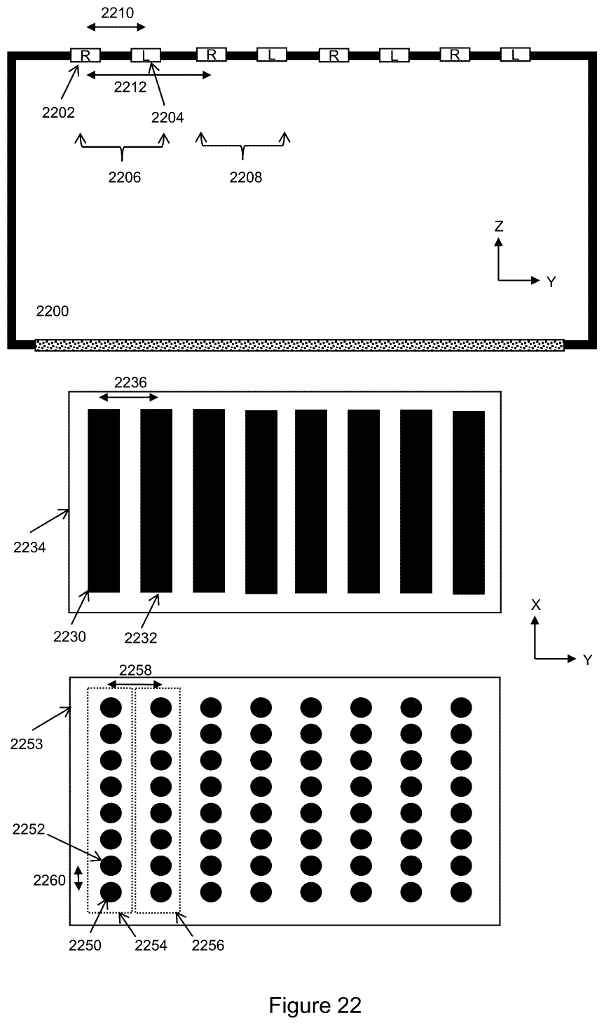

FIG. 22 depicts schematic examples of optical windows arranged with respect to an enclosure. FIG. 22 depicts a side view of an enclosure 2200, e.g., of a processing chamber, including an array of optical windows, e.g., optical windows 2202, 2204. The array of optical windows is arranged in pairs of optical windows, e.g., pairs 2206, 2208. Each pair of optical windows has a spacing, e.g., a spacing 2210 between optical windows 2202 and 2204. Pairs of optical windows are arranged separated by a gap, e.g., a gap 2212 between pairs 2206 and 2208. FIG. 22 depicts a schematic example of an array of optical windows, e.g., optical windows 2230, 2232, arranged on a surface of an enclosure 2234, e.g., on a ceiling of an enclosure. As depicted, the optical windows, e.g., optical windows 2230, 2232, are elongated strips oriented along an X-axis. The optical windows are separated by a spacing, e.g., optical windows 2230 and 2232 are separated by spacing 2236. FIG. 22 depicts a schematic example of an array of optical windows, e.g., optical windows 2250, 2252 arranged on a surface of an enclosure 2253, e.g., on a ceiling of an enclosure. As depicted, the optical windows, e.g., optical windows 2250, 2252, are circular and arranged in linear arrays oriented along the X-axis. The linear arrays of optical windows, e.g., linear arrays 2254 and 2256, are separated by a spacing, e.g., separated by spacing 2258. The optical windows of a linear array are separated by a gap, e.g., optical windows 2250 and 2252 are separated by gap 2260.

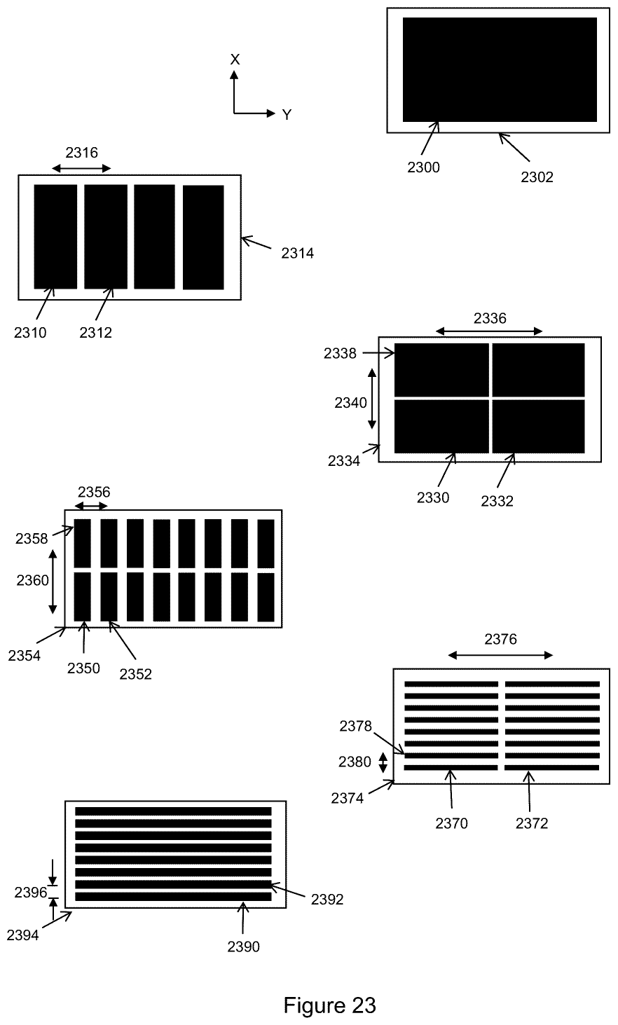

FIG. 23 depicts schematic examples of optical windows arranged with respect to an enclosure. FIG. 23 depicts a schematic example of an optical window 2300 arranged with respect to a surface of an enclosure 2302, e.g., on a ceiling of an enclosure. FIG. 23 depicts a schematic example of an array of optical windows, e.g., optical windows 2310, 2312, arranged on a surface of an enclosure 2314, e.g., on a ceiling of an enclosure. As depicted, the optical windows, e.g., optical windows 2310, 2312, are elongated strips oriented along an X-axis. The optical windows are separated by a spacing, e.g., optical windows 2310 and 2312 are separated by spacing 2316. FIG. 23 depicts a schematic example of an array of optical windows, e.g., optical windows 2330, 2332, arranged on a surface of an enclosure 2334, e.g., on a ceiling of an enclosure. As depicted, the optical windows, e.g., optical windows 2330, 2332, are elongated strips oriented along an X-axis. The optical windows are separated by a spacing, e.g., optical windows 2330 and 2332 are separated by spacing 2336, along the Y-axis. The optical windows are separated by a gap, e.g., optical windows 2330 and 2338 are separated by a gap 2340, along the X-axis. FIG. 23 depicts a schematic example of an array of optical windows, e.g., optical windows 2350, 2352, arranged on a surface of an enclosure 2354, e.g., on a ceiling of an enclosure. As depicted, the optical windows, e.g., optical windows 2350, 2352, are elongated strips oriented along an X-axis. The optical windows are separated by a spacing, e.g., optical windows 2350 and 2352 are separated by spacing 2356, along the Y-axis. The optical windows are separated by a gap, e.g., optical windows 2350 and 2358 are separated by a gap 2360, along the X-axis. FIG. 23 depicts a schematic example of an array of optical windows, e.g., optical windows 2370, 2372, arranged on a surface of an enclosure 2374, e.g., on a ceiling of an enclosure. As depicted, the optical windows, e.g., optical windows 2370, 2372, are elongated strips oriented along a Y-axis. The optical windows are separated by a spacing, e.g., optical windows 2370 and 2372 are separated by spacing 2376, along the Y-axis. The optical windows are separated by a gap, e.g., optical windows 2370 and 2378 are separated by a gap 2380, along the X-axis. FIG. 23 depicts a schematic example of an array of optical windows, e.g., optical windows 2390, 2392, arranged on a surface of an enclosure 2394, e.g., on a ceiling of an enclosure. As depicted, the optical windows, e.g., optical windows 2390, 2392, are elongated strips oriented along a Y-axis. The optical windows are separated by a spacing, e.g., optical windows 2390 and 2392 are separated by spacing 2396, along the X-axis.

In some embodiments, the 3D printing system comprises at least one controller, e.g., as part of a control system. The controller may include one or more components. The controller may comprise a processor. The controller may comprise a specialized hardware (e.g., electronic circuit). The controller may be a proportional—integral—derivative controller (PID controller). The control may comprise dynamic control (e.g., in real time during the 3D printing process). For example, the control of the (e.g., transforming) energy beam may be a dynamic control (e.g., during the 3D printing process). The PID controller may comprise a PID tuning software. The PID control may comprise constant and/or dynamic PID control parameters. The PID parameters may relate a variable to the required power needed to maintain and/or achieve a setpoint of the variable at any given time. The calculation may comprise calculating a process value. The process value may be the value of the variable to be controlled at a given moment in time. For example, the process controller may control a height of at least one portion of the layer of hardened material that deviates from the average surface of the target surface (e.g., exposed surface of the material bed) by altering the power of the energy source and/or power density of the energy beam, wherein the height measurement is the variable, and the power of the energy source and/or power density of the energy beam are the process value(s). The variable may comprise a temperature or metrological value. The parameters may be obtained and/or calculated using a historical (e.g., past) 3D printing process. The parameters may be obtained in real time, during a 3D printing process. During a 3D printing process, may comprise during the formation of a 3D object, during the formation of a layer of hardened material, or during the formation of a portion of a layer of hardened material. The calculation output may be a relative distance (e.g., height) of the material bed (e.g., from a cooling mechanism, bottom of the enclosure, optical window, energy source, or any combination thereof).

In some embodiments, a controller of a 3D printing system comprises a metrological detection system. The metrological detection system may be used in the control of 3D printing processes of the 3D printing system. The metrological detection system may be configured to detect distance variations such as vertical distance variations, e.g., height variations. The metrological detection system may be configured to detect distance variations such as horizontal distance variations, e.g., variations with respect to an XY plane. For example, a horizontal distance variation along an X-axis that is oriented parallel to a direction of translation of a translatable component (e.g., a translation mechanism). For example, a horizontal distance variation along a Y-axis that is orientated perpendicular to the direction of translation of the translatable component (e.g., the translation mechanism) and perpendicular to a gravitational vector. The metrological detection system may be configured to detect a vertical (e.g., height) variations in a planar surface, e.g., a planar exposed surface of a material bed. The metrological detection system may comprise a height mapper system. The metrological detection system may comprise an interferometric optical system. The metrological detection system may comprise a position sensitive device system. The metrological detection system may comprise an optical detector. The metrological detection system may include, or be operatively coupled to, an image processor. The metrological detection system may comprise an imaging detector to monitor irregularities. The image detector may comprise a camera such as a charged coupled device (CCD) camera. The image detector may comprise detecting a location or an area of the printed 3D object and convert it to a pixel in the X-Y (e.g., horizontal) plane. The image detector may comprise detecting an interference pattern generated by an interferometric beam path. The image detector may comprise detecting position of a beam incident on the image detector relative to an imaging region of the image detector. The controller may comprise one or more computational schemes to convert data (e.g., measurement data) from the metrological detection system to generate a result. The one or more computational schemes may be utilized to determine one or more aspects of the build platform assembly, the optical system, and/or of the target surface, e.g., the exposed surface of the material bed or the build platform surface. The one or more aspects may comprise positional aspects, or localization aspects. The one or more aspects may be absolute or relative. For example, an aspect can include a physical orientation of a moving component of the build module, the moving component comprising a base, substrate, or build platform assembly, the build module assembly comprises the base (also herein “build platform”). For example, an aspect can include a physical orientation of a moving component of the optical system, e.g., of one or more optical assemblies, energy beam paths, or processing cones incident on the target surface. The physical orientation may comprise a relative orientation (e.g., relative to a requested orientation) or an absolute orientation (e.g., relative to a coordinate axis). For example, an aspect may comprise a relative orientation of at least one optical assembly (e.g., a plurality of optical assemblies) with respect to an enclosure (e.g., the processing chamber) with respect to a requested orientation, e.g., characterizing offset value(s) of the position (e.g., XY position) of the optical assembly from the requested value(s). For example, an aspect may comprise a relative orientation of an array of optical assemblies (e.g., a plurality of optical assemblies) with respect to an enclosure (e.g., the processing chamber) with respect to a requested orientation, e.g., characterizing offset value(s) of the position (e.g., XY position) of the array of optical assemblies from the requested value(s). For example, an aspect may comprise a relative orientation of a processing cone of an energy beam directed by an optical assembly onto a target surface with respect to a requested orientation. For example, an aspect may comprise a relative orientation of the target surface with respect to requested orientation, e.g., characterizing offset value(s) of the target surface from requested value(s). For example, an aspect may include (a) a height (e.g., along a z-axis) of the target surface, (b) an XY position (c) a rotation of the target surface, or (d) any combination of (a), (b), and (c). The orientation of the array of optical assemblies may include (A) pitch or roll (e.g., due to movement around the horizontal axis) of the array. The controller may utilize one or more computational schemes to measure a height (e.g., along a z-axis) of the target surface (e.g., a phase shift computational scheme). The controller may utilize one or more computational schemes to measure a position (e.g., about the XY plane) of the array of optical assemblies. The computational scheme may comprise an algorithm. The controller may utilize a computational scheme comprising a (e.g., digital) modulation scheme that conveys data by changing (e.g., modulating) the phase of a reference signal (e.g., carrier wave).

In some embodiments, to facilitate a 3D printing process, a metrological detection system measures an aspect of a moving component of the three-dimensional printing system, the moving component comprising an optical system (e.g., a translation mechanism of the optical system configured to translate an array of optical assemblies, a base, a substrate, or a build platform assembly. The aspect may be measured before, during, and/or after any 3D printing process described herein. For example, the aspect may be measured in real time during the 3D printing process. For example, the aspect may be measured before, during, and/or after a translation of an array of optical assemblies (e.g., by the translation mechanism) with respect to the enclosure. For example, the aspect may be measured before, during, and/or after a translation of the build platform assembly. For example, the aspect may be measured before, during, and/or after a layer of pre-transformed material is deposited on a target surface. For example, the aspect may be measured before, during, and/or after a lasing process to form transformed material. The aspect may be measured and processed before, during, and/or after any 3D printing process described herein. For example, the aspect may be measured and processed in real time during the 3D printing process. For example, the aspect may be measured and processed before, during, and/or after a translation of the array of optical assemblies. For example, the aspect may be measured and processed before, during, and/or after a layer of pre-transformed material is deposited on a target surface. For example, the aspect may be measured and processed before, during, and/or after a lasing process to form transformed material. An aspect of the moving component of the array of optical assemblies may comprise (i) an orientation about an XY plane (e.g., perpendicular to a gravitational vector), (ii) a rotation about a z-axis (e.g., with respect to the gravitational vector), or (iii) a combination thereof. For example, an interferometric detection system may measure an orientation about the XY plane (e.g., perpendicular to a gravitational vector), a rotation of the array of the optical assemblies (e.g., of one or more optical assemblies), the rotation comprising a roll. For example, a height mapper system may measure an orientation of the moving component of the optical system (e.g., array of optical assemblies) about the XY plane. At times, the metrological detection system may measure a positional deviation (e.g., error, offset, deflection) in an aspect of the moving component of the optical system. For example, a positional deviation in the aspect may be an offset from a request position. A positional deviation in an aspect of the moving component of the optical system, may occur due to variations in 3D printing processes. For example, positioning errors due to encoder, actuators, or the like, may result in a deviation in an aspect of the moving component of the optical system (e.g., the translation mechanism). Measurements collected by the metrological detection system may be utilized by one or more controllers, for example, to provide feedback controls to one or more control systems. For example, the one or more controllers may process, or direct processing, the measurements at a time including before, after and/or during the 3D printing process (e.g., in real time). The one or more controllers may be integrated in a control system that controls the 3D printing process (e.g., the recoater, gas flow system, and/or energy beam(s)). The control system may be any control system disclosed herein. For example, the control system may be a hierarchical control system. For example, the control system may comprise a least three hierarchical control levels.

In some embodiments, a metrological detection system comprises an interferometric detection system. An interferometric detection system may comprise a plurality of optical components. The plurality of optical components may comprise mirrors, lenses, prisms, fibers, or another optical component disclosed herein. The interferometric detection system may comprise at least one energy source, e.g., a laser source. The interferometric detection system may comprise a plurality of energy sources, e.g., three or more energy sources. Each energy source may generate an energy beam along a respective beam path. At times, the interferometric detection system is configured to divide (e.g., split) an energy beam from an energy source into a plurality of beam paths, e.g., two beam paths, three beam paths, or more. The interferometric detection system may comprise a beam splitter to divide the energy beam from the energy source into the two or more beam paths. The interferometric detection system may comprise an encoder. The encoder may comprise any encoder disclosed herein. The encoder may comprise an optical encoder. The encoder may comprise a linear encoder. The encoder may comprise a laser encoder, e.g., a fiber optic interferometric laser encoder. The encoder may be configured for active galvanometric registration. The encoder may be mounted on the processing chamber, e.g., on a ceiling (e.g., a roof) of the processing chamber or on a wall of the processing chamber. The encoder may be mounting on the optical enclosure of the optical system. The encoder may be mounting on the translation mechanism, e.g., on a rail of the translation mechanism. At times, at least two encoders may be utilized, e.g., corresponding to each railing of a translation mechanism. At times, two or more (e.g., four) encoders may be utilized. At times, the interferometric detection system comprises a mirror, for example, a retroreflector. The retroreflector may be mounted on a stationary surface of the processing chamber or optical enclosure. The retroreflector may be mounting on a translatable surface of the translation mechanism (e.g., on a support mount, on a housing of an optical assembly). The interferometric detection system may comprise a plurality of beam paths, e.g., two beam paths, three beam paths, four beam paths, or more. The interferometric detection system may comprise a beam path. Each beam path may traverse from a respective encoder to a retroreflector. For example, a stationary encoder mounted on a stationary point of the processing chamber or optical enclosure and a translatable retroreflector mounted on a translatable point of the translation mechanism. For example, a stationary retroreflector mounted on a stationary point of the processing chamber or optical enclosure and a translatable encoder mounted on a translatable point of the translation mechanism. The original beam path and the reflected beam path may be incident on an encoder, e.g., a detector. An interference pattern generated between an original beam path and the reflected beam path may be detected by the fiber optic laser encoder. At times, the interferometric detection system is configured to capture a differential interferometric measurement from two or more beam paths. The differential measurement may comprise a first measurement capturing a stationary (e.g., unmoving) beam path and a second measurement capturing a different, moving (e.g., translating) beam path. One or more controllers may utilize the information from the interference patterns to determine a position about the XY plane or a roll about a z-axis of the moving components of the optical system (e.g., of the array of optical assemblies). At times, the interferometric detection system may comprise a resolution of at most about 2 microns (μm), 1.5 μm, 1 μm, 0.75 μm, 0.5 μm, or less.

FIG. 24 depicts a schematic view of example of a 3D printing system including an interferometric detection system. A 3D printing system 2400 comprises an enclosure including a processing chamber 2407 coupled to a build module 2423. The 3D printing system 2400 includes an interferometric detection system 2403. The build module comprises an elevation mechanism 2405 to vertically translate a substrate (e.g., piston) 2409 along arrow 2412 with respect to a bottom 2411 of the build module 2423. A build platform 2402 is disposed on substrate (e.g., piston) 2409. Material bed 2404 is disposed above build platform 2402. The 3D printing system 2400 comprises a translatable optical system including an array of optical assemblies, e.g., optical assembly 2420 to direct one or more energy beams, e.g., energy beam 2401, to a target surface of the material bed. Optical assembly 2420 can be translatable along direction 2480, e.g., translatable along an axis perpendicular to gravitational vector 2499. Energy source (e.g., laser source) 2421 generates energy beam 2401 that traverses through the optical assembly 2420 and through an optical window 2415 into enclosure (e.g., processing chamber) 2407 enclosing interior space 2426 that can include an atmosphere. The optical window 2415 is configured to allow the energy beam to pass through without (e.g., substantial) energetic loss. Seal 2413 encircles the substrate and/or build platform, e.g., to deter (e.g., prevent) migration of material of the material bed from reaching elevation mechanism 2405. Energy beam 2401 impinges upon a target surface (e.g., an exposed surface 2419 of material bed 2404), to form at least a portion of a 3D object 2406. As depicted in FIG. 24, the 3D printer comprises a layer dispensing mechanism 2422. The layer dispensing mechanism 2422 includes a material dispenser 2416 and a powder removal mechanism 2418 to form a layer of pre-transformed material (e.g., starting material) within the enclosure. Layer dispensing mechanism 2422 includes a leveler 2417. The material may be layered (e.g., spread) in the enclosure such as by using the layer dispensing mechanism 2422. The interferometric detection system 2403 includes beam paths 2482, 2484 distributed on a surface of the enclosure, e.g., on a ceiling of the processing chamber. Interferometric detection system 2403 includes at least one energy beam from an energy source (not shown), e.g., a fiber-coupled laser source. At times, one energy source can be divided into two or more energy beams along respective beam paths, e.g., by a beam splitter (not shown). Each energy beam is coupled to an encoder 2490 (e.g., a fiber coupled laser encoder). Interferometric detection system 2403 includes mirrors, e.g., mirrors 2486, 2488. Mirrors can be retroreflectors. Mirror 2486 is located on translating portion of the optical system, e.g., engaged with a translation mechanism of the translatable optical system, and can translate along direction 2480. Mirror 2488 is stationary with respect to the translatable optical system, e.g., affixed to a portion of the enclosure, e.g., on the ceiling or sidewall of the processing chamber. Beam paths 2482, 2484 originate from the encoder 2490 and propagate to respective mirrors 2486 and 2488 before reflecting off respective mirrors 2486, 2488 and returning along the respective beam paths to the encoder 2490. A differential interferometric measurement can be made between the detected reflected beam paths 2482 and 2484, where mirror 2486 is translatable along direction 2480 and mirror 2488 is stationary with respect to the enclosure 2407. A position of the optical system, e.g., of the optical assembly 2420 with respect to the stationary mirror 2488 can be determined based at least in part of an interference pattern formed at the encoder 2490 between the stationary energy beam path and the translatable (e.g., variable distance) energy beam path. Two or more sets of beam paths, e.g., beam paths 2482, 2484, can be utilized to generate respective measurements of distance, e.g., to yield information about a pitch, roll, and/or yaw, of the optical system such as of the optical assembly 2420.

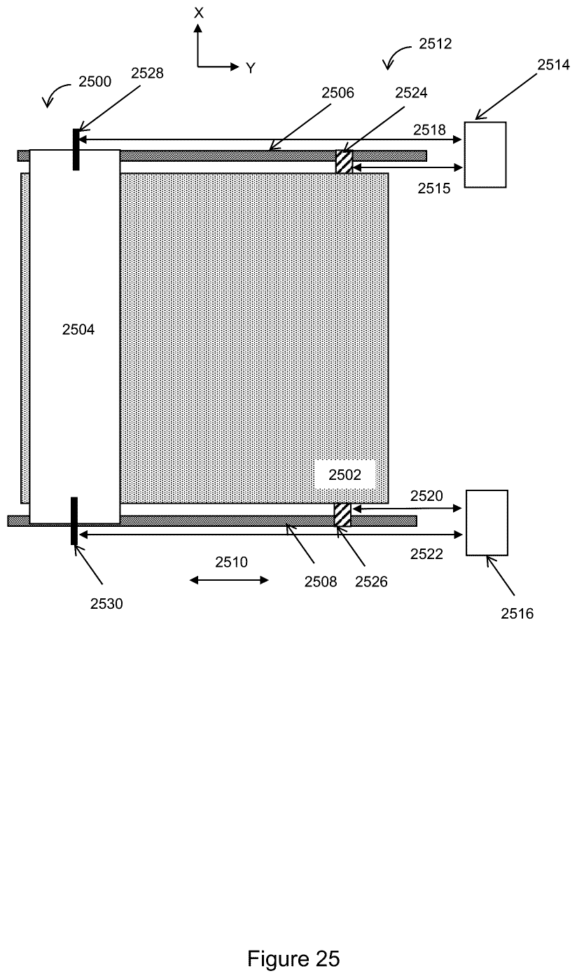

FIG. 25 depicts a schematic view of example of a 3D printing system including an interferometric detection system. As depicted in FIG. 25, a translatable optical system 2500 is arranged with respect to a surface of an enclosure 2502, e.g., a ceiling of a processing chamber. The translatable optical system 2500 includes a translation mechanism including a support mount 2504 that is configured to reversibly engage and disengage to an array of optical assemblies (not shown). The support mount 2504 is operatively coupled with a guiding system comprising rail(s), e.g., rails 2506, 2508, such that the support mount 2504 translates along the rails in direction 2510, e.g., along the Y-axis. The 3D printing system includes interferometric detection system 2512. Interferometric detection system 2512 includes encoders, e.g., encoders 2514, 2516 such as fiber-coupled laser encoders. Each encoder can generate at least one energy beam propagating along a respective beam path. As depicted in FIG. 25, encoder 2514 generates beam paths 2515 and 2518, and encoder 2516 generates beam paths 2520 and 2522. Beam paths 2515 and 2520 comprise stationary beam path measurements where respective mirrors, e.g., mirrors 2524 and 2526, are configured to reflect respective beam paths 2515 and 2520 and are stationary with respect to enclosure 2502. Beam paths 2518 and 2522 comprise variable (e.g., translatable) beam paths where respective mirrors, e.g., mirrors 2528 and 2530, are configured to reflect respective beam paths 2518 and 2522 and are translatable with respect to enclosure 2502. Mirrors 2528 and 2530 are configured to be translatable with respect to support mount 2504, e.g., are operatively coupled with support mount 2504, such that a distance between the mirrors 2528 and 2530 and the respective encoders 2514 and 2516 is variable based at least in part on a translated position of the mirrors. A differential interferometric measurement can be made for each encoder 2514, 2516, e.g., between the detected reflected beam paths 2518 and 2515 and between reflected beam paths 2520 and 2522, respectively. A position of the optical system, e.g., of an array of optical assemblies supported by support mount 2504 with respect to the stationary mirrors, e.g., mirrors 2524 and 2526, can be determined based at least in part on an interference pattern formed at the encoders 2514 and 2516 between the stationary energy beam paths (e.g., 2515 and 2520) and the translatable energy beam paths (e.g., variable distance) e.g., 2518 and 2522. The two sets of beam paths, e.g., beam paths 2518, 2515 and 2520, 2522, can be utilized to generate respective measurements of distance, e.g., to yield information about a pitch, roll, and/or yaw, of the optical system with respect to the enclosure 2502.

In some embodiments, a metrological detection system comprises an in-situ alignment system. The in-situ alignment system may comprise one or more detector(s), sensor(s), and/or one or more controllers. The sensor may be any sensor described herein. The detector may be any detector described herein. The in-situ alignment system may calibrate one or more components of the optical system (e.g., the energy beams of respective optical assemblies). The in-situ alignment system may calibrate one or more characteristics of at least one energy beam (e.g., a respective energy beam for an optical assembly). For example, the in-situ alignment system may calibrate (i) the position at which the energy beam contacts the target surface, (ii) the shape of the footprint of the energy beam at the target surface, (iii) the XY offset of a first energy beam position at the target surface with a second energy beam position at the target surface, and/or (iv) the XY offset of the energy beam with respect to the target surface. The characteristics of the energy beam may be calibrated along the one or more processing regions of the target surface in a field of view of the translatable optical system. The field of view may be described as the maximum area of target surface that is covered (e.g., intersected, or accessed) by the energy beam. The energy beam is directed by an optical assembly to impinge on the target surface within a processing volume having a processing region (e.g., field of view) on the target surface. The processing volume is determined at least in part by (i) the vertical distance between the optical window and the target surface (e.g., height H in FIG. 8), (ii) an FLS of the optical window (e.g., diameter d in FIG. 8), (iii) an FLS of the optical assembly opening (e.g., FLS of opening 1010 of FIG. 10 such as a diameter of opening 1010), (iv) the horizontal placement of the optical window (e.g., with respect to the processing chamber such as 807 of FIG. 8 and/or to the optical enclosure such as 831 of FIG. 8), (v) the horizontal placement of the optical assembly (e.g., with respect to the processing chamber such as 807 of FIG. 8), (vi) settings of optical component(s) of the optical assembly, (vii) chemical nature of optical component(s) of the optical assembly (e.g., material(s) it comprises), (viii) physical nature of optical component(s) of the optical assembly (e.g., type and/or physical shape of optical component(s)), or (ix) any combination thereof. The calibration may be utilized to calibrate one or more components (e.g., scanners) of one or more optical assemblies, e.g., with respect to a target surface. Examples of 3D printing systems, apparatuses, devices, and components, controllers, software (e.g., calibration software), and 3D printing processes can be found in Patent Application Serial No. PCT/US19/14635, filed Jan. 22, 2019, which is entirely incorporated herein by reference.

In some embodiments, an alignment marker arrangement is generated in a manner that allows detection of the positions and/or size of alignment markers of the arrangement by a detection system. The alignment marker may be a physical alignment marker comprising a transformed material, e.g., a lightly transformed material. The lightly transformed material may not be a fully densified transformed material. For example, the transformed material maybe lightly fused, e.g., a lace like structure. The alignment markers may be disposed on the pre-transformed material. The alignment marker may be a 3D object. The alignment marker arrangement may be located within the processing chamber. The alignment marker arrangement may be generated within the enclosure of the 3D printer. For example, the alignment marker arrangement may be generated at or adjacent to the build platform. The alignment marker arrangement may be generated at or adjacent to the target surface. The alignment marker arrangement may comprise transformed (and hardened) material. The arrangement of the alignment marker may be located outside of, or at an edge of, the build module (e.g., in the processing chamber). The alignment marker arrangement may be located outside of the processing chamber (e.g., in the build module). The physical alignment markers may be removed using a layer dispensing mechanism, e.g., before, during, and/or after, the three-dimensional printing. For example, the alignment markers may be removed in the course of depositing a new layer of transformed material.

In some embodiments, the alignment marker arrangement comprises one or more alignment markers. The arrangement may be characterized by a coherence length in a direction of the arrangement. The marker may be characterized by an actual shape (e.g., as deviating from a requested shape). The alignment marker may comprise hardened (e.g., transformed) material, pre-transformed material, or a combination thereof, e.g., lightly fused material. The alignment marker may be an area (e.g., at the target surface) comprising an embossing, depression, protrusion, line, and/or point. The alignment marker arrangement may comprise an alignment marker type having a (e.g., optically) detectable shape. The shape may be at least a two-dimensional shape. The shape may be a 3D shape. Detectable may include use of an illumination source (e.g., a light source, a projector, or an energy beam). The alignment marker arrangement may comprise two or more alignment marker portions. The alignment marker arrangement may include two different alignment marker portions. The alignment marker arrangement may include two different alignment marker types (e.g., each of which constituting an alignment marker portion). The two different marker types may differ in at least one detectable property. The detectable property may comprise a geometry, absorption spectrum, reflection spectrum (e.g., color), reflectivity, or diffusivity.

In some embodiments, an alignment marker is made up of a plurality of transformed material portions (e.g., plurality of 3D objects). At times, the alignment markers are optical and do not comprise transformed material. For example, the alignment markers may comprise heated portions of the target surface leaving a heat signature that can be detected, e.g., using an infrared (IR) detector such as an IR camera. In some embodiments, the alignment marker arrangement may include alignment markers located at different layers that form a material bed. At least one of the plurality of transformed material portions may be located at a different material layer than another of the plurality of transformed material portions. The layers may be layers of a material bed. For example, a first subset of alignment markers of the alignment marker arrangement may be located at a first layer and a second (e.g., remainder) subset of alignment markers of the alignment marker arrangement may be located at a second layer. The first layer may be (e.g., directly) below the second layer. The first layer may be (e.g., directly) above the second layer. The first and the second layer may be (e.g., directly) adjacent layers (e.g., sequential layers). At times, the first and the second layers may have one or more intervening layers. The one or more intervening layers may comprise pre-transformed material, transformed material, or a combination thereof. The alignment markers may be formed during the 3D printing, e.g., in locations of the target surface that are not occupied with the requested 3D object that is being built. The alignment markers may be formed in layers that are or that are not occupied by a requested 3D object. In some embodiments, the alignment markers are disposed on one layer of the material bed.

At times, an alignment marker arrangement includes alignment markers that are formed from one or more partial alignment markers (e.g., “partial markers”). A partial marker may correspond to an alignment marker that is split to form scale-independent (e.g., partial) markers. For example, the partial markers may correlate to each other at least one point. A first set of partial alignment markers may be generated on a first layer, and a second (e.g., corresponding) set of partial alignment markers may be generated on a second layer. A combination of partial markers may be used to form a (e.g., complete) alignment marker in an alignment marker arrangement. A combination of the first set and the second set of partial alignment markers may form the (e.g., complete) alignment marker arrangement. A combination of partial markers may reduce a variability in the combined alignment marker. A reduction in variability can be with respect to a shape, position (e.g., on the target surface), and/or a dimension of the combined alignment marker, as compared to a (e.g., full) alignment marker generated in one processing step.

In some embodiments, the alignment marker arrangement forms a grid covering an area of interest (e.g., a processing field) of the energy beam. The area of interest may be the total available processing area (e.g., total surface of a material bed). The area of interest may be larger than the total available processing area. The area of interest may be smaller than the total available processing area. The area of intent may comprise an overlap between two or more energy beams.

In some embodiments, the alignment marker is of a predetermined shape (e.g., a polygonal solid) and size. The alignment marker may include two lines disposed at an angle from each other, e.g., the alignment maker may be an “X”, a “+”, an “L”, a “T”, a “V”, a square, a rhombus, or the like. A size of the alignment marker may be from about 0.5 mm to about 10 mm, or from about 10 mm to about 20 mm. In some embodiments, the alignment marker has a well-defined edge. A well-defined edge may be a material transition (e.g., from transformed material to pre-transformed material). A well-defined edge may be a transition from the alignment marker to a surrounding region (e.g., of the material bed). A well-defined edge may be characterized by a roughness of the alignment marker at or along the edge (e.g., along a side face of the edge. For example, an alignment marker edge roughness (e.g., arithmetic average of the roughness profile Ra value) may be from about 2 microns to about 30 microns, or from about 30 microns to about 100 microns.

At times, the in-situ calibration system includes an image processing module. Image processing may include comparing an image of the alignment marker arrangement against a reference, to determine any distortion in the energy beam positioning (e.g., across its processing field) by the optical assembly (e.g., by a component of the optical assembly). Image processing may include comparing an image of the alignment marker arrangement against a reference, to determine any deviation in position of the optical assembly from a requested position of the optical assembly with respect to the processing chamber (e.g., with respect to an optical window). The alignment marker arrangement may comprise alignment markers formed completely (e.g., in one step by the energy beam). The alignment marker arrangement may comprise combined (e.g., partial) alignment markers. The image processing may include recognition of alignment marker locations. Recognition of alignment marker locations may be performed on a one-by-one basis (e.g., per-alignment marker). Recognition of alignment marker positions may be performed image-wide (e.g., all alignment markers at once). Recognition of alignment marker positions may be performed on subsets of the image (e.g., for groups of alignment markers).

In some embodiments, a 3D printing system includes an image processor operatively coupled with the detection system. The image processor may be operatively coupled or included in a controller. The controller and/or processor may be in coupled with (e.g., in communication with) a guidance system for directing an energy beam, e.g., with a scanner of the optical assembly. The controller and/or processor may be in coupled with (e.g., in communication with) a translation mechanism (e.g., with servo motors) for positioning an array of optical assemblies with respect to the target surface. An image processor may perform image processing to determine a deviation between a given (e.g., measured) alignment marker position and its corresponding (e.g., commanded) reference position (e.g., from the reference image and/or image data vs. the requested alignment marker).

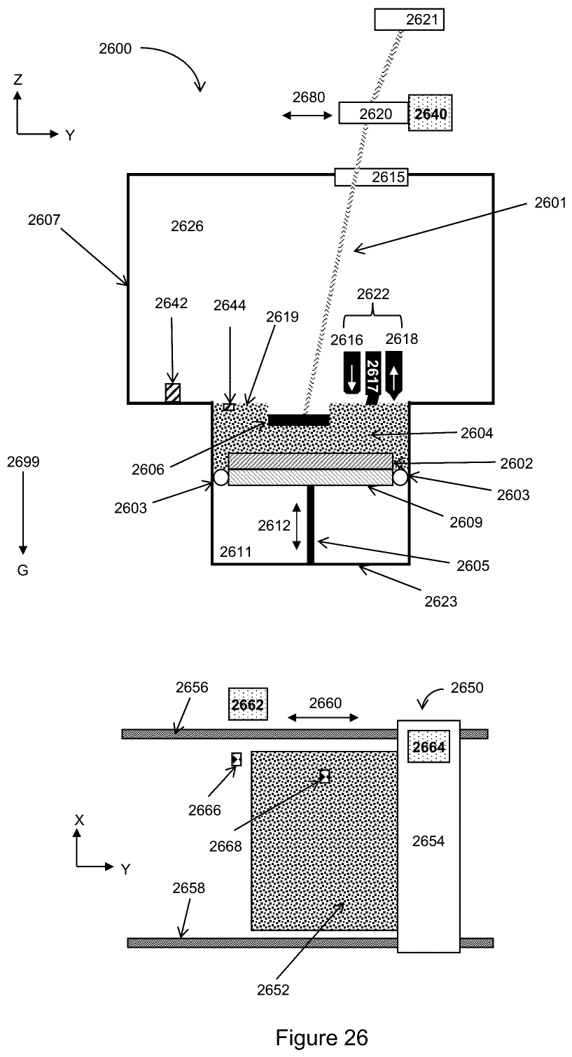

FIG. 26 depicts a schematic view of example of a 3D printing system including an interferometric detection system. A 3D printing system 2600 comprises an enclosure (e.g., processing chamber) 2607 coupled to a build module 2623. The 3D printing system 2600 includes an in-situ alignment system. The build module comprises an elevation mechanism 2605 to vertically translate a substrate (e.g., piston) 2609 along arrow 2612. A build platform 2602 is disposed on substrate (e.g., piston) 2609. Material bed 2604 is disposed above build platform 2602. The 3D printing system 2600 comprises a translatable optical system including an array of optical assemblies, e.g., optical assembly 2620 to direct energy beams, e.g., energy beam 2601 to a target surface of the material bed. Optical assembly 2620 can be translatable along axis 2680, e.g., translatable along an axis perpendicular to gravitational vector 2699. Energy source (e.g., laser source) 2621 generates energy beam 2601 that traverses through the optical assembly 2620 and through an optical window 2615 into enclosure (e.g., processing chamber) 2607 enclosing interior space 2626 that can include an atmosphere. The optical window 2615 is configured to allow the energy beam to pass through without (e.g., substantial) energetic loss. Seal 2603 encircles the substrate and/or build platform, e.g., to deter (e.g., prevent) migration of material of the material bed from reaching elevation mechanism 2605. Energy beam 2601 impinges upon a target surface (e.g., an exposed surface 2619 of material bed 2604), to form at least a portion of a 3D object 2606. As depicted in FIG. 26, the 3D printer comprises a layer dispensing mechanism 2622. The layer dispensing mechanism 2622 includes a material dispenser 2616 and a powder removal mechanism 2618 to form a layer of pre-transformed material (e.g., starting material) within the enclosure. Layer dispensing mechanism 2622 includes a leveler 2617. The material may be layered (e.g., spread) in the enclosure such as by using the layer dispensing mechanism 2622. In-situ alignment system includes a detector, e.g., detector 2640. As depicted, detector 2640 is a part of the optical system, e.g., the translatable optical system. A detector of the in-situ alignment system may optionally be stationary with respect to the enclosure 2607. Detector 2640 is arranged with respect to an optical window, e.g., optical window 2615, to have line-of-sight of at least a portion of a target surface, e.g., exposed surface 2619 of the material bed 2604 within the enclosure 2607. Alignment markers, e.g., alignment marker 2642, can be located within the interior space 2626 of the enclosure 2607 and adjacent to the target surface, e.g., the exposed surface 2619 of the material bed 2604. Alignment markers, e.g., alignment marker 2642, can be any alignment marker disclosed herein. Alignment markers, e.g., alignment marker 2642, can be a permanent or semi-permanent calibration feature within the enclosure 2607. Alignment markers, e.g., alignment marker 2644, can be located within the interior space 2626 of the enclosure 2607 and formed on the target surface, e.g., on the exposed surface 2619 of the material bed 2604. Alignment markers, e.g., alignment marker 2644, can be formed using energy beam 2601 on the target surface. For example, alignment markers can be any alignment marker disclosed herein. Alignment markers, e.g., alignment markers 2642, 2644, can be detectable (e.g., optically detectable) by a detector (e.g., by detector 2640). The detector may capture imaging data of the alignment marker to determine a characteristic of the alignment marker, e.g., position, shape, or orientation. The in-situ calibration system can perform image processing to compare the imaging data captured by the detector of the alignment marker against a reference, to determine a characteristic of the energy beam 2601, e.g., to determine a deviation in (A) the energy beam positioning (e.g., across its processing field) by the optical assembly (e.g., by a component of the optical assembly, (B) the position of the optical assembly from a requested position of the optical assembly with respect to the processing chamber (e.g., with respect to an optical window), or (C) a combination thereof. FIG. 26 depicts a schematic view of example of a 3D printing system including an interferometric detection system. As depicted in FIG. 26, a translatable optical system 2650 is arranged with respect to a target surface 2652, e.g., exposed surface of a material bed, within an enclosure of a 3D printing system. The translatable optical system 2650 includes a translation mechanism including a support mount 2654 that is configured to reversibly engage and disengage to an array of optical assemblies (not shown). The support mount 2654 is operatively coupled with rail(s), e.g., rails 2656, 2658, such that the support mount 2654 translates along the rails in direction 2660, e.g., along the Y-axis. In-situ alignment system includes at least one detector, e.g., detectors 2662, 2664, configured to capture imaging data of one or more alignment markers, e.g., alignment markers 2666, 5668. A detector, e.g., detector 2664, can be optionally operatively coupled with the translatable optical system, e.g., affixed to the support mount 2654. A detector, e.g., detector 2662, can be affixed to a surface of the enclosure, e.g., a ceiling of the processing chamber. Detectors have line-of-sight of at least a portion of the target surface 2652 within the enclosure. An alignment marker, e.g., alignment marker 2666, is offset from the target surface 2652 and within the enclosure. An alignment marker, e.g., alignment marker 2668, is located (e.g., formed) on the target surface 2652, e.g., an exposed surface of the material bed.

In some embodiments, a metrological detection system comprises a height mapper system. The height mapper system may comprise one or more detectors (e.g., also referred to herein as sensors), and an optical image generator. The one or more detectors may comprise a metrological detector, e.g., a video camera or a stills camera. The optical image generator may comprise a projector or a laser. The optical image generator may generate a detectable optical image. The optical image may comprise areas of different optical intensity having a detectable difference. For example, areas of light and no light. For example, areas of more intense light and areas of discernable diminished light. For example, the optical image generator may generate an optical image having detectable oscillating (e.g., fluctuating) intensity. The optical image may, or may not, vary in time. The optical image generator may project an oscillating image having areas of detectable different optical intensity. The height mapper system may include (1) one or more optical detectors, and (2) one or more optical image generators. The height mapper system may comprise, or be operatively coupled to, one or more processors configured to process the detected image. The one or more processors may be operatively coupled to, or part of, one or more controllers. The one or more controllers (e.g., control system) may be the control may be configured to control the 3D printing of one or more 3D objects. The control system may be a hierarchical control system (e.g., comprising three or more hierarchical levels of control). At times, the height mapper system may comprise a first detector and an additional detector distant from the first detector. The exposed surface of a material bed may be the target surface. The additional detector can be disposed distant from the first optical image generator that is configured to project the image on the exposed surface from another angle. The location of the additional detector can alleviate detection issues, e.g., due to specular reflection, by projecting an image on the exposed surface that will not cause saturation of the detector. At times, the height mapper system may comprise a first projector and an additional projector distant from the first projector. The additional projector can be disposed distant from the detector that is configured to detect the image on the exposed surface. The location of the additional projector can alleviate detection issues, e.g., due to specular reflection, by projecting an image on the exposed surface that will not cause saturation of the detector. A number of optical image generators for a height mapper system may depend, in part, on one or more optical components of the optical image generator, e.g., a lens. For example, a number of optical image generators utilized may depend on (a) a throw of the lens of the projector, (b) a focal length of the lens of the projector, (c) a depth of field of the lens of the projector, (d) a focus of the lens of the projector, or (e) any combination of (a) to (d). The throw of the lens is the distance between a projector lens and the target surface on which light passing the lens is incident. A number of optical image generators for a height mapper system may depend, in part, on one or more FLS of the target surface. For example, a number of optical image generators may be utilized to project a substantially resolvable projected image (e.g., stripes) onto the target surface. The stripes may have discernable stripes of higher intensity and lower intensity (e.g., not light) arranged interchangeably. A number of optical image generators (e.g., projectors) for a height mapper system may depend, in part, on an angle of incidence of the projected image by the optical image generator onto the target surface. For example, an angle of incidence that is at most about 25 degrees, 20 degrees, 15 degrees, or less from the plane of the target surface may result in shadow formation at the target surface (e.g., due to features of the target surface). At times, utilizing two or more optical image generators in the height mapper system may reduce a shadowing effect at the target surface. A number of detectors (e.g., cameras) for a height mapper system may depend, in part, on one or more FLS of the target surface. For example, a number of cameras may be utilized to capture the entire target surface within respective fields of view of the number of cameras. A number of detectors (e.g., cameras) fora height mapper system may depend, at least in part, on optical features generated at the target surface. For example, a number of cameras may be utilized to compensate for specular reflection generated at the target surface.

In some embodiments, optical image generator of the height mapper system projects an image, e.g., a light pattern, onto a target surface such as an exposed surface of a material bed. The target surface may comprise a protruding object such as a marker object, or at least a portion of a 3D object. The target surface may include a protruding object. The projected image may be a projected pattern. The projected image may be an oscillatory (e.g., fluctuating) pattern. The height mapper system may operate during at least a portion of the 3D printing. For example, the height mapper system can project an image before, after, and/or during the operation of the transforming energy beam. For example, the height mapper system can project an image before operation of a layer dispensing mechanism (e.g., recoater), e.g., to prevent harmful interaction of the layer dispensing mechanism with the protruding object. Harmful may be to the layer dispensing mechanism and/or to the protruding object. The projected image may comprise a shape. The shape may be a geometrical shape. The shape may be a rectangular shape. The shape may comprise a line. The shape may scan the target surface (e.g., exposed surface of the material bed) laterally, for example, from one side of the target surface to its opposing side. The shape may scan at least a portion of the target surface (e.g., in a lateral scan). The scan may be along the length of the exposed surface. The projected shape may span (e.g., occupy) at least a portion of the width of the target surface. For example, the shape may span a portion of the width of the target surface, the width of the target surface, or exceed the width of the target surface. The shape may scan the at least a portion of the target surface before, after and/or during the 3D printing. The scan may be controlled manually and/or automatically (e.g., by a controller). The projected shape may be of an electromagnetic radiation (e.g., visible light). The projected shape may be detectable. The projected shape may be formed by an energy beam scanning the target surface at a frequency of at least about 0.1 Hertz (Hz), 0.2 Hz, 0.5 Hz, 0.7 Hz, 1 Hz, 1.5 Hz, 2 Hz, 3 Hz, 4 Hz, 5 Hz, 6 Hz, 7 Hz, 8 Hz, 10 Hz, 20 Hz, 50 Hz, 100 Hz, 200 Hz, 300 Hz, 400 Hz, or 500 Hz. The projected shape may be formed by an energy beam scanning can the target surface at a frequency between any of the afore-mentioned frequencies (e.g., from about 0.1 Hz to about 500 Hz, from about 1 Hz to about 500 Hz, from about 1 Hz to about 100 Hz, from about 0.1 Hz to about 100 Hz, from about 0.1 Hz, to about 1 Hz, from about 0.5 Hz to about 8 Hz, or from about 1 Hz to about 8 Hz). At times, the projected image is altered in time. The projected image may alter in time by any of the above frequencies of the energy beam scan. The projected image may comprise (e.g., alternating) stripes. The distance between the stripes may be constant. The distance between the stripes may be variable. The distance between the stripes may be varied (e.g., manually or by a controller) in real time. Real time may be when performing metrological detection. Real time may be when building (e.g., printing) the 3D object. Real time may be before, during, or after a translation of the translation mechanism with respect to the processing chamber. The deviation from the regularity (e.g., linearity) of the stripes may reveal a height deviation from the average (or mean) exposed surface (e.g., of the material bed) height. The shape of the deviation from regularity (e.g., linearity) may reveal a shape characteristic of the buried 3D object portion (that is buried in the material bed). The deviated (e.g., curved) lines above a 3D object may relate to a warping of the 3D object that is (immediately) underneath. The regularity (e.g., linearity) of the lines detected above the 3D object may relate to the planarity of the top surface of the 3D object that is (immediately) underneath. For example, lines above the 3D object (whether buried in the material bed, or exposed) that match the regularity of the projected image, may reveal a planar top surface of a 3D object. For example, a deviation from the regularity of the projected image above the 3D object (whether buried in the material bed, or exposed), may reveal a deformation in the top surface of a 3D object. For example, linear lines above the 3D object may reveal a planar top surface of a 3D object, when the metrology projector projects stripes. For example, non-linear (e.g., curved) lines above the 3D object may reveal a non-planar (e.g., curved) top surface of a 3D object, when the metrology projector projects stripes. The reflectivity of the target surface may indicate the planar uniformity of the exposed surface. At times, a fluctuating pattern may be apparent on at least a portion of the target surface. In some embodiments the fluctuating pattern is detectable (e.g., may appear) on at least a portion of the target surface, wherein fluctuating intensity pattern is presented as a function of location (e.g., of at least a portion of the target surface).

At times, the target surface is planer and tilted with respect to the horizon. In some embodiments, the height mapper system detects a planar target surface that deviates from its horizontal placement. The target surface may or may not have protruding objects therefrom. The deviation from planarity may cause a deviation (e.g., deformation) in the projected image apparent on the planar surface that is horizontally oriented as compared to the original image utilized for the projection. For example, the projected image includes parallel rectangular shapes. When this image is projected on the target surface that is horizontally aligned, the shapes will be detected as parallel and rectangular. When this image is projected on the target surface that deviates from its horizontal alignment (e.g., a slanted surface), the image detected may include trapezoid shapes instead of the rectangular shapes. The degree of deviation between the rectangular shape to the trapezoid shape may be indicative on the degree and/or direction of deviation from planarity of the target surface. The size of the features (e.g., shapes) of the image as projected onto the target surface, may facilitate determination of the vertical distance of the target surface from the detector and/or projector. This distance may correlate to a distance from the floor of the build module.

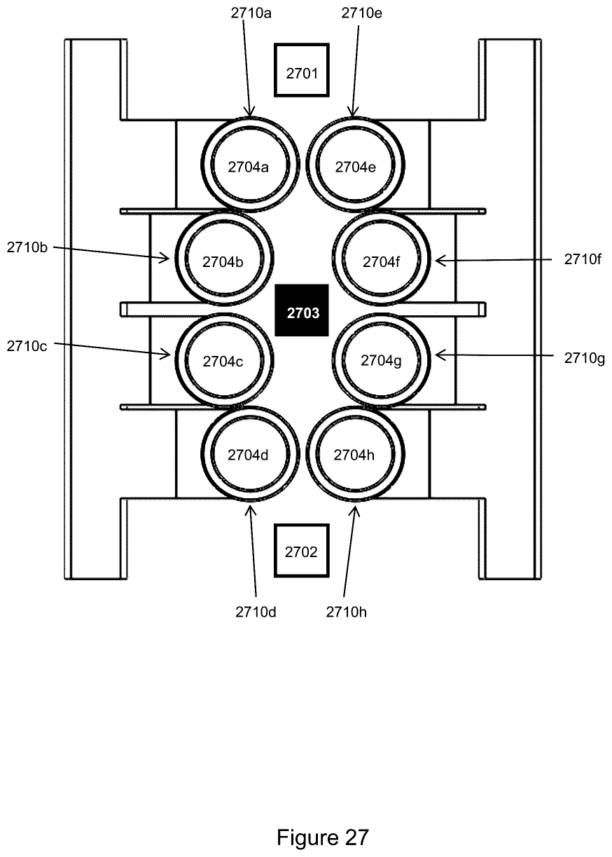

FIG. 27 illustrates an example of a device comprising a plurality of optical window holders 2710a-f disposed in two manifolds. Each of holders 2710a-d is supporting each of optical windows 2704a-d, respectively. The optical windows are similar to the optical windows depicted in FIG. 9, 958. Each of holders 2710e-h is supporting each of optical windows 2704e-h, respectively. The device comprising the optical windows 2704a-h is configured for disposition at a ceiling of a processing chamber in which one or more 3D object can be printed. Each of the optical windows 2704a-h is configured to facilitate passage of a transforming energy beam into the processing chamber. The device in FIG. 27 comprises two components 2701 and 2702 of a first type, and component 2703 of a different type. The first type can be a detector (e.g., a camera), and the second type can be a projector configured to project an image. The second type can be a detector (e.g., a metrological detector), and the first type can be a projector configured to project an image. Examples of gas flow system, 3D printers, related control system, related methods, apparatuses, systems, and program instructions (e.g., software), can be found in International Patent Application Serial No. PCT/US22/16550, filed on Feb. 16, 2022, each of which is incorporated herein by reference in its entirety.

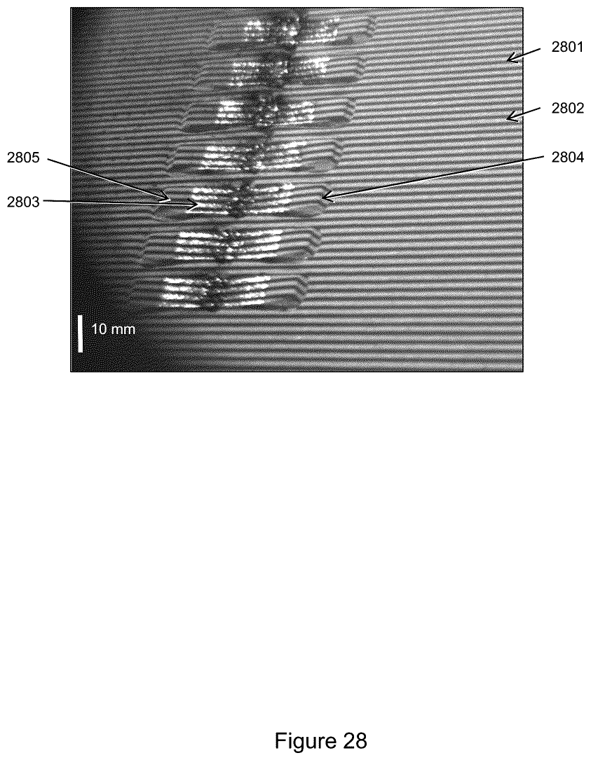

FIG. 28 shows an example of a metrological detector (e.g., included in a height mapper system) which projects a striped image on the exposed surface of a material bed (e.g., powder bed), which image comprises darker stripes 2801 and lighter stripes 2802. The material bed in the example of FIG. 28 is an Inconel 718 powder bed. In the example shown in FIG. 28, a 3D object 2805 is partially buried in the material bed and lifts a portion of the pre-transformed material (e.g., powder) of the material bed such that a deviation from the linearity of the stripes is visible. A portion 2803 of the 3D object 2805 is reflective, whereas the material bed is substantially less reflective. The deviated (e.g., curved) lines above a 3D object may relate to a warping of the 3D object (e.g., 2805) that is (immediately) underneath. The shape of the deviation from regularity (e.g., linearity) may reveal a shape characteristic of the buried 3D object portion (that is buried in the material bed). For example, the lines above the exposed surface 2804 of the 3D object are (e.g., substantially) linear, whereas the lines above the 3D object 2805 curve. The deviated (e.g., curved) lines above a 3D object may relate to a warping of the 3D object that is (immediately) underneath. The regularity (e.g., linearity) of the lines detected above the 3D object may relate to the planarity of the top surface 2804 of the 3D object 2805 that is (immediately) underneath.

At times, one or more components of the height mapper system may be translatable. At times, the translation mechanism is configured to translate at least one component of a metrological detection system. The at least one component of the metrological detection system may be affixed to a same or a different support mount than the support mount of the optical assemblies. The at least one component of the metrological detection system may be translated asynchronously or synchronously to a translation of the optical assemblies. For example, the one or more components of the height mapper system may be operatively coupled to, or a part of, the translatable optical system. For example, the one or more components of the height mapper system may be separately translatable from the translatable optical system. The one or more components that may be translatable can include (A) one or more detectors, (B) one or more projectors, or (C) a combination of (A) and (B). One or more components of the height mapper system may be stationary (e.g., non-translatable). The one or more stationary components can include (A) at least one detector, (B) at least one projector, or (C) a combination of (A) and (B). The height mapper system may include at least one translatable component and at least one non-translatable component. The at least one translatable component and the at least one non-translatable component may be of a same type or of a different type. The at least one translatable component may be of a first type (e.g., a detector or an optical image generator) and the at least one non-translatable component may of a second, different type (e.g., an optical image generator or a detector). For example, when first type is detector(s), the second type is projector(s). For example, when second type is detector(s), the first type is projector(s). The at least one translatable component may be affixed to (e.g., supported by) the translation mechanism, e.g., by a support mount of the translation mechanism. The at least one translatable component may be affixed to (e.g., supported by) an optical assembly of the array of optical assemblies. The at least one translatable component may be a detector having a first field of view of the target surface in a first position with respect to the translation mechanism and have a second field of view of the target surface in a second position with respect to the translation mechanism. The at least one translatable component may be a projector configured to project an image onto a first region of the target surface in a first position with respect to the translation mechanism and be configured to project the image onto a second region of the target surface in a second position with respect to the translation mechanism. The at least one translatable component may be arranged such that a central axis of the non-translatable component aligned with a gravitational vector does not intersect with the target surface. The at least one non-translatable component may be affixed to the enclosure (e.g., a ceiling or side wall of the processing chamber) and arranged such that a central axis of the non-translatable component aligned with a gravitational vector does not intersect with the target surface. At times, the height mapper system may comprise a plurality of components, e.g., (A) a plurality of detectors, (B) a plurality of projectors, or (C) a combination of (A) and (B). Fewer than the plurality of detectors may be utilized by the height mapper system at a given time, e.g., based at least in part on a location of the array of optical assemblies. Fewer than the plurality of projectors may be utilized by the height mapper system at a given time, e.g., based at least in part on a location of the array of optical assemblies. The plurality of components of the height mapper system may be arranged as at least one array of components. The plurality of components may be arranged as an array of detectors. The plurality of components may be arranged as an array of optical image generators. At least a portion of the array of detectors and at least a portion of the array of optical image generators may be overlapped with respect to one another such that detectors are interleaved, interlaced, staggered, or disposed interchangeably with respect to the optical image generators, e.g., projectors. For example, at least one optical image generator of the array of optical image generators is interleaved with detectors of the array of detectors. For example at least one detector is interleaved with detectors of the optical image generators.

At times, components of the height mapper system may be arranged with respect to at least one other component based on a symmetry of the components. Components of the height mapper system may be arranged with respect to at least one other component based on a plurality of symmetries of the components. For example, a location of a detector of the height mapper system may depend at least in part on a location of (A) another detector of the height mapper system, (B) an optical image generator of the height mapper system, or (C) a combination of (A) and (B). For example, a location of an optical image generator of the height mapper system may depend in part on a location of (A) another optical image generator of the height mapper system, (B) a detector of the height mapper system, or (C) a combination of (A) and (B). At times, components of the height mapper system may comprise a set of optical image generator(s) and detector(s). For example, one optical image generator and two detectors. For example, two optical image generators and one detector. For example, two or more optical image generators and two or more detectors. The height mapper system may comprise multiple sets of components, where each set of components may be arranged with respect to another set of components via one or more symmetries. At least one component of the height mapper system may be arranged with respect to the array of optical assemblies. The at least one component of the height mapper system may be arranged between linear arrays of the optical assemblies. Between may comprise bounded on two sides by a central axis of each of the linear arrays. Between may comprise located adjacent to (e.g., immediately proximate) to respective central axes of each of the linear arrays of optical assemblies. Between may comprise being two immediately adjacent linear arrays devoid of an intervening linear array disposed between the two immediately adjacent linear arrays. Between may comprise located adjacent to (e.g., immediately proximate) to respective outer surfaces of respective housings of at least two optical assemblies. Between may comprise being two immediately adjacent optical assemblies devoid of an intervening optical assembly disposed between the two immediately adjacent optical assemblies.

At times, at least one optical assembly of the array of optical assemblies includes a component of the height mapper system enclosed by a housing of the optical assembly. At times, each optical assembly of the array of optical assemblies includes a component of the height mapper system enclosed by a respective housing of each optical assembly. At times, at least one optical assembly of the array of optical assemblies excludes (does not include) a component of the height mapper system enclosed by the housing of the optical assembly. The component may comprise a detector or an optical image generator (e.g., a projector). The detector may be a camera, e.g., a video camera or a stills camera. The detector may be arranged with respect to the optical assembly such that at least a portion of a field of view of the detector overlaps with an opening of the housing of the optical assembly. The detector may be arranged with respect to the optical assembly such that at least a portion of a field of view of the detector overlaps with a beam path of an energy beam of the optical assembly. The detector may be arranged with respect to the optical assembly such that at least a portion of the field of view of the detector overlaps with an optical window coupled with an opening of the optical assembly through which energy beam(s) emerge on their way to the target surface. The detector may be arranged with respect to the optical assembly such that the detector may capture imaging data within a field of view of the detector at least a portion of the target surface (e.g., at least a portion of a processing region of the target surface). At times, a first type of component of the height mapper system is enclosed within at least one housing of an optical assembly (e.g., a detector or an optical image generator, and a second, different type of component of the height mapper system is located outside the housing of the optical assembly (e.g., an optical image generator or detector). At times, at least two detectors may be arranged with respect to respective optical assemblies of the array of optical assemblies, where the two detectors may capture imaging data with respective fields of view of the detectors. The at least two detectors may have at least a portion of overlapping fields of view. The at least two detectors may have adjacent fields of view, e.g., may capture adjacent (e.g., abutting) portions of the target surface within their respective fields of view. For example, each detector may capture a field of view having a resolution area of about 300 millimeters (mm)×300 mm, about 250 mm×250 mm, about 200 mm×200 mm, about 150 mm×150 mm, or less. For example, each detector may capture a field of view having a resolution area of about 6%, about 5%, about 4%, about 3%, about 2%, about 1%, about 0.5%, about 0.25% or less of the area of the target surface. Each detector may capture a field of view having a resolution area between any of the aforementioned values relative to the area of the target surface, for example, from about 6% to about 3%, from about 4% to about 1%, or from about 2% to about 0.25%. Captured imaging data may be processed to combine (e.g., stitch) the imaging data from different detectors together (e.g., mosaicked) to generate combined imaging data of the at least two fields of view.

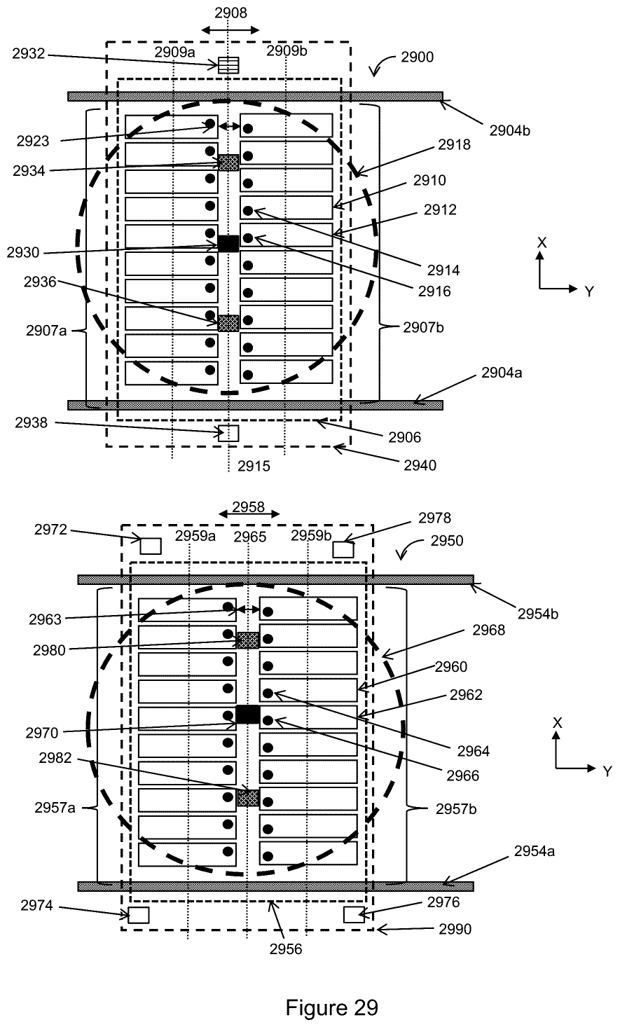

FIG. 29 depicts an example translatable optical system 2900 including a height mapper system. Translatable optical system 2900 includes a guidance system that is a rail system, including rails 2904a, and 2904b. A support mount 2906 is operatively coupled with the rails 2904a, and 2904b such that the support mount may translate along rails 2904a, 2904b along a direction 2908, e.g., aligned with the Y-axis. Rails 2904a, 2904b and/or support mount 2906 may be operatively coupled with an actuator (e.g., a motor) and an encoder (e.g., an optical encoder), not shown. The support mount 2906 is operatively coupled with (e.g., engaged with) optical assemblies, e.g., optical assemblies 2910, 2912. The optical assemblies are arranged in respective linear arrays 2907a, 2907b, where the optical assemblies of each linear array are arranged along a respective central axis 2909a, 2909b. The optical assemblies may be reversibly engaged with the support mount 2906 by fixtures, e.g., mounting hardware. The support mount 2906 can align the openings of the optical assemblies, e.g., openings 2914, 2916, with respect to a target surface 2918 within an enclosure. The openings of the optical assemblies are aligned with optical window(s), e.g., on a ceiling of a processing chamber (now shown). Adjacent optical assemblies are separated along the y-axis by a gap 2923. Gap 2923 is sufficiently large to accommodate one or more components of the height mapper system. The height mapper system includes at least one component of a first type, e.g., either a detector or an optical image generator, e.g., component 2930. The height mapper system includes at least one component of a second type, e.g., either an optical image generator or a detector, e.g., component 2932. The at least one component of the first type and the at least one component of the second type are aligned with axis 2915, that is parallel to axis 2909a, 2909b (e.g., parallel to the X-axis). Optionally, the height mapper system includes two or more components of the first type, e.g., components 2930, 2934, 2936. Optionally, the height mapper system includes two or more components of the second type, e.g., components 2932, 2938. As depicted in FIG. 29, the first type of components is operatively coupled with the support mount 2906 and configured to translate with the translatable optical system 2900. Optionally, the second type of components is not operatively coupled with the support mount 2906 and can be affixed to a surface of the enclosure (e.g., a ceiling of the processing chamber). Optionally, the second type of components may be operatively coupled with the support mount 2906 or to another translatable mount 2940 that is configured to translated along direction 2908. FIG. 29 depicts an example translatable optical system 2950 including a height mapper system. Translatable optical system 2950 includes a rail system including rails 2954a, 2954b. A support mount 2956 is operatively coupled with the rails 2954a, 2954b such that the support mount may translate along rails 2954a, 2954b along a direction 2958, e.g., aligned with the Y-axis. Rails 2954a, 2954b and/or support mount 2956 may be operatively coupled with an actuator (e.g., a motor) and an encoder (e.g., an optical encoder), not shown. The support mount 2956 is operatively coupled with (e.g., engaged with) optical assemblies, e.g., optical assemblies 2960, 2962. The optical assemblies are arranged in respective linear arrays 2957a, 2957b, where the optical assemblies of each linear array are arranged along a respective central axis 2959a, 2959b. The optical assemblies may be reversibly engaged with the support mount 2956 by fixtures, e.g., mounting hardware. The support mount 2956 can align the openings of the optical assemblies, e.g., opening 2964, 2966, with respect to a target surface 2968 within an enclosure. The openings of the optical assemblies are aligned with optical window(s), e.g., on a ceiling of a processing chamber (now shown). Adjacent optical assemblies are separated along the y-axis by a gap 2963. Gap 2963 is sufficiently large to accommodate one or more components of the height mapper system. The height mapper system includes at least one component of a first type, e.g., either a detector or an optical image generator, e.g., component 2970. The at least one component of the first type is aligned with axis 2965, that is parallel to axis 2959a, 2959b (e.g., parallel to the X-axis). The height mapper system includes at least one component of a second type, e.g., either an optical image generator or a detector, e.g., at least one of components 2972, 2974, 2976, and 2978. Optionally, the height mapper system includes two or more components of the first type, e.g., components 2970, 2980, 2982. Optionally, the height mapper system includes two or more components of the second type, e.g., two or more of components 2972, 2974, 2976, and 2978. As depicted in FIG. 29, the first type of components is operatively coupled with the support mount 2956 and configured to translate with the translatable optical system 2950. Optionally, the second type of components is not operatively coupled with the support mount 2956 and can be affixed to a surface of the enclosure (e.g., a ceiling of the processing chamber). Optionally, the second type of components may be operatively coupled with the support mount 2956 or to another translatable mount 2990 that is configured to translated along direction 2958.

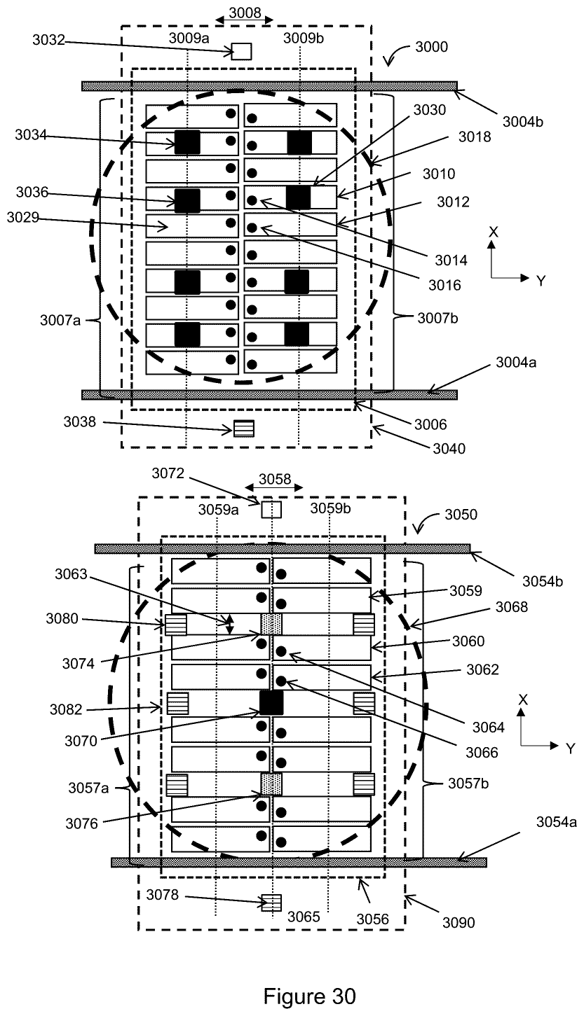

FIG. 30 depicts an example translatable optical system 3000 including a height mapper system. Translatable optical system 3000 includes a rail system including rails 3004a, 3004b. A support mount 3006 is operatively coupled with the rails 3004a, 3004b such that the support mount may translate along rails 3004a, 3004b along a direction 3008, e.g., aligned with the Y-axis. Rails 3004a, 3004b and/or support mount 3006 may be operatively coupled with an actuator (e.g., a motor) and an encoder (e.g., an optical encoder), not shown. The support mount 3006 is operatively coupled with (e.g., engaged with) optical assemblies, e.g., optical assemblies 3010, 3012. The optical assemblies are arranged in respective linear arrays 3007a, 3007b, where the optical assemblies of each linear array are arranged along a respective central axis 3009a, 3009b. The optical assemblies may be reversibly engaged with the support mount 3006 by fixtures, e.g., mounting hardware. The support mount 3006 can align the openings of the optical assemblies, e.g., optical windows 3014, 3016, with respect to a target surface 3018 within an enclosure. The openings of the optical assemblies are aligned with optical window(s), e.g., on a ceiling of a processing chamber (now shown). The height mapper system includes components, where at least one component of the height mapper system is arranged within a housing of an optical assembly, e.g., component 3030 within optical assembly 3010. Optionally, at least one optical assembly does not include a component of the height mapper system, e.g., optical assembly 3029. The height mapper system includes at least one component of a first type, e.g., either a detector or an optical image generator, e.g., component 3030. The height mapper system includes at least one component of a second type, e.g., either an optical image generator or a detector, e.g., component 3032. Optionally, the height mapper system includes two or more components of the first type, e.g., components 3030, 3034, 3036. Optionally, the height mapper system includes two or more components of the second type, e.g., components 3032, 3038. As depicted in FIG. 30, the first type of components is enclosed within housings of the optical assemblies and operatively coupled with the support mount 3006 such that the first type of components is configured to translate with the translatable optical system 3000. Optionally, the second type of components is not operatively coupled with the support mount 3006 and can be affixed to a surface of the enclosure (e.g., a ceiling of the processing chamber). Optionally, the second type of components may be operatively coupled with the support mount 3006 or to another translatable mount 3040 that is configured to translated along direction 3008. FIG. 30 depicts an example translatable optical system 3050 including a height mapper system. Translatable optical system 3050 includes a rail system including rails 3054a, 3054b. A support mount 3056 is operatively coupled with the rails 3054a, 3054b such that the support mount may translate along rails 3054a, 3054b along a direction 3058, e.g., aligned with the Y-axis. Rails 3054a, 3054b and/or support mount 3056 may be operatively coupled with an actuator (e.g., a motor) and an encoder (e.g., an optical encoder), not shown. The support mount 3056 is operatively coupled with (e.g., engaged with) optical assemblies, e.g., optical assemblies 3060, 3062. The optical assemblies are arranged in respective linear arrays 3057a, 3057b, where the optical assemblies of each linear array are arranged along a respective central axis 3059a, 3059b. The optical assemblies may be reversibly engaged with the support mount 3056 by fixtures, e.g., mounting hardware. The support mount 3056 can align the openings of the optical assemblies, e.g., openings 3064, 3066, with respect to a target surface 3068 within an enclosure. The openings of the optical assemblies are aligned with optical window(s), e.g., on a ceiling of a processing chamber (now shown). Two or more optical assemblies are separated along the X-axis by a gap 3063, e.g., optical assembly 3060 and 3059 are separated by gap 3063. Gap 3063 is sufficiently large to accommodate one or more components of the height mapper system. The height mapper system includes at least one component of a first type, e.g., either a detector or an optical image generator, e.g., component 3070. The at least one component of the first type is aligned with axis 3065, that is parallel to axis 3059a, 3059b (e.g., parallel to the X-axis). The height mapper system includes at least one component of a second type, e.g., either an optical image generator or a detector, e.g., at least one of components 3072. Optionally, the height mapper system includes two or more components of the first type, e.g., components 3070, 3074, 3076. Optionally, the height mapper system includes two or more components of the second type, e.g., components 3072, 3078, 3080, 3082. As depicted in FIG. 30, the first type of components is operatively coupled with the support mount 3056 and configured to translate with the translatable optical system 3050. Optionally, the second type of components is not operatively coupled with the support mount 3056 and can be affixed to a surface of the enclosure (e.g., a ceiling of the processing chamber). Optionally, the second type of components may be operatively coupled with the support mount 3056 or to another translatable mount 3090 that is configured to translated along direction 3058.

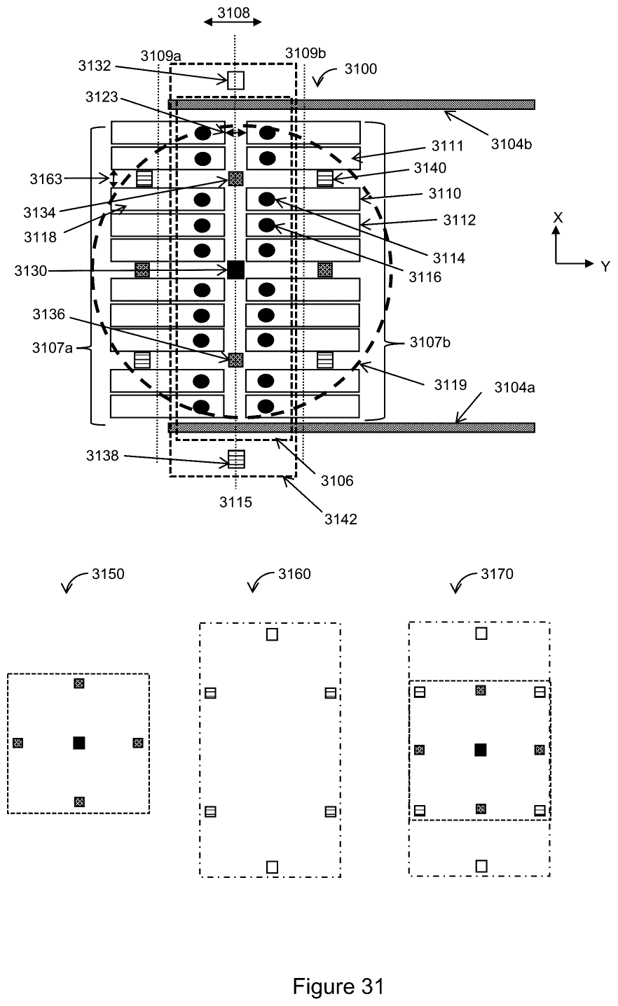

FIG. 31 depicts an example translatable optical system 3100 including a height mapper system. Translatable optical system 3100 includes a rail system including rails 3104a, 3104b. A support mount 3106 is operatively coupled with the rails 3104a, 3104b such that the support mount may translate along rails 3104a, 3104b along a direction 3108, e.g., aligned with the Y-axis. Rails 3104a, 3104b and/or support mount 3106 may be operatively coupled with an actuator (e.g., a motor) and an encoder (e.g., an optical encoder), not shown. The support mount 3106 is operatively coupled with (e.g., engaged with) optical assemblies, e.g., optical assemblies 3110, 3112. The optical assemblies are arranged in respective linear arrays 3107a, 3107b, where the optical assemblies of each linear array are arranged along a respective central axis 3109a, 3109b. The optical assemblies may be reversibly engaged with the support mount 3106 by fixtures, e.g., mounting hardware. The support mount 3106 can align the openings of the optical assemblies, e.g., openings 3114, 3116, with respect to a target surface 3119 within an enclosure. Adjacent optical assemblies are separated along the y-axis by a spacing 3123, e.g., optical assemblies 3110 and 3118 are separated by spacing 3123. Spacing 3123 is sufficiently large to accommodate one or more components of the height mapper system. Two or more optical assemblies are separated along the X-axis by a gap 3163, e.g., optical assembly 3110 and 3111 are separated by gap 3163. Gap 3163 is sufficiently large to accommodate one or more components of the height mapper system. The height mapper system includes at least one component of a first type, e.g., either a detector or an optical image generator, e.g., component 3130. The height mapper system includes at least one component of a second type, e.g., either an optical image generator or a detector, e.g., component 3132. The at least one component of the first type and the at least one component of the second type are aligned with axis 3115, that is parallel to axis 3109a, 3109b (e.g., parallel to the X-axis). Optionally, the height mapper system includes two or more components of the first type, e.g., components 3130, 3134, 3136. Optionally, the height mapper system includes two or more components of the second type, e.g., components 3132, 3138, 3140. As depicted in FIG. 31, the first type of components is operatively coupled with the support mount 3106 and configured to translate with the translatable optical system 3100. Optionally, the second type of components is not operatively coupled with the support mount 3106 and can be affixed to a surface of the enclosure (e.g., a ceiling of the processing chamber). Optionally, the second type of components may be operatively coupled with the support mount 3106 or to another translatable mount 3142 that is configured to translated along direction 3108. FIG. 31 depicts schematic views of example arrays of components of a height mapper system. A first type of components, e.g., a detector or an optical image generator, is arranged in an array of first type components 3150. A second type of components, e.g., an optical image generator or a detector, is arranged in an array of second type components 3160. The array of the first type components 3150 and the array of the second type components 3160 are overlaid such that the two types of components are interleaved, overlapped, staggered, or disposed interchangeably in a combined array of first and second type components 3170.

At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS between any of the afore-mentioned FLS values (e.g., from about 1 nm to about 20 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dpi. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80 μm, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

At times, a 3D printing process, e.g., 3D printing processes described herein, may result in a physical signature in a 3D object such as a material signature. A physical signature may comprise a detectable deviation or change on a surface of the 3D object.

At times, the printing of a (e.g., complex) 3D object involves using a combination of methodologies (e.g., having respective process parameters). In some cases, different methodologies may be used to transform different portions of the object. Various apparatuses (e.g., controllers), systems (e.g., 3D printers), software, methods related to types of energy beam and formation of 3D objects, as well as various control schemes are described in U.S. patent application Ser. No. 15/435,128; International Patent Application number PCT/US17/18191; European Patent Application number EP17156707.6; and International Patent Application number PCT/US18/20406, each of which is entirely incorporated herein by reference.

In some embodiments, the one or more energy beams used to form the 3D object forms melt pools. The melt pools can have any shape and size. For example, the one or more energy beams can irradiate pre-transformed material to form a high aspect ratio melt pool. Such energy beam processing may be referred to as a high aspect ratio melt pool (abbreviated as “HARMP”) energy beam. For example, a high aspect ratio (e.g., deep) melt pool may span a least about 2, 2¼, 2½, 2¾, 3, 4, 5, or 6 layers of pre-transformed and/or transformed material. Examples of 3D printing systems, apparatuses, devices, and components, controllers, software, and 3D printing processes (e.g., melt pool generation, melt pool control, and melt pool processing conditions) can be found in International Patent Application Serial No. PCT/US19/24402 filed Mar. 27, 2019, which is entirely incorporated herein by reference.

In some instances, a high aspect ratio melt pool (HARMP) energy beam is used to modify (e.g., densify) a transformed material. At times, an energy beam may cause a portion of the one or more layers of material to exit the HARMP volume during its formation. The exiting material may comprise vapor, plasma, and/or other forms of sputtered (e.g., liquid (e.g., molten)) material. The exiting material may form a HARMP well (e.g., a “keyhole”) which can correspond to an open cavity. The HARMP well may be formed within at least a portion of the HARMP. At times, the energy beam may be moved in a lateral direction to elongate the HARMP well in the lateral direction, for example, to increase an amount of transformed material in the lateral direction. In some cases, the opening of the HARMP well closes to form a pore (e.g., void) in the HARMP. The HARMP may comprise one or more pores. The position and/or number of pores may be controlled (e.g., in real time (e.g., using one or more controllers)). The controller(s) may control at least one characteristic of the energy beam and/or the energy source that generates it. In some instances, the HARMP comprises (e.g., on average) a low porosity percentage. In some instances, the HARMP comprises (e.g., substantially) no (e.g., detectable) pores. The closing may comprise reducing (e.g., gradually) an intensity of the energy beam. The intensity reduction may include reducing a power per unit area of the energy beam. At times, the gradual intensity reduction of the energy beam may alter (e.g., reduce) its degree of penetration into the HARMP. A reduction of the energy beam penetration into the HARMP may allow liquid material to settle at the bottom of the HARMP well and close the opening of the HARMP well. A reduction of the energy beam penetration into the HARMP may reduce the amount of material that exits the HARMP during the irradiation of the energy beam, and thus reduce the size of the HARMP well.

In some embodiments, the printing methodologies may comprise gradually cooling melt pools (e.g., HARMP or other types of melt pools). The gradually cooling melt pools may be brought upon by gradually reducing an intensity of the energy beam generating the melt pool. The gradual intensity reduction may cause slow cooling of the melt pools. The slow cooling may facilitate organization of the material upon cooling. Such organization may materialize as formation of detectable grains. The grains may comprise crystals such as single crystals. The crystals may comprise microcrystals. The grains may be sufficiently large to be detected in a microscope such as an optical microscope, or in an electrical microscope (e.g., scanning electron microscope or tunneling electron microscope). The grain may span at least about 40%, 50%, 60%, 70%, 80%, 90% or 95% of the FLS of the meltpool in which it is generated. The grain may span any value between the aforementioned values, for example, from about 40% to about 70%, from about 50% to about 90%, or from about 70% to about 95%. The grain may have defined facets. The coherence length of the crystal may span at least about 10%, 20%, 40%, 50%, 60%, or 70%, of the FLS of the grain. The coherence length of the crystal may span any value between the aforementioned values, for example, from about 10% to about 50%, from about 40% to about 60%, or from about 40% to about 70%, of the FLS of the grain. The coherence length of the crystal may span at least about 10%, 20%, 40%, 50%, 60%, or 70%, of the FLS of the meltpool in which it is generated. The coherence length of the crystal may span any value between the aforementioned values, for example, from about 10% to about 50%, from about 40% to about 60%, or from about 40% to about 70%, of the FLS of the melt pool in which it is generated. The grain may have defined facets such as angled facets.

At times, the combination of methodologies (e.g., having respective process parameters) can result in the three-dimensional object formed utilizing the methodologies to comprise microstructures indicative of the combination of methodologies. For example, the microstructures can be indicative of a number of different methodologies that were utilized to form the three-dimensional object, e.g., one or more, at least two, two or more different methodologies. The methodologies may include variations related to the one or more energy beams utilized to form the three-dimensional object, for example, (i) a number of energy beams utilized to form the three-dimensional object, (ii) respective angles of incidence of the one or more energy beams utilized to form the three-dimensional object, (iii) an amount of overlap between processing regions (e.g., processing cones) of respective energy beams utilized to form the three-dimensional object, (iv) processing conditions for the energy beams (e.g., power, spot size, dwell time, or (iv) any combination thereof. The methodologies may include variations in the processing conditions utilized, for example, different processing conditions may be utilized based at least in part on a requested object geometry, e.g., an overhang angle, a core, or a cavity ceiling.

In some cases, a 3D object includes one or more features that may be indicative of the process(es) used to form the 3D object. The features may be microstructure features, which are very small features (e.g., as revealed by imaging techniques such as various microscopies, e.g., as disclosed herein). In some cases, the microstructure features influence and/or dictate physical properties of the 3D object, such as strength, toughness, ductility, hardness, corrosion resistance, thermal conductivity and/or wear resistance. The microstructure features may include melt pools, metallurgical microstructures, grain (e.g., crystal) structures and/or material phases. Metallurgical microstructures can comprise cells or dendrites. The shape, size and/or orientation of the microstructure features may be influenced by and/or indicative of the transformation (e.g., melting) process. For example, the size and/or shape of a melt pool may at least partially depend on the power density and/or dwell time of the energy beam at the target surface. The grain (e.g., crystal) structure, material phase, and/or metallurgical microstructure can at least partially depend on the solidification and/or cooling dynamics associated with the transformation process. For example, the type, size, shape and/or orientation of the microstructures may be influenced by thermal gradients in the molten material and/or the rate in which the molten material cools. In some cases, different process conditions (e.g., energy beam power and/or dwell time) result in different microstructures. The cooling rate may correspond to a hardening rate of the hardened material. In some embodiments, the microstructures are indicative of a rate of cooling, hardening and/or crystallization. In some embodiments, the microstructures are indicative of faster or slower cooling, hardening and/or grain formation (e.g., crystallization) rates. In some cases, the microstructure features are dendrites, which are branched crystal structures. The crystal structures may be formed during the cooling and/or hardening of the material while forming the 3D object. In some cases, the microstructures (e.g., dendrites) are in the form of elongated structures.

At times, the combination of methodologies (e.g., have respective process parameters) may result in the three-dimensional object formed utilizing the methodologies to comprise microstructures including directional indicators indicative of the combination of methodologies. Directional indicators may comprise a microstructure indicative of a direction of incidence on the target surface utilized to form (a portion of) the three-dimensional object. For example, a dimension of the microstructure may be oriented along an axis with respect to the target surface. The axis of the microstructure may be indicative of an angle of incidence of the energy beam utilized to form the microstructure, e.g., aligned with an angle of incidence. For example, a dimension of the microstructure may comprise a length of the microstructure. For example, a dimension of the microstructure is a major axis (e.g., a larger dimension) of the microstructure. The dimension may be oriented along a dendritic growth direction of the microstructure. For example, a dimension of the microstructure may be a minor axis (e.g., a smaller dimension) of the microstructure. The dimension may be oriented at an angle with respect to a growth (e.g., layerwise) direction. The dimension may be oriented perpendicular to a growth (e.g., layerwise) direction. At times, the three-dimensional object may comprise at least one directional indicator. The three-dimensional object may comprise two or more directional indicators. The three-dimensional object may comprise a plurality of direction indicators. A number of directional indicators in a three-dimensional object may relate (A) to a number of energy beams utilized in forming the three-dimensional, (B) a number of optical assemblies utilized in forming the three-dimensional object, (C) a number of angles of incidence of energy beam(s) impinging on the target surface in forming the three-dimensional object, or (D) any combination of (A) to (C). A number of directional indicators in a three-dimensional object may relate to material properties of the material utilized to form the three-dimensional object. Material properties may include, for example, (i) material composition, (ii) powder size distribution, (iii) atmosphere in an enclosure including the three-dimensional printing of the object, or (iv) any combination thereof. A number of directional indicators in a three-dimensional object may relate to processing parameters utilized in forming the three-dimensional object. For example, processing parameters may comprise (a) energy beam power, (b) energy beam spot size, (c) energy beam dwell time, (d) energy beam scan speed, (e) a depth of penetration into the material bed, or (f) any combination of (a) to (e). A directional indicator may comprise a hatching pattern, tiling pattern, keyholing structure, dendrite, or another microstructure resulting from the three-dimensional printing processes utilized to form the three-dimensional object. The dendrites may comprise columnar dendrites, or equiaxed dendrites.

At times, a three-dimensional object formed utilizing the three-dimensional printing process includes directional microstructures (e.g., microstructures indicative of a direction of energy beam projection) in which microstructures are apparent in (A) at least two different processing regions, (B) at least two different processing cones of adjacent (e.g., abutting) energy beams, or (C) a combination thereof. The directional microstructures may be elongated in a direction related to a direction of energy beam impingement on the target surface (e.g., on the exposed surface of the material bed) from which the three-dimensional object is printed. The three-dimensional object may comprise portions (e.g., regions) including directional microstructures which are all (e.g., substantially) aligned with respect to each other, e.g., aligned along a same axis. For example, a portion of the three-dimensional object where a single energy beam is utilized to form the portion of the three-dimensional object, may have directional indicators aligned in a single direction (e.g., indicative of an angle of incidence of the energy beam with respect to the target surface). The three-dimensional object may comprise portions (e.g., regions) including directional microstructures which are aligned along two or more directions with respect to each other, e.g., aligned with respect to two or more axis. For example, a portion of the three-dimensional object where two or more energy beams is utilized to form the portion of the three-dimensional object, may have directional indicators aligned in two or more directions (e.g., indicative of an angles of incidence of the respective energy beams with respect to the target surface). The three-dimensional object may comprise portions (e.g., regions) including no (e.g., zero) direction indicators where two or more energy beams overlapped in forming the portion of the three-dimensional object. The dimensional indicators in the overlap portions may be blurred (e.g., unclear or anisotropic). For example, a portion of the three-dimensional object where two or more energy beams overlapped to form the portion of the three-dimensional object, may have zero directional indicators. At times, different processing conditions are utilized to form a three-dimensional object which may result in different microstructures formed in the three-dimensional object corresponding to the different processing conditions. Different processing conditions may be utilized to form three-dimensional objects based in part on a requested object geometry, e.g., an overhang angle, a core, or a cavity ceiling.

In some embodiments the microstructure of a slower hardening region is (on average) different from microstructures of a faster hardening region of the 3D object. Different may be in size, material type, microstructure shape (e.g., globular or elongated), crystal structure, alignment (e.g., direction), and/or coherence length. In some embodiments, the microstructures of the skin are more organized than the microstructures of the core. More organized may comprise more aligned, form a grain (e.g., crystal with larger coherence length), form a grain such as with more organized units, form a grain such as with more repeating units, or form larger repeating units. Larger may comprise longer or wider. In some embodiments, the grains (e.g., dendrites) of the skin are more organized (e.g., aligned) than the grains of the core. For example, in some cases the grains (e.g., at least about 2, 5, 10, 20, 50 or 100 grains) of the skin are (e.g., substantially) aligned with respect to an alignment line (e.g., build direction). In some embodiments, the FLS of the microstructures of a first object portion generated by a first printing methodology are greater than the respective FLS of the microstructures of a second object portion generated by a second printing methodology. In some embodiments, the FLS of the grain of a first microstructure generated by a first printing methodology are larger than the respective FLS of the grains of a second object portion generated by a second printing methodology.

In some embodiments, the 3D object is printed using printing process parameters. The printing process parameters may be adjusted depending which part of the overhang is being printed and/or the type of overhang. For example, a skin (e.g., bottom skin) of the overhang may be printed using one or more different conditions compared to a core portion (also referred to herein as the “core” or “interior portion”) of the overhang and/or 3D object. The bottom skin of the overhang can refer to a portion (e.g., a layer) of the overhang that includes the surface of the overhang that is most proximate to the support surface of the platform (e.g., bottom-most surface of the overhang). In some embodiments, the 3D object comprises at least one overhang. The overhang of the 3D object may be at least partially defined by the orientation of the 3D object with respect to the target surface (e.g., exposed surface of the material bed and/or the support surface of the platform) and/or a (e.g., average) layering plane. The overhang of the 3D object may be at least partially defined by the orientation of the 3D object with respect to the layering plane, and/or direction perpendicular to the build direction (e.g., exposed surface of the material bed and/or the support surface of the platform) and/or a (e.g., average) layering plane. The build direction may be opposite to the direction in which the platform is lowered during the printing. The build direction may be the direction of layerwise formation (e.g., direction of deposition one layer on another, e.g., growth direction of the 3D object during its printing). The growth direction may oppose the direction in which the platform is lowered during the printing. For example, an overhang portion of a 3D object may be oriented at shallow, steep and/or intermediate angle with respect to the target surface, layering plane, and/or the direction perpendicular to the 3D object's growth direction, during printing.

In some embodiments, the 3D object comprises one or more layering planes N of the layered structure. A layering plane can be used to refer to an orientation of a layer of the 3D object during its printing. In some embodiments, a layering plane is (e.g., substantially) parallel to the support surface of the platform, (e.g., substantially) parallel to the exposed surface of the material bed, and/or (e.g., substantially) orthogonal (e.g., perpendicular) to the gravitational field vector. The layering plane may be the average or mean plane of a layer of hardened material (as part of the 3D object). The layer structure may comprise any material(s) used for 3D printing. Each layer of the 3D structure (e.g., 3D object) can be made of a single material or of multiple materials. The 3D object may be composed of a composite material. In some cases, the orientation of the layering plane can be identified in a 3D object by inspection (e.g., using X-ray, optical microscopy, scanning electron microscopy and/or tunneling electron microscopy).

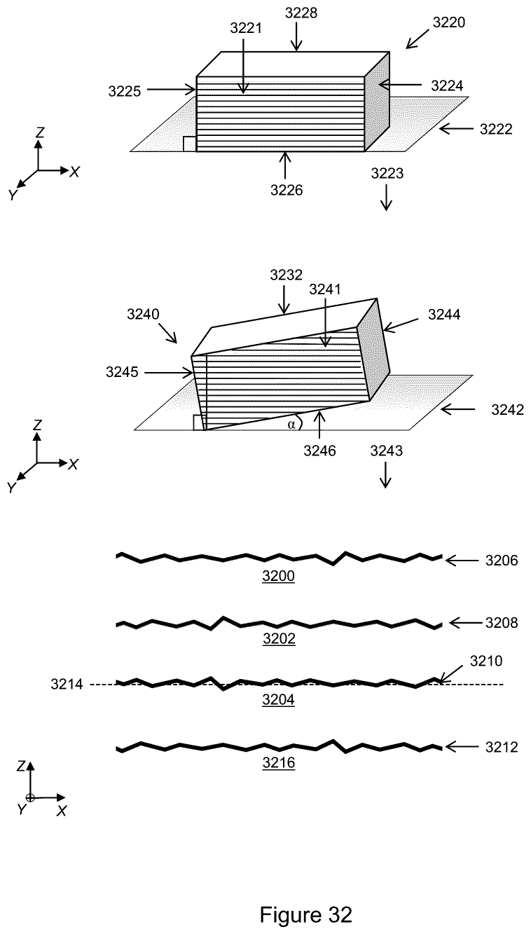

A layering plane of a 3D object may be at any angle with respect to a surface of the surface of the 3D object. The angle may reveal the angle at which the object (or a portion of the object) was oriented with respect to the surface of the build platform. FIG. 32 shows an example 3D object 3220 that is formed (e.g., substantially) horizontally on a platform 3222 and/or (e.g., substantially) vertically with respect to the gravity vector 3223. The resulting layers (e.g., 3221) of hardened material can be (e.g., substantially) parallel with respect to each other (e.g., in accordance with an average layering plane). Adjacent layers may be integrally coupled with (e.g., chemically (e.g., metallically) bonded) with each other during the transformation (e.g., melting) process. The layers may be oriented (e.g., substantially) horizontally with respect to a bottom surface (e.g., 3226) and/or a top surface (e.g., 3228) of the 3D object. The layers may be oriented (e.g., substantially) vertically with respect to a side surface (e.g., 3224 or 3225) of the 3D object. FIG. 32 shows an example of a 3D object 3240 that is formed at an angle alpha (α) relative to the surface of a platform 3242 and/or an angle of 90 degrees plus alpha (α) with respect to the gravity vector 3243. The resulting layers (e.g., 3241) of hardened material may be at the angle alpha (α) with respect to a bottom surface (e.g., 3246) and/or top surface (e.g., 3248) of the 3D object. The layers may be oriented an angle of 90 degrees plus alpha (α) with respect to a side surface (e.g., 3244 or 3245) of the 3D object.

In some embodiments, 3D printing methodologies are employed for printing an object that is substantially two-dimensional, such as a wire or a planar object. The 3D object may comprise a plane like structure (referred to herein as “planar object,” “three-dimensional plane,” or “3D plane”). The 3D plane may have a relatively small width as opposed to a relatively large surface area. The 3D plane may have a relatively small height relative to its width and length. For example, the 3D plane may have a small height relative to a large horizontal plane. The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface. The one or more layers within the 3D object may be substantially planar (e.g., flat). The planarity of a surface or a boundary the layer may be (e.g., substantially) uniform. Substantially uniform may be relative to the intended purpose of the 3D object. The height of the layer at a particular position may be compared to an average layering plane. The layering plane can refer to a plane that a layer of the 3D object is (e.g., substantially) oriented during printing. A boundary between two adjacent (printed) layers of hardened material of the 3D object may define a layering plane. The boundary may be apparent by, for example, one or more melt pool terminuses (e.g., bottom or top). A 3D object may include multiple layering planes (e.g., corresponding to each layer). In some embodiments, the layering planes are (e.g., substantially) parallel to one another. An average layering plane may be defined by a linear regression analysis (e.g., least squares planar fit of the top-most part of the surface of the layer of hardened material). An average layering plane may be a plane calculated by averaging the material height at each selected point on the top surface of the layer of hardened material. The selected points may be within a specified region of the 3D object. The deviation from any point at the surface of the planar layer of hardened material may be at most 20% 15%, 10%, 5%, 3%, 1%, or 0.5% of the height (e.g., thickness) of the layer of hardened material. FIG. 32 shows a schematic example of a vertical cross section of a portion of a 3D object having layers 3200, 3202 3204 and 3216 of hardened material, with each layer sequentially formed during the 3D printing process. Boundaries (e.g., 3206, 3208, 3210 and 3212) between the layers may be (e.g., substantially) planar. The boundaries between the layers may have some irregularity (e.g., roughness) due to the transformation (e.g., melting) process. An average layering plane (e.g., 3214) may correspond to a (e.g., imaginary) plane that is calculated or estimated as an average layering plane thereof.

In some embodiments, the 3D object is an extensive 3D object. The 3D object can be a large 3D object. The 3D object may comprise a hanging structure (e.g., wire, ledge, shelf, or 3D plane). In some embodiments, the 3D object includes a geometry that comprises an overhang structure connected to at least one rigid portion (also referred herein as “core”) that may be a part of the 3D object. In some embodiments, the rigid portion may be thick enough to resist stress (e.g., upon depositing an additional (e.g., layer of) transformed material on the rigid portion). The rigid portion may be thick enough to resist deformation (e.g., upon depositing an additional (e.g., layer of) transformed material on the rigid portion). The rigid portion may provide support to a second portion (e.g., an overhang structure such as a structure comprising a ledge having a constant or varying angle with respect to the rigid portion and/or platform) of the 3D object. The angle may be acute (e.g., steep, or shallow), or obtuse (e.g., as indicated herein). Examples of such an overhang 3D structure may comprise an arch, dome, ledge, or blade. For example, the 3D object may comprise a ledge having a constant or varying angle (e.g., with respect to a platform). The overhang structure may be formed within a material bed. At times, the overhang structure may be formed on a target surface (e.g., on an exposed surface of the material bed, on a platform, or connected to a rigid portion (e.g., that is formed on a platform)). The rigid portion may be connected (e.g., anchored) to a build platform (also referred to as a build plate). For example, the rigid portion may act as, or may comprise, an anchor feature which may be utilized during one or more three-dimensional processes to provide support for pre-transformed and/or transformed material supported by the build platform. The overhang (e.g., the hanging ledge structure) may be printed without auxiliary supports other than the connection to the one or more rigid portions (that are part of the requested 3D object). The overhang may be formed at an angle with respect to the build platform. The overhang and/or the rigid portion may be formed from the same or different pre-transformed material (e.g., powder).

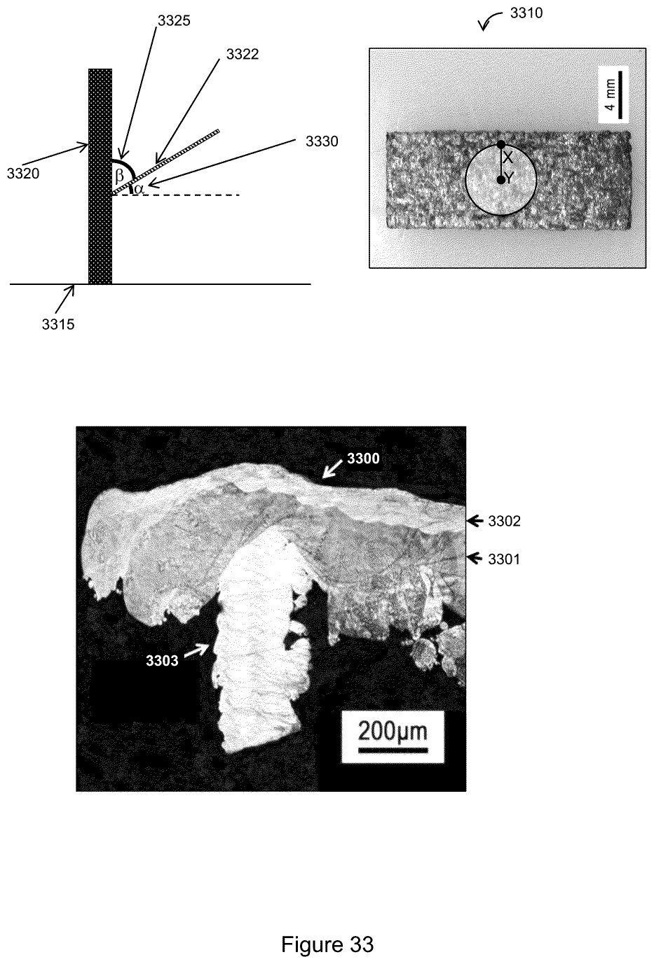

FIG. 33 shows an example of an overhang structure 3322 connected to a rigid portion 3320. The rigid portion 3320 is connected (e.g., anchored) to a build platform 3315. As depicted, the overhang structure 3322 (e.g., the hanging ledge structure) is printed without auxiliary supports other than the connection to the one or more rigid portion 3320 (that are part of the requested 3D object). The overhang structure 3322 is formed at an angle α 3330 with respect to the build platform 3315. The overhang structure 3322 is formed at an angle β 3325 with respect to the rigid structure 3320.

In some embodiments, the 3D object comprises points X and Y, which reside on the surface of the 3D object. FIG. 33 shows an example of points X and Y on the surface of a 3D object 3310. In some embodiments, X is spaced apart from Y by the auxiliary feature spacing distance. A sphere of radius XY that is centered at X lacks one or more auxiliary supports or one or more auxiliary support marks that are indicative of a presence or removal of the one or more auxiliary support features. An acute angle between the straight line XY and the direction normal to N may be from about 45 degrees to about 90 degrees. The acute angle between the straight line XY and the direction normal to the layering plane may be of the value of the acute angle alpha. When the angle between the straight line XY and the direction of normal to N is greater than 90 degrees, one can consider the complementary acute angle.

In some embodiments, once a 3D object is removed from a printer, the object may include identifying one or more characteristics that indicate the orientation of the object during its formation in the printer. For example, the object may include features (e.g., transition lines, surface steps, melt pools and/or grain boundaries) that indicate one or more (e.g., average) layering planes. In some embodiments, the portion of the requested 3D object comprises (e.g., substantially) the same material as the support member. In some embodiments, the portion of the requested object comprises different material than the support member. Some or (e.g., substantially) all the support members may be removed from the main portion (e.g., after the printing is complete). In some cases, the support member causes one or more layers of the portion of the requested object to deform during printing (e.g., due to the presence of the support member during formation of the requested 3D object). Sometimes, the deformed layers comprise a visible mark. The mark may be a region of discontinuity in the layer, such as a microstructure discontinuity and/or an abrupt microstructural variation. The discontinuity in the microstructure may be explained by an inclusion of a foreign object (e.g., the support member). The microstructural variation may include (e.g., abruptly) altered melt pools and/or grain structure (e.g., crystals, e.g., dendrites) at or near the attachment point of the support member. The microstructure variation may be due to differential thermal gradients due to the presence of the support member. The discontinuity may be external at the surface of the 3D object. The discontinuity may arise from inclusion of the support member to the surface of the 3D object (e.g., the discontinuity may be visible as a breakage of the support member when at attempt is made to remove the support member after the printing). Breakage may be the result of cutting, shaving, chipping, sawing, polishing, sanding, or any combination thereof (e.g., to remove the support member from the main portion). In some instances, the object includes two or more support members and/or support marks. The two or more support members and/or support marks can be used to define a build plane that is (e.g., substantially) parallel to the platform surface during printing. In some embodiments, the build plane is (e.g., substantially) parallel to the (e.g., average) layering plane. In some embodiments, the process used for printing at least a portion of the 3D object leaves one or more surface marks. The surface mark(s) may comprise (i) a surface marking characteristic of a top surface, (ii) a surface marking characteristic of a top surface, or (iii) a surface marking characteristic of a side surface. The characteristic may comprise a roughness, material deposition trajectory pattern, tessellation pattern, or auxiliary support(s) or mark(s) indicative thereof.

FIG. 33 shows an example of a vertical cross section of a 3D object that includes a main portion 3300 coupled with a support member 3303. The main portion can include multiple layers (e.g., 3301 and 3302) that were sequentially added during a printing operation. The support member 3303 (e.g., auxiliary support) may be printed or may be the build platform (e.g., base) itself.

In some embodiments, to form the complex geometry structure, the printing methodology comprises generating a transformed material at least in part by forming a high aspect ratio melt pool. The high aspect ratio melt pool may penetrate one or more layers. The high aspect ratio melt pool may be formed with an energy beam that has a footprint sufficiently narrow to form the intricate structure. The high aspect ratio melt pool may be formed with an energy beam that has a sufficient power density to form the high aspect ratio melt pool. In some embodiments, the high aspect ratio melt pool may be elongated (e.g., expanding laterally the amount of transformed material that is a part of the melt pool). The elongation may be effectuated at least in part by moving the transforming energy beam. At times, gas is trapped in the high aspect ratio melt pool. Prior to moving away from the high aspect ratio melt pool, the power density of the energy beam may be lowered during the final stages the high aspect ratio melt pool formation. Lowering the power density of the energy beam may alter (e.g., lower) the amount of gas trapping within the melt pool. A reduction of the energy beam penetration into the HARMP may reduce the amount of material that exits the HARMP during the irradiation of the energy beam, and thus reduce the size of the well. The hardened HARMP may comprise a low (e.g., diminished) number of pores, for example, compared to the material before the HARMP is formed. The various printing processes may comprise various core processes such as a shallow core and a bulk core.

At times, the 3D printing comprises different printing methodologies. Each of the different printing methodologies may have a material signature, e.g., that is detectable. At least one of the 3D printing methodologies may have a material signature associated with an energy beam that facilitated in its generation. For example, a directional material signature associated with a direction of the energy beam associated with its formation. The directional material signature may or may not be in the direction in which the energy beam impinged on the target surface during its generation. The directional material signature may have a direction associated with a progression direction of the energy beam during its generation.

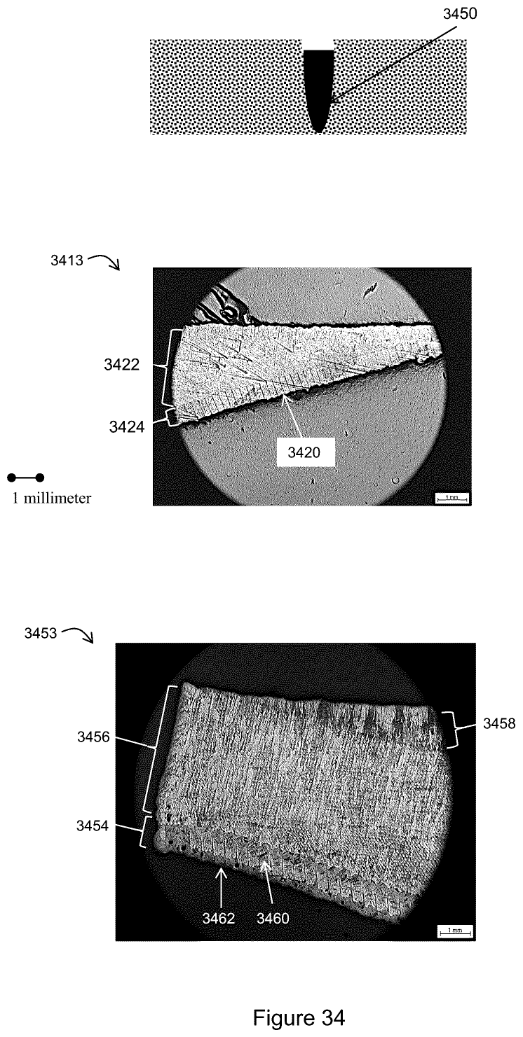

FIG. 34 shows an example of various 3D objects, presenting different material signatures associated with different printing methodologies. FIG. 34 shows a magnified portion 3413 of a 3D object showing a ledge having (a) a first portion 3424 that is a bottom skin portion and (b) a second portion of a 3D object 3422 disposed above the first portion 3424. The object shown in 3413 is formed using a first material composition comprising Ti64. In the magnified 3D object portion 3413 shown in FIG. 34, the first portion of 3D object 3422 is generated in a printing methodology different from the methodology utilized to print the second portion of the 3D object 3413. The first portion 3424 shows elongated microstructures such as 3520, having detectable directionality and detectable borders. The microstructures may be generated using the HARMP methodology. The direction of the microstructures such as 3420 in first portion 3424 may be indicative of utilizing one energy beam for generating first portion 3424.

FIG. 34 shows a magnified portion 3453 of a 3D object having (a) a first portion 3454 that is a bottom skin, (b) a second portion 3456, and (c) a third portion 3458. The object shown in the magnified portion 3453 is printed using a second material composition different than the first material composition of the magnified portion 3413. The second material composition is Inconel718. In the magnified portion 3453 shown in the example of FIG. 34, the first (bottom skin) portion 3454, the second portion 3456, and the third portion 3458 are generated each using a different type of printing methodology. The microstructures may be generated using the HARMP methodology. The direction of the microstructures such as 3462 in first portion 3454 may be indicative of utilizing one energy beam for generating first portion 3454. First portion 3454 includes grains, e.g., grain 3460, having grain boundaries. The presence of the grains in first portion 3454 may be indicative of a slow cooling process during generation of the microstructures such as 3462.

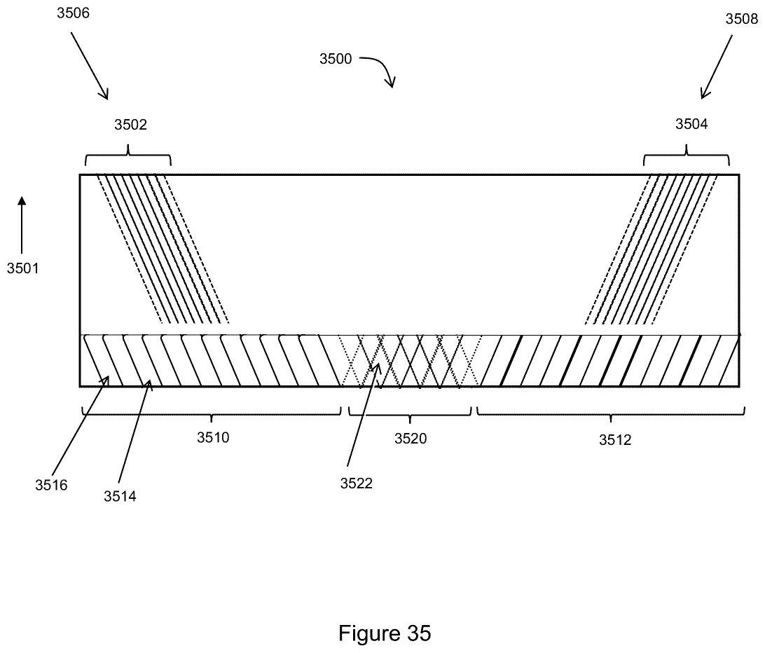

At times, a three-dimensional object formed utilizing the three-dimensional printing process includes directional microstructures (e.g., microstructures indicative of a direction of energy beam projection) in which microstructures are apparent in (A) at least two different processing regions, (B) at least two different processing cones of adjacent (e.g., abutting) energy beams, or (C) a combination thereof. The microstructure may comprise a meltpool. FIG. 35 depicts a schematic cross-sectional view of a portion of 3D object 3500, with an indicated build direction 3501. Directional microstructures, e.g., directional microstructures 3502, 3504, are elongated in respective directions related to a direction of energy beam impingement on the target surface, e.g., directions 3506 and 3508, respectively. The three-dimensional object 3500 comprises portions (e.g., regions) including directional microstructures which are all (e.g., substantially) aligned with respect to each other, e.g., portion 3510 or portion 3512. For example, a single energy beam is utilized to form the portion 3510 of the three-dimensional object 3500, and includes directional indicators, e.g., direction indicators 3514, 3516, aligned in a single direction (e.g., aligned with direction 3506 of the energy beam with respect to the target surface). The three-dimensional object may comprise portions (e.g., regions) including no (e.g., zero) direction indicators where two or more energy beams overlapped in forming the portion of the three-dimensional object, e.g., portion 3520. The dimensional indicators, e.g., dimensional indicators 3522, in the overlap portions may be blurred (e.g., unclear or anisotropic).

At times, it may be advantageous to allow for easy installation and/or maneuvering of at least one component of the 3D printing system. For example, it may be advantageous if one or more components of the 3D printing system are easily maneuvered (e.g., insertable and/or removed). Easy maneuvering (e.g., removal and/or insertion) may include actions of a user facing the 3D printing system, and maneuvering (e.g., pulling and/or pushing) the one or more components to facilitate their maneuver (e.g., removal and/or insertion, respectively). For example, easy maneuvering (e.g., removal and/or insertion) may include actions of a personnel facing a front, a back, a side, a top, or a bottom of the 3D system, and maneuvering (e.g., pulling and/or pushing) the one or more components to facilitate their maneuver (e.g., removal and/or insertion, respectively). The one or more components may comprise: an (e.g., laser generator), an optical system (e.g., any component thereof such as an optical assembly), a detection system, an optical system enclosure, an optical (assembly) housing, a side cover, or a door. The front of the 3D printing system can include a door to the processing chamber. A top of the 3D printing system can face the platform, e.g., through the optical window(s). The one or more components can be reversibly secured to and release from the rest of the 3D printing system using a (e.g., flexible) fastener. The flexible fastener may facilitate reversible maneuvering of a component (e.g., retraction and insertion of the component into a designated location in the 3D printing system. The fastener may comprise any material disclosed herein, e.g., an elemental metal, a metal alloy, or a polymer. The fastener may comprise a lock assembly. The fastener may comprise a snap (e.g., snap fit) assembly, or a latch assembly. The fastener may comprise interlocking portions that engage and/or disengage using human exerted force. The fastener may comprise a cantilever, torsional or annular. The fastener may be devoid of loose parts. The fastener may or may not comprise a spring. In some embodiments, a component may be configured to (e.g., reversibly) snap into and/or out of a cavity in the 3D printing system, e.g., without any fastener, and rather due to the geometric configuration of the cavity edge and component edge that fit together. The fastener may comprise a screw, a peg, or a pin. The component (e.g., energy source) may be disposed on a rack (e.g., an electronic rack). The component may be engaged with a guidance system such as a sliding mechanism (e.g., similar to a drawer). The guidance system may comprise a railing system. For example, the component may comprise at least one wheel (e.g., wheels) configured to couple to at least one rail (e.g., two rails) disposed in 3D printing system cavity. For example, the component may comprise at least one rail (e.g., two rails) configured to couple to the 3D printing system cavity (e.g., wheel(s) configured to engage with the at least one rail. The component and/or 3D printing system cavity may comprise bracket(s) as part of the engagement mechanism between the 3D printing system cavity and the component of the 3D printing system. The engagement mechanism may comprise a rail, a wheel, or a bracket. The engagement mechanism may facilitate linear and/or tilting sliding of the component with respect to the 3D printing system. Any parts of the components may remain stable (e.g., configured to remain stable) during the maneuvering. For example, one or more parts (e.g., all parts) of the optical system (e.g., of the optical assembly) may be stable during extraction of the optical system and/or one or more components of the optical system (e.g., an optical assembly of the array of optical assemblies) from the 3D printing system and/or insertion of the optical system into the 3D printing system. Such (e.g., reversible) maneuvering methodology may allow easy assembly, and/or maintenance of the 3D printing system (e.g., of the component thereof).

In some embodiments, at least one component of the optical system is maneuverable. For example, an optical assembly is maneuverable. For example, during installation, assembly, repair, maintenance, or the like. At times, maneuvering at least a portion of the optical system (e.g., an optical assembly such as an optical FRU) with respect to the 3D printing system causes no, or minimum (e.g., non-material), alternation of the optical assembly disposed in the optical housing. For example, one or more parts (e.g., all parts) of the optical system components may be stable during maneuvering of the optical system or of at least one of the optical assemblies, from the 3D printing system. Maneuvering may comprise moving, inserting or extracting. The optical system components may comprise the optical assembly, the optical housing, the optical components of the optical assembly, or the optical system enclosure. Such (e.g., reversible) maneuvering methodology may allow easy assembly, and/or maintenance of the 3D printing system (e.g., of the component thereof). The optical system including optical assembly/ies may comprise one or more mirrors (e.g., tilted mirror such as with the aid of screws). The tilted mirror may be susceptible to maneuverings (e.g., susceptible to changes in their maneuverings and/or directionality). A small change in the disposition of the tilted mirror may cause a substantial change in deflection of the energy beam (e.g., laser beam), e.g., with respect to the exposed surface of the material bed (e.g., FIG. 1, 104) upon which the energy beam (e.g., 101) impinges. In some embodiments, one or more tilting mirrors are substituted by one or more (e.g., a set of) optical wedges. The optical wedge can be rotated around an axis (e.g., z axis), e.g., at an angle φ. A projection angle on the X axis may be θₓ, and a projection angle on the Y axis may be θ_{y}, where X, Y, and Z are Cartesian coordinate axes. The projections θₓ and θ_{y} may abide by the following mathematical relationships:

θₓ=α cos(φ)

θ_{y}=α sin(φ)

By having an integer number of wedges k=1, 2, 3, . . . n with all of angles α (where “n” is an integer), the following relationships can result:

$$\begin{matrix}{θ}_{x} = {\sum }_{k - 1}^{n} α cos ( {φ}_{k} ) \\ {θ}_{y} = {\sum }_{k - 1}^{n} α sin ( {φ}_{k} )\end{matrix}$$

When n≥2, the projection angles θₓ and θ_{y} may be controlled independently. In some embodiments, when the value of each of θₓ and θ_{y} is much smaller than angle φ, e.g., θₓ<<φ and θ_{y}<<φ, the resulting optical mechanism is not as susceptible to maneuvering (e.g., stirring, tilting, and/or shaking), as compared with a tilting mirror mechanism. The wedges may be configured to rotate (e.g., are rotatable) to facilitate alteration of the direction of the energy beam passing therethrough, e.g., in two directions and/or in two dimensions. Such alteration may facilitate using the optical assembly to direct the energy beam towards the scanner that translate the energy beam with respect to the exposed surface of the material bed, e.g., to form the 3D object(s). In some embodiments, in order to alter the position of the energy beam going through the wedges (e.g., with respect to the scanner) a large change in the positions of the wedges is required. Such requirement for large changes minimizes error in the optical path of the energy beam upon maneuvering of the optical system or any of its components (e.g., optical assembly thereof), e.g., with respect to another optical system/assembly that uses tilting mirror(s) instead of the optical wedge(s).

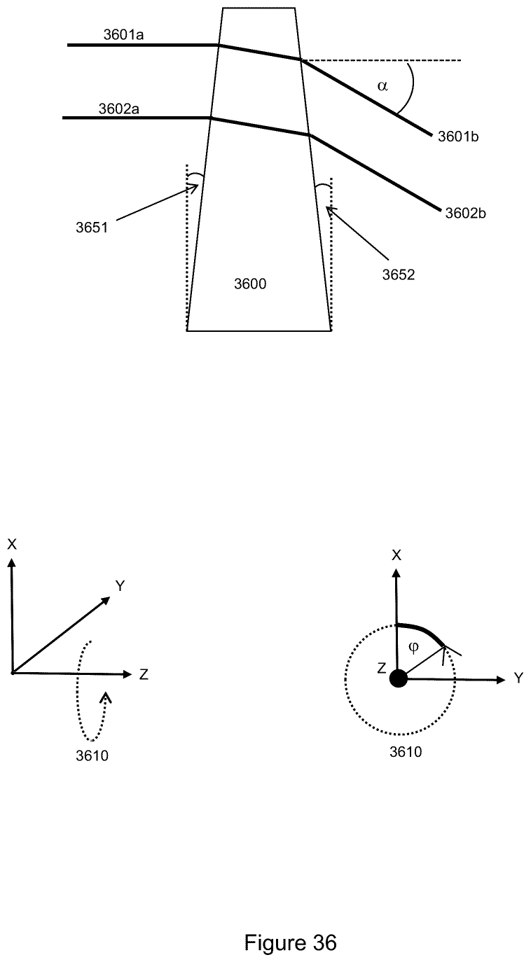

FIG. 36 shows an example of a wedge 3600 into which beams 3601a and 3602a (e.g., optical energy beams such as laser beams) penetrate, the energy beams are refracted by the optical wedge as beams 3601b and 3602b. The angle of refraction is denoted as alpha (α). FIG. 36 shows an example of a Cartesian system including axes X, Y, and Z. The wedge can be rotated about the Z axis such as along circular arrow 3610 forming an angle φ with respect to another axis of the Cartesian system (e.g., Y axis, or X axis). The refraction of the rays penetrating the wedge that emerge at the opposing side of the wedge may depend on the shape of the wedge, e.g., on the angles (e.g., 3651 and 3652) the wedge is cut, and the refractive index of the material from which the wedge is composed. The angles 3651 and 3652 can have the same value or a different value. The angles 3651 and 3652 can be two-dimensional angles or three-dimensional angles. The wedge may comprise glass, quartz, sapphire, beryllium, zinc selenide, calcium fluoride, or fused silica. The wedge may comprise any material that may exhibit a reduced thermal lensing effect, e.g., as disclosed herein. For example, the wedge may comprise a material having a (e.g., substantially) diminished thermal lensing effect during a three-dimensional printing process. The wedge may comprise any high thermal conductivity optical element material, e.g., as disclosed herein.

In some embodiments, the optical system (e.g., and/or optical assembly) comprising the wedge(s) is subject to installation and/or maintenance. As compared to another similar optical system (e.g., and/or optical assembly) having tilting mirror(s) instead of the wedge(s), the maintenance and/or installation of the wedges containing optical system (e.g., and/or optical assembly) has one or more benefits. The benefits my comprise being quicker, cheaper, simpler, requiring fewer personnel, being more robust, or being more reliable.

In some embodiments, the 3D printing system comprises a control system. The control system may comprise one or more controllers. The control system may comprise, or be operatively coupled to, one or more devices, apparatuses, and/or systems of the 3D printing system, including any component of the device(s), apparatuses(s), and/or system(s). The controller(s) may comprise, or be operatively coupled to, a hierarchical control system. The hierarchical control system may comprise at least three, four, or five, control levels. In some embodiments, at least two operations are performed, or directed, by the same controller. In some embodiments, at least two operations are each performed, or directed, by a different controller. A control system may comprise a build module control system. A control system may comprise a laser control system. The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. The control system may comprise, or be operatively coupled to, a metrological detection system and configured to receive measurement data from the metrological detection system. The control system may be configured to generate control signals responsive to the measurement data collected by the metrological detection system.

At times, a control system comprises an optical translation control system. The optical translation control system may comprise various control schemes (e.g., a feedback loop) for directing the translational movement of the translational mechanism. The optical translation control system may direct the operation of one or more actuators (e.g., servo motors) of the translational mechanism to control the movement of the translational mechanism. The control schemes may comprise a feedback loop. The control schemes may comprise a control scheme for minimizing a dwell time (e.g., stabilization time) associated with the translational movement of the translation mechanism. The dwell time may comprise a period of time between an end of a first three-dimensional printing process and a start of a sequentially ordered second three-dimensional printing process. For example, a period of time between turning an energy beam “OFF” to complete a three-dimensional process and turning the energy beam “ON” to initiate a three-dimensional process. For example, a period of time comprises a wait time for the components of the optical system to reach a threshold stabilization (e.g., a threshold internal vibration). For example, minimizing a stabilization time may comprise reducing a vibrational movement induced in the component(s) (e.g., optical component(s) of an optical assembly during the translational movement. For example, minimizing a stabilization time may comprise reducing a vibrational movement induced in mirror(s) of the optical assembly during the translational movement of the optical assembly. The control scheme(s) may comprise a set of translation control inputs that cause the translation mechanism (e.g., the servo motors) to translate with varying acceleration, deceleration, or a combination thereof as the translation mechanism translates from a first location to a second location. For example, the control scheme(s) may comprise a set of translation control inputs that cause the translation mechanism to translate utilizing a plurality of acceleration sub-intervals and a plurality of deceleration sub-intervals as the translation mechanism translates from a first location to a second location.

In some embodiments the control system comprises a laser control system. The laser control system may comprise, or may be operatively coupled to, an optical translation control system. The laser control system may comprise, or be operatively coupled to, a laser system (e.g., optical system) of the 3D printing system, e.g., energy sources, optical components, translation mechanism, optical assemblies, motors, encoders, or the like. At times, the laser control system is operable to control operations of the optical system (e.g., optical assemblies) of the 3D printing system. The laser control system may be operable to adjust operations of the optical system (e.g., of the optical assemblies) in response to a measured positional deviation of one or more aspects of the translatable optical system. The laser control system may be operable to adjust (e.g., calibrate) one or more characteristics of the irradiating energy (e.g., the energy beam) incident on the target surface, e.g., the exposed surface of the material bed. Adjusting one or more characteristics of the irradiating energy beam may comprise a software adjustment (e.g., calibration). Adjusting one or more characteristics of the irradiating energy beam may comprise a hardware adjustment (e.g., calibration).

In some embodiments, the laser control system is configured to calibrate one or more characteristics of the irradiating energy (e.g., energy beam) in response to a positional deviation of the target surface, translational mechanism, array of optical assemblies, build platform assembly, or build platform, from a requested position. For example, the laser control system may be configured to calibrate one or more characteristics of the irradiating energy in response to a positional deviation of the target surface about an XY plane and/or about a rotational axis of the target surface (e.g., rotation about a central axis). For example, the laser control system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with respect to a second energy beam position at the (e.g., target) surface, and/or (iv) the XY offset of the energy beam with respect to the (e.g., target) surface. The position at which the energy beam contacts the surface is the position at which the energy beam impinges on the surface.

In some embodiments, the laser control system is configured to calibrate one or more characteristics of the irradiating energy (e.g., energy beam). A calibration may include a comparison of a commanded (e.g., instructed) energy beam position (e.g., at the target surface) compared with an actual (e.g., measured) energy beam position at the target surface. The characteristics of the energy beam may be calibrated along a field of view of the optical system (e.g., and/or detector). The laser control system may calibrate characteristics of a processing cone of the energy (e.g., laser beam). The calibration of the focus mechanism may achieve a requested spot or footprint size for various locations in the field of view of the irradiating energy (e.g., intersection of the processing cone with the target surface and/or calibration structure surface). The power density distribution measure may be calibrated (e.g., substantially) identically, or differently, along the field of view of the irradiating energy. In some embodiments, different positions in the field of view may require different focus offsets and/or or footprint size. Processing cone coverage of the material bed can depend in part on dimensions of one or more of the mirrors of a scanner, e.g., galvanometric scanner, utilized to direct a path of the energy beam about the target surface. Laser control systems, control systems, controllers and operation thereof, 3D printing systems and processes, apparatus, methods, computer programs, are disclosed in International Patent Application Serial No. PCT/US19/14635 filed Jan. 22, 2019, which is incorporated herein by reference in its entirety.

At times, a calibration comprises generated a compensation for one or more characteristics of the laser system. A compensation may be effectuated at least in part by a (e.g., energy beam) calibration. At times, an energy beam calibration comprises formation of one or more (e.g., physically printed or optically projected) alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). The deviation of the detected position(s) from the commanded position(s) may be caused in part by (a) thermal effects on the energy beam and/or optical components, (b) position deviation of the target surface, (c) a non-uniformity of layer deposition, or (d) a combination thereof. Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source.

In some embodiments, the control system utilizes data from a metrological detection system. The control system may use the data to control one or more parameters of the 3D printing. For example, the control system may use the metrology data to control one or more positions of the optical system. At times, the control system may utilize a control scheme comprising a feedback control loop that utilizes alignment data, e.g., collected from one or more metrological detection systems to update control parameters of one or more control systems. Data collected from one or more metrological detection systems may comprise alignment data indicative of a position of a component of the optical system, for example, a position of (A) an optical assembly, (B) the array of optical assemblies, (C) the translation mechanism, (D) energy beam(s) of the optical system incident on the target surface, or (E) any combination of (A) to (D). The data collected from one or more metrological detection systems can be utilized by a feedback control loop to adjust a position of the component of the optical system, for example, a position of (A) an optical assembly, (B) the array of optical assemblies, (C) the translation mechanism, (D) energy beam(s) of the optical system incident on the target surface, or (E) any combination of (A) to (D). At times, a control scheme comprises a feedforward control loop that utilizes alignment data to update control parameters of one or more control systems. Alignment data may comprise historical data, e.g., data collected after a three-dimensional process performed by a three-dimensional printer. Historical data (e.g., historical measurements) may comprise characterization of three-dimensional objects formed utilizing the three-dimensional printer. The historical data may be utilized in a feedforward control loop to adjust a position of (A) an optical assembly, (B) the array of optical assemblies, (C) the translation mechanism, (D) energy beam(s) of the optical system incident on the target surface, or (E) any combination of (A) to (D). The control system may use the metrology data to control one or more parameters of the energy source and/or energy beam. The one or more measurements from the metrological detection system may be used to alter (e.g., in real time, and/or offline) the computer model. For example, the metrological detection system measurement(s) may be used to alter the optical proximity correction data. For example, the metrological detection system measurement(s) may be used to alter the printing instruction of one or more successive layers (e.g., during the printing of the 3D object).

In some embodiments, the detector and/or controller(s) averages at least a portion of the detected signal over time (e.g., period). In some embodiments, the detector and/or controller(s) reduces (at least in part) noise from the detected signal (e.g., over time). The noise may comprise detector noise, sensor noise, noise from the target surface, or any combination thereof. The noise from the target surface may arise from a deviation from planarity of the target surface (e.g., when a target surface comprises particulate material (e.g., powder)). The reduction of the noise may comprise using a filter, noise reduction algorithm, averaging of the signal over time, or any combination thereof.

In some embodiments, the controller(s) (e.g., continuously or intermittently) calculates an error value during the control time. The intermittent calculation may or may not be periodic. The error value may be the difference between a requested setpoint and a measured process variable. The control may be continuous control (e.g., during the 3D printing process, during formation of the 3D object, and/or during formation of a layer of hardened material). The control may be discontinuous. For example, the control may cause the occurrence of a sequence of discrete events. The control scheme may comprise a continuous, discrete, or batch control. The requested setpoint may comprise a temperature, power, power density, or a metrological (e.g., height) setpoint. The metrological setpoint may relate to the target surface (e.g., the exposed surface of the material bed). The metrological setpoints may relate to one or more height setpoints of the target surface (e.g., the exposed (e.g., top) surface of the material bed). The controller(s) may attempt to minimize an error (e.g., temperature and/or metrological error) over time by adjustment of a control variable. The control variable may comprise a direction and/or (electrical) power supplied to any component of the 3D printing apparatus and/or system. For example, direction and/or power supplied to the: energy beam, scanner, motor translating the platform, optical system component, optical diffuser, or any combination thereof.

In some embodiments, the systems, apparatuses, and/or components thereof comprise one or more controllers. The one or more controllers can comprise one or more central processing unit (CPU), input/output (I/O) and/or communications module. The CPU can comprise electronic circuitry that carries out instructions of a computer program by performing basic arithmetic, logical, control and I/O operations specified by the instructions. The controller can comprise a suitable software (e.g., operating system). The control system may optionally include a feedback control loop and/or feed-forward control loop. The controllers may be shared between one or more systems or apparatuses. Each apparatus or system may have its own controller. Two or more systems and/or its components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. The controller may be any controller (e.g., a controller used in 3D printing) such as, for example, the controller disclosed in PCT Patent Application serial number PCT/US16/59781, that was filed on Oct. 31, 2016, titled “ADEPT THREE-DIMENSIONAL PRINTING”, all three of which are incorporated herein by reference in their entirety.

At times, multiple of tuning schemes can be generated for the one or more controllers, each tuning scheme selectable for a set of operating conditions and/or powder characteristics. For example, tuning scheme may utilize (i) a look-up table (LUT), (ii) historical data, (iii) experiments, (iv) physics simulation, (v) artificial intelligence, (vi) data analysis, and/or (vii) the like. The artificial intelligence may comprise training a plant model (a machine-learned model). The artificial intelligence may comprise data analysis. The training model may be trained utilizing (i) a look-up table (LUT), (ii) historical data, (iii) experiments, (iv) synthesized results from physics simulation, or (v) the like. In some embodiments, control scheme(s) can use a single plant model and project changes due to the temperature based at least in part on previously identified models. The control scheme(s) may be inscribed as program instructions (e.g., software).

In some embodiments, the control scheme used the controller(s) disclosed herein involve data analysis. The data analysis techniques involve one or more regression analys(es) and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analys(es). The learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity and metric learning, sparse dictionary learning, or genetic algorithms (e.g., evolutional algorithm). The non-transitory computer media may comprise any of the algorithms disclosed herein. The controller and/or processor may comprise the non-transitory computer media. The software may comprise any of the algorithms disclosed herein. The controller and/or processor may comprise the software. The learning scheme may comprise random forest scheme.

In some embodiments, the control system utilizes a physics simulation in, e.g., in a computer model (e.g., comprising a prediction model, statistical model, a thermal model, or a thermo-mechanical model). The computer model may provide feedforward information to the control system. The computer model may provide the feed forward control scheme. There may be more than one computer models (e.g., at least 1, 2, 3, 4, 5, 6, 7, 8, 9 or 10 different computer models). The controller may (e.g., dynamically) switch between the computer models to predict and/or estimate the behavior of the optical elements. Dynamic includes changing computer models (e.g., in real time) based at least in part on a sensor input or based at least in part on a controller decision that may in turn be based at least in part on monitored target temperature. The dynamic switch may be performed in real-time, e.g., during operation of the optical system and/or during printing 3D object(s). The controller may be configured (e.g., reconfigured) to include additional one or more computer models and/or readjust the existing one or more computer models. A prediction may be done offline (e.g., predetermined) and/or in real-time. Examples of the calibration, control systems, controllers and operation thereof, 3D printing systems and processes, apparatus, methods, and computer programs, are disclosed in International Patent Application serial number PCT/US19/14635, filed Jan. 22, 2019, titled “CALIBRATION IN THREE-DIMENSIONAL PRINTING,” which is incorporated herein by reference in its entirety.

In some instances, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS).

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

In some instances, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the algorithm (e.g., control algorithm). In some instances, the controller uses calculations, real time measurements, or any combination thereof to regulate the energy beam(s).

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some examples, the computer system comprises a memory. The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some instances, all or portions of the software are at times communicated through the Internet and/or other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium or media that participate(s) in providing instructions to a processor for execution.

In some embodiments, the computer system utilizes a machine readable medium/media to execute, or direct execution of, operation(s). The program instructions can be inscribed in a machine executable code. A machine-readable medium/media, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system includes a user interface. The computer system can include, or be in communication with, an electronic display unit that comprises a user interface (UI) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real time or in a delayed time. The display unit may display the requested printed 3D object (e.g., according to a model), the printed 3D object, real time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The display unit may display the amount of a certain gas in the chamber. The gas may comprise an oxidizing gas (e.g., oxygen), hydrogen, water vapor, or any of the gasses mentioned herein. The gas may comprise a reactive agent. The display unit may display the pressure in the chamber. The computer may generate a report comprising various parameters of the methods, objects, apparatuses, or systems described herein. The report may be generated at predetermined time(s), on a request (e.g., from an operator) or at a whim.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Other control and/or algorithm examples may be found in International Patent Application Serial No. PCT/US17/18191, filed Feb. 16, 2017, titled “ACCURATE THREE-DIMENSIONAL PRINTING;” which is incorporated herein by reference in their entirety.

In some embodiments, the 3D printer comprises and/or communicates with a plurality of processors. The processors may form a network architecture. The 3D printer may comprise at least one processor (referred herein as the “3D printer processor”). The 3D printer may comprise a plurality of processors. At least two of the plurality of the 3D printer processors may interact with each other. At times, at least two of the plurality of the 3D printer processors may not interact with each other.

In some embodiments, a 3D printer processor interacts with at least one processor that acts as a 3D printer interface (also referred to herein as “machine interface processor”). The processor (e.g., machine interface processor) may be stationary or mobile. The processor may be a remote computer system. The machine interface one or more processors may be connected to at least one 3D printer processor. The connection may be through a wire (e.g., cable) and/or be wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise coaxial cable, shielded twisted cable pair, unshielded twisted cable pair, structured cable (e.g., used in structured cabling), or fiber-optic cable.

In some embodiments, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly or indirectly). The printer controller may direct start (e.g., initiation) of a 3D printing process, stopping a 3D printing process, maintenance of the 3D printer, clearing alarms (e.g., concerning safety features of the 3D printer).

In some embodiments, the machine interface processor allows monitoring of the 3D printing process (e.g., accessible remotely or locally). The machine interface processor may allow viewing a log of the 3D printing and status of the 3D printer at a certain time (e.g., 3D printer snapshot). The machine interface processor may allow to monitor one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of pre-transformed material used in the 3D printing (e.g., amount of pre-transformed material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (boot log, status change, safety events, motion control commands (e.g., of the energy beam, or of the layer dispensing mechanism), or printed 3D object status (e.g., what layer number is being printed),

In some embodiments, the machine interface processor allows controlling (e.g., monitoring) the 3D print job management. The 3D print job management may comprise status of each build enclosure, e.g., atmosphere condition, power levels of the energy beam, type of pre-transformed material loaded, 3D printing operation diagnostics, status of a filter, or the like. The machine interface processor (e.g., output device thereof) may allow viewing and/or editing any of the job management and/or one or more printing parameters. The machine interface processor may show the permission level given to the user (e.g., view, or edit). The machine interface processor may allow prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof.

In some embodiments, the 3D printer interacts with at least one server (e.g., print server). The 3D print server may be separate or interrelated in the 3D printer. One or more users may interact with the one or more 3D printing processors through one or more user processors (e.g., respectively). The interaction may be in parallel and/or sequentially. The users may be clients. The users may belong to entities that requests a 3D object to be printed, or entities who prepare the 3D object printing instructions. The one or more users may interact with the 3D printer (e.g., through the one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connection. Direct connection may be using a local area network (LAN), and/or a wide area network (WAN). The network may interconnect computers within a limited area (e.g., a building, campus, neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, thickness of a layer (e.g., of hardened material or of pre-transformed material).

In some embodiments, a user develops at least one 3D printing instruction and directs the 3D printer (e.g., through communication with the 3D printer processor) to print in a requested manner according to the developed at least one 3D printing instruction. A user may or may not be able to control (e.g., locally or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based at least in part on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

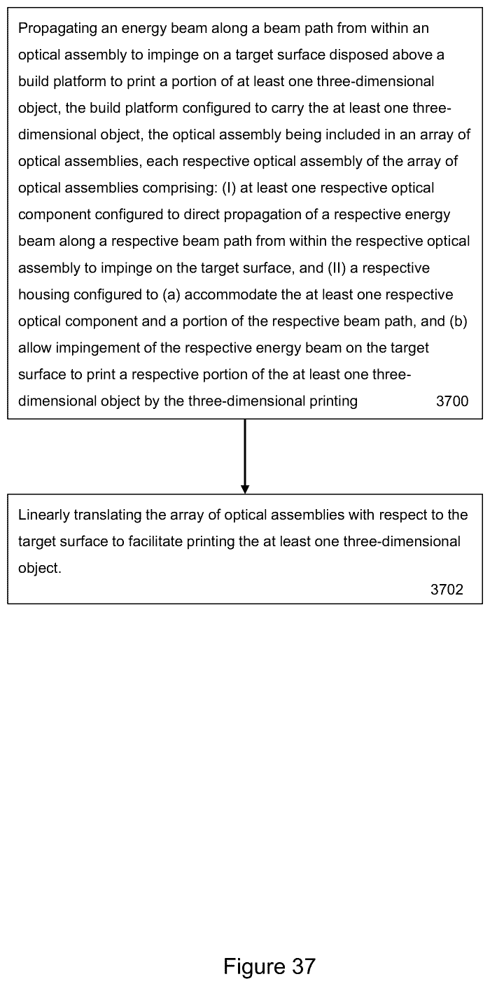

FIG. 37 shows a flow diagram of an example three-dimensional printing process. The 3D printing process comprises: in block 3700, propagating an energy beam along a beam path from within an optical assembly to impinge on a target surface disposed above a build platform to print a portion of at least one three-dimensional object, the build platform configured to carry the at least one three-dimensional object, the optical assembly being included in an array of optical assemblies, each respective optical assembly of the array of optical assemblies comprising: (I) at least one respective optical component configured to direct propagation of a respective energy beam along a respective beam path from in the respective optical assembly to impinge on the target surface, and (II) a respective housing configured to (a) accommodate the at least one respective optical component and a portion of the respective beam path, and (b) allow impingement of the respective energy beam on the target surface to print a respective portion of the at least one three-dimensional object by the three-dimensional printing. In block 3702, (e.g., linearly) translating the array of optical assemblies with respect to the target surface to facilitate printing the at least one three-dimensional object.

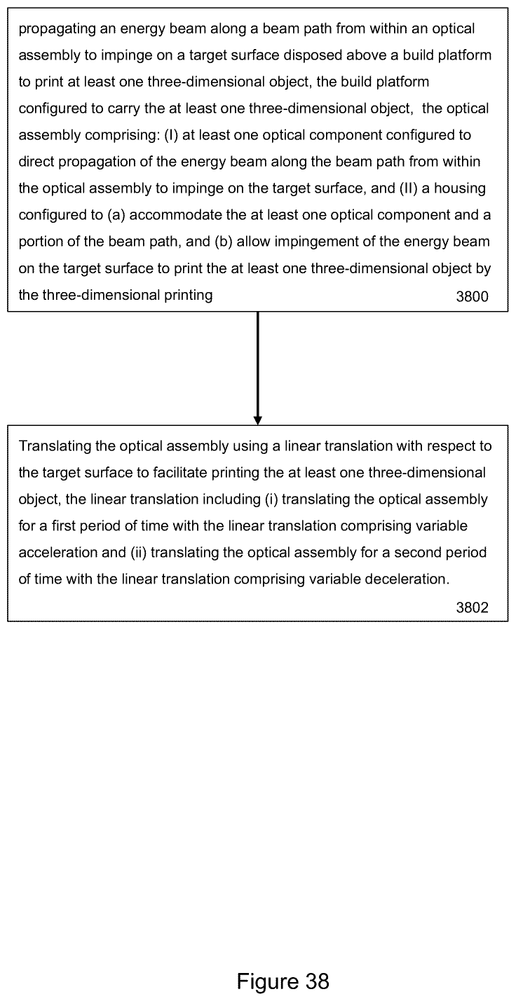

FIG. 38 shows a flow diagram of an example three-dimensional printing process. The 3D printing process comprises: in block 3800, propagating an energy beam along a beam path from within an optical assembly to impinge on a target surface disposed above a build platform to print at least one three-dimensional object, the build platform configured to carry the at least one three-dimensional object, the optical assembly comprising: (I) at least one optical component configured to direct propagation of the energy beam along the beam path from in the optical assembly to impinge on the target surface, and (II) a housing configured to (a) accommodate the at least one optical component and a portion of the beam path, and (b) allow impingement of the energy beam on the target surface to print the at least one three-dimensional object by the three-dimensional printing. In block 3802, translating the optical assembly using a linear translation with respect to the target surface to facilitate printing the at least one three-dimensional object, the linear translation including (i) translating the optical assembly for a first period of time with the linear translation comprising variable acceleration and (ii) translating the optical assembly for a second period of time with the linear translation comprising variable deceleration.

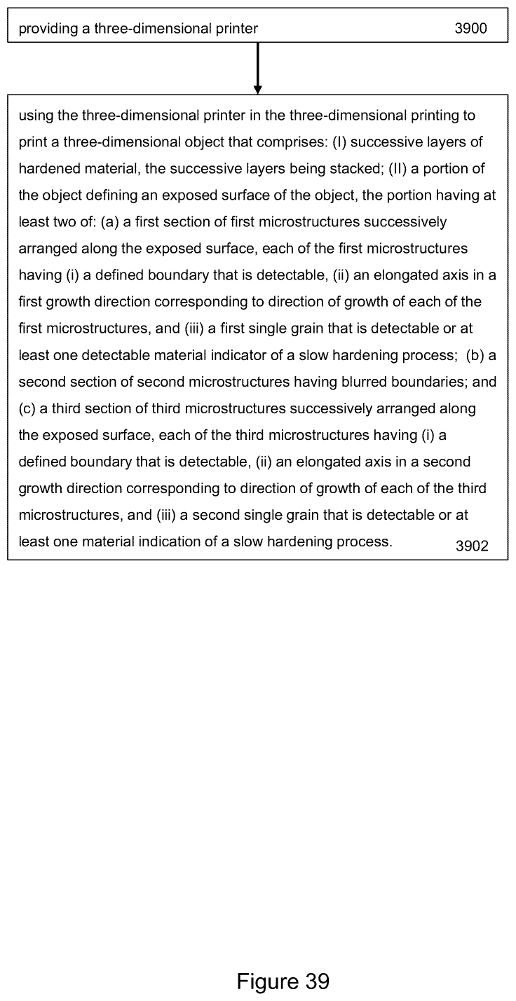

FIG. 39 shows a flow diagram of an example three-dimensional printing process. The 3D printing process comprises: in block 3900, providing a three-dimensional printer; and in block 3902, using the three-dimensional printer in the three-dimensional printing to print a three-dimensional object that comprises: (I) successive layers of hardened material, the successive layers being stacked; (II) a portion of the object defining an exposed surface of the object, the portion having at least two of: (a) a first section of first microstructures successively arranged along the exposed surface, each of the first microstructures having (i) a defined boundary that is detectable, (ii) an elongated axis in a first growth direction corresponding to direction of growth of each of the first microstructures, and (iii) a first single grain that is detectable or at least one detectable material indicator of a slow hardening process; (b) a second section of second microstructures having blurred boundaries; and (c) a third section of third microstructures successively arranged along the exposed surface, each of the third microstructures having (i) a defined boundary that is detectable, (ii) an elongated axis in a second growth direction corresponding to direction of growth of each of the third microstructures, and (iii) a second single grain that is detectable or at least one material indication of a slow hardening process.

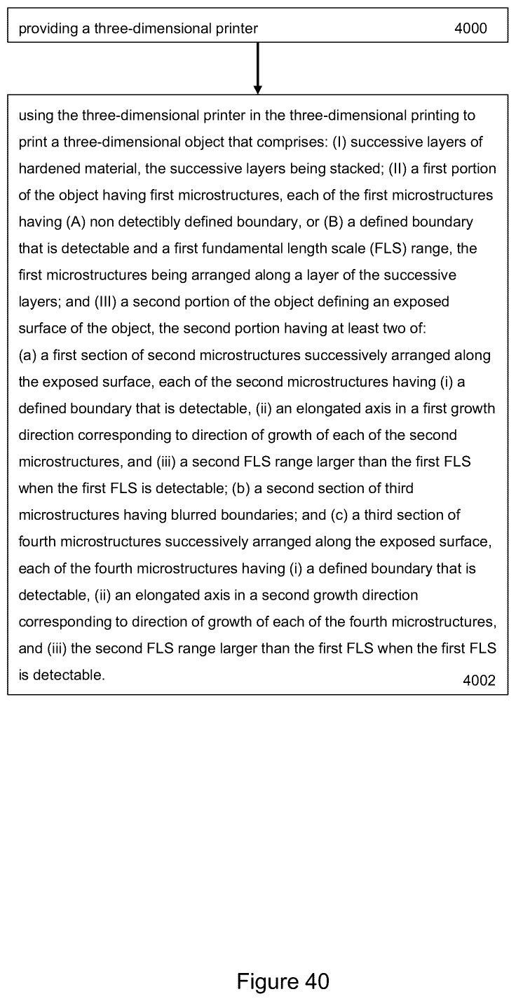

FIG. 40 shows a flow diagram of an example three-dimensional printing process. The 3D printing process comprises: in block 4000, providing a three-dimensional printer; and in block 4002, using the three-dimensional printer in the three-dimensional printing to print a three-dimensional object that comprises: (I) successive layers of hardened material, the successive layers being stacked; (II) a first portion of the object having first microstructures, each of the first microstructures having (A) non detectibly defined boundary, or (B) a defined boundary that is detectable and a first fundamental length scale (FLS) range, the first microstructures being arranged along a layer of the successive layers; and (III) a second portion of the object defining an exposed surface of the object, the second portion having at least two of: (a) a first section of second microstructures successively arranged along the exposed surface, each of the second microstructures having (i) a defined boundary that is detectable, (ii) an elongated axis in a first growth direction corresponding to direction of growth of each of the second microstructures, and (iii) a second FLS range larger than the first FLS when the first FLS is detectable; (b) a second section of third microstructures having blurred boundaries; and (c) a third section of fourth microstructures successively arranged along the exposed surface, each of the fourth microstructures having (i) a defined boundary that is detectable, (ii) an elongated axis in a second growth direction corresponding to direction of growth of each of the fourth microstructures, and (iii) the second FLS range larger than the first FLS when the first FLS is detectable.

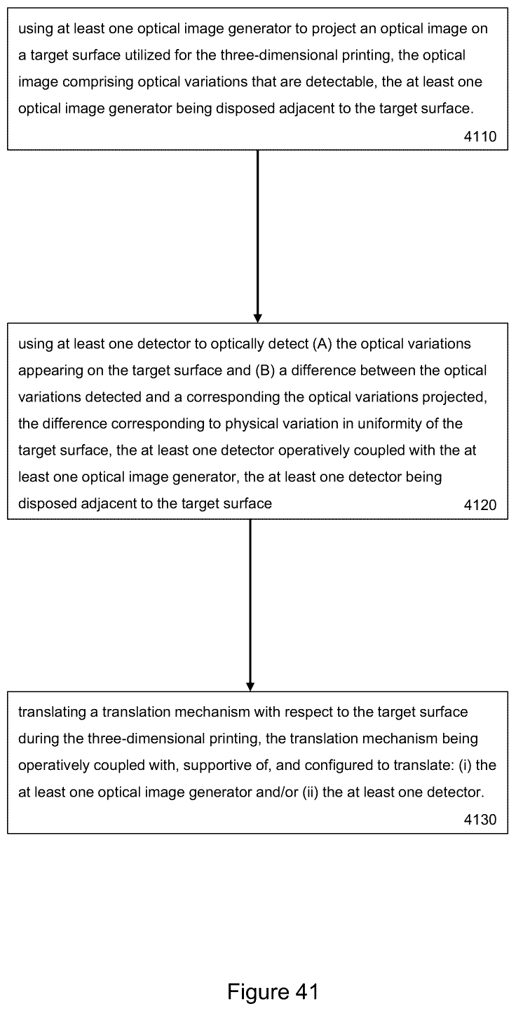

FIG. 41 shows a flow diagram of an example three-dimensional printing process. The 3D printing process comprises: in block 4110, using at least one optical image generator to project an optical image on a target surface utilized for the three-dimensional printing, the optical image comprising optical variations that are detectable, the at least one optical image generator being disposed adjacent to the target surface; in block 4120, using at least one detector to optically detect (A) the optical variations appearing on the target surface and (B) a difference between the optical variations detected and a corresponding the optical variations projected, the difference corresponding to physical variation in uniformity of the target surface, the at least one detector operatively coupled with the at least one optical image generator, the at least one detector being disposed adjacent to the target surface; and in block 4130, translating a translation mechanism with respect to the target surface during the three-dimensional printing, the translation mechanism being operatively coupled to, supportive of, and configured to translate: (i) the at least one optical image generator and/or (ii) the at least one detector.

While preferred embodiments of the present invention have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. A device for three-dimensional printing, the device comprising:
at least one optical image generator configured to project an optical image on a target surface utilized for the three-dimensional printing, the optical image comprising optical variations that are detectable, the at least one optical image generator being disposed adjacent to the target surface;
at least one detector configured to optically detect (A) the optical variations appearing on the target surface and (B) a difference between the optical variations detected and a corresponding the optical variations projected, the difference corresponding to physical variation in uniformity of the target surface, the at least one detector operatively coupled with the at least one optical image generator, the at least one detector being disposed adjacent to the target surface; and
a translation mechanism configured to translate with respect to the target surface during the three-dimensional printing, the translation mechanism being operatively coupled to, supportive of, and configured to translate: (A) the at least one optical image generator and/or (B) the at least one detector.

2. The device of claim 1, wherein the device is utilized at least in part to generate a topographical image of the target surface.

3. The device of claim 2, wherein the device is utilized at least in part to generate a topographical image of the target surface in real time during the three-dimensional printing.

4. The device of claim 1, wherein the uniformity of the target surface comprises uniformity in planarity of the target surface.

5. The device of claim 1, wherein the optical variations comprise a series of optical variations.

6. The device of claim 1, wherein the device is configured to facilitate alteration of the printing based at least in part on the difference detected.

7. The device of claim 6, wherein the device is configured to facilitate alteration of the printing at least in part by being configured to cause alteration of operations of at least one other mechanism associated with the three-dimensional printing, the at least one mechanism being different than the translation mechanism.

8. The device of claim 1, wherein the translation mechanism is configured to linearly translate laterally and parallel to the target surface.

9. The device of claim 1, further comprising an array of optical assemblies, each optical assembly of the array of optical assemblies comprising: (i) at least one optical component configured to direct propagation of an energy beam along a beam path from within the optical assembly to impinge on the target surface disposed above a build platform to print at least one three-dimensional object as part of the three-dimensional printing, the build platform configured to carry at least one three-dimensional object printed by the three-dimensional printing; and (ii) a housing configured to (a) accommodate the at least one optical component and a portion of the beam path of the energy beam, and (b) allow impingement of the energy beam on the target surface to print the at least one three-dimensional object by the three-dimensional printing.

10. The device of claim 9, wherein the optical assembly is reversibly retractable from the device and reversibly insertable into the device.

11. The device of claim 1, wherein an optical image generator is stationary during translation of the translation mechanism, the optical image generator being of the at least one optical image generator.

12. The device of claim 1, wherein an optical image generator translates during translation of the translation mechanism, the optical image generator being of the at least one optical image generator.

13. The device of claim 1, wherein a detector is stationary during translation of the translation mechanism, the detector being of the at least one detector.

14. The device of claim 1, wherein a detector translates during translation of the translation mechanism, the detector being of the at least one detector.

15. The device of claim 1, wherein the translation mechanism is configured to translate for a first period of time comprising variable acceleration and for a second period time comprising variable deceleration.

16. The device of claim 1, further comprising an array of optical windows disposed on a ceiling of an enclosure in which the target surface is disposed, each optical window being configured to respectively facilitate traversal of an energy beam therethrough to impinge on the target surface to print at least one three-dimensional object, the energy beam being of energy beams.

17. The device of claim 16, wherein the device is configured to allow unobstructed operation of the at least one detector, of the at least one optical image generators, and of the energy beams each traversing through an optical window of the array of optical windows.

18. A method of three-dimensional printing, the method comprising: providing the device of claim 1; and using the device as part of the three-dimensional printing.

19. An apparatus for three-dimensional printing, the apparatus comprising at least one controller configured to couple to a power source, the at least one controller being configured to (i) operatively coupled with the device of claim 1; and control, or direct control of, one or more operations associated with the device.

20. Non-transitory computer readable program instructions for three-dimensional printing, the program instructions, when read by one or more processors operatively coupled with the device in device of claim 1, cause the one or more processors to execute, or direct execution of, one or more operations associated with the device, the printing instructions being inscribed on one or more media.
